(19) United States
(12) Patent Application Publication
(10) Pub. No.: US 2022/0229524 A1
(43) Pub. Date: Jul. 21, 2022

(54) METHODS FOR INTERACTING WITH OBJECTS IN AN ENVIRONMENT

(71) Applicant: Apple Inc., Cupertino, CA (US)

(72) Inventors: Christopher D. MCKENZIE, San Mateo, CA (US); Pol PLA I CONESA, San Francisco, CA (US); Stephen O. LEMAY, Palo Alto, CA (US); William A. SORRENTINO, III, San Francisco, CA (US); Shih-Sang CHIU, San Francisco, CA (US); Jonathan RAVASZ, Sunnyvale, CA (US); Benjamin Hunter BOESEL, Cornelius, NC (US); Kristi E. BAUERLY, Sunnyvale, CA (US)

(21) Appl. No.: 17/580,495

(22) Filed: Jan. 20, 2022

Related U.S. Application Data
(60) Provisional application No. 63/139,566, filed on Jan. 20, 2021.
(60) Provisional application No. 63/261,559, filed on Sep. 23, 2021.

(51) Int. Cl. G06F 3/0484; G06V 40/18; G06F 3/01; G06F 3/0481

(52) U.S. Cl. CPC G06F 3/0484; G06V 40/18; G06F 3/0481; G06F 3/017; G06F 3/013

(57) ABSTRACT

In some embodiments, an electronic device selectively performs operations in response to user inputs depending on whether the inputs are preceded by detecting a ready state. In some embodiments, an electronic device processes user inputs based on an attention zone associated with the user. In some embodiments, an electronic device enhances interactions with user interface elements at different distances and/or angles with respect to a gaze of a user. In some embodiments, an electronic device enhances interactions with user interface elements for mixed direct and indirect interaction modes. In some embodiments, an electronic device manages inputs from two of the user's hands and/or presents visual indications of user inputs. In some embodiments, an electronic device enhances interactions with user interface elements in a three-dimensional environment using visual indications of such interactions. In some embodiments, an electronic device redirects a selection input from one user interface element to another.

### CROSS-REFERENCE TO RELATED APPLICATIONS

This application claims the benefit of U.S. Provisional Application No. 63/139,566, filed Jan. 20, 2021, and U.S. Provisional Application No. 63/261,559, filed Sep. 23, 2021, the contents of which are incorporated herein by reference in their entireties for all purposes.

### TECHNICAL FIELD

This relates generally to computer systems with a display generation component and one or more input devices that present graphical user interfaces, including but not limited to electronic devices that present interactive user interface elements via the display generation component.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects include digital images, video, text, icons, and control elements such as buttons and other graphics.

But methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious and error-prone, create a significant cognitive burden on a user, and detract from the experience with the virtual/augmented reality environment. In addition, these methods take longer than necessary, thereby wasting energy. This latter consideration is particularly important in battery-operated devices.

### SUMMARY

Accordingly, there is a need for computer systems with improved methods and interfaces for providing computer generated experiences to users that make interaction with the computer systems more efficient and intuitive for a user. Such methods and interfaces optionally complement or replace conventional methods for providing computer generated reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems with a display generation component and one or more input devices are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has a touch-sensitive display (also known as a “touch screen” or “touch-screen display”). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through stylus and/or finger contacts and gestures on the touch-sensitive surface, movement of the user's eyes and hand in space relative to the GUI or the user's body as captured by cameras and other movement sensors, and voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a non-transitory computer readable storage medium or other computer program product configured for execution by one or more processors.

There is a need for electronic devices with improved methods and interfaces for interacting with objects in a three-dimensional environment. Such methods and interfaces may complement or replace conventional methods for interacting with objects in a three-dimensional environment. Such methods and interfaces reduce the number, extent, and/or the nature of the inputs from a user and produce a more efficient human-machine interface.

In some embodiments, an electronic device performs or does not perform an operation in response to a user input depending on whether the user input is preceded by detecting a ready state of the user. In some embodiments, an electronic device processes user inputs based on an attention zone associated with the user. In some embodiments, an electronic device enhances interactions with user interface elements at different distances and/or angles with respect to a gaze of a user in a three-dimensional environment. In some embodiments, an electronic device enhances interactions with user interface elements for mixed direct and indirect interaction modes. In some embodiments, an electronic device manages inputs from two of the user's hands. In some embodiments, an electronic device presents visual indications of user inputs. In some embodiments, an electronic device enhances interactions with user interface elements in a three-dimensional environment using visual indications of such interactions. In some embodiments, an electronic device redirects an input from one user interface element to another in accordance with movement included in the input.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1 is a block diagram illustrating an operating environment of a computer system for providing CGR experiences in accordance with some embodiments.

FIG. 2 is a block diagram illustrating a controller of a computer system that is configured to manage and coordinate a CGR experience for the user in accordance with some embodiments.

FIG. 3 is a block diagram illustrating a display generation component of a computer system that is configured to provide a visual component of the CGR experience to the user in accordance with some embodiments.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6A is a flowchart illustrating a glint-assisted gaze tracking pipeline in accordance with some embodiments.

FIG. 6B illustrates an exemplary environment of an electronic device providing a CGR experience in accordance with some embodiments.

FIGS. 7A-7C illustrate exemplary ways in which electronic devices perform or do not perform an operation in response to a user input depending on whether the user input is preceded by detecting a ready state of the user in accordance with some embodiments.

FIGS. 8A-8K is a flowchart illustrating a method of performing or not performing an operation in response to a user input depending on whether the user input is preceded by detecting a ready state of the user in accordance with some embodiments.

FIGS. 9A-9C illustrate exemplary ways in which an electronic device processes user inputs based on an attention zone associated with the user in accordance with some embodiments.

FIGS. 10A-10H is a flowchart illustrating a method of processing user inputs based on an attention zone associated with the user in accordance with some embodiments.

FIGS. 11A-11C illustrate examples of how an electronic device enhances interactions with user interface elements at different distances and/or angles with respect to a gaze of a user in a three-dimensional environment in accordance with some embodiments.

FIGS. 12A-12F is a flowchart illustrating a method of enhancing interactions with user interface elements at different distances and/or angles with respect to a gaze of a user in a three-dimensional environment in accordance with some embodiments.

FIGS. 13A-13C illustrate examples of how an electronic device enhances interactions with user interface elements for mixed direct and indirect interaction modes in accordance with some embodiments.

FIGS. 14A-14H is a flowchart illustrating a method of enhancing interactions with user interface elements for mixed direct and indirect interaction modes in accordance with some embodiments.

FIGS. 15A-15E illustrate exemplary ways in which an electronic device manages inputs from two of the user's hands according to some embodiments.

FIGS. 16A-16I is a flowchart illustrating a method of managing inputs from two of the user's hands according to some embodiments.

FIGS. 17A-17E illustrate various ways in which an electronic device presents visual indications of user inputs according to some embodiments.

FIGS. 18A-180 is a flowchart illustrating a method of presenting visual indications of user inputs according to some embodiments.

FIGS. 19A-19D illustrate examples of how an electronic device enhances interactions with user interface elements in a three-dimensional environment using visual indications of such interactions in accordance with some embodiments.

FIGS. 20A-20F is a flowchart illustrating a method of enhancing interactions with user interface elements in a three-dimensional environment using visual indications of such interactions in accordance with some embodiments.

FIGS. 21A-21E illustrate examples of how an electronic device redirects an input from one user interface element to another in response to detecting movement included in the input in accordance with some embodiments.

FIGS. 22A-22K is a flowchart illustrating a method of redirecting an input from one user interface element to another in response to detecting movement included in the input in accordance with some embodiments.

### DESCRIPTION OF EMBODIMENTS

The present disclosure relates to user interfaces for providing a computer generated reality (CGR) experience to a user, in accordance with some embodiments.

The systems, methods, and GUIs described herein provide improved ways for an electronic device to interact with and manipulate objects in a three-dimensional environment. The three-dimensional environment optionally includes one or more virtual objects, one or more representations of real objects (e.g., displayed as photorealistic (e.g., “pass-through”) representations of the real objects or visible to the user through a transparent portion of the display generation component) that are in the physical environment of the electronic device, and/or representations of users in the three-dimensional environment.

In some embodiments, an electronic device automatically updates the orientation of a virtual object in a three-dimensional environment based on a viewpoint of a user in the three-dimensional environment. In some embodiments, the electronic device moves the virtual object in accordance with a user input and, in response to termination of the user input, displays the object at an updated location. In some embodiments, the electronic device automatically updates the orientation of the virtual object at the updated location (e.g., and/or as the virtual object moves to the updated location) so that the virtual object is oriented towards a viewpoint of the user in the three-dimensional environment (e.g., throughout and/or at the end of its movement). Automatically updating the orientation of the virtual object in the three-dimensional environment enables the user to view and interact with the virtual object more naturally and efficiently, without requiring the user to adjust the orientation of the object manually.

In some embodiments, an electronic device automatically updates the orientation of a virtual object in a three-dimensional environment based on viewpoints of a plurality of users in the three-dimensional environment. In some embodiments, the electronic device moves the virtual object in accordance with a user input and, in response to termination of the user input, displays the object at an updated location. In some embodiments, the electronic device automatically updates the orientation of the virtual object at the updated location (e.g., and/or as the virtual object moves to the updated location) so that the virtual object is oriented towards viewpoints of a plurality of users in the three-dimensional environment (e.g., throughout and/or at the end of its movement). Automatically updating the orientation of the virtual object in the three-dimensional environment enables the users to view and interact with the virtual object more naturally and efficiently, without requiring the users to adjust the orientation of the object manually.

In some embodiments, the electronic device modifies an appearance of a real object that is between a virtual object and the viewpoint of a user in a three-dimensional environment. The electronic device optionally blurs, darkens, or otherwise modifies a portion of a real object (e.g., displayed as a photorealistic (e.g., “pass-through”) representation of the real object or visible to the user through a transparent portion of the display generation component) that is in between a viewpoint of a user and a virtual object in the three-dimensional environment. In some embodiments, the electronic device modifies a portion of the real object that is within a threshold distance (e.g., 5, 10, 30, 50, 100, etc. centimeters) of a boundary of the virtual object without modifying a portion of the real object that is more than the threshold distance from the boundary of the virtual object. Modifying the appearance of the real object allows the user to more naturally and efficiently view and interact with the virtual object. Moreover, modifying the appearance of the real object reduces cognitive burden on the user.

In some embodiments, the electronic device automatically selects a location for a user in a three-dimensional environment that includes one or more virtual objects and/or other users. In some embodiments, a user gains access to a three-dimensional environment that already includes one or more other users and one or more virtual objects. In some embodiments, the electronic device automatically selects a location with which to associate the user (e.g., a location at which to place the viewpoint of the user) based on the locations and orientations of the virtual objects and other users in the three-dimensional environment. In some embodiments, the electronic device selects a location for the user to enable the user to view the other users and the virtual objects in the three-dimensional environment without blocking other users' views of the users and the virtual objects. Automatically placing the user in the three-dimensional environment based on the locations and orientations of the virtual objects and other users in the three-dimensional environment enables the user to efficiently view and interact with the virtual objects and other users in the three-dimensional environment, without requiring the user manually select a location in the three-dimensional environment with which to be associated.

In some embodiments, the electronic device redirects an input from one user interface element to another in accordance with movement included in the input. In some embodiments, the electronic device presents a plurality of interactive user interface elements and receives, via one or more input devices, an input directed to a first user interface element of the plurality of user interface elements. In some embodiments, after detecting a portion of the input (e.g., without detecting the entire input), the electronic device detects a movement portion of the input corresponding to a request to redirect the input to a second user interface element. In response, in some embodiments, the electronic device directs the input to the second user interface element. In some embodiments, in response to movement that satisfies one or more criteria (e.g., based on speed, duration, distance, etc.), the electronic device cancels the input instead of redirecting the input. Enabling the user to redirect or cancel an input after providing a portion of the input enables the user to efficiently interact with the electronic device with fewer inputs (e.g., to undo unintended actions and/or to direct the input to a different user interface element).

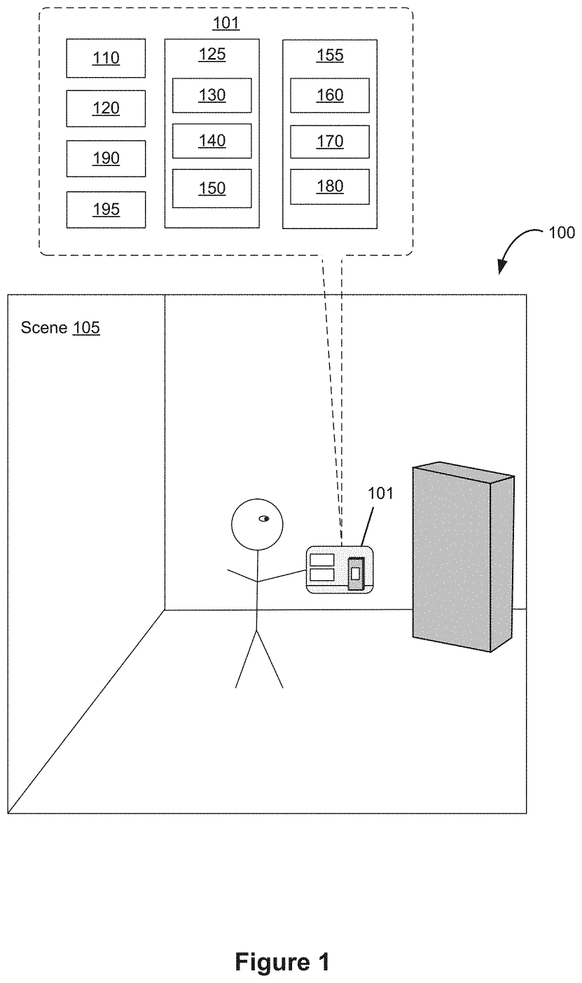

FIGS. 1-6 provide a description of example computer systems for providing CGR experiences to users (such as described below with respect to methods 800, 1000, 1200, 1400, 1600, 1800, 2000, and 2200). In some embodiments, as shown in FIG. 1, the CGR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

When describing a CGR experience, various terms are used to differentially refer to several related but distinct environments that the user may sense and/or with which a user may interact (e.g., with inputs detected by a computer system 101 generating the CGR experience that cause the computer system generating the CGR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Computer-generated reality: In contrast, a computer-generated reality (CGR) environment refers to a wholly or partially simulated environment that people sense and/or interact with via an electronic system. In CGR, a subset of a person's physical motions, or representations thereof, are tracked, and, in response, one or more characteristics of one or more virtual objects simulated in the CGR environment are adjusted in a manner that comports with at least one law of physics. For example, a CGR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a CGR environment may be made in response to representations of physical motions (e.g., vocal commands). A person may sense and/or interact with a CGR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some CGR environments, a person may sense and/or interact only with audio objects.

Examples of CGR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

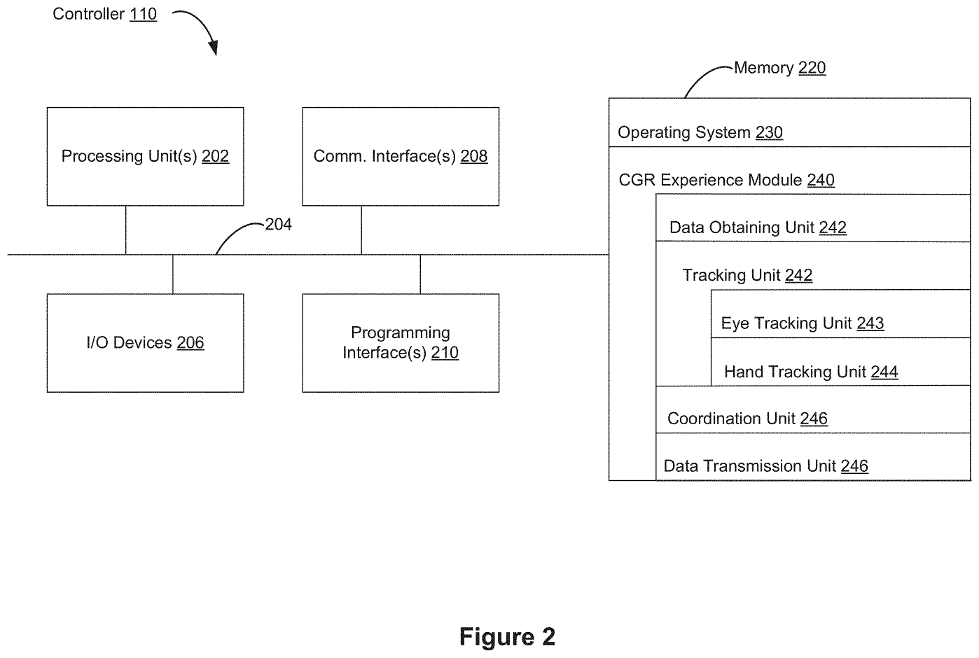

Hardware: There are many different types of electronic systems that enable a person to sense and/or interact with various CGR environments. Examples include head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a CGR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

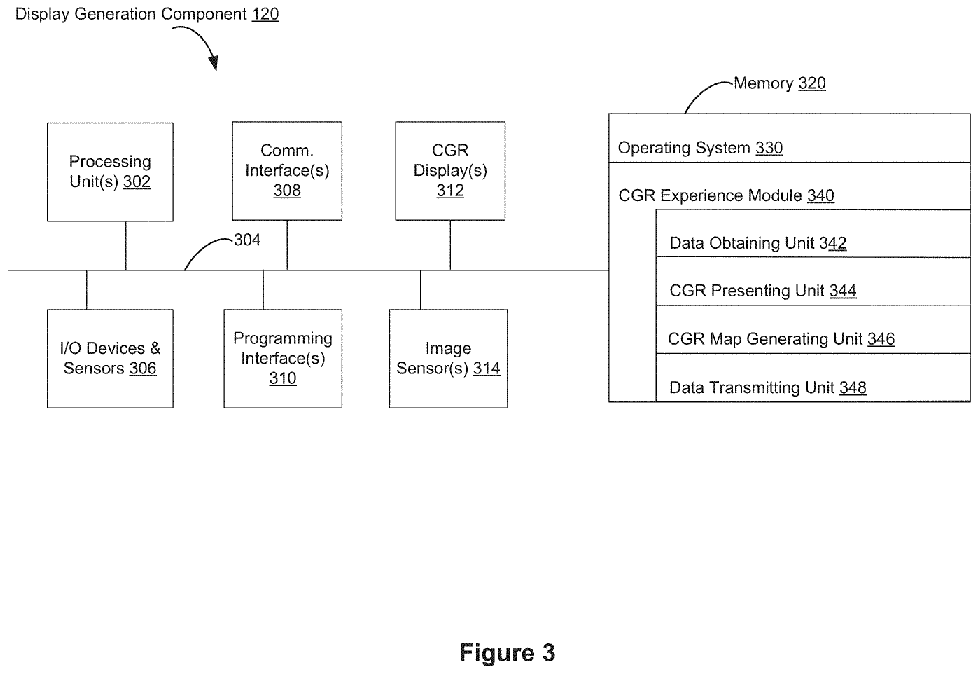

In some embodiments, the display generation component 120 is configured to provide the CGR experience (e.g., at least a visual component of the CGR experience) to the user. In some embodiments, the display generation component 120 includes a suitable combination of software, firmware, and/or hardware. The display generation component 120 is described in greater detail below with respect to FIG. 3. In some embodiments, the functionalities of the controller 110 are provided by and/or combined with the display generation component 120.

According to some embodiments, the display generation component 120 provides a CGR experience to the user while the user is virtually and/or physically present within the scene 105.

In some embodiments, the display generation component is worn on a part of the user's body (e.g., on his/her head, on his/her hand, etc.). As such, the display generation component 120 includes one or more CGR displays provided to display the CGR content. For example, in various embodiments, the display generation component 120 encloses the field-of-view of the user. In some embodiments, the display generation component 120 is a handheld device (such as a smartphone or tablet) configured to present CGR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a CGR chamber, enclosure, or room configured to present CGR content in which the user does not wear or hold the display generation component 120. Many user interfaces described with reference to one type of hardware for displaying CGR content (e.g., a handheld device or a device on a tripod) could be implemented on another type of hardware for displaying CGR content (e.g., an HMD or other wearable computing device). For example, a user interface showing interactions with CGR content triggered based on interactions that happen in a space in front of a handheld or tripod mounted device could similarly be implemented with an HMD where the interactions happen in a space in front of the HMD and the responses of the CGR content are displayed via the HMD. Similarly, a user interface showing interactions with CRG content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operation environment 100 are shown in FIG. 1, those of ordinary skill in the art will appreciate from the present disclosure that various other features have not been illustrated for the sake of brevity and so as not to obscure more pertinent aspects of the example embodiments disclosed herein.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a CGR experience module 240.

The operating system 230 includes instructions for handling various basic system services and for performing hardware dependent tasks. In some embodiments, the CGR experience module 240 is configured to manage and coordinate one or more CGR experiences for one or more users (e.g., a single CGR experience for one or more users, or multiple CGR experiences for respective groups of one or more users). To that end, in various embodiments, the CGR experience module 240 includes a data obtaining unit 242, a tracking unit 244, a coordination unit 246, and a data transmitting unit 248.

In some embodiments, the data obtaining unit 242 is configured to obtain data (e.g., presentation data, interaction data, sensor data, location data, etc.) from at least the display generation component 120 of FIG. 1, and optionally one or more of the input devices 125, output devices 155, sensors 190, and/or peripheral devices 195. To that end, in various embodiments, the data obtaining unit 242 includes instructions and/or logic therefor, and heuristics and metadata therefor.

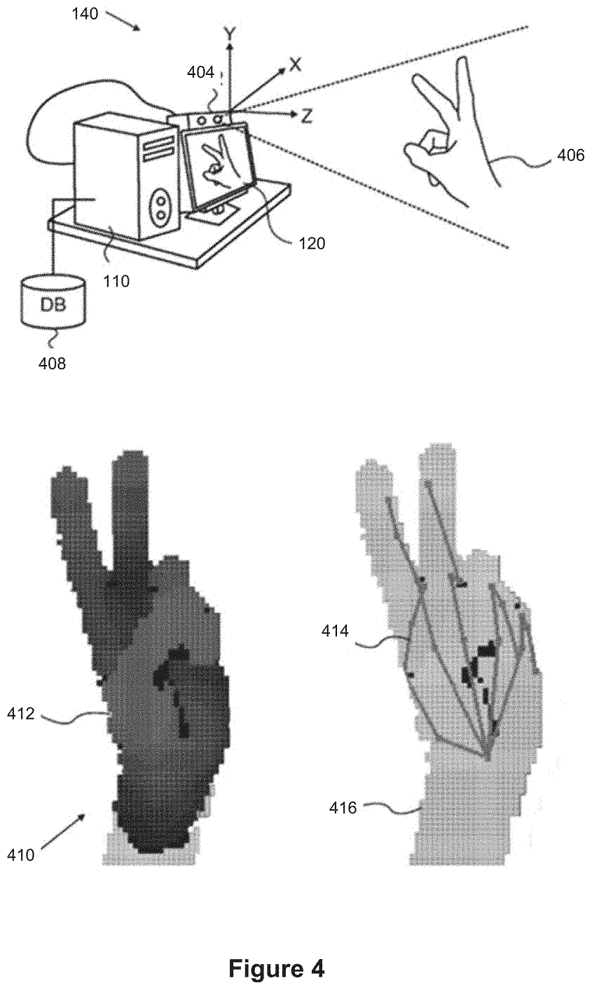

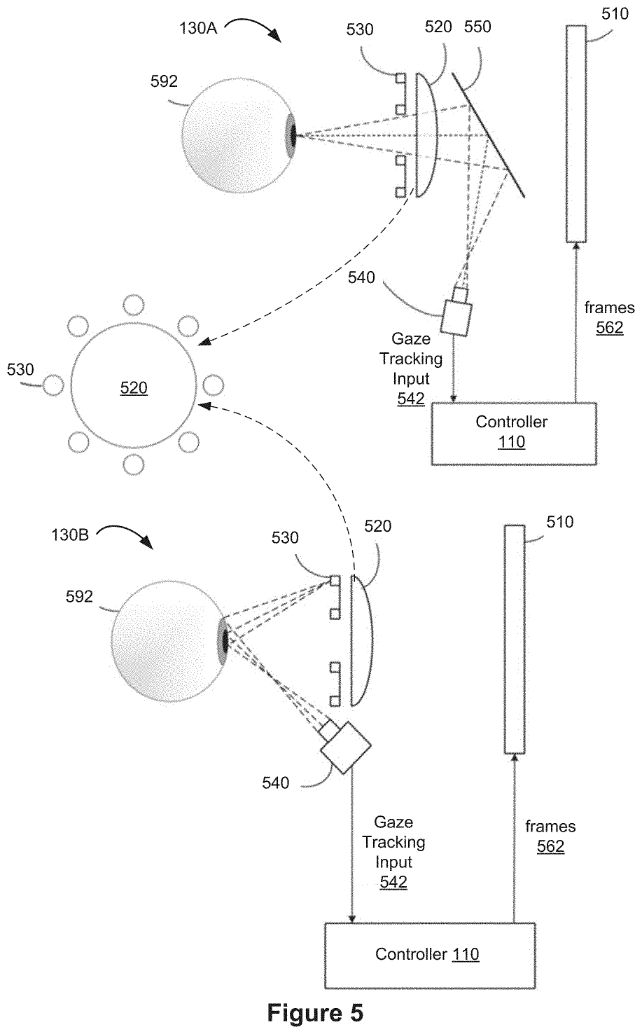

In some embodiments, the tracking unit 244 is configured to map the scene 105 and to track the position/location of at least the display generation component 120 with respect to the scene 105 of FIG. 1, and optionally, to one or more of the input devices 125, output devices 155, sensors 190, and/or peripheral devices 195. To that end, in various embodiments, the tracking unit 244 includes instructions and/or logic therefor, and heuristics and metadata therefor. In some embodiments, the tracking unit 244 includes hand tracking unit 243 and/or eye tracking unit 245. In some embodiments, the hand tracking unit 243 is configured to track the position/location of one or more portions of the user's hands, and/or motions of one or more portions of the user's hands with respect to the scene 105 of FIG. 1, relative to the display generation component 120, and/or relative to a coordinate system defined relative to the user's hand. The hand tracking unit 243 is described in greater detail below with respect to FIG. 4. In some embodiments, the eye tracking unit 245 is configured to track the position and movement of the user's gaze (or more broadly, the user's eyes, face, or head) with respect to the scene 105 (e.g., with respect to the physical environment and/or to the user (e.g., the user's hand)) or with respect to the CGR content displayed via the display generation component 120. The eye tracking unit 245 is described in greater detail below with respect to FIG. 5.

In some embodiments, the coordination unit 246 is configured to manage and coordinate the CGR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 242, the tracking unit 244 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 242, the tracking unit 244 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3 is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the HMD 120 includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more CGR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more CGR displays 312 are configured to provide the CGR experience to the user. In some embodiments, the one or more CGR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more CGR displays 312 correspond to diffractive, reflective, polarized, holographic, etc. waveguide displays. For example, the HMD 120 includes a single CGR display. In another example, the HMD 120 includes a CGR display for each eye of the user. In some embodiments, the one or more CGR displays 312 are capable of presenting MR and VR content. In some embodiments, the one or more CGR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the HMD 120 was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a CGR presentation module 340.

The operating system 330 includes instructions for handling various basic system services and for performing hardware dependent tasks. In some embodiments, the CGR presentation module 340 is configured to present CGR content to the user via the one or more CGR displays 312. To that end, in various embodiments, the CGR presentation module 340 includes a data obtaining unit 342, a CGR presenting unit 344, a CGR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1. To that end, in various embodiments, the data obtaining unit 342 includes instructions and/or logic therefor, and heuristics and metadata therefor.

In some embodiments, the CGR presenting unit 344 is configured to present CGR content via the one or more CGR displays 312. To that end, in various embodiments, the CGR presenting unit 344 includes instructions and/or logic therefor, and heuristics and metadata therefor.

In some embodiments, the CGR map generating unit 346 is configured to generate a CGR map (e.g., a 3D map of the mixed reality scene or a map of the physical environment into which computer generated objects can be placed to generate the computer generated reality) based on media content data. To that end, in various embodiments, the CGR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the CGR presenting unit 344, the CGR map generating unit 346, and the data transmitting unit 348 are shown as residing on a single device (e.g., the display generation component 120 of FIG. 1), it should be understood that in other embodiments, any combination of the data obtaining unit 342, the CGR presenting unit 344, the CGR map generating unit 346, and the data transmitting unit 348 may be located in separate computing devices.

Moreover, FIG. 3 is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 4 is a schematic, pictorial illustration of an example embodiment of the hand tracking device 140. In some embodiments, hand tracking device 140 (FIG. 1) is controlled by hand tracking unit 243 (FIG. 2) to track the position/location of one or more portions of the user's hands, and/or motions of one or more portions of the user's hands with respect to the scene 105 of FIG. 1 (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 outputs a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 408 and changing his hand posture.

In some embodiments, the image sensors 404 project a pattern of spots onto a scene containing the hand 406 and captures an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the hand tracking device 440 may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion and gesture information are provided via the above-mentioned API to an application program running on the controller 110. This program may, for example, move and modify images presented on the display generation component 120, or perform other functions, in response to the pose and/or gesture information.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 440, some or all of the processing functions of the controller may be performed by a suitable microprocessor and software or by dedicated circuitry within the housing of the hand tracking device 402 or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1). In some embodiments, the eye tracking device 130 is controlled by the eye tracking unit 245 (FIG. 2) to track the position and movement of the user's gaze with respect to the scene 105 or with respect to the CGR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the CGR content for viewing by the user and a component for tracking the gaze of the user relative to the CGR content. In some embodiments, the eye tracking device 130 is separate from the display generation component 120. For example, when display generation component is a handheld device or a CGR chamber, the eye tracking device 130 is optionally a separate device from the handheld device or CGR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, a gaze tracking device 130 includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The gaze tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provide the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the CGR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., light sources 530 (e.g., IR or NIR LEDs), mounted in a wearable housing. The Light sources emit light (e.g., IR or NIR light) towards the user's eye(s) 592. In some embodiments, the light sources may be arranged in rings or circles around each of the lenses as shown in FIG. 5. In some embodiments, eight light sources 530 (e.g., LEDs) are arranged around each lens 520 as an example. However, more or fewer light sources 530 may be used, and other arrangements and locations of light sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g. 850 nm) and a camera 540 that operates at a different wavelength (e.g. 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

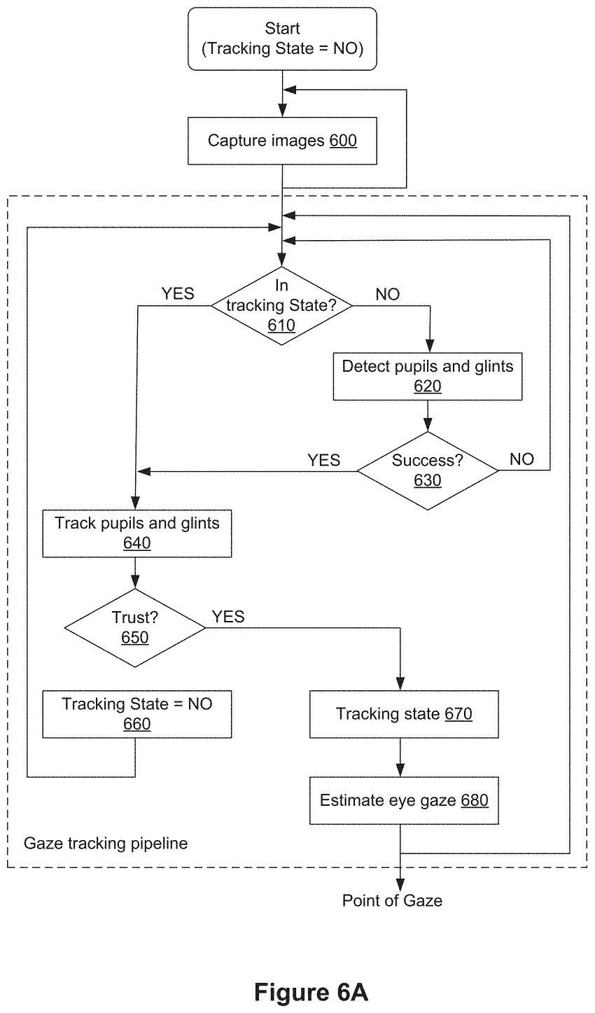

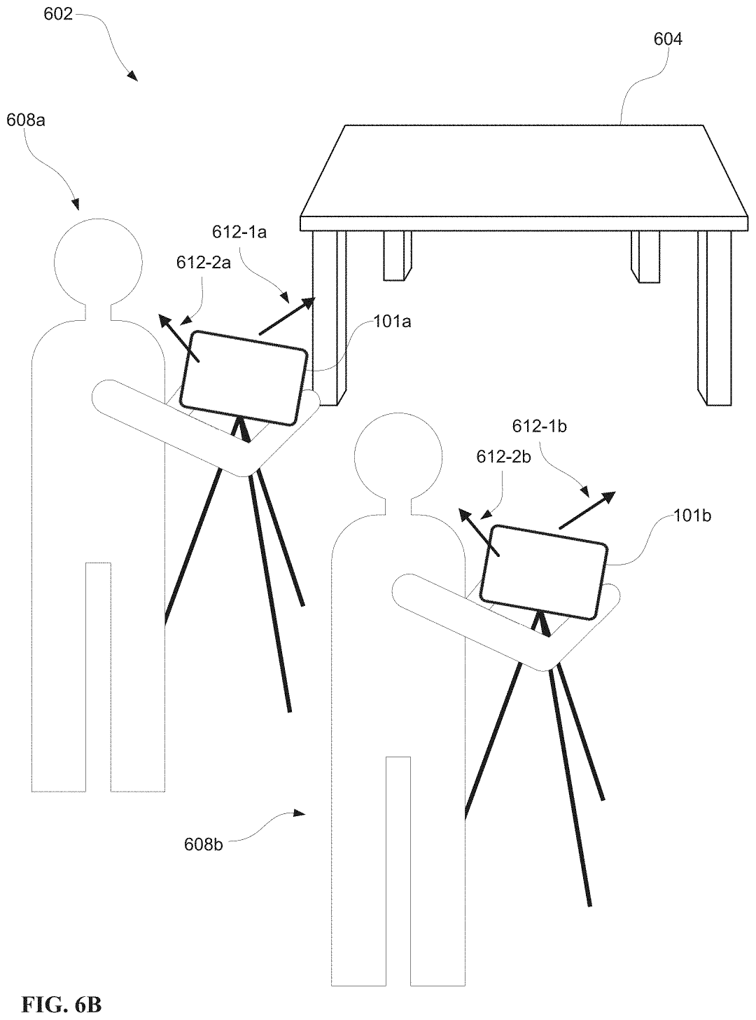

FIG. 6A illustrates a glint-assisted gaze tracking pipeline, in accordance with some embodiments. In some embodiments, the gaze tracking pipeline is implemented by a glint-assisted gaze tracing system (e.g., eye tracking device 130 as illustrated in FIGS. 1 and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6A, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 410, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6A is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing CGR experiences to users, in accordance with various embodiments.

FIG. 6B illustrates an exemplary environment of electronic devices 101a and 101b providing a CGR experience in accordance with some embodiments. In FIG. 6B, real world environment 602 includes electronic devices 101a and 101b, users 608a and 608b, and a real world object (e.g., table 604). As shown in FIG. 6B, electronic devices 101a and 101b are optionally mounted on tripods or otherwise secured in real world environment 602 such that one or more hands of users 608a and 608b are free (e.g., users 608a and 608b are optionally not holding devices 101a and 101b with one or more hands). As described above, devices 101a and 101b optionally have one or more groups of sensors positioned on different sides of devices 101a and 101b, respectively. For example, devices 101a and 101b optionally include sensor group 612-1a and 612-1b and sensor groups 612-2a and 612-2b located on the “back” and “front” sides of devices 101a and 101b, respectively (e.g., which are able to capture information from the respective sides of devices 101a and 101b). As used herein, the front side of devices 101a are the sides that are facing users 608a and 608b, and the back side of devices 101a and 101b are the side facing away from users 608a and 608b.

In some embodiments, sensor groups 612-2a and 612-2b include eye tracking units (e.g., eye tracking unit 245 described above with reference to FIG. 2) that include one or more sensors for tracking the eyes and/or gaze of the user such that the eye tracking units are able to “look” at users 608a and 608b and track the eye(s) of users 608a and 608b in the manners previously described. In some embodiments, the eye tracking unit of devices 101a and 101b are able to capture the movements, orientation, and/or gaze of the eyes of users 608a and 608b and treat the movements, orientation, and/or gaze as inputs.

In some embodiments, sensor groups 612-1a and 612-1b include hand tracking units (e.g., hand tracking unit 243 described above with reference to FIG. 2) that are able to track one or more hands of users 608a and 608b that are held on the “back” side of devices 101a and 101b, as shown in FIG. 6B. In some embodiments, the hand tracking units are optionally included in sensor groups 612-2a and 612-2b such that users 608a and 608b are able to additionally or alternatively hold one or more hands on the “front” side of devices 101a and 101b while devices 101a and 101b track the position of the one or more hands. As described above, the hand tracking unit of devices 101a and 101b are able to capture the movements, positions, and/or gestures of the one or more hands of users 608a and 608b and treat the movements, positions, and/or gestures as inputs.

In some embodiments, sensor groups 612-1a and 612-1b optionally include one or more sensors configured to capture images of real world environment 602, including table 604 (e.g., such as image sensors 404 described above with reference to FIG. 4). As described above, devices 101a and 101b are able to capture images of portions (e.g., some or all) of real world environment 602 and present the captured portions of real world environment 602 to the user via one or more display generation components of devices 101a and 101b (e.g., the displays of devices 101a and 101b, which are optionally located on the side of devices 101a and 101b that are facing the user, opposite of the side of devices 101a and 101b that are facing the captured portions of real world environment 602).

In some embodiments, the captured portions of real world environment 602 are used to provide a CGR experience to the user, for example, a mixed reality environment in which one or more virtual objects are superimposed over representations of real world environment 602.

Thus, the description herein describes some embodiments of three-dimensional environments (e.g., CGR environments) that include representations of real world objects and representations of virtual objects. For example, a three-dimensional environment optionally includes a representation of a table that exists in the physical environment, which is captured and displayed in the three-dimensional environment (e.g., actively via cameras and displays of an electronic device, or passively via a transparent or translucent display of the electronic device). As described previously, the three-dimensional environment is optionally a mixed reality system in which the three-dimensional environment is based on the physical environment that is captured by one or more sensors of the device and displayed via a display generation component. As a mixed reality system, the device is optionally able to selectively display portions and/or objects of the physical environment such that the respective portions and/or objects of the physical environment appear as if they exist in the three-dimensional environment displayed by the electronic device. Similarly, the device is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the device optionally displays a vase such that it appears as if a real vase is placed on top of a table in the physical environment. In some embodiments, each location in the three-dimensional environment has a corresponding location in the physical environment. Thus, when the device is described as displaying a virtual object at a respective location with respect to a physical object (e.g., such as a location at or near the hand of the user, or at or near a physical table), the device displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment can interact with virtual objects that exist only in the three-dimensional environment. For example, a three-dimensional environment can include a table and a vase placed on top of the table, with the table being a view of (or a representation of) a physical table in the physical environment, and the vase being a virtual object.

Similarly, a user is optionally able to interact with virtual objects in the three-dimensional environment using one or more hands as though the virtual objects were real objects in the physical environment. For example, as described above, one or more sensors of the device optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or projection of the user interface onto a transparent/translucent surface or projection of the user interface onto the user's eye or into a field of view of the user's eye. Thus, in some embodiments, the hands of the user are displayed at a respective location in the three-dimensional environment and are treated as though they were objects in the three-dimensional environment that are able to interact with the virtual objects in the three-dimensional environment as though they were real physical objects in the physical environment. In some embodiments, a user is able to move his or her hands to cause the representations of the hands in the three-dimensional environment to move in conjunction with the movement of the user's hand.

In some of the embodiments described below, the device is optionally able to determine the “effective” distance between physical objects in the physical world and virtual objects in the three-dimensional environment, for example, for the purpose of determining whether a physical object is interacting with a virtual object (e.g., whether a hand is touching, grabbing, holding, etc. a virtual object or within a threshold distance from a virtual object). For example, the device determines the distance between the hands of the user and virtual objects when determining whether the user is interacting with virtual objects and/or how the user is interacting with virtual objects. In some embodiments, the device determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the device optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared against the position of the virtual object of interest in the three-dimensional environment to determine the distance between the one or more hands of the user and the virtual object. In some embodiments, the device optionally determines a distance between a physical object and a virtual object by comparing positions in the physical world (e.g., as opposed to comparing positions in the three-dimensional environment). For example, when determining the distance between one or more hands of the user and a virtual object, the device optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the device optionally performs any of the techniques described above to map the location of the physical object to the three-dimensional environment and/or map the location of the virtual object to the physical world.

In some embodiments, the same or similar technique is used to determine where and what the gaze of the user is directed to and/or where and at what a physical stylus held by a user is pointed. For example, if the gaze of the user is directed to a particular position in the physical environment, the device optionally determines the corresponding position in the three-dimensional environment and if a virtual object is located at that corresponding virtual position, the device optionally determines that the gaze of the user is directed to that virtual object. Similarly, the device is optionally able to determine, based on the orientation of a physical stylus, to where in the physical world the stylus is pointing. In some embodiments, based on this determination, the device determines the corresponding virtual position in the three-dimensional environment that corresponds to the location in the physical world to which the stylus is pointing, and optionally determines that the stylus is pointing at the corresponding virtual position in the three-dimensional environment.

Similarly, the embodiments described herein may refer to the location of the user (e.g., the user of the device) and/or the location of the device in the three-dimensional environment. In some embodiments, the user of the device is holding, wearing, or otherwise located at or near the electronic device. Thus, in some embodiments, the location of the device is used as a proxy for the location of the user. In some embodiments, the location of the device and/or user in the physical environment corresponds to a respective location in the three-dimensional environment. In some embodiments, the respective location is the location from which the “camera” or “view” of the three-dimensional environment extends. For example, the location of the device would be the location in the physical environment (and its corresponding location in the three-dimensional environment) from which, if a user were to stand at that location facing the respective portion of the physical environment displayed by the display generation component, the user would see the objects in the physical environment in the same position, orientation, and/or size as they are displayed by the display generation component of the device (e.g., in absolute terms and/or relative to each other). Similarly, if the virtual objects displayed in the three-dimensional environment were physical objects in the physical environment (e.g., placed at the same location in the physical environment as they are in the three-dimensional environment, and having the same size and orientation in the physical environment as in the three-dimensional environment), the location of the device and/or user is the position at which the user would see the virtual objects in the physical environment in the same position, orientation, and/or size as they are displayed by the display generation component of the device (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

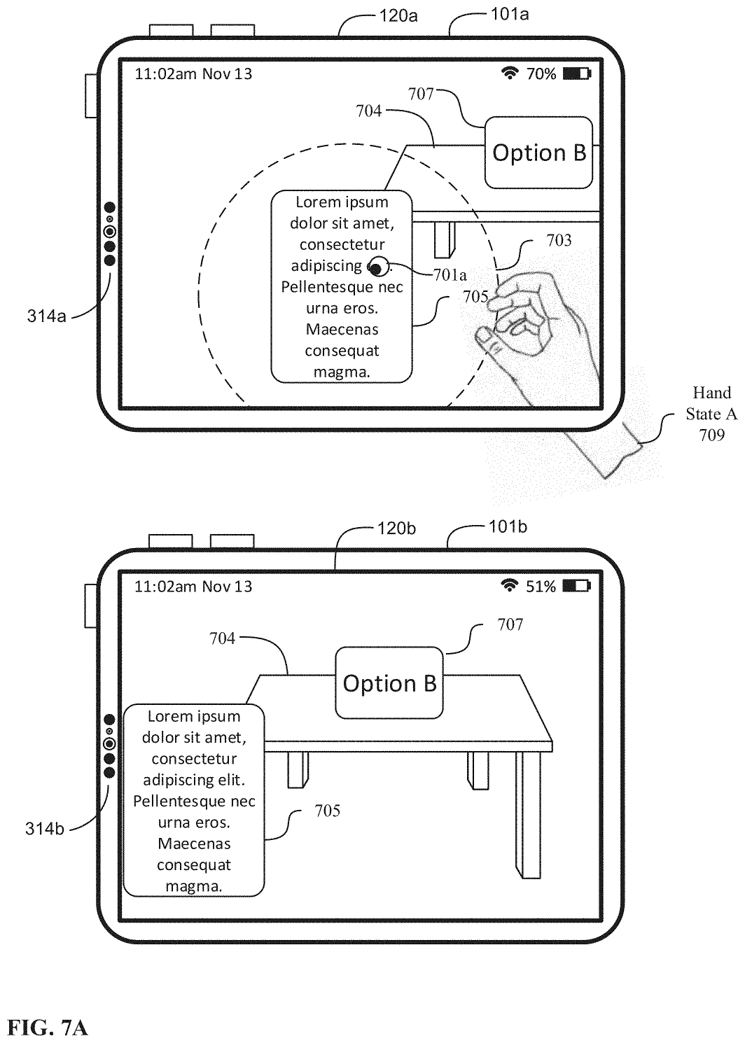

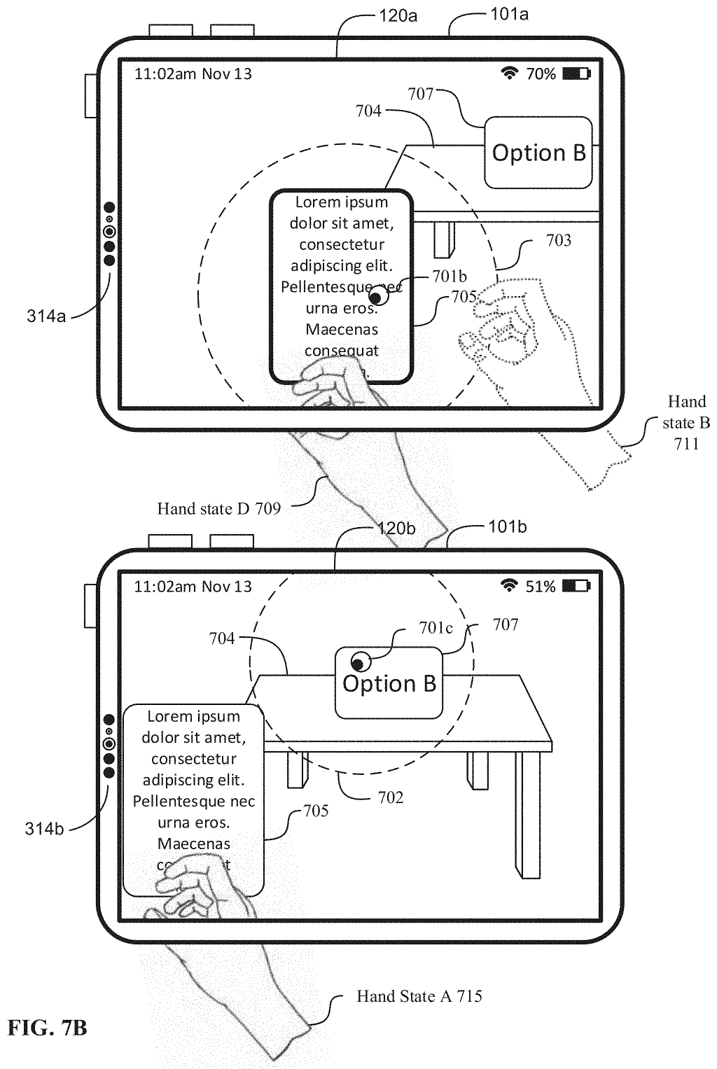

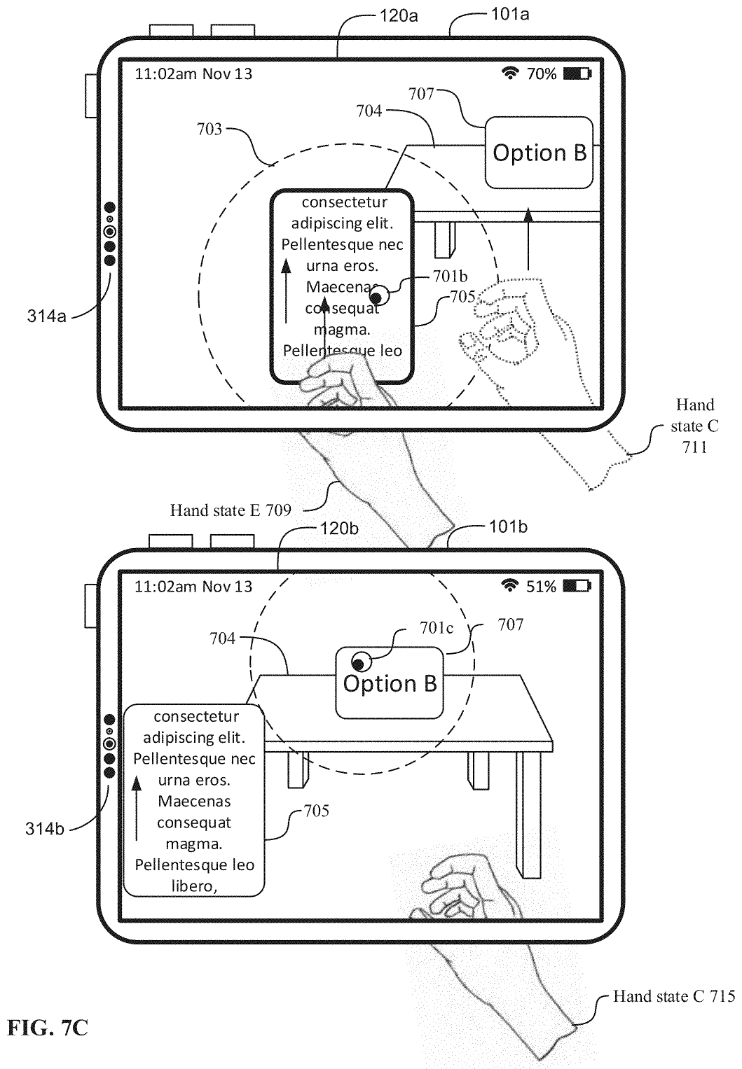

FIGS. 7A-7C illustrate exemplary ways in which electronic devices 101a or 101b perform or do not perform an operation in response to a user input depending on whether the user input is preceded by detecting a ready state of the user in accordance with some embodiments.

FIG. 7A illustrates electronic devices 101a and 101b displaying, via display generation components 120a and 120b, a three-dimensional environment. It should be understood that, in some embodiments, electronic devices 101a and/or 101b utilize one or more techniques described with reference to FIGS. 7A-7C in a two-dimensional environment or user interface without departing from the scope of the disclosure. As described above with reference to FIGS. 1-6, the electronic devices 101a and 1010b optionally include display generation components 120a and 120b (e.g., touch screens) and a plurality of image sensors 314a and 314b. The image sensors optionally include one or more of a visible light camera, an infrared camera, a depth sensor, or any other sensor the electronic device 101a and/or 101b would be able to use to capture one or more images of a user or a part of the user while the user interacts with the electronic devices 101a and/or 101b. In some embodiments, display generation components 120a and 120b are touch screens that are able to detect gestures and movements of a user's hand. In some embodiments, the user interfaces described below could also be implemented on a head-mounted display that includes a display generation component that displays the user interface to the user, and sensors to detect the physical environment and/or movements of the user's hands (e.g., external sensors facing outwards from the user), and/or gaze of the user (e.g., internal sensors facing inwards towards the face of the user).

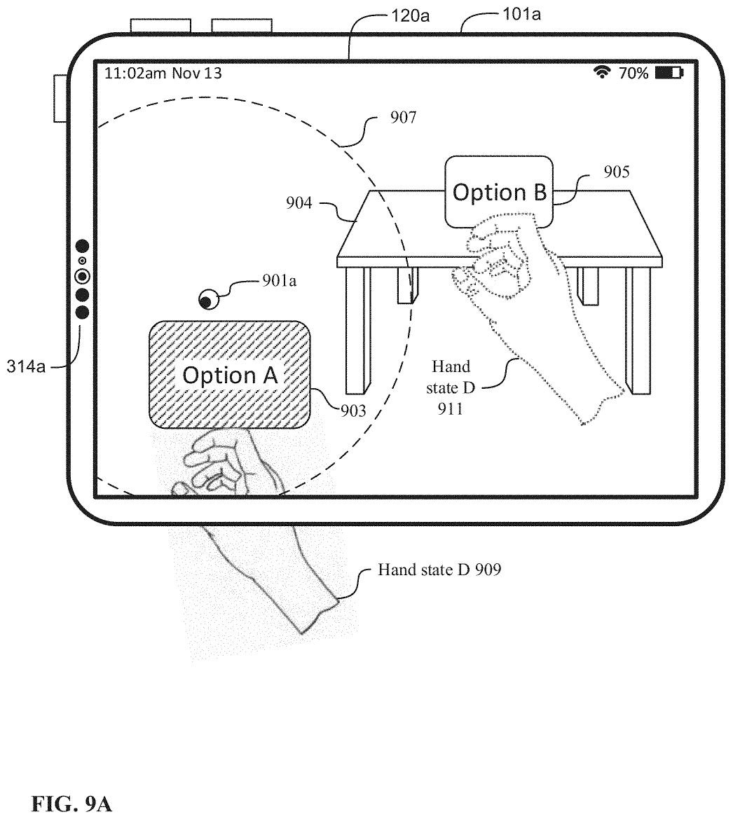

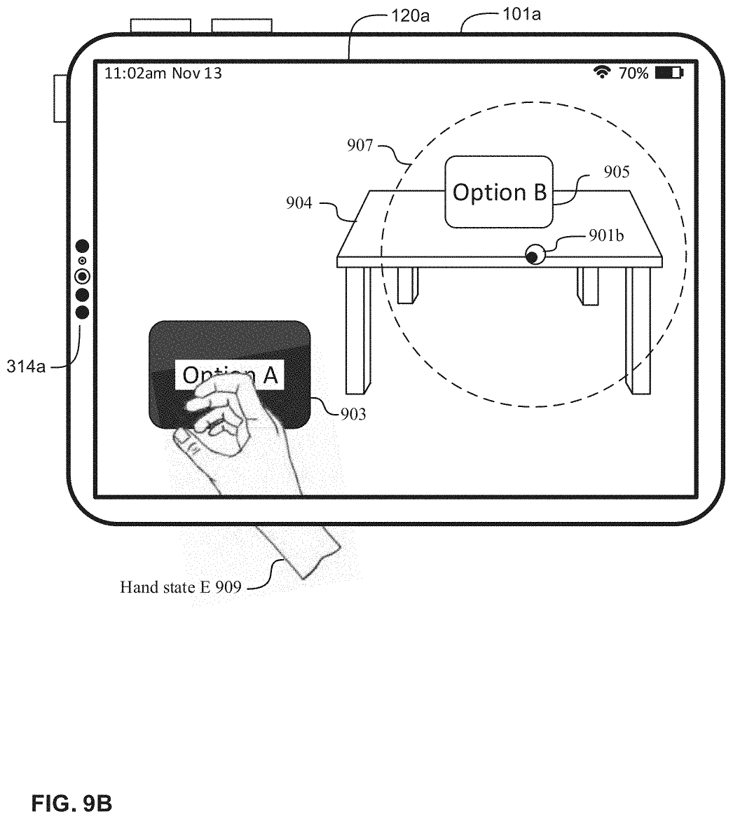

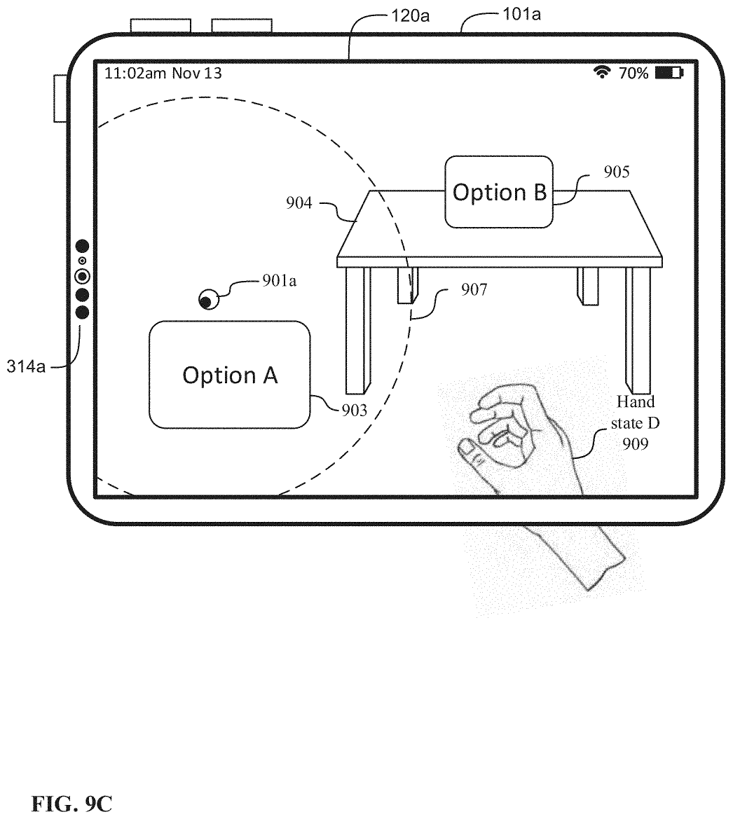

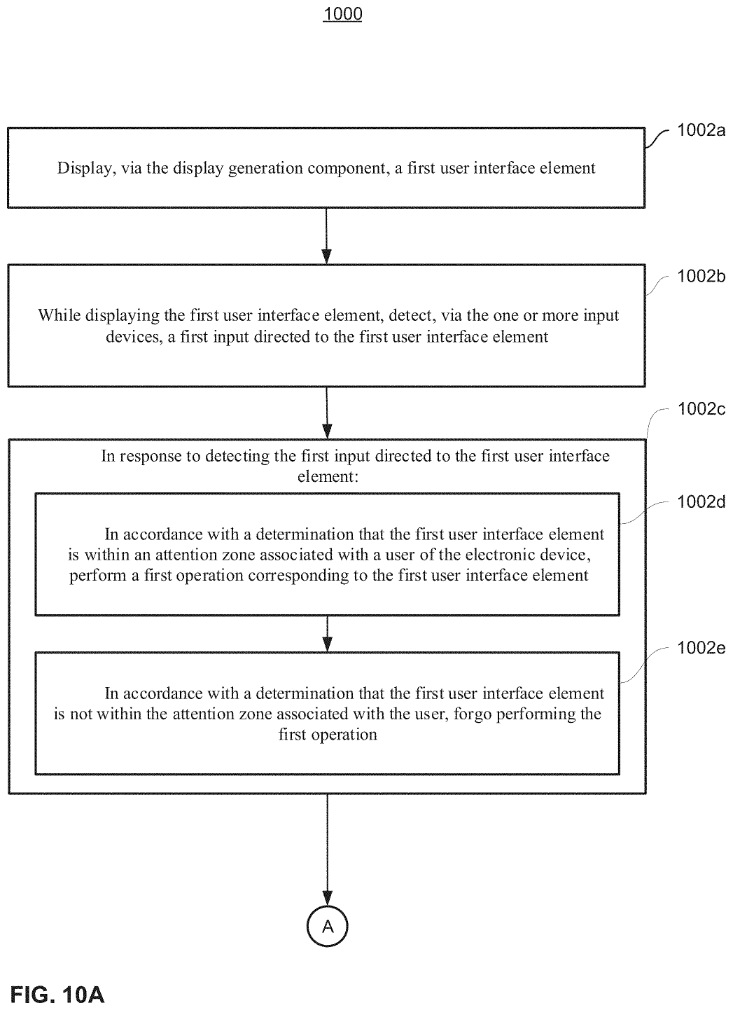

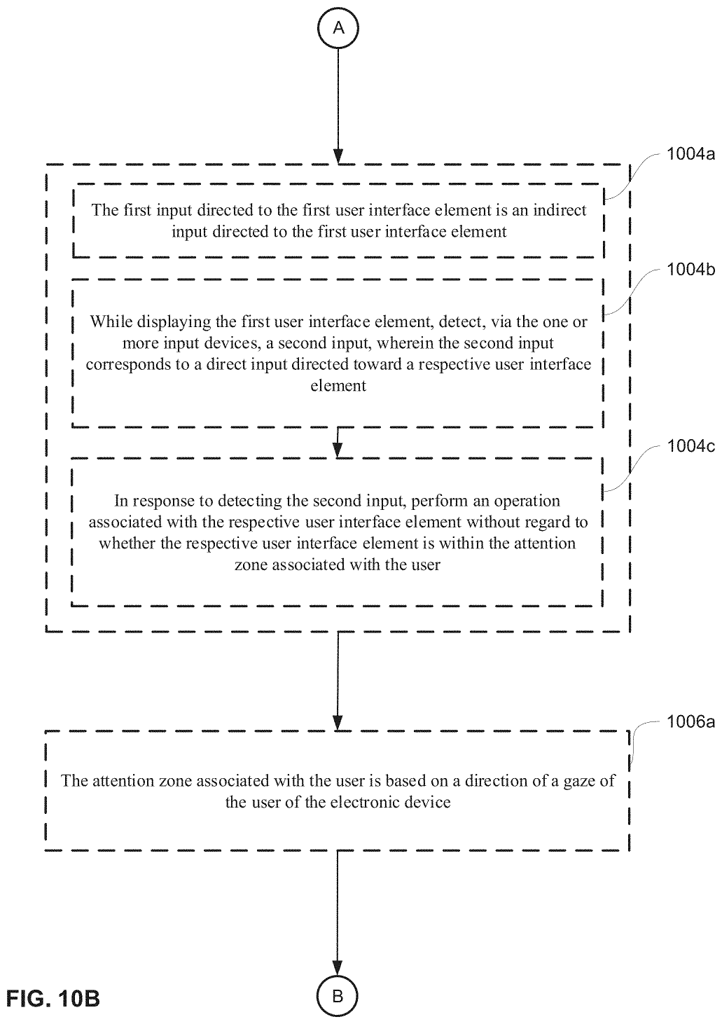

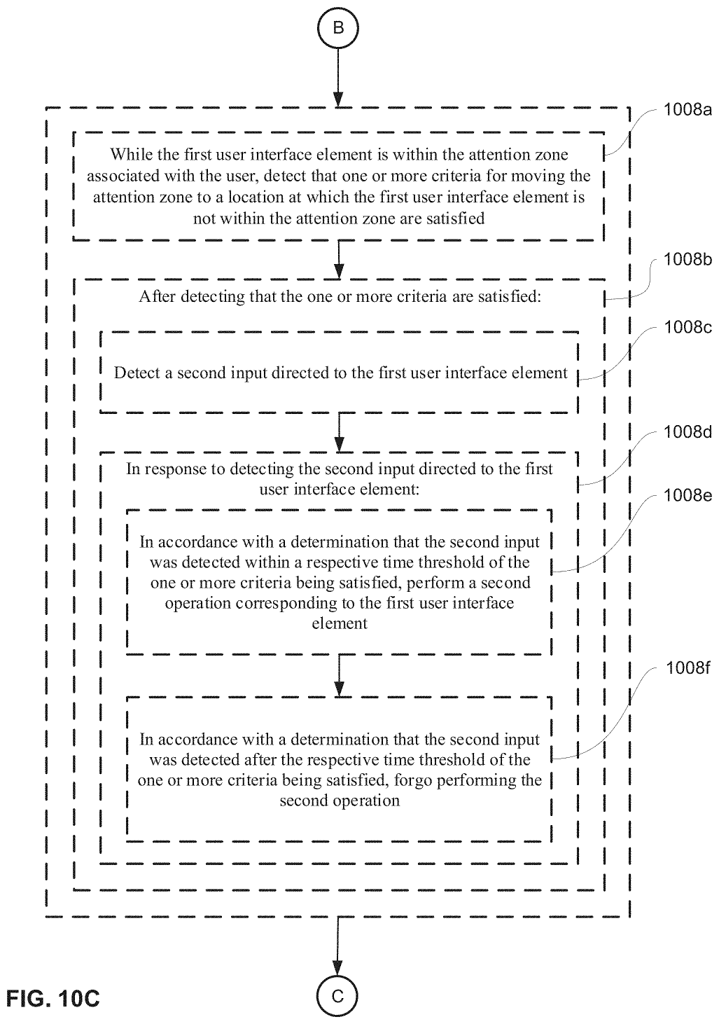

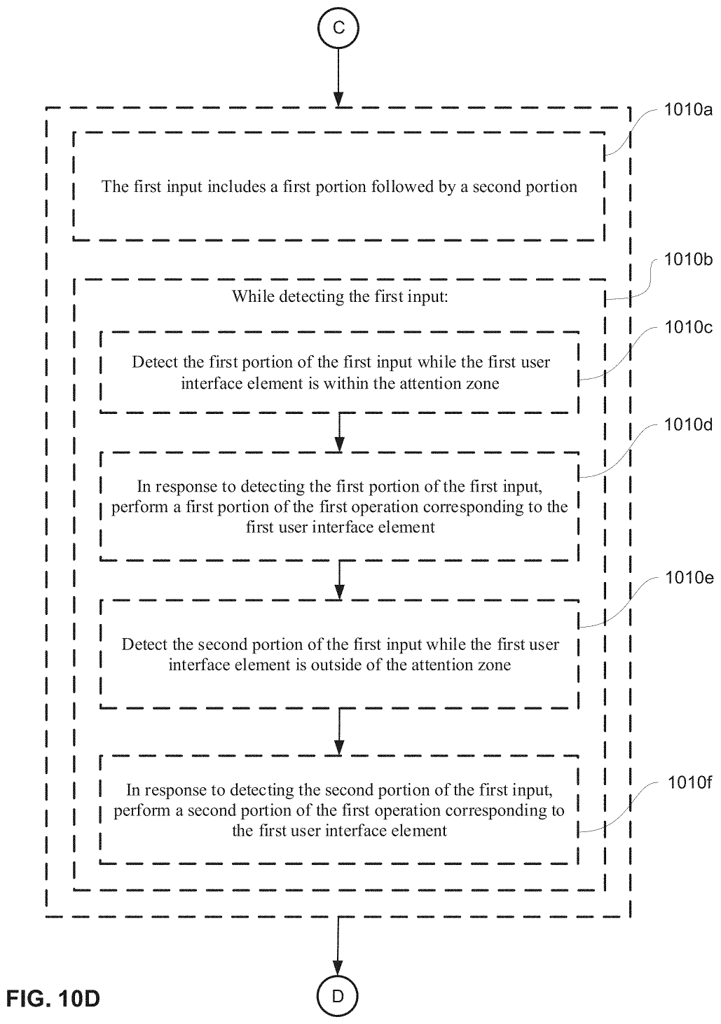

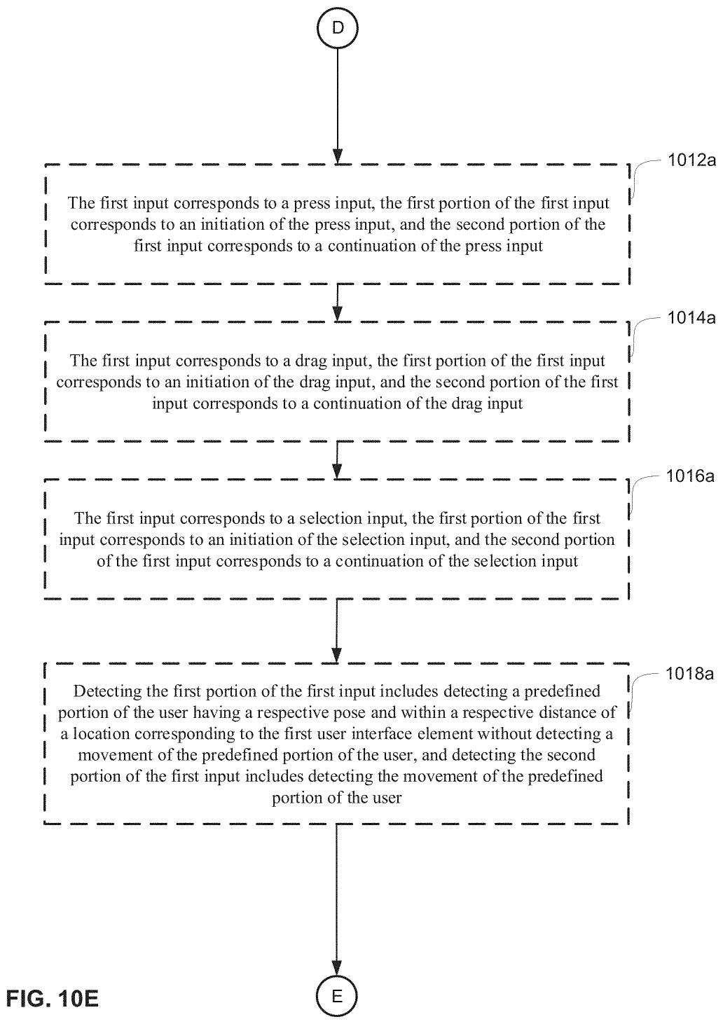

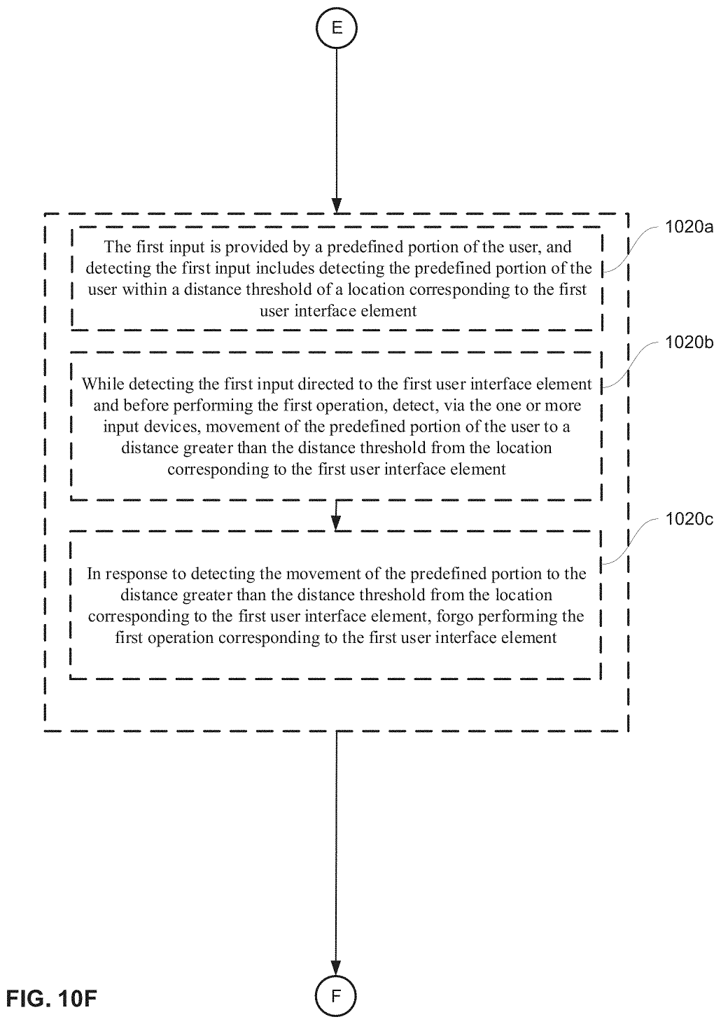

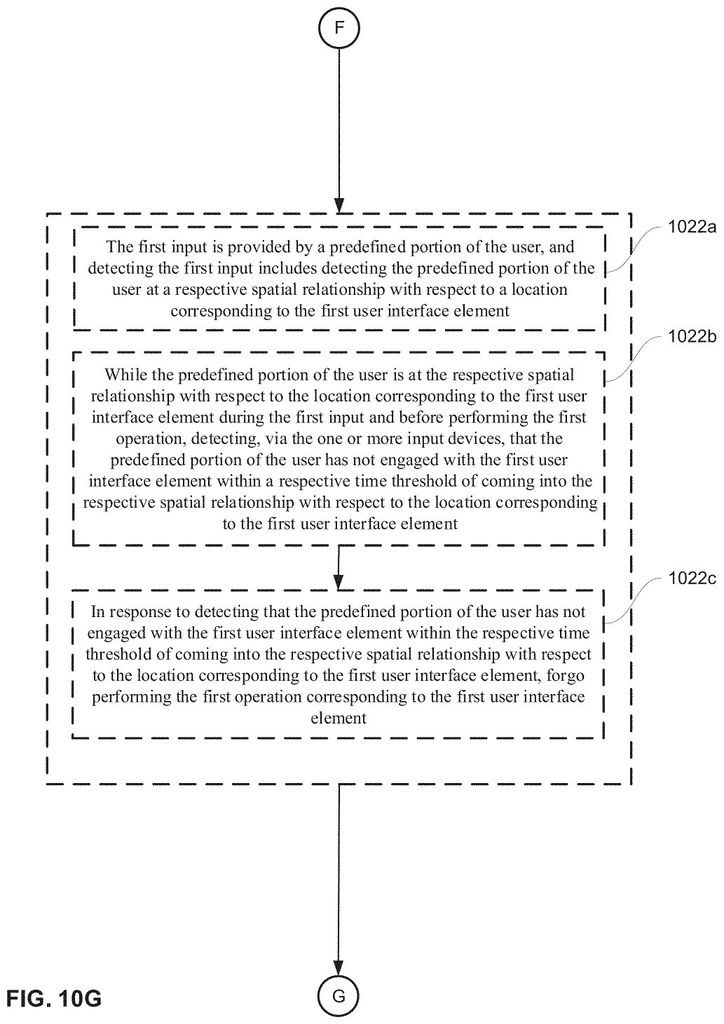

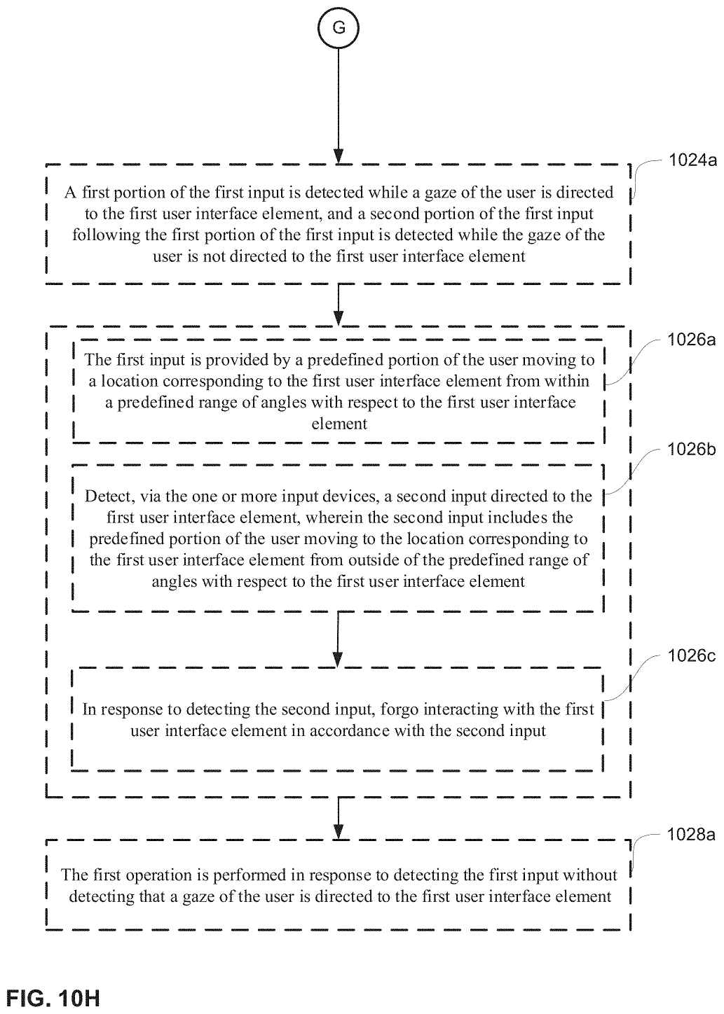

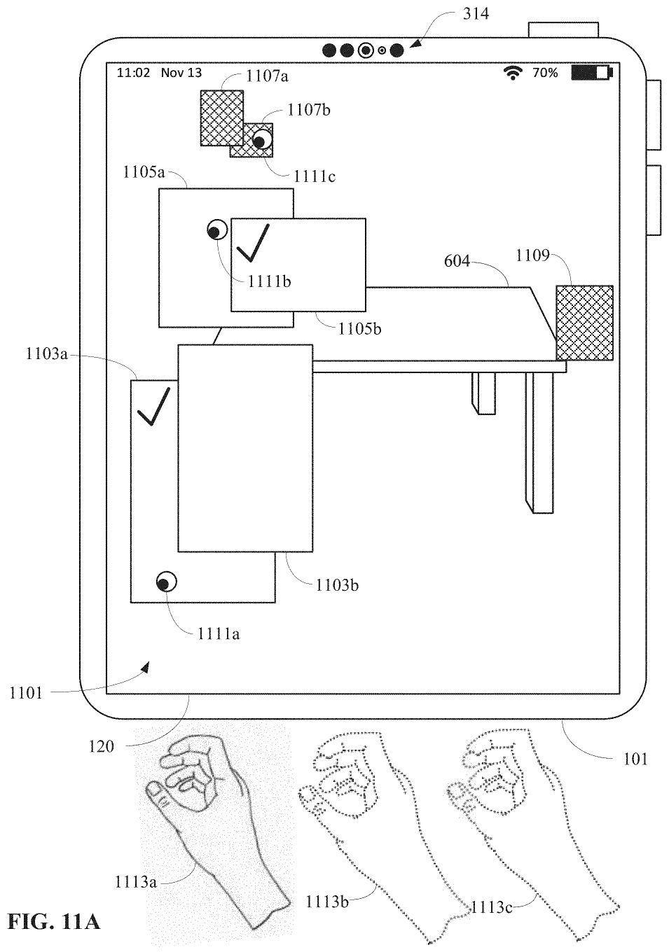

FIG. 7A illustrates two electronic devices 101a and 101b displaying a three-dimensional environment that includes a representation 704 of a table in the physical environment of the electronic devices 101a and 101b (e.g., such as table 604 in FIG. 6B), a selectable option 707, and a scrollable user interface element 705. The electronic devices 101a and 101b present the three-dimensional environment from different viewpoints in the three-dimensional environment because they are associated with different user viewpoints in the three-dimensional environment. In some embodiments, the representation 704 of the table is a photorealistic representation displayed by display generation components 120a and/or 120b (e.g., digital pass-through). In some embodiments, the representation 704 of the table is a view of the table through a transparent portion of display generation components 120a and/or 120b (e.g., physical pass-through). In FIG. 7A, the gaze 701a of the user of the first electronic device 101a is directed to the scrollable user interface element 705 and the scrollable user interface element 705 is within an attention zone 703 of the user of the first electronic device 101a. In some embodiments, the attention zone 703 is similar to the attention zones described in more detail below with reference to FIGS. 9A-10H.

In some embodiments, the first electronic device 101a displays objects (e.g., the representation of the table 704 and/or option 707) in the three-dimensional environment that are not in the attention zone 703 with a blurred and/or dimmed appearance (e.g., a de-emphasized appearance). In some embodiments, the second electronic device 101b blurs and/or dims (e.g., de-emphasize) portions of the three-dimensional environment based on the attention zone of the user of the second electronic device 101b, which is optionally different from the attention zone of the user of the first electronic device 101a. Thus, in some embodiments, the attention zones and blurring of objects outside of the attention zones is not synced between the electronic devices 101a and 101b. Rather, in some embodiments, the attention zones associated with the electronic devices 101a and 101b are independent from each other.

In FIG. 7A, the hand 709 of the user of the first electronic device 101a is in an inactive hand state (e.g., hand state A). For example, the hand 709 is in a hand shape that does not correspond to a ready state or an input as described in more detail below. Because the hand 709 is in the inactive hand state, the first electronic device 101a displays the scrollable user interface element 705 without indicating that an input will be or is being directed to the scrollable user interface element 705. Likewise, electronic device 101b also displays the scrollable user interface element 705 without indicating that an input will be or is being directed to the scrollable user interface element 705.

In some embodiments, the electronic device 101a displays an indication that the gaze 701a of the user is on the user interface element 705 while the user's hand 709 is in the inactive state. For example, the electronic device 101a optionally changes a color, size, and/or position of the scrollable user interface element 705 in a manner different from the way in which the electronic device 101a updates the scrollable user interface element 705 in response to detecting the ready state of the user, which will be described below. In some embodiments, the electronic device 101a indicates the gaze 701a of the user on user interface element 705 by displaying a visual indication separate from updating the appearance of the scrollable user interface element 705. In some embodiments, the second electronic device 101b forgoes displaying an indication of the gaze of the user of the first electronic device 101a. In some embodiments, the second electronic device 101b displays an indication to indicate the location of the gaze of the user of the second electronic device 101b.

In FIG. 7B, the first electronic device 101a detects a ready state of the user while the gaze 701b of the user is directed to the scrollable user interface element 705. In some embodiments, the ready state of the user is detected in response to detecting the hand 709 of the user in a direct ready state hand state (e.g., hand state D). In some embodiments, the ready state of the user is detected in response to detecting the hand 711 of the user in an indirect ready state hand state (e.g., hand state B).

In some embodiments, the hand 709 of the user of the first electronic device 101a is in the direct ready state when the hand 709 is within a predetermined threshold distance (e.g., 0.5, 1, 2, 3, 4, 5, 10, 15, 20, 30, etc. centimeters) of the scrollable user interface element 705, the scrollable user interface element 705 is within the attention zone 703 of the user, and/or the hand 709 is in a pointing hand shape (e.g., a hand shape in which one or more fingers are curled towards the palm and one or more fingers are extended towards the scrollable user interface element 705). In some embodiments, the scrollable user interface element 705 does not have to be in the attention zone 703 for the ready state criteria to be met for a direct input. In some embodiments, the gaze 701b of the user does not have to be directed to the scrollable user interface element 705 for the ready state criteria to be met for a direct input.

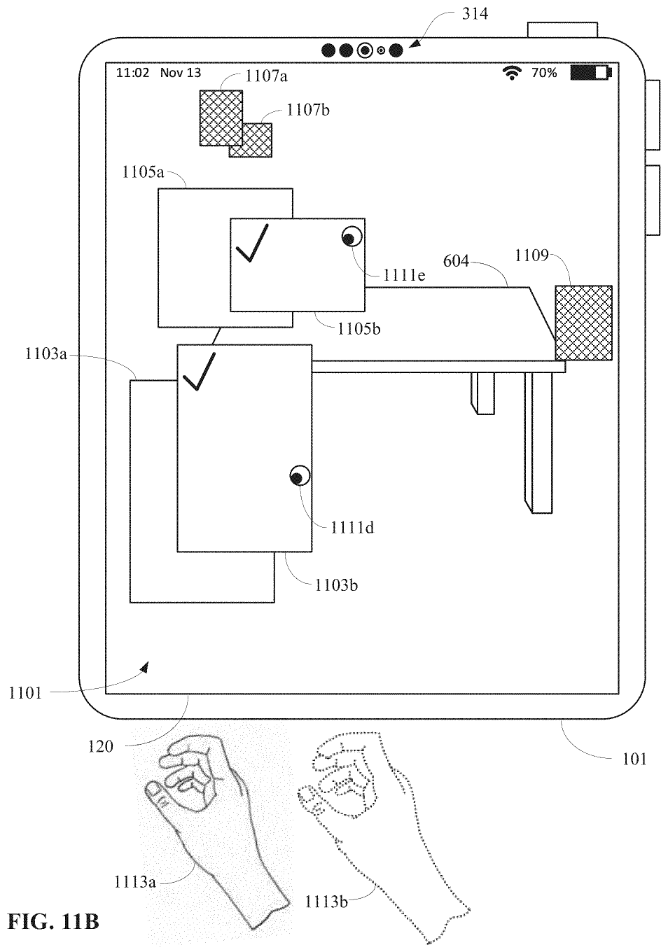

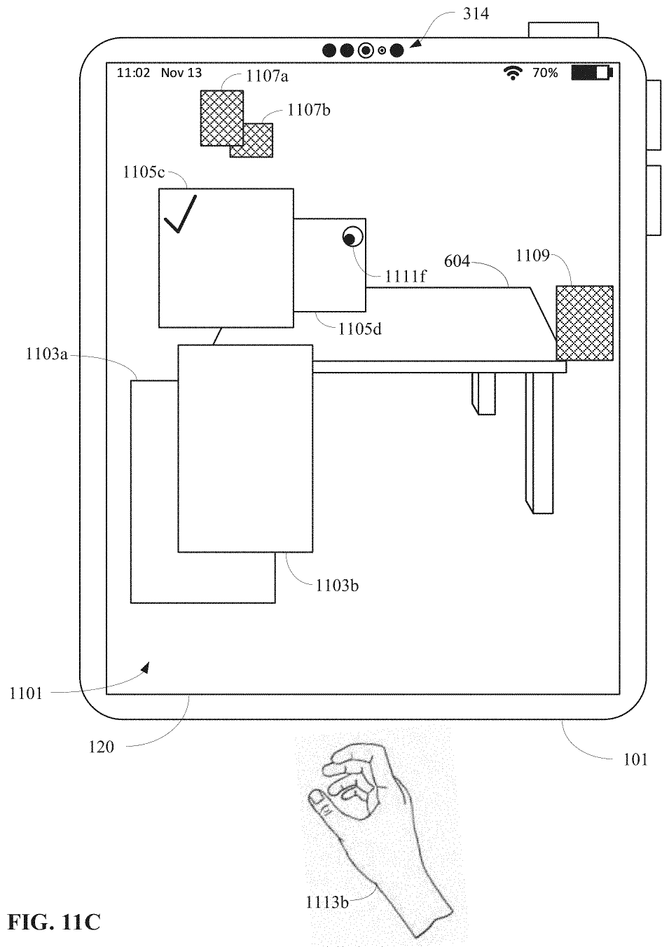

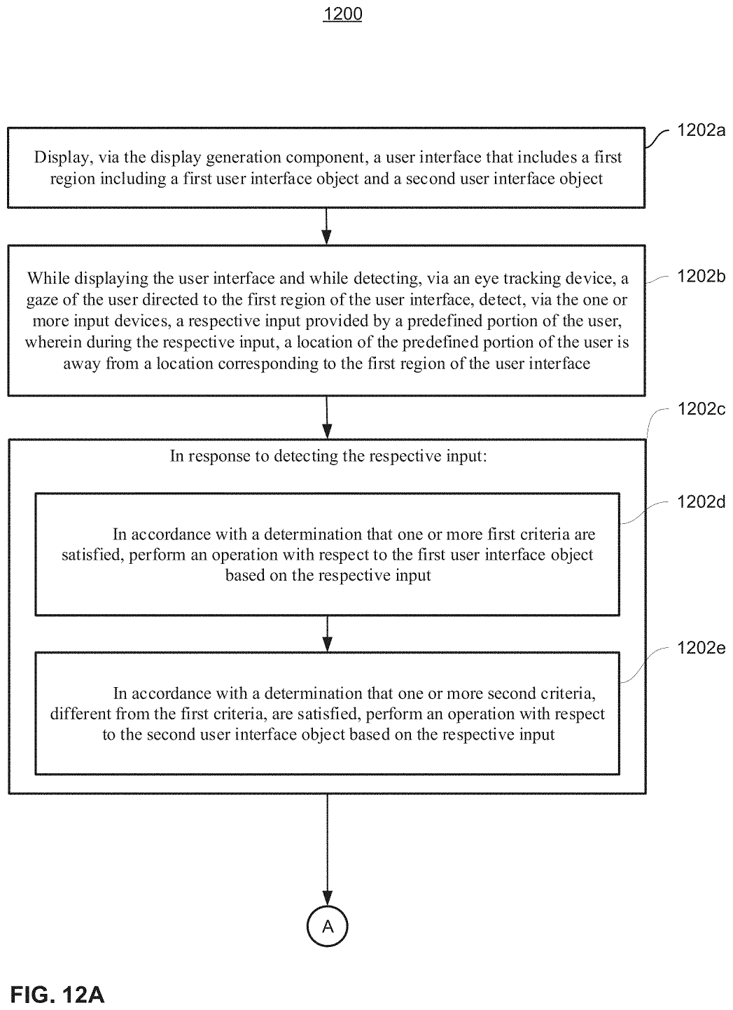

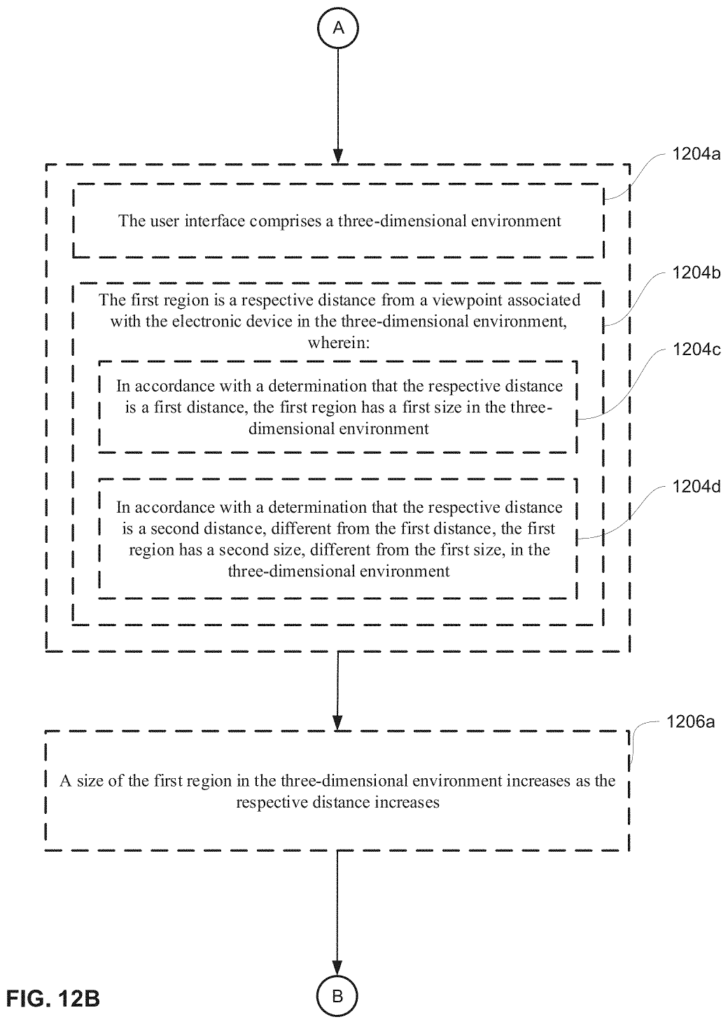

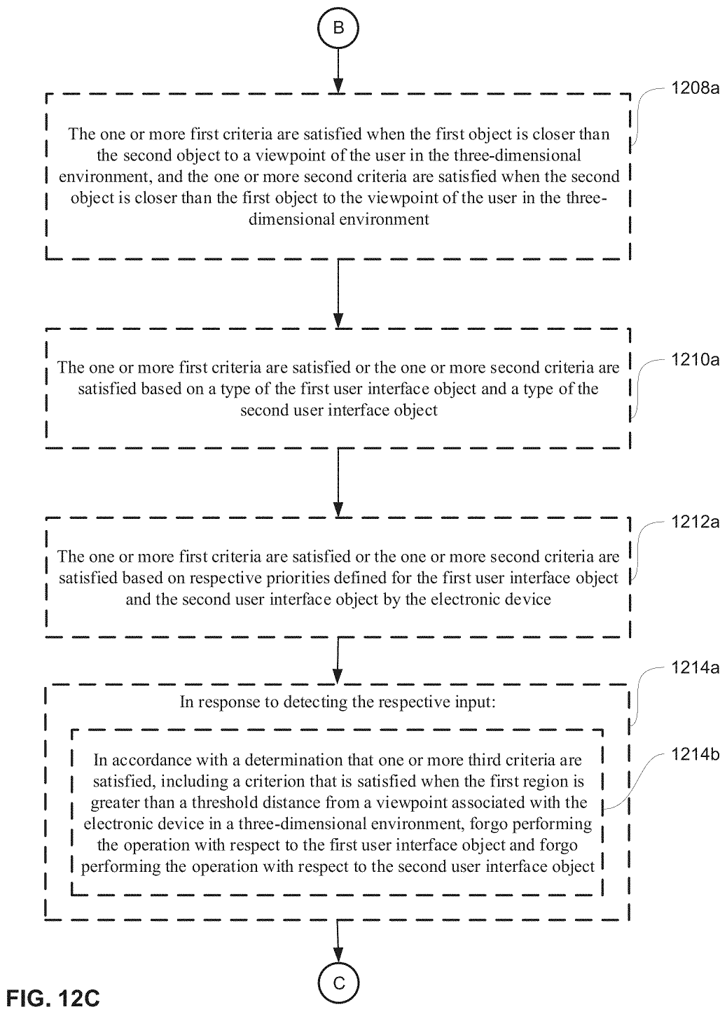

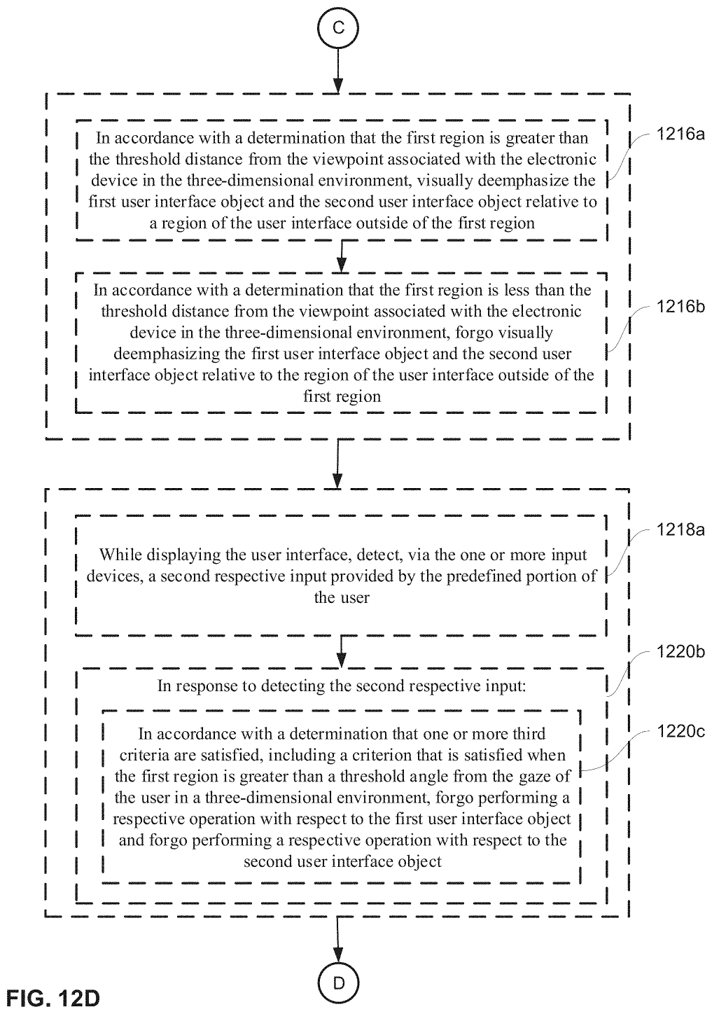

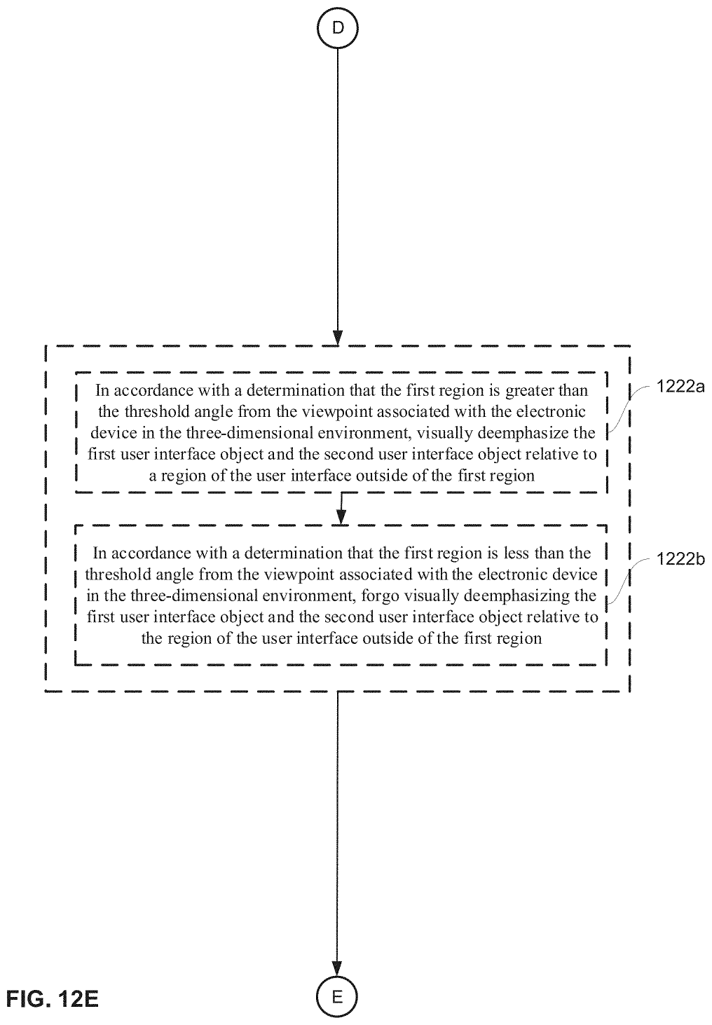

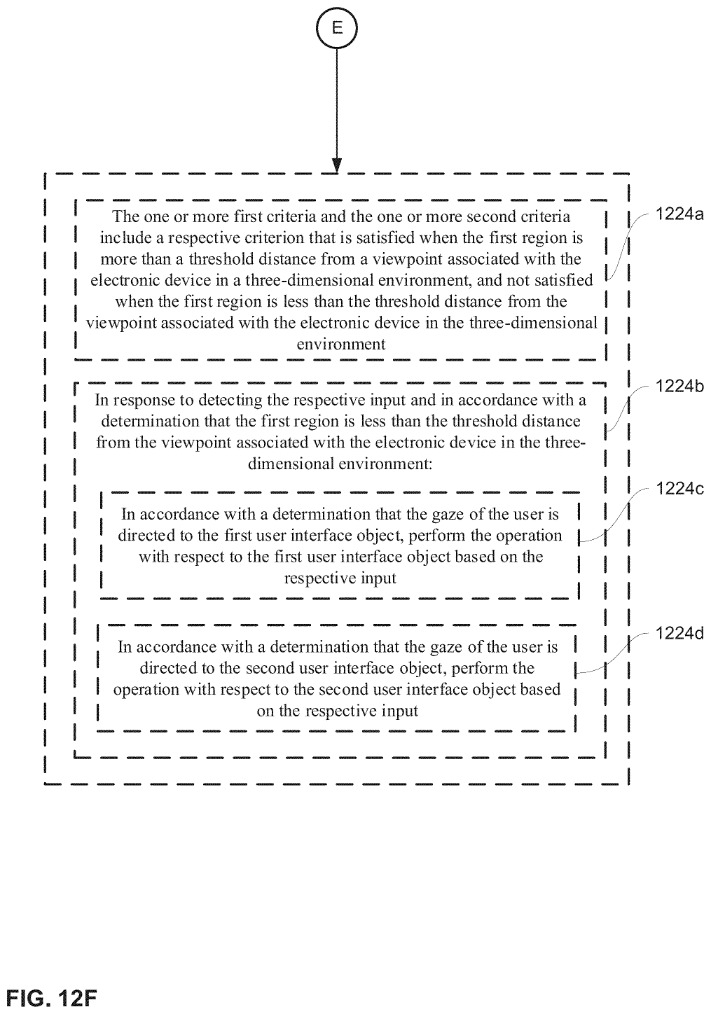

In some embodiments, the hand 711 of the user of the electronic device 101a is in the indirect ready state when the hand 711 is further than the predetermined threshold distance (e.g., 0.5, 1, 2, 3, 4, 5, 10, 15, 20, 30, etc. centimeters) from the scrollable user interface element 705, the gaze 701b of the user is directed to the scrollable user interface element 705, and the hand 711 is in a pre-pinch hand shape (e.g., a hand shape in which the thumb is within a threshold distance (e.g., 0.1, 0.5, 1, 2, 3, etc. centimeters) of another finger on the hand without touching the other finger on the hand). In some embodiments, the ready state criteria for indirect inputs are satisfied when the scrollable user interface element 705 is within the attention zone 703 of the user even if the gaze 701b is not directed to the user interface element 705. In some embodiments, the electronic device 101a resolves ambiguities in determining the location of the user's gaze 701b as described below with reference to FIGS. 11A-12F.

In some embodiments, the hand shapes that satisfy the criteria for a direct ready state (e.g., with hand 709) are the same as the hand shapes that satisfy the criteria for an indirect ready state (e.g., with hand 711). For example, both a pointing hand shape and a pre-pinch hand shape satisfy the criteria for direct and indirect ready states. In some embodiments, the hand shapes that satisfy the criteria for a direct ready state (e.g., with hand 709) are different from the hand shapes that satisfy the criteria for an indirect ready state (e.g., with hand 711). For example, a pointing hand shape is required for a direct ready state but a pre-pinch hand shape is required for an indirect ready state.

In some embodiments, the electronic device 101a (and/or 101b) is in communication with one or more input devices, such as a stylus or trackpad. In some embodiments, the criteria for entering the ready state with an input device are different from the criteria for entering the ready state without one of these input devices. For example, the ready state criteria for these input devices do not require detecting the hand shapes described above for the direct and indirect ready states without a stylus or trackpad. For example, the ready state criteria when the user is using a stylus to provide input to device 101a and/or 101b require that the user is holding the stylus and the ready state criteria when the user is using a trackpad to provide input to device 101a and/or 101b require that the hand of the user is resting on the trackpad.

In some embodiments, each hand of the user (e.g., a left hand and a right hand) have an independently associated ready state (e.g., each hand must independent satisfy its ready state criteria before devices 101a and/or 101b will respond to inputs provided by each respective hand). In some embodiments, the criteria for the ready state of each hand are different from each other (e.g., different hand shapes required for each hand, only allowing indirect or direct ready states for one or both hands). In some embodiments, the visual indication of the ready state for each hand is different. For example, if the color of the scrollable user interface element 705 changes to indicate the ready state being detected by device 101a and/or 101b, the color of the scrollable user interface element 705 could be a first color (e.g., blue) for the ready state of the right hand and could be a second color (e.g., green) for the ready state of the left hand.

In some embodiments, in response to detecting the ready state of the user, the electronic device 101a becomes ready to detect input provided by the user (e.g., by the user's hand(s)) and updates display of the scrollable user interface element 705 to indicate that further input will be directed to the scrollable user interface element 705. For example, as shown in FIG. 7B, the scrollable user interface element 705 is updated at electronic device 101a by increasing the thickness of a line around the boundary of the scrollable user interface element 705. In some embodiments, the electronic device 101a updates the appearance of the scrollable user interface element 705 in a different or additional manner, such as by changing the color of the background of the scrollable user interface element 705, displaying highlighting around the scrollable user interface element 705, updating the size of the scrollable user interface element 705, updating a position in the three-dimensional environment of the scrollable user interface element 705 (e.g., displaying the scrollable user interface element 705 closer to the viewpoint of the user in the three-dimensional environment), etc. In some embodiments, the second electronic device 101b does not update the appearance of the scrollable user interface element 705 to indicate the ready state of the user of the first electronic device 101a.

In some embodiments, the way in which the electronic device 101a updates the scrollable user interface element 705 in response to detecting the ready state is the same regardless of whether the ready state is a direct ready state (e.g., with hand 709) or an indirect ready state (e.g., with hand 711). In some embodiments, the way in which the electronic device 101a updates the scrollable user interface element 705 in response to detecting the ready state is different depending on whether the ready state is a direct ready state (e.g., with hand 709) or an indirect ready state (e.g., with hand 711). For example, if the electronic device 101a updates the color of the scrollable user interface element 705 in response to detecting the ready state, the electronic device 101a uses a first color (e.g., blue) in response to a direct ready state (e.g., with hand 709) and uses a second color (e.g., green) in response to an indirect ready state (e.g., with hand 711).

In some embodiments, after detecting the ready state to the scrollable user interface element 705, the electronic device 101a updates the target of the ready state based on an indication of the user's focus. For example, the electronic device 101a directs the indirect ready state (e.g., with hand 711) to the selectable option 707 (e.g., and removes the ready state from scrollable user interface element 705) in response to detecting the location of the gaze 701b move from the scrollable user interface element 705 to the selectable option 707. As another example, the electronic device 101a directs the direct ready state (e.g., with hand 709) to the selectable option 707 (e.g., and removes the ready state from scrollable user interface element 705) in response to detecting the hand 709 move from being within the threshold distance (e.g., 0.5, 1, 2, 3, 4, 5, 10, 15, 30, etc. centimeters) of the scrollable user interface element 705 to being within the threshold distance of the selectable option 707.

In FIG. 7B, device 101b detects that the user of the second electronic device 101b directs their gaze 701c to the selectable option 707 while the hand 715 of the user is in the inactive state (e.g., hand state A). Because the electronic device 101b does not detect the ready state of the user, the electronic device 101b forgoes updating the selectable option 707 to indicate the ready state of the user. In some embodiments, as described above, the electronic device 101b updates the appearance of the selectable option 707 to indicate that the gaze 701c of the user is directed to the selectable option 707 in a manner that is different from the manner in which the electronic device 101b updates user interface elements to indicate the ready state.

In some embodiments, the electronic devices 101a and 101b only perform operations in response to inputs when the ready state was detected prior to detecting the input. FIG. 7C illustrates the users of the electronic devices 101a and 101b providing inputs to the electronic devices 101a and 101b, respectively. In FIG. 7B, the first electronic device 101a detected the ready state of the user, whereas in the second electronic device 101b did not detect the ready state, as previously described. Thus, in FIG. 7C, the first electronic device 101a performs an operation in response to detecting the user input, whereas the second electronic device 101b forgoes performing an operation in response to detecting the user input.

In particular, in FIG. 7C, the first electronic device 101a detects a scrolling input directed to scrollable user interface element 705. FIG. 7C illustrates a direct scrolling input provided by hand 709 and/or an indirect scrolling input provided by hand 711. The direct scrolling input includes detecting hand 709 within a direct input threshold (e.g., 0.05, 0.1, 0.2, 0.3, 0.5, 1, etc. centimeters) or touching the scrollable user interface element 705 while the hand 709 is in the pointing hand shape (e.g., hand state E) while the hand 709 moves in a direction in which the scrollable user interface element 705 is scrollable (e.g., vertical motion or horizontal motion). The indirect scrolling input includes detecting hand 711 further than the direct input ready state threshold (e.g., 0.5, 1, 2, 3, 4, 5, 10, 15, 30, etc. centimeters) and/or further than the direct input threshold (e.g., 0.05, 0.1, 0.2, 0.3, 0.5, 1, etc. centimeters) from the scrollable user interface element 705, detecting the hand 711 in a pinch hand shape (e.g., a hand shape in which the thumb touches another finger on the hand 711, hand state C) and movement of the hand 711 in a direction in which the scrollable user interface element 705 is scrollable (e.g., vertical motion or horizontal motion), while detecting the gaze 701b of the user on the scrollable user interface element 705.

In some embodiments, the electronic device 101a requires that the scrollable user interface element 705 is within the attention zone 703 of the user for the scrolling input to be detected. In some embodiments, the electronic device 101a does not require the scrollable user interface element 705 to be within the attention zone 703 of the user for the scrolling input to be detected. In some embodiments, the electronic device 101a requires the gaze 701b of the user to be directed to the scrollable user interface element 705 for the scrolling input to be detected. In some embodiments, the electronic device 101a does not require the gaze 701b of the user to be directed to the scrollable user interface element 705 for the scrolling input to be detected. In some embodiments, the electronic device 101a requires the gaze 701b of the user to be directed to the scrollable user interface element 705 for indirect scrolling inputs but not for direct scrolling inputs.

In response to detecting the scrolling input, the first electronic device 101a scrolls the content in the scrollable user interface element 705 in accordance with the movement of hand 709 or hand 711, as shown in FIG. 7C. In some embodiments, the first electronic device 101a transmits an indication of the scrolling to the second electronic device 101b (e.g., via a server) and, in response, the second electronic device 101b scrolls the scrollable user interface element 705 the same way in which the first electronic device 101a scrolls the scrollable user interface element 705. For example, the scrollable user interface element 705 in the three-dimensional environment has now been scrolled, and therefore the electronic devices that display viewpoints of the three-dimensional environment (e.g., including electronic devices other than those that detected the input for scrolling the scrollable user interface element 705) that include the scrollable user interface element 705 reflect the scrolled state of the user interface element. In some embodiments, if the ready state of the user shown in FIG. 7B had not been detected prior to detecting the input illustrated in FIG. 7C, the electronic devices 101a and 101b would forgo scrolling the scrollable user interface element 705 in response to the inputs illustrated in FIG. 7C.

Therefore, in some embodiments, the results of user inputs are synchronized between the first electronic device 101a and the second electronic device 101b. For example, if the second electronic device 101b were to detect selection of the selectable option 707, both the first and second electronic devices 101a and 101b would update the appearance (e.g., color, style, size, position, etc.) of the selectable option 707 while the selection input is being detected and perform the operation in accordance with the selection.

Thus, because the electronic device 101a detected the ready state of the user in FIG. 7B before detecting the input in FIG. 7C, the electronic device 101a scrolls the scrollable user interface 705 in response to the input. In some embodiments, the electronic devices 101a and 101b forgo performing actions in response to inputs that were detected without first detecting the ready state.

For example, in FIG. 7C, the user of the second electronic device 101b provides an indirect selection input with hand 715 directed to selectable option 707. In some embodiments, detecting the selection input includes detecting the hand 715 of the user making a pinch gesture (e.g., hand state C) while the gaze 701c of the user is directed to the selectable option 707. Because the second electronic device 101b did not detect the ready state (e.g., in FIG. 7B) prior to detecting the input in FIG. 7C, the second electronic device 101b forgoes selecting the option 707 and forgoes performing an action in accordance with the selection of option 707. In some embodiments, although the second electronic device 101b detects the same input (e.g., an indirect input) as the first electronic device 101a in FIG. 7C, the second electronic device 101b does not perform an operation in response to the input because the ready state was not detected before the input was detected. In some embodiments, if the second electronic device 101b had detected a direct input without having first detected the ready state, the second electronic device 101b would also forgo performing an action in response to the direct input because the ready state was not detected before the input was detected.

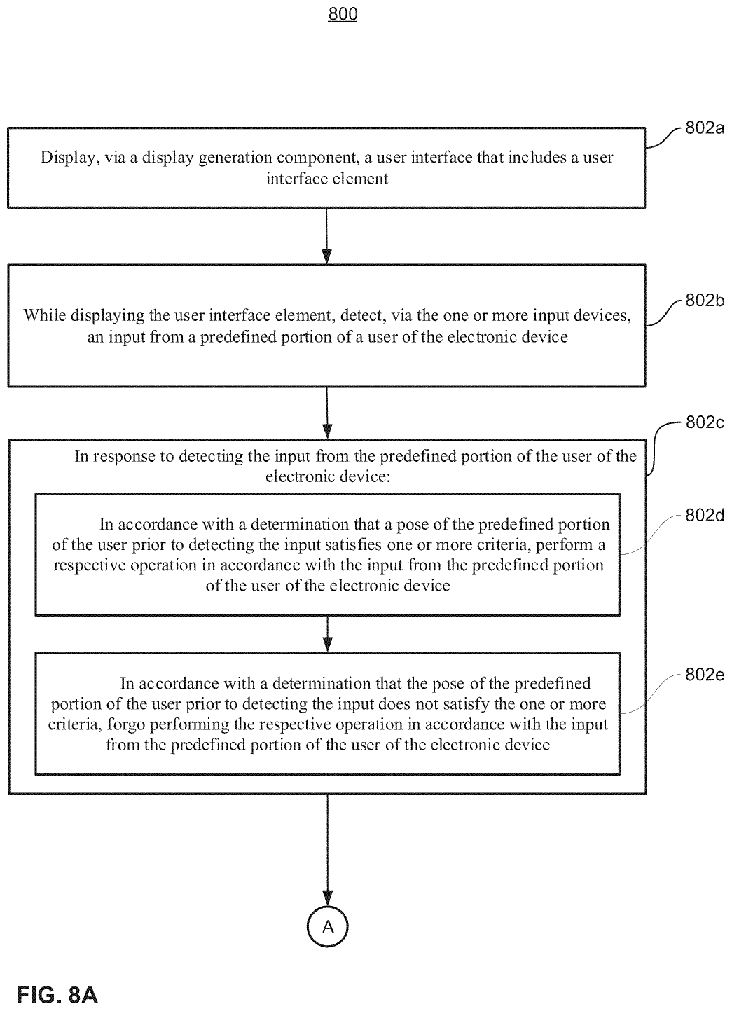

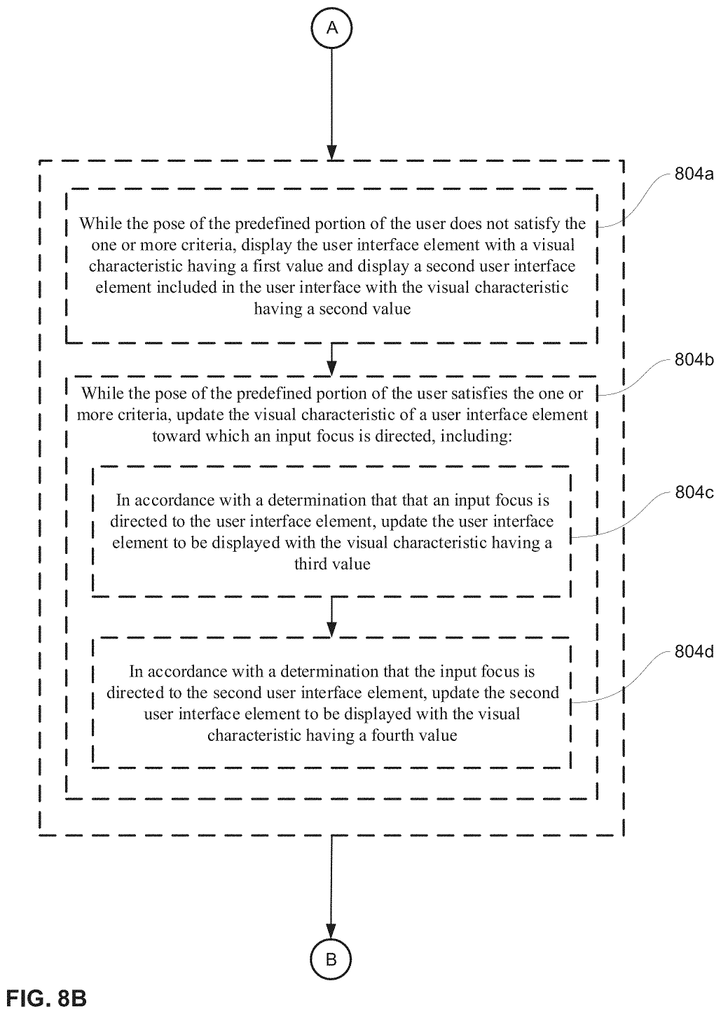

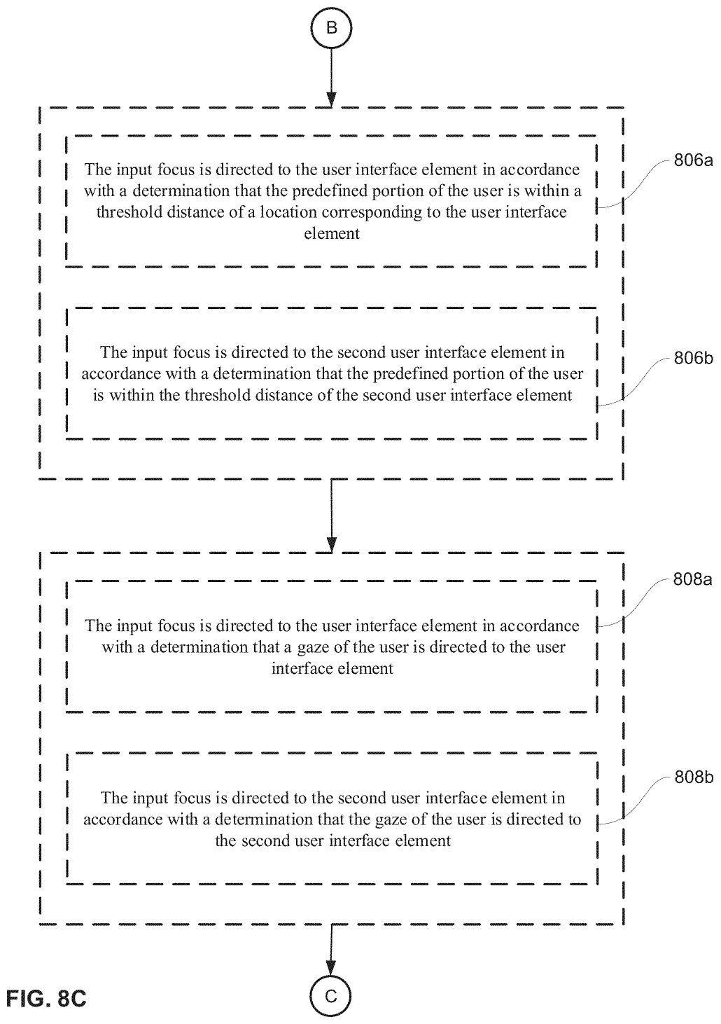

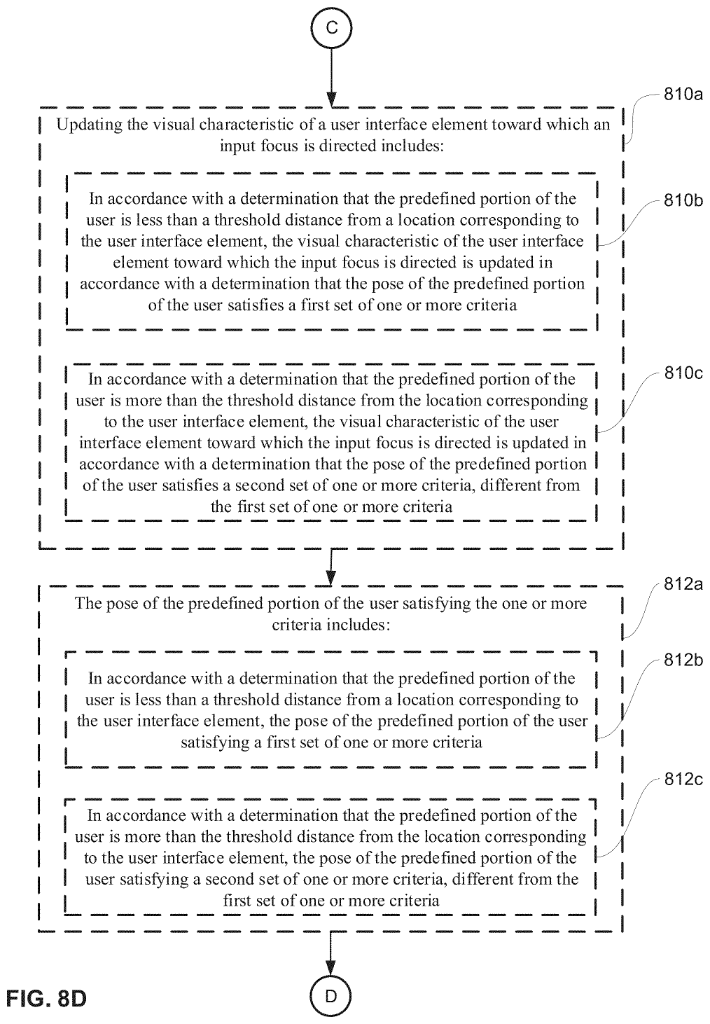

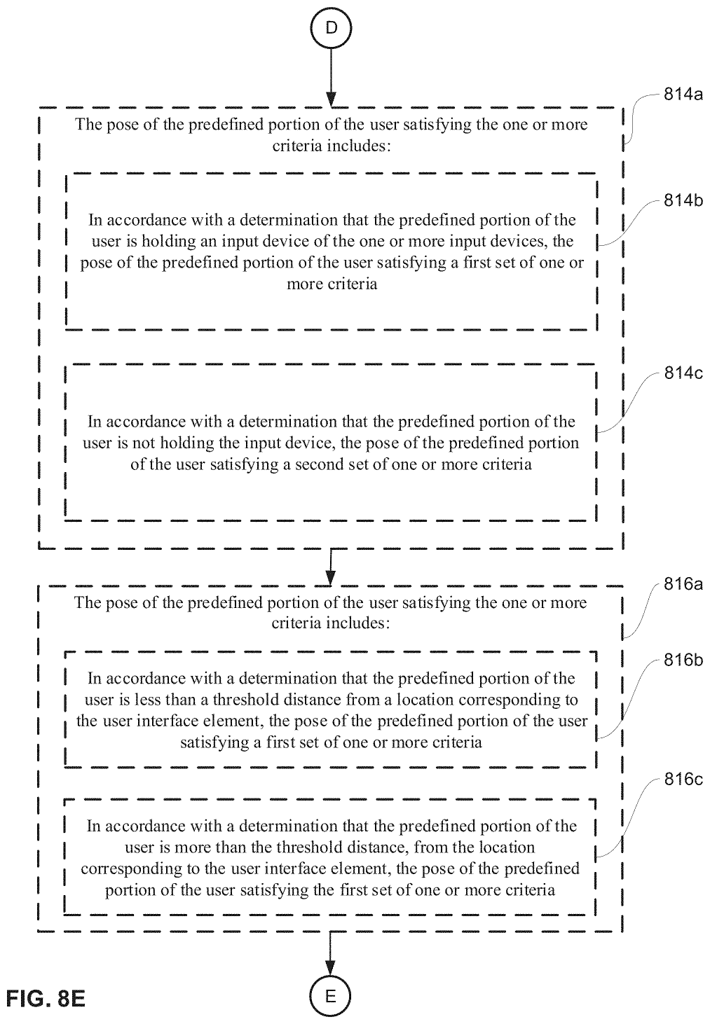

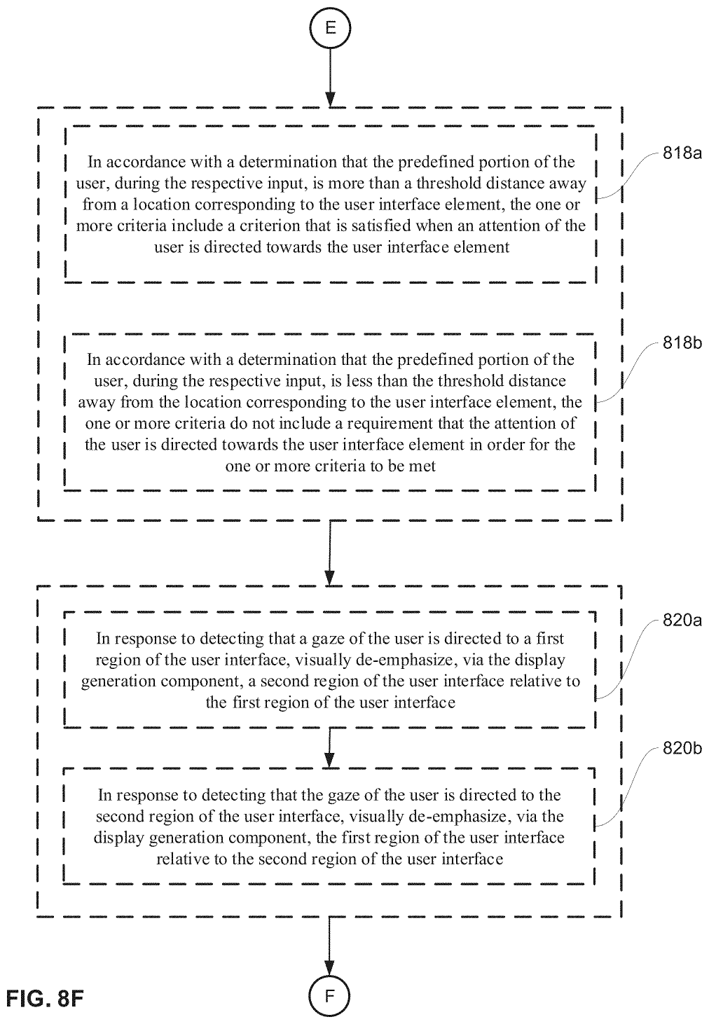

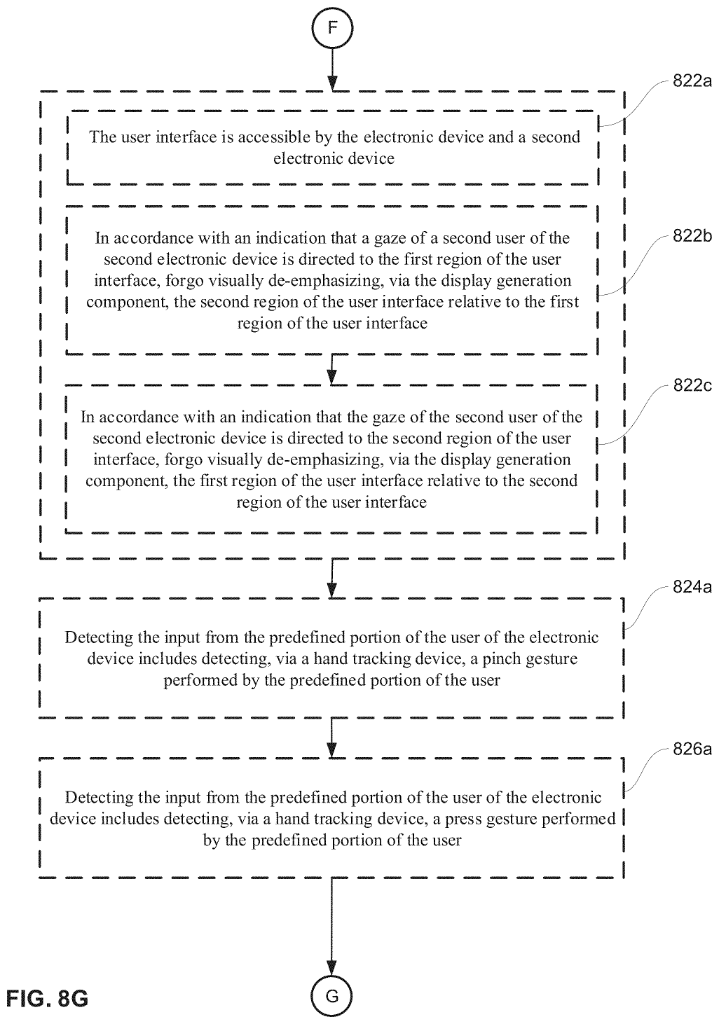

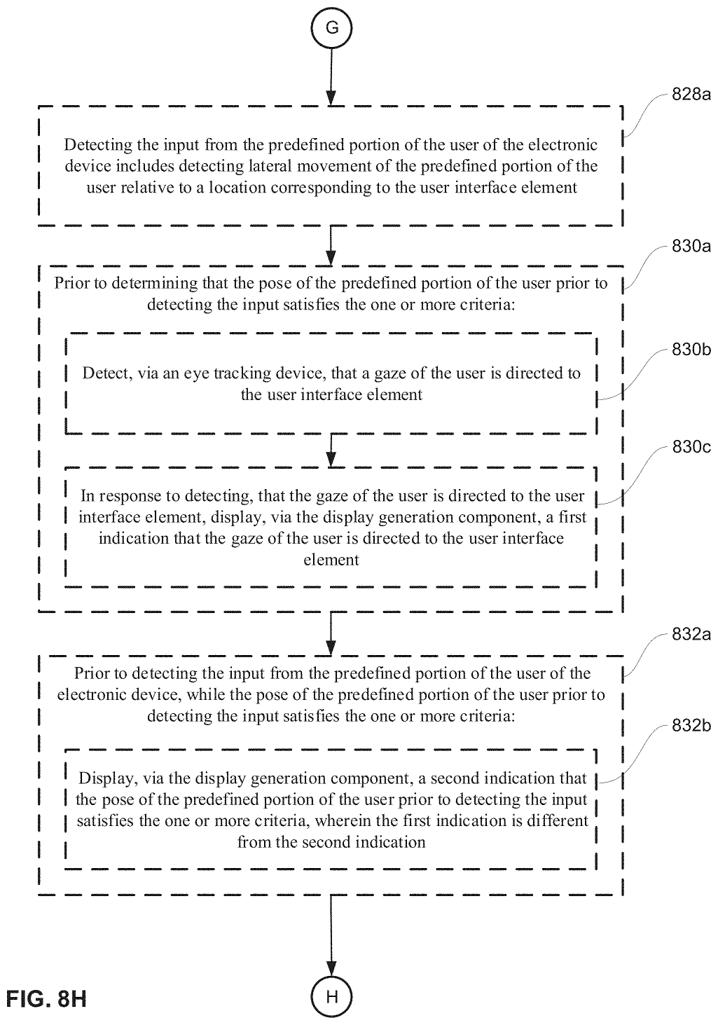

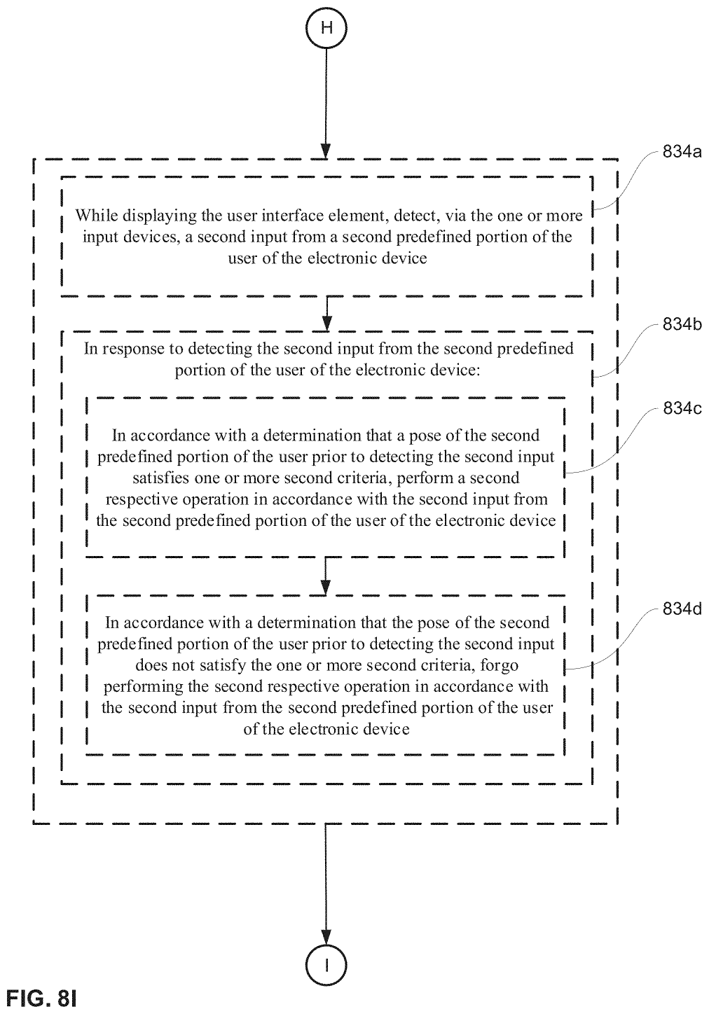

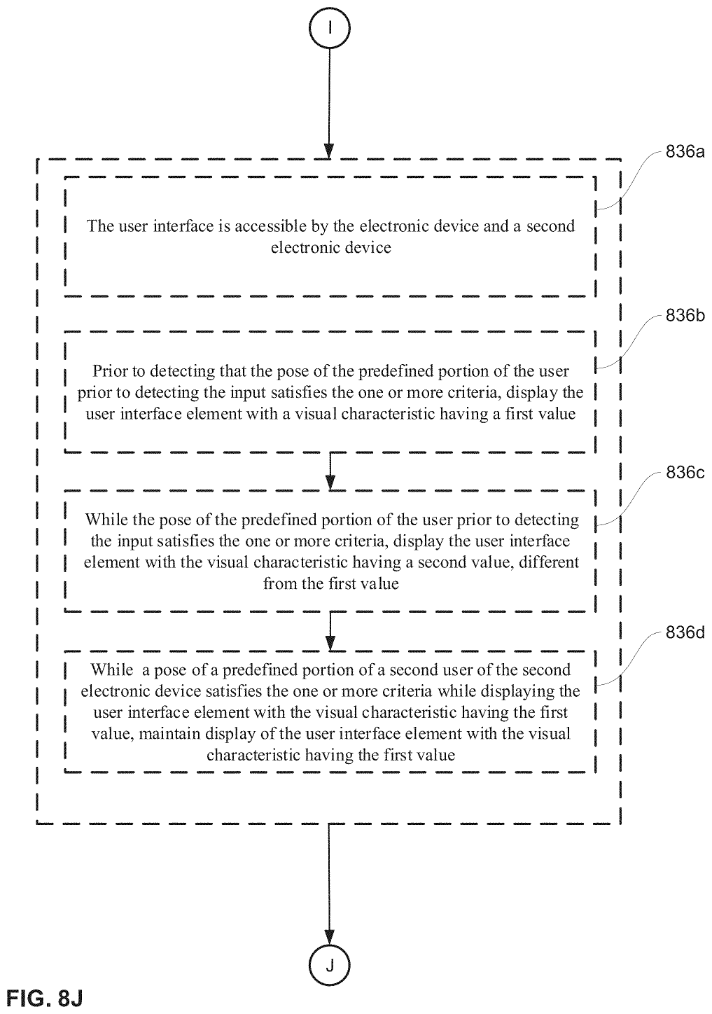

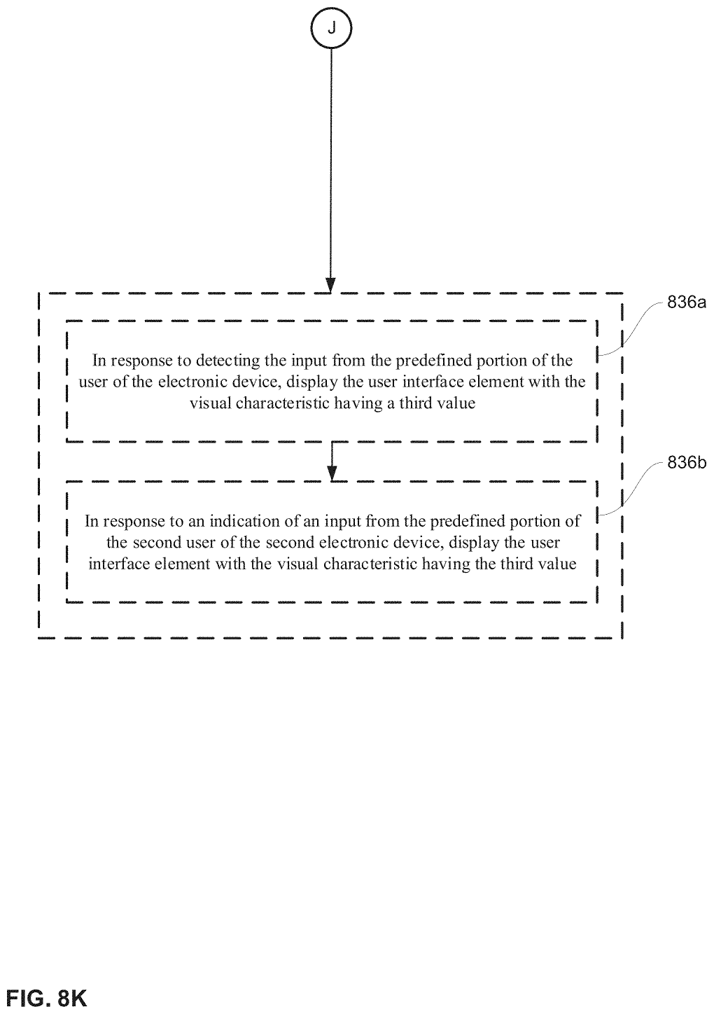

FIGS. 8A-8K is a flowchart illustrating a method 800 of performing or not performing an operation in response to a user input depending on whether the user input is preceded by detecting a ready state of the user in accordance with some embodiments. In some embodiments, the method 800 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, a projector, etc.) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 800 are, optionally, combined and/or the order of some operations is, optionally, changed.

In some embodiments, method 800 is performed at an electronic device 101a or 101b in communication with a display generation component and one or more input devices (e.g., a mobile device (e.g., a tablet, a smartphone, a media player, or a wearable device), or a computer). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. In some embodiments, the one or more input devices include an electronic device or component capable of receiving a user input (e.g., capturing a user input, detecting a user input, etc.) and transmitting information associated with the user input to the electronic device. Examples of input devices include a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera, a depth sensor, an eye tracking device, and/or a motion sensor (e.g., a hand tracking device, a hand motion sensor), etc. In some embodiments, the electronic device is in communication with a hand tracking device (e.g., one or more cameras, depth sensors, proximity sensors, touch sensors (e.g., a touch screen, trackpad). In some embodiments, the hand tracking device is a wearable device, such as a smart glove. In some embodiments, the hand tracking device is a handheld input device, such as a remote control or stylus.

In some embodiments, such as in FIG. 7A the electronic device 101a displays (802a), via the display generation component, a user interface that includes a user interface element (e.g., 705). In some embodiments, the user interface element is an interactive user interface element and, in response to detecting an input directed towards the user interface element, the electronic device performs an action associated with the user interface element. For example, the user interface element is a selectable option that, when selected, causes the electronic device to perform an action, such as displaying a respective user interface, changing a setting of the electronic device, or initiating playback of content. As another example, the user interface element is a container (e.g., a window) in which a user interface/content is displayed and, in response to detecting selection of the user interface element followed by a movement input, the electronic device updates the position of the user interface element in accordance with the movement input. In some embodiments, the user interface and/or user interface element are displayed in a three-dimensional environment (e.g., the user interface is the three-dimensional environment and/or is displayed within a three-dimensional environment) that is generated, displayed, or otherwise caused to be viewable by the device (e.g., a computer-generated reality (CGR) environment such as a virtual reality (VR) environment, a mixed reality (MR) environment, or an augmented reality (AR) environment, etc.

In some embodiments, such as in FIG. 7C, while displaying the user interface element (e.g., 705), the electronic device 101a detects (802b), via the one or more input devices, an input from a predefined portion (e.g., 709) (e.g., hand, arm, head, eyes, etc.) of a user of the electronic device 101a. In some embodiments, detecting the input includes detecting, via the hand tracking device, that the user performs a predetermined gesture with their hand optionally while the gaze of the user is directed towards the user interface element. For example, the predetermined gesture is a pinch gesture that includes touching a thumb to another finger (e.g., index, middle, ring, little finger) on the same hand as the thumb while the looking at the user interface element. In some embodiments, the input is a direct or indirect interaction with the user interface element, such as described with reference to methods 1000, 1200, 1400, 1600, 1800 and/or 2000).

In some embodiments, in response to detecting the input from the predefined portion of the user of the electronic device (802c), in accordance with a determination that a pose (e.g., position, orientation, hand shape) of the predefined portion (e.g., 709) of the user prior to detecting the input satisfies one or more criteria, the electronic device performs (802d) a respective operation in accordance with the input from the predefined portion (e.g., 709) of the user of the electronic device 101a, such as in FIG. 7C. In some embodiments, the pose of the physical feature of the user is an orientation and/or shape of the hand of the user. For example, the pose satisfies the one or more criteria if the electronic device detects that the hand of the user is oriented with the user's palm facing away from the user's torso while in a pre-pinch hand shape in which the thumb of the user is within a threshold distance (e.g., 0.5, 1, 2, etc. centimeters) of another finger (e.g., index, middle, ring, little finger) on the hand of the thumb. As another example, the one or more criteria are satisfied when the hand is in a pointing hand shape in which one or more fingers are extended and one or more other fingers are curled towards the user's palm. Input by the hand of the user subsequent to the detection of the pose is optionally recognized as directed to the user interface element, and the device optionally performs the respective operation in accordance with that subsequent input by the hand. In some embodiments, the respective operation includes scrolling a user interface, selecting an option, activating a setting, or navigating to a new user interface. In some embodiments, in response to detecting an input that includes selection followed by movement of the portion of the user after detecting the predetermined pose, the electronic device scrolls a user interface. For example, the electronic device detects the user's gaze directed to the user interface while first detecting a pointing hand shape, followed by movement of the user's hand away from the torso of the user and in a direction in which the user interface is scrollable and, in response to the sequence of inputs, scrolls the user interface. As another example, in response to detecting the user's gaze on an option to activate a setting of the electronic device while detecting the pre-pinch hand shape followed by a pinch hand shape, the electronic device activates the setting on the electronic device.

In some embodiments, such as in FIG. 7C, in response to detecting the input from the predefined portion (e.g., 715) of the user of the electronic device 101b (802c), in accordance with a determination that the pose of the predefined portion (e.g., 715) of the user prior to detecting the input does not satisfy the one or more criteria, such as in FIG. 7B, the electronic device 101b forgoes (802e) performing the respective operation in accordance with the input from the predefined portion (e.g., 715) of the user of the electronic device 101b, such as in FIG. 7C. In some embodiments, even if the pose satisfies the one or more criteria, the electronic device forgoes performing the respective operation in response to detecting that, while the pose and the input were detected, the gaze of the user was not directed towards the user interface element. In some embodiments, in accordance with a determination that the gaze of the user is directed towards the user interface element while the pose and the input are detected, the electronic device performs the respective operation in accordance with the input.

The above-described manner of performing or not performing the first operation depending on whether or not the pose of the predefined portion of the user prior to detecting the input satisfies one or more criteria provides an efficient way of reducing accidental user inputs, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage and by reducing the likelihood that the electronic device performs an operation that was not intended and will be subsequently reversed.

In some embodiments, such as in FIG. 7A, while the pose of the predefined portion (e.g., 709) of the user does not satisfy the one or more criteria (e.g., prior to detecting the input from the predefined portion of the user), the electronic device 101a displays (804a) the user interface element (e.g., 705) with a visual characteristic (e.g., size, color, position, translucency) having a first value and displaying a second user interface element (e.g., 707) included in the user interface with the visual characteristic (e.g., size, color, position, translucency) having a second value. In some embodiments, displaying the user interface element with the visual characteristic having the first value and displaying the second user interface element with the visual characteristic having the second value indicates that the input focus is not directed to the user interface element nor the second user interface element and/or that the electronic device will not direct input from the predefined portion of the user to the user interface element or the second user interface element.

In some embodiments, such as in FIG. 7B, while the pose of the predefined portion (e.g., 709) of the user satisfies the one or more criteria, the electronic device 101a updates (804b) the visual characteristic of a user interface element (e.g., 705) toward which an input focus is directed, including (e.g., prior to detecting the input from the predefined portion of the user), in accordance with a determination that that an input focus is directed to the user interface element (e.g., 705), the electronic device 101a updates (804c) the user interface element (e.g., 705) to be displayed with the visual characteristic (e.g., size, color, translucency) having a third value (e.g., different from the first value, while maintaining display of the second user interface element with the visual characteristic having the second value). In some embodiments, the input focus is directed to the user interface element in accordance with a determination that the gaze of the user is directed towards the user interface element, optionally including disambiguation techniques according to method 1200. In some embodiments, the input focus is directed to the user interface element in accordance with a determination that the predefined portion of the user is within a threshold distance (e.g., 0.5, 1, 2, 3, 4, 5, 10, 30, 50, etc. centimeters) of the user interface element (e.g., a threshold distance for a direct input). For example, before the predefined portion of the user satisfies the one or more criteria, the electronic device displays the user interface element in a first color and, in response to detecting that the predefine portion of the user satisfies the one or more criteria and the input focus is directed to the user interface element, the electronic device displays the user interface element in a second color different from the first color to indicate that input from the predefined portion of the user will be directed to the user interface element.

In some embodiments, while the pose of the predefined portion (e.g., 705) of the user satisfies the one or more criteria, such as in FIG. 7B, the electronic device 101a updates (804b) the visual characteristic of a user interface element toward which an input focus is directed (e.g., in the way in which the electronic device 101a updates user interface element 705 in FIG. 7B), including (e.g., prior to detecting the input from the predefined portion of the user), in accordance with a determination that the input focus is directed to the second user interface element, the electronic device 101a updates (804d) the second user interface element to be displayed with the visual characteristic having a fourth value (e.g., updating the appearance of user interface element 707 in FIG. 7B if user interface element 707 has the input focus instead of user interface element 705 having the input focus as is the case in FIG. 7B) (e.g., different from the second value, while maintaining display of the user interface element with the visual characteristic having the first value). In some embodiments, the input focus is directed to the second user interface element in accordance with a determination that the gaze of the user is directed towards the second user interface element, optionally including disambiguation techniques according to method 1200. In some embodiments, the input focus is directed to the second user interface element in accordance with a determination that the predefined portion of the user is within a threshold distance (e.g., 0.5, 1, 2, 3, 4, 5, 10, 50, etc. centimeters) of the second user interface element (e.g., a threshold distance for a direct input). For example, before the predefined portion of the user satisfies the one or more criteria, the electronic device displays the second user interface element in a first color and, in response to detecting that the predefined portion of the user satisfies the one or more criteria and the input focus is directed to the second user interface element, the electronic device displays the second user interface element in a second color different from the first color to indicate that input will be directed to the user interface element.

The above-described manner of updating the visual characteristic of the user interface element to which input focus is directed in response to detecting that the predefined portion of the user satisfies the one or more criteria provides an efficient way of indicating to the user which user interface element input will be directed towards, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 7B, the input focus is directed to the user interface element (e.g., 705) in accordance with a determination that the predefined portion (e.g., 709) of the user is within a threshold distance (e.g., 0.5, 1, 2, 3, 4, 5, 10, 50, etc. centimeters) of a location corresponding to the user interface element (e.g., 705) (806a) (e.g., and not within the threshold distance of the second user interface element). In some embodiments, the threshold distance is associated with a direct input, such as described with reference to methods 800, 1000, 1200, 1400, 1600, 1800 and/or 2000. For example, the input focus is directed to the user interface element in response to detecting the finger of the user's hand in the pointing hand shape within the threshold distance of the user interface element.

In some embodiments, the input focus is directed to the second user interface element (e.g., 707) in FIG. 7B in accordance with a determination that the predefined portion (e.g., 709) of the user is within the threshold distance (e.g., 0.5, 1, 2, 3, 4, 5, 10, 50, etc. centimeters) of the second user interface element (806b) (e.g., and not within the threshold distance of the user interface element; such as if the user's hand 709 were within the threshold distance of user interface element 707 instead of user interface element 705 in FIG. 7B, for example). In some embodiments, the threshold distance is associated with a direct input, such as described with reference to methods 800, 1000, 1200, 1400, 1600, 1800 and/or 2000. For example, the input focus is directed to the second user interface element in response to detecting the finger of the user's hand in the pointing hand shape within the threshold distance of the second user interface element.

The above-described manner of directing the input focus based on which user interface element the predefined portion of the user is within the threshold distance of provides an efficient way of directing user input when providing inputs using the predefined portion of the user, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 7B, the input focus is directed to the user interface element (e.g., 705) in accordance with a determination that a gaze (e.g., 701b) of the user is directed to the user interface element (e.g., 705) (808a) (e.g., and the predefined portion of the user is not within the threshold distance of the user interface element and/or any interactive user interface element). In some embodiments, determining that the gaze of the user is directed to the user interface element includes one or more disambiguation techniques according to method 1200. For example, the electronic device directs the input focus to the user interface element for indirect input in response to detecting the gaze of the user directed to the user interface element.

In some embodiments, the input focus is directed to the second user interface element (e.g., 707) in FIG. 7B in accordance with a determination that the gaze of the user is directed to the second user interface element (e.g., 707) (808b) (e.g., and the predefined portion of the user is not within a threshold distance of the second user interface element and/or any interactable user interface element). For example, if the gaze of the user was directed to user interface element 707 in FIG. 7B instead of user interface element 705, the input focus would be directed to user interface element 707. In some embodiments, determining that the gaze of the user is directed to the second user interface element includes one or more disambiguation techniques according to method 1200. For example, the electronic device directs the input focus to the second user interface element for indirect input in response to detecting the gaze of the user directed to the second user interface element.

The above-described manner of directing the input focus to the user interface at which the user is looking provides an efficient way of directing user inputs without the user of additional input devices (e.g., other than an eye tracking device and hand tracking device), which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 7B, updating the visual characteristic of a user interface element (e.g., 705) toward which an input focus is directed includes (810a), in accordance with a determination that the predefined portion (e.g., 709) of the user is less than a threshold distance (e.g., 1, 2, 3, 4, 5, 10, 15, 30, etc. centimeters) from a location corresponding to the user interface element (e.g., 705), the visual characteristic of the user interface element (e.g., 705) toward which the input focus is directed is updated in accordance with a determination that the pose of the predefined portion (e.g., 709) of the user satisfies a first set of one or more criteria (810b), such as in FIG. 7B (and, optionally, the visual characteristic of the user interface element toward which the input focus is directed is not updated in accordance with a determination that the pose of the predefined portion of the user does not satisfy the first set of one or more criteria) (e.g., associated with direct inputs such as described with reference to methods 800, 1000, 1200, 1400, 1600, 1800 and/or 2000). For example, while the hand of the user is within the direct input threshold distance of the user interface element, the first set of one or more criteria include detecting a pointing hand shape (e.g., a shape in which a finger is extending out from an otherwise closed hand.

In some embodiments, such as in FIG. 7B, updating the visual characteristic of a user interface element (e.g., 705) toward which an input focus is directed includes (810a), in accordance with a determination that the predefined portion (e.g., 711) of the user is more than the threshold distance (e.g., 1, 2, 3, 4, 5, 10, 15, 30, etc. centimeters) from the location corresponding to the user interface element (e.g., 705), the visual characteristic of the user interface element (e.g., 705) toward which the input focus is directed is updated in accordance with a determination that the pose of the predefined portion (e.g., 711) of the user satisfies a second set of one or more criteria (e.g., associated with indirect inputs such as described with reference to methods 800, 1000, 1200, 1400, 1600, 1800 and/or 2000), different from the first set of one or more criteria (810c), such as in FIG. 7B (and, optionally, the visual characteristic of the user interface element toward which the input focus is directed is not updated in accordance with a determination that the pose of the predefined portion of the user does not satisfy the second set of one or more criteria). For example, while the hand of the user is more than the direct input threshold from the user interface element, the second set of one or more criteria include detecting a pre-pinch hand shape instead of detecting the pointing hand shape. In some embodiments, the hand shapes that satisfy the one or more first criteria are different from the hand shapes that satisfy the one or more second criteria. In some embodiments, the one or more criteria are not satisfied when the predefined portion of the user is greater than the threshold distance from the location corresponding to the user interface element and the pose of the predefined portion of the user satisfies the first set of one or more criteria without satisfying the second set of one or more criteria. In some embodiments, the one or more criteria are not satisfied when the predefined portion of the user is less than the threshold distance from the location corresponding to the user interface element and the pose of the predefined portion of the user satisfies the second set of one or more criteria without satisfying the first set of one or more criteria.

The above-described manner of using different criteria to evaluate the predefined portion of the user depending on whether the predefined portion of the user is within the threshold distance of a location corresponding to the user interface element provides efficient and intuitive ways of interacting with the user interface element that are tailored to whether the input is a direct or indirect input, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 7B, the pose of the predefined portion (e.g., 709) of the user satisfying the one or more criteria includes (812a), in accordance with a determination that the predefined portion (e.g., 709) of the user is less than a threshold distance (e.g., 1, 2, 3, 4, 5, 10, 15, 30, etc. centimeters) from a location corresponding to the user interface element (e.g., 705), the pose of the predefined portion (e.g., 709) of the user satisfying a first set of one or more criteria (812b) (e.g., associated with direct inputs such as described with reference to methods 800, 1000, 1200, 1400, 1600, 1800 and/or 2000). For example, while the hand of the user is within the direct input threshold distance of the user interface element, the first set of one or more criteria include detecting a pointing hand shape (e.g., a shape in which a finger is extending out from an otherwise closed hand).

In some embodiments, such as in FIG. 7B, the pose of the predefined portion (e.g., 711) of the user satisfying the one or more criteria includes (812a), in accordance with a determination that the predefined portion (e.g., 711) of the user is more than the threshold distance (e.g., 1, 2, 3, 4, 5, 10, 15, 30, etc. centimeters) from the location corresponding to the user interface element (e.g., 705), the pose of the predefined portion (e.g., 711) of the user satisfying a second set of one or more criteria (e.g., associated with indirect inputs such as described with reference to methods 800, 1000, 1200, 1400, 1600, 1800 and/or 2000), different from the first set of one or more criteria (812c). For example, while the hand of the user is more than the direct input threshold from the user interface element, the second set of one or more criteria include detecting a pre-pinch hand shape. In some embodiments, the hand shapes that satisfy the one or more first criteria are different from the hand shapes that satisfy the one or more second criteria. In some embodiments, the one or more criteria are not satisfied when the predefined portion of the user is greater than the threshold distance from the location corresponding to the user interface element and the pose of the predefined portion of the user satisfies the first set of one or more criteria without satisfying the second set of one or more criteria. In some embodiments, the one or more criteria are not satisfied when the predefined portion of the user is less than the threshold distance from the location corresponding to the user interface element and the pose of the predefined portion of the user satisfies the second set of one or more criteria without satisfying the first set of one or more criteria.

The above-described manner of using different criteria to evaluate the predefined portion of the user depending on whether the predefined portion of the user is within the threshold distance of a location corresponding to the user interface element provides efficient and intuitive ways of interacting with the user interface element that are tailored to whether the input is a direct or indirect input, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, the pose of the predefined portion of the user satisfying the one or more criteria such as in FIG. 7B includes (814a), in accordance with a determination that the predefined portion of the user is holding (e.g., or interacting with, or touching) an input device (e.g., stylus, remote control, trackpad) of the one or more input devices, the pose of the predefined portion of the user satisfying a first set of one or more criteria (814b) (e.g., if the hand 709 of the user in FIG. 7B were holding an input device). In some embodiments, the predefined portion of the user is the user's hand. In some embodiments, the first set of one or more criteria are satisfied when the user is holding a stylus or controller in their hand within a predefined region of the three-dimensional environment, and/or with a predefined orientation relative to the user interface element and/or relative to the torso of the user. In some embodiments, the first set of one or more criteria are satisfied when the user is holding a remote control within a predefined region of the three-dimensional environment, with a predefined orientation relative to the user interface element and/or relative to the torso of the user, and/or while a finger of thumb of the user is resting on a respective component (e.g., a button, trackpad, touchpad, etc.) of the remote control. In some embodiments, the first set of one or more criteria are satisfied when the user is holding or interacting with a trackpad and the predefined portion of the user is in contact with the touch-sensitive surface of the trackpad (e.g., without pressing into the trackpad, as would be done to make a selection).

In some embodiments, such as in FIG. 7B, the pose of the predefined portion (e.g., 709) of the user satisfying the one or more criteria includes (814a), in accordance with a determination that the predefined portion (e.g., 709) of the user is not holding the input device, the pose of the predefined portion (e.g., 709) of the user satisfying a second set of one or more criteria (814c) (e.g., different from the first set of one or more criteria). In some embodiments, while the user of the electronic device is not holding, touching, or interacting with the input device, the second set of one or more criteria are satisfied when the pose of the user is a predefined pose (e.g., a pose including a pre-pinch or pointing hand shape), such as previously described instead of holding the stylus or controller in their hand. In some embodiments, the pose of the predefined portion of the user does not satisfy the one or more criteria when the predefined portion of the user is holding an input device and the second set of one or more criteria are satisfied and the first set of one or more criteria are not satisfied. In some embodiments, the pose of the predefined portion of the user does not satisfy the one or more criteria when the predefined portion of the user is not holding an input device and the first set of one or more criteria are satisfied and the second set of one or more criteria are not satisfied.

The above-described manner of evaluating the predefined portion of the user according to different criteria depending on whether or not the user is holding the input device provides efficient ways of switching between accepting input using the input device and input that does not use the input device (e.g., an input device other than eye tracking and/or hand tracking devices) which simplifies the interaction between the user and the electronic device and enhances the operability of the electronic device and makes the user-device interface more efficient, which additionally reduces power usage and improves battery life of the electronic device by enabling the user to use the electronic device more quickly and efficiently.

In some embodiments, such as in FIG. 7B, the pose of the predefined portion (e.g., 709) of the user satisfying the one or more criteria includes (816a), in accordance with a determination that the predefined portion (e.g., 709) of the user is less than a threshold distance (e.g., 0.5, 1, 2, 3, 4, 5, 10, 15, 30, 50, etc. centimeters, corresponding to direct inputs) from a location corresponding to the user interface element (e.g., 705), the pose of the predefined portion (e.g., 709) of the user satisfying a first set of one or more criteria (816b). For example, while the hand of the user is within the direct input threshold distance of the user interface element, the first set of one or more criteria include detecting a pointing hand shape and/or a pre-pinch hand shape.

In some embodiments, such as in FIG. 7B, the pose of the predefined portion (e.g., 711) of the user satisfying the one or more criteria includes (816a), in accordance with a determination that the predefined portion (e.g., 711) of the user is more than the threshold distance (e.g., 0.5, 1, 2, 3, 4, 5, 10, 15, 30, 50, etc. centimeters, corresponding to indirect inputs) from the location corresponding to the user interface element (e.g., 705), the pose of the predefined portion (e.g., 711) of the user satisfying the first set of one or more criteria (816c).

For example, while the hand of the user is more than the direct input threshold from the user interface element, the second set of one or more criteria include detecting a pre-pinch hand shape and/or a pointing hand shape that is the same as the hand shapes used to satisfy the one or more criteria for the. In some embodiments, the hand shapes that satisfy the one or more first criteria are the same regardless of whether or not the predefined portion of the hand is greater than or less than the threshold distance from the location corresponding to the user interface element.

The above-described manner of evaluating the pose of the predefined portion of the user against the first set of one or more criteria irrespective of the distance between the predefined portion of the user and the location corresponding to the user interface element provides an efficient and consistent way of detecting user inputs provided with the predefined portion of the user, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 7C, in accordance with a determination that the predefined portion (e.g., 711) of the user, during the respective input, is more than a threshold distance (e.g., 0.5, 1, 2, 3, 4, 5, 10, 15, 30, 50, etc. centimeters, corresponding to indirect input) away from a location corresponding to the user interface element (e.g., 705) (e.g., the input is an indirect input), the one or more criteria include a criterion that is satisfied when an attention of the user is directed towards the user interface element (e.g., 705) (818a) (e.g., and the criterion is not satisfied when the attention of the user is not directed towards the user interface element) (e.g., the gaze of the user is within a threshold distance of the user interface element, the user interface element is within the attention zone of the user, etc., such as described with reference to method 1000). In some embodiments, the electronic device determines which user interface element an indirect input is directed to based on the attention of the user, so it is not possible to provide an indirect input to a respective user interface element without directing the user attention to the respective user interface element.

In some embodiments, such as in FIG. 7C, in accordance with a determination that the predefined portion (e.g., 709) of the user, during the respective input, is less than the threshold distance (e.g., 0.5, 1, 2, 3, 4, 5, 10, 15, 30, 50, etc. centimeters, corresponding to direct input) away from the location corresponding to the user interface element (e.g., 705) (e.g., the input is a direct input), the one or more criteria do not include a requirement that the attention of the user is directed towards the user interface element (e.g., 709) in order for the one or more criteria to be met (818b) (e.g., it is possible for the one or more criteria to be satisfied without the attention of the user being directed towards the user interface element). In some embodiments, the electronic device determines the target of a direct input based on the location of the predefined portion of the user relative to the user interface elements in the user interface and directs the input to the user interface element closest to the predefined portion of the user irrespective of whether or not the user's attention is directed to that user interface element.

The above-described manner of requiring the attention of the user to satisfy the one or more criteria while the predefined portion of the user is more than the threshold distance from the user interface element and not requiring the attention of the user to satisfy the one or more criteria while the predefined portion of the user is less than the threshold distance from the user interface element provides an efficient way of enabling the user to look at other portions of the user interface element while providing direct inputs, thus saving the user time while using the electronic device and reduces user errors while providing indirect inputs, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently.

In some embodiments, in response to detecting that a gaze (e.g., 701a) of the user is directed to a first region (e.g., 703) of the user interface, such as in FIG. 7A the electronic device 101a visually de-emphasizes (820a) (e.g., blur, dim, darken, and/or desaturate), via the display generation component, a second region of the user interface relative to the first region (e.g., 705) of the user interface. In some embodiments, the electronic device modifies display of the second region of the user interface and/or modifies display of the first region of the user interface to achieve visual de-emphasis of the second region of the user interface relative to the first region of the user interface.

In some embodiments, such as in FIG. 7B, in response to detecting that the gaze 701c of the user is directed to the second region (e.g., 702) of the user interface, the electronic device 101b visually de-emphasizes (820b) (e.g., blur, dim, darken, and/or desaturate), via the display generation component, the first region of the user interface relative to the second region (e.g., 702) of the user interface. In some embodiments, the electronic device modifies display of the first region of the user interface and/or modifies display of the second region of the user interface to achieve visual de-emphasis of the first region of the user interface relative to the second region of the user interface. In some embodiments, the first and/or second regions of the user interface include one or more virtual objects (e.g., application user interfaces, items of content, representations of other users, files, control elements, etc.) and/or one or more physical objects (e.g., pass-through video including photorealistic representations of real objects, true pass-through wherein a view of the real object is visible through a transparent portion of the display generation component) that are de-emphasized when the regions of the user interface are de-emphasized.

The above-described manner of visually de-emphasizing the region other than the region to which the gaze of the user is directed provides an efficient way of reducing visual clutter while the user views a respective region of the user interface, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently.

In some embodiments, such as in FIG. 7A, the user interface is accessible by the electronic device 101a and a second electronic device 101b (822a) (e.g., the electronic device and second electronic device are in communication (e.g., via a wired or wireless network connection). In some embodiments, the electronic device and the second electronic device are remotely located from each other. In some embodiments, the electronic device and second electronic device are collocated (e.g., in the same room, building, etc.). In some embodiments, the electronic device and the second electronic device present the three-dimensional environment in a co-presence session in which representations of the users of both devices are associated with unique locations in the three-dimensional environment and each electronic device displays the three-dimensional environment from the perspective of the representation of the respective user.

In some embodiments, such as in FIG. 7B, in accordance with an indication that a gaze 701c of a second user of the second electronic device 101b is directed to the first region 702 of the user interface, the electronic device 101a forgoes (822b) visually de-emphasizing (e.g., blur, dim, darken, and/or desaturate), via the display generation component, the second region of the user interface relative to the first region of the user interface. In some embodiments, the second electronic device visually de-emphasizes the second region of the user interface in accordance with the determination that the gaze of the second user is directed to the first region of the user interface. In some embodiments, in accordance with a determination that the gaze of the user of the electronic device is directed to the first region of the user interface, the second electronic device forgoes visually de-emphasizing the second region of the user interface relative to the first region of the user interface.

In some embodiments, such as in FIG. 7B, in accordance with an indication that the gaze of the second user of the second electronic device 101a is directed to the second region (e.g., 703) of the user interface, the electronic device 101b forgoes (822c) visually de-emphasizing (e.g., blur, dim, darken, and/or desaturate), via the display generation component, the first region of the user interface relative to the second region of the user interface. In some embodiments, the second electronic device visually de-emphasizes the first region of the user interface in accordance with the determination that the gaze of the second user is directed to the second region of the user interface. In some embodiments, in accordance with a determination that the gaze of the user of the electronic device is directed to the second region of the user interface, the second electronic device forgoes visually de-emphasizing the first region of the user interface relative to the second region of the user interface.

The above-described manner of forgoing visually de-emphasizing regions of the user interface based on the gaze of the user of the second electronic device provides an efficient way of enabling the users to concurrently look at different regions of the user interface, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently.

In some embodiments, such as in FIG. 7C, detecting the input from the predefined portion (e.g., 705) of the user of the electronic device 101a includes detecting, via a hand tracking device, a pinch (e.g., pinch, pinch and hold, pinch and drag, double pinch, pluck, release without velocity, toss with velocity) gesture performed by the predefined portion (e.g., 709) of the user (824a). In some embodiments, detecting the pinch gesture includes detecting the user move their thumb toward and/or within a predefined distance of another finger (e.g., index, middle, ring, little finger) on the hand of the thumb. In some embodiments, detecting the pose satisfying the one or more criteria includes detecting the user is in a ready state, such as a pre-pinch hand shape in which the thumb is within a threshold distance (e.g., 1, 2, 3, 4, 5, etc. centimeters) of the other finger.

The above-described manner of detecting an input including a pinch gesture provides an efficient way of accepting user inputs based on hand gestures without requiring the user to physically touch and/or manipulate an input device with their hands which simplifies the interaction between the user and the electronic device and enhances the operability of the electronic device and makes the user-device interface more efficient, which additionally reduces power usage and improves battery life of the electronic device by enabling the user to use the electronic device more quickly and efficiently.

In some embodiments, such as in FIG. 7C, detecting the input from the predefined portion (e.g., 709) of the user of the electronic device 101a includes detecting, via a hand tracking device, a press (e.g., tap, press and hold, press and drag, flick) gesture performed by the predefined portion (e.g., 709) of the user (826a). In some embodiments, detecting the press gesture includes detecting the predefined portion of the user pressing a location corresponding to a user interface element displayed in the user interface (e.g., such as described with reference to methods 1400, 1600 and/or 2000), such as the user interface element or a virtual trackpad or other visual indication according to method 1800. In some embodiments, prior to detecting the input including the press gesture, the electronic device detects the pose of the predefined portion of the user that satisfies the one or more criteria including detecting the user in a ready state, such as the hand of the user being in a pointing hand shape with one or more fingers extended and one or more fingers curled towards the palm. In some embodiments, the press gesture includes moving the finger, hand, or arm of the user while the hand is in the pointing hand shape.

The above-described manner of detecting an input including a press gesture provides an efficient way of accepting user inputs based on hand gestures without requiring the user to physically touch and/or manipulate an input device with their hands which simplifies the interaction between the user and the electronic device and enhances the operability of the electronic device and makes the user-device interface more efficient, which additionally reduces power usage and improves battery life of the electronic device by enabling the user to use the electronic device more quickly and efficiently.

In some embodiments, such as in FIG. 7C, detecting the input from the predefined portion (e.g., 709) of the user of the electronic device 101a includes detecting lateral movement of the predefined portion (e.g., 709) of the user relative to a location corresponding to the user interface element (e.g., 705) (828a) (e.g., such as described with reference to method 1800). In some embodiments, lateral movement includes movement that includes a component normal to a straight line path between the predefined portion of the user and the location corresponding to the user interface element. For example, if the user interface element is in front of the predefined portion of the user and the user moves the predefined portion of the user left, right, up, or down, the movement is a lateral movement. For example, the input is one of a press and drag, pinch and drag, or toss (with velocity) input.

The above-described manner of detecting an input including lateral movement of the predefined portion of the user relative to the user interface element provides an efficient way of providing directional input to the electronic device with the predefined portion of the user, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently.

In some embodiments, such as in FIG. 7A, prior to determining that the pose of the predefined portion (e.g., 709) of the user prior to detecting the input satisfies the one or more criteria (830a), the electronic device 101a detects (830b), via an eye tracking device, that a gaze (e.g., 701a) of the user is directed to the user interface element (e.g., 705) (e.g., according to one or more disambiguation techniques of method 1200).

In some embodiments, prior to determining that the pose of the predefined portion (e.g., 709) of the user prior to detecting the input satisfies the one or more criteria (830a), such as in FIG. 7A, in response to detecting, that the gaze (e.g., 701a) of the user is directed to the user interface element (e.g., 705), the electronic device 101a displays (830c), via the display generation component, a first indication that the gaze (e.g., 701a) of the user is directed to the user interface element (e.g., 705). In some embodiments, the first indication is highlighting overlaid on or displayed around the user interface element. In some embodiments, the first indication is a change in color or change in location (e.g., towards the user) of the user interface element. In some embodiments, the first indication is a symbol or icon displayed overlaid on or proximate to the user interface element.

The above-described manner of displaying the first indication that the gaze of the user is directed to the user interface element provides an efficient way of communicating to the user that the input focus is based on the location at which the user is looking, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently.

In some embodiments, such as in FIG. 7B, prior to detecting the input from the predefined portion (e.g., 709) of the user of the electronic device 101a, while the pose of the predefined portion (e.g., 709) of the user prior to detecting the input satisfies the one or more criteria (832a) (e.g., and while the gaze of the user is directed to the user interface element (e.g., according to one or more disambiguation techniques of method 1200), the electronic device 101a displays (832b), via the display generation component, a second indication that the pose of the predefined portion (e.g., 709) of the user prior to detecting the input satisfies the one or more criteria, such as in FIG. 7B, wherein the first indication is different from the second indication. In some embodiments, displaying the second indication includes modifying a visual characteristic (e.g., color, size, position, translucency) of the user interface element at which the user is looking. For example, the second indication is the electronic device moving the user interface element towards the user in the three-dimensional environment. In some embodiments, the second indication is displayed overlaid on or proximate to the user interface element at which the user is looking. In some embodiments, the second indication is an icon or image displayed at a location in the user interface independent of the location to which the user's gaze is directed.

The above-described manner of displaying an indication that the pose of the user satisfies one or more criteria that is different from the indication of the location of the user's gaze provides an efficient way of indicating to the user that the electronic device is ready to accept further input from the predefined portion of the user, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently.

In some embodiments, such as in FIG. 7C, while displaying the user interface element (e.g., 705), the electronic device 101a detects (834a), via the one or more input devices, a second input from a second predefined portion (e.g., 717) (e.g., a second hand) of the user of the electronic device 101a.

In some embodiments, in response to detecting the second input from the second predefined portion (e.g., 717) of the user of the electronic device (834b), in accordance with a determination that a pose (e.g., position, orientation, hand shape) of the second predefined portion (e.g., 711) of the user prior to detecting the second input satisfies one or more second criteria, such as in FIG. 7B, the electronic device 101a performs (834c) a second respective operation in accordance with the second input from the second predefined portion (e.g., 711) of the user of the electronic device 101a. In some embodiments, the one or more second criteria differ from the one or more criteria in that a different predefined portion of the user performs the pose, but otherwise the one or more criteria and the one or more second criteria are the same. For example, the one or more criteria require that the right hand of the user is in a ready state such as a pre-pinch or pointing hand shape and the one or more second criteria require that the left hand of the user is in a ready state such as the pre-pinch or pointing hand shape. In some embodiments, the one or more criteria are different from the one or more second criteria. For example, a first subset of poses satisfy the one or more criteria for the right hand of the user and a second, different subset of poses satisfy the one or more criteria for the left hand of the user.

In some embodiments, such as in FIG. 7C, in response to detecting the second input from the second predefined portion (e.g., 715) of the user of the electronic device 101b (834b), in accordance with a determination that the pose of the second predefined portion (e.g., 721) of the user prior to detecting the second input does not satisfy the one or more second criteria, such as in FIG. 7B, the electronic device forgoes (834d) performing the second respective operation in accordance with the second input from the second predefined portion (e.g., 715) of the user of the electronic device 101b, such as in FIG. 7C. In some embodiments, the electronic device is able to detect inputs from the predefined portion of the user and/or the second predefined portion of the user independently of each other. In some embodiments, in order to perform an action in accordance with an input provided by the left hand of the user, the left hand of the user must have a pose that satisfies the one or more criteria prior to providing the input and in order to perform an action in accordance with an input provided by the right hand of the user, the right hand of the user must have a posed that satisfies the second one or more criteria. In some embodiments, in response to detecting the pose of the predefined portion of the user that satisfies one or more criteria followed by an input provided by the second predefined portion of the user without the second predefined portion of the user satisfying the second one or more criteria first, the electronic device forgoes performing an action in accordance with the input of the second predefined portion of the user. In some embodiments, in response to detecting the pose of the second predefined portion of the user that satisfies the second one or more criteria followed by an input provided by the predefined portion of the user without the predefined portion of the user satisfying the one or more criteria first, the electronic device forgoes performing an action in accordance with the input of the predefined portion of the user.

The above-described manner of accepting inputs from the second predefined portion of the user independent from the predefined portion of the user provides an efficient way of increasing the rate at which the user is able to provide inputs to the electronic device, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently.

In some embodiments, such as in FIGS. 7A-7C, the user interface is accessible by the electronic device 101a and a second electronic device 101b (836a) (e.g., the electronic device and second electronic device are in communication (e.g., via a wired or wireless network connection). In some embodiments, the electronic device and the second electronic device are remotely located from each other. In some embodiments, the electronic device and second electronic device are collocated (e.g., in the same room, building, etc.). In some embodiments, the electronic device and the second electronic device present the three-dimensional environment in a co-presence session in which representations of the users of both devices are associated with unique locations in the three-dimensional environment and each electronic device displays the three-dimensional environment from the perspective of the representation of the respective user.

In some embodiments, such as in FIG. 7A, prior to detecting that the pose of the predefined portion (e.g., 709) of the user prior to detecting the input satisfies the one or more criteria, the electronic device 101a displays (836b) the user interface element (e.g., 705) with a visual characteristic (e.g., size, color, translucency, position) having a first value.

In some embodiments, such as in FIG. 7B, while the pose of the predefined portion (e.g., 709) of the user prior to detecting the input satisfies the one or more criteria, the electronic device 101a displays (836c) the user interface element (e.g., 705) with the visual characteristic (e.g., size, color, translucency, position) having a second value, different from the first value. In some embodiments, the electronic device updates the visual appearance of the user interface element in response to detecting that the pose of the predefined portion of the user satisfies the one or more criteria. In some embodiments, the electronic device only updates the appearance of the user interface element to which the user's attention is directed (e.g., according to the gaze of the user or an attention zone of the user according to method 1000). In some embodiments, the second electronic device maintains display of the user interface element with the visual characteristic having the first value in response to the predefined portion of the user satisfying the one or more criteria.

In some embodiments, while (optionally, in response to an indication that) a pose of a predefined portion of a second user of the second electronic device 101b satisfies the one or more criteria while displaying the user interface element with the visual characteristic having the first value, the electronic device 101a maintains (836d) display of the user interface element with the visual characteristic having the first value, similar to how electronic device 101b maintains display of user interface element (e.g., 705) while the portion (e.g., 709) of the user of the first electronic device 101a satisfies the one or more criteria in FIG. 7B. In some embodiments, in response to detecting the pose of the predefined portion of the user of the second electronic device satisfies the one or more criteria, the second electronic device updates the user interface element to be displayed with the visual characteristic having the second value, similar to how both electronic devices 101a and 101b scroll user interface element (e.g., 705) in response to the input detected by electronic device 101a (e.g., via hand 709 or 711) in FIG. 7C. In some embodiments, in response to an indication that the pose of the user of the electronic device satisfies the one or more criteria while displaying the user interface element with the visual characteristic having the first value, the second electronic device maintains display of the user interface element with the visual characteristic having the first value. In some embodiments, in accordance with a determination that that the pose of the user of the electronic device satisfies the one or more criteria and an indication that that the pose of the user of the second electronic device satisfies the one or more criteria, the electronic device displays the user interface element with the visual characteristic having a third value.

The above-described manner of not synchronizing the updating of the visual characteristic of the user interface element across the electronic devices provides an efficient way of indicating the portions of the user interface with which the user is interacting without causing confusion by also indicating portions of the user interface with which other users are interacting, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently.

In some embodiments, in response to detecting the input from the predefined portion (e.g., 709 or 711) of the user of the electronic device, the electronic device 101a displays (836a) the user interface element (e.g., 705) with the visual characteristic having a third value, such as in FIG. 7C (e.g., the third value is different from the first value and the second value. In some embodiments, in response to the input, the electronic device and second electronic device perform the respective operation in accordance with the input.

In some embodiments, in response to an indication of an input from the predefined portion of the second user of the second electronic device (e.g., after the second electronic device detects that the predefined portion of the user of the second electronic device satisfies the one or more criteria), the electronic device 101a displays (836b) the user interface element with the visual characteristic having the third value, such as though electronic device 101b were to display user interface element (e.g., 705) in the same manner in which electronic device 101a displays the user interface element (e.g., 705) in response to electronic device 101a detecting the user input from the hand (e.g., 709 or 711) of the user of the electronic device 101a. In some embodiments, in response to the input from the second electronic device, the electronic device and the second electronic device perform the respective operation in accordance with the input. In some embodiments, the electronic device displays an indication that the user of the second electronic device has provided an input directed to the user interface element, but does not present an indication of a hover state of the user interface element.

The above-described manner of updating the user interface element in response to an input irrespective of the device at which the input was detected provides an efficient way of indicating the current interaction state of a user interface element displayed by both devices, which simplifies the interaction between the user and the electronic device and enhances the operability of the electronic device and makes the user-device interface more efficient (e.g., by clearly indicating which portions of the user interface other users are interacting with), which additionally reduces power usage and improves battery life of the electronic device by enabling the user to use the electronic device more quickly and efficiently, and avoids errors caused by changes to the interaction status of the user interface element that would subsequently require correction.

FIGS. 9A-9C illustrate exemplary ways in which an electronic device 101a processes user inputs based on an attention zone associated with the user in accordance with some embodiments.

FIG. 9A illustrates an electronic device 101a, via display generation component 120a, a three-dimensional environment. It should be understood that, in some embodiments, electronic device 101a utilizes one or more techniques described with reference to FIGS. 9A-9C in a two-dimensional environment or user interface without departing from the scope of the disclosure. As described above with reference to FIGS. 1-6, the electronic device optionally includes display generation component 120a (e.g., a touch screen) and a plurality of image sensors 314a. The image sensors optionally include one or more of a visible light camera, an infrared camera, a depth sensor, or any other sensor the electronic device 101a would be able to use to capture one or more images of a user or a part of the user while the user interacts with the electronic device 101a. In some embodiments, display generation component 120a is a touch screen that is able to detect gestures and movements of a user's hand. In some embodiments, the user interfaces described below could also be implemented on a head-mounted display that includes a display generation component that displays the user interface to the user, and sensors to detect the physical environment and/or movements of the user's hands (e.g., external sensors facing outwards from the user), and/or gaze of the user (e.g., internal sensors facing inwards towards the face of the user).

FIG. 9A illustrates the electronic device 101a presenting a first selectable option 903, a second selectable option 905, and a representation 904 of a table in the physical environment of the electronic device 101a via display generation component 120a (e.g., such as table 604 in FIG. 6B). In some embodiments, the representation 904 of the table is a photorealistic image of the table generated by the display generation component 120a (e.g., passthrough video or digital passthrough). In some embodiments, the representation 904 of the table is a view of the table through a transparent portion of the display generation component 120a (e.g., true or actual passthrough). In some embodiments, the electronic device 101a displays the three-dimensional environment from a viewpoint associated with the user of the electronic device in the three-dimensional environment.

In some embodiments, the electronic device 101a defines an attention zone 907 of the user as a cone-shaped volume in the three-dimensional environment that is based on the gaze 901a of the user. For example, the attention zone 907 is optionally a cone centered around a line defined by the gaze 901a of the user (e.g., a line passing through the location of the user's gaze in the three-dimensional environment and the viewpoint associated with electronic device 101a) that includes a volume of the three-dimensional environment within a predetermined angle (e.g., 1, 2, 3, 5, 10, 15, etc. degrees) from the line defined by the gaze 901a of the user. Thus, in some embodiments, the two-dimensional area of the attention zone 907 increases as a function of distance from the viewpoint associated with electronic device 101a. In some embodiments, the electronic device 101a determines the user interface element to which an input is directed and/or whether to respond to an input based on the attention zone of the user.

As shown in FIG. 9A, the first selectable option 903 is within the attention zone 907 of the user and the second selectable option 905 is outside of the attention zone of the user. As shown in FIG. 9A, it is possible for the selectable option 903 to be in the attention zone 907 even if the gaze 901a of the user isn't directed to selectable option 903. In some embodiments, it is possible for the selectable option 903 to be in the attention zone 907 while the gaze of the user is directed to the selectable option 903. FIG. 9A also shows the hand 909 of the user in a direct input ready state (e.g., hand state D). In some embodiments, the direct input ready state is the same as or similar to the direct input ready state(s) described above with reference to FIGS. 7A-8K. Further, in some embodiments, the direct inputs described herein share one or more characteristics of the direct inputs described with reference to methods 800, 1200, 1400, 1600, 1800, and/or 2000. For example, the hand 909 of the user is in a pointing hand shape and within a direct ready state threshold distance (e.g., 0.5, 1, 2, 3, 5, 10, 15, 30, etc. centimeters) of the first selectable option 903. FIG. 9A also shows the hand 911 of the user in a direct input ready state. In some embodiments, hand 911 is an alternative to hand 909. In some embodiments, the electronic device 101a is able to detect two hands of the user at once (e.g., according to one or more steps of method 1600). For example, hand 911 of the user is in the pointing hand shape and within the ready state threshold distance of the second selectable option 905.

In some embodiments, the electronic device 101a requires user interface elements to be within the attention zone 907 in order to accept inputs. For example, because the first selectable option 903 is within the attention zone 907 of the user, the electronic device 101a updates the first selectable option 903 to indicate that further input (e.g., from hand 909) will be directed to the first selectable option 903. As another example, because the second selectable option 905 is outside of the attention zone 907 of the user, the electronic device 101a forgoes updating the second selectable option 905 to indicate that further input (e.g., from hand 911) will be directed to the second selectable option 905. It should be appreciated that, although the gaze 901a of the user is not directed to the first selectable option 903, the electronic device 101a is still configured to direct inputs to the first selectable option 903 because the first selectable option 903 is within the attention zone 907, which is optionally broader than the gaze of the user.

In FIG. 9B, the electronic device 101a detects the hand 909 of the user making a direct selection of the first selectable option 903. In some embodiments, the direct selection includes moving the hand 909 to a location touching or within a direct selection threshold (e.g., 0.1, 0.2, 0.3, 0.5, 1, 2, etc. centimeters) of the first selectable option 903 while the hand is in the pointing hand shape. As shown in FIG. 9B, the first selectable option 903 is no longer in the attention zone 907 of the user when the input is detected. In some embodiments, the attention zone 907 moves because the gaze 901b of the user moves. In some embodiments, the attention zone 907 moves to the location illustrated in FIG. 9B after the electronic device 101a detects the ready state of hand 909 illustrated in FIG. 9A. In some embodiments, the input illustrated in FIG. 9B is detected before the ready state 907 moves to the location illustrated in FIG. 9B. In some embodiments, the input illustrated in FIG. 9B is detected after the ready state 907 moves to the location illustrated in FIG. 9B. Although the first selectable option 903 is no longer in the attention zone 907 of the user, in some embodiments, the electronic device 101a still updates the color of the first selectable option 903 in response to the input because the first selectable option 903 was in the attention zone 907 during the ready state, as shown in FIG. 9A. In some embodiments, in addition to updating the appearance of the first selectable option 903, the electronic device 101a performs an action in accordance with the selection of the first selectable option 903. For example, the electronic device 101a performs an operation such as activating/deactivating a setting associated with option 903, initiating playback of content associated with option 903, displaying a user interface associated with option 903, or a different operation associated with option 903.

In some embodiments, the selection input is only detected in response to detecting the hand 909 of the user moving to the location touching or within the direct selection threshold of the first selectable option 903 from the side of the first selectable option 903 visible in FIG. 9B. For example, if the user were to instead reach around the first selectable option 903 to touch the first selectable option 903 from the back side of the first selectable option 903 not visible in FIG. 9B, the electronic device 101a would optionally forgo updating the appearance of the first selectable option 903 and/or forgo performing the action in accordance with the selection.

In some embodiments, in addition to continuing to accept a press input (e.g., a selection input) that was started while the first selectable option 903 was in the attention zone 907 and continued while the first selectable option 903 was not in the attention zone 907, the electronic device 101a accepts other types of inputs that were started while the user interface element to which the input was directed was in the attention zone even if the user interface element is no longer in the attention zone when the input continues. For example, the electronic device 101a is able to continue drag inputs in which the electronic device 101a updates the position of a user interface element in response to a user input even if the drag input continues after the user interface element is outside of the attention zone (e.g., and was initiated when the user interface element was inside of the attention zone). As another example, the electronic device 101a is able to continue scrolling inputs in response to a user input even if the scrolling input continues after the user interface element is outside of the attention zone 907 (e.g., and was initiated when the user interface element was inside of the attention zone). As shown in FIG. 9A, in some embodiments, inputs are accepted even if the user interface element to which the input is directed is outside of the attention zone for a portion of the input if the user interface element was in the attention zone when the ready state was detected.

Moreover, in some embodiments, the location of the attention zone 907 remains in a respective position in the three-dimensional environment for a threshold time (e.g., 0.5, 1, 2, 3, 5, etc. seconds) after detecting movement of the gaze of the user. For example, while the gaze 901a of the user and the attention zone 907 are at the locations illustrated in FIG. 9A, the electronic device 101a detects the gaze 901b of the user move to the location illustrated in FIG. 9B. In this example, the attention zone 907 remains at the location illustrated in FIG. 9A for the threshold time before moving the attention zone 907 to the location in FIG. 9B in response to the gaze 901b of the user moving to the location illustrated in FIG. 9B. Thus, in some embodiments, inputs initiated after the gaze of the user moves that are directed to user interface elements that are within the original attention zone (e.g., the attention zone 907 in FIG. 9A) are optionally responded-to by the electronic device 101a as long as those inputs were initiated within the threshold time (e.g., 0.5, 1, 2, 3, 5, etc. seconds) of the gaze of the user moving to the location in FIG. 9B—in some embodiments, the electronic device 101a does not respond to such inputs that are initiated after the threshold time of the gaze of the user moving to the location in FIG. 9B.

In some embodiments, the electronic device 101a cancels a user input if the user moves their hand away from the user interface element to which the input is directed or does not provide further input for a threshold time (e.g., 1, 2, 3, 5, 10, etc. seconds) after the ready state was detected. For example, if the user were to move their hand 909 to the location illustrated in FIG. 9C after the electronic device 101a detected the ready state as shown in FIG. 9A, the electronic device 101a would revert the appearance of the first selectable option 903 to no longer indicate that input is being directed to the first selectable option 903 and no longer accept direct inputs from hand 909 directed to option 903 (e.g., unless and until the ready state is detected again).

As shown in FIG. 9C, the first selectable option 903 is still within the attention zone 907 of the user. The hand 909 of the user is optionally in a hand shape corresponding to the direct ready state (e.g., a pointing hand shape, hand state D). Because the hand 909 of the user has moved away from the first selectable option 903 by a threshold distance (e.g., 1, 2, 3, 5, 10, 15, 20, 30, 50, etc. centimeters) and/or to a threshold distance (e.g., 1, 2, 3, 5, 10, 15, 20, 30, 50, etc. centimeters) away from the first selectable option 903, the electronic device 101a is no longer configured to direct inputs to the first selectable option 903 from hand 909. In some embodiments, even if the user were to maintain the position of the hand 909 illustrated in FIG. 9A, the electronic device 101a would cease directing further input from the hand to the first user interface element 903 if the input were not detected within a threshold period of time (e.g., 1, 2, 3, 5, 10, etc. seconds) of the hand being positioned and having a shape as in FIG. 9A. Likewise, in some embodiments, if the user were to begin to provide additional input (e.g., in addition to satisfying the ready state criteria—for example, beginning to provide a press input to element 903, but not yet reaching the press distance threshold required to complete the press/selection input) and then move the hand away from the first selectable option 903 by the threshold distance and/or move the hand the threshold distance from the first selectable option 903, the electronic device 101a would cancel the input. It should be appreciated, as described above with reference to FIG. 9B, that the electronic device 101a optionally does not cancel an input in response to detecting the gaze 901b of the user or the attention zone 907 of the user moving away from the first selectable option 903 if the input was started while the first selectable option 903 was in the attention zone 907 of the user.

Although FIGS. 9A-9C illustrate examples of determining whether to accept direct inputs directed to user interface elements based on the attention zone 907 of the user, it should be appreciated that the electronic device 101a is able to similarly determine whether to accept indirect inputs directed to user interface elements based on the attention zone 907 of the user. For example, the various results illustrated in and described with reference to FIGS. 9A-9C would optionally apply to indirect inputs (e.g., as described with reference to methods 800, 1200, 1400, 1800, etc.) as well. In some embodiments, the attention zone is not required in order to accept direct inputs but is required for indirect inputs.

FIGS. 10A-10H is a flowchart illustrating a method 1000 of processing user inputs based on an attention zone associated with the user in accordance with some embodiments. In some embodiments, the method 1000 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, a projector, etc.) and one or more cameras (e.g., a camera (e.g., color sensors, infrared sensors, and other depth-sensing cameras) that points downward at a user's hand or a camera that points forward from the user's head). In some embodiments, the method 1000 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1000 are, optionally, combined and/or the order of some operations is, optionally, changed.

In some embodiments, method 1000 is performed at an electronic device 101a in communication with a display generation component and one or more input devices (e.g., a mobile device (e.g., a tablet, a smartphone, a media player, or a wearable device), or a computer. In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. In some embodiments, the one or more input devices include an electronic device or component capable of receiving a user input (e.g., capturing a user input, detecting a user input, etc.) and transmitting information associated with the user input to the electronic device. Examples of input devices include a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera, a depth sensor, an eye tracking device, and/or a motion sensor (e.g., a hand tracking device, a hand motion sensor), etc. In some embodiments, the electronic device is in communication with a hand tracking device (e.g., one or more cameras, depth sensors, proximity sensors, touch sensors (e.g., a touch screen, trackpad). In some embodiments, the hand tracking device is a wearable device, such as a smart glove. In some embodiments, the hand tracking device is a handheld input device, such as a remote control or stylus.

In some embodiments, such as in FIG. 9A, the electronic device 101a displays (1002a), via the display generation component 120a, a first user interface element (e.g., 903, 905). In some embodiments, the first user interface element is an interactive user interface element and, in response to detecting an input directed towards the first user interface element, the electronic device performs an action associated with the first user interface element. For example, the first user interface element is a selectable option that, when selected, causes the electronic device to perform an action, such as displaying a respective user interface, changing a setting of the electronic device, or initiating playback of content. As another example, the first user interface element is a container (e.g., a window) in which a user interface/content is displayed and, in response to detecting selection of the first user interface element followed by a movement input, the electronic device updates the position of the first user interface element in accordance with the movement input. In some embodiments, the user interface and/or user interface element are displayed in a three-dimensional environment (e.g., the user interface is the three-dimensional environment and/or is displayed within a three-dimensional environment) that is generated, displayed, or otherwise caused to be viewable by the device (e.g., a computer-generated reality (CGR) environment such as a virtual reality (VR) environment, a mixed reality (MR) environment, or an augmented reality (AR) environment, etc.

In some embodiments, such as in FIG. 9B, while displaying the first user interface element (e.g., 909), the electronic device 101a detects (1002b), via the one or more input devices, a first input directed to the first user interface element (e.g., 909). In some embodiments, detecting the first user input includes detecting, via the hand tracking device, that the user performs a predetermined gesture (e.g., a pinch gesture in which the user touches a thumb to another finger (e.g., index, middle, ring, little finger) on the same hand as the thumb). In some embodiments, detecting the input includes detecting that the user performs a pointing gesture in which one or more fingers are extended and one or more fingers are curled towards the user's palm and moves their hand a predetermined distance (e.g., 2, 5, 10, etc. centimeters) away from the torso of the user in a pressing or pushing motion. In some embodiments, the pointing gesture and pushing motion are detected while the hand of the user is within a threshold distance (e.g., 1, 2, 3, 5, 10, etc. centimeters) of the first user interface element in a three-dimensional environment. In some embodiments, the three-dimensional environment includes virtual objects and a representation of the user. In some embodiments, the three-dimensional environment includes a representation of the hands of the user, which can be a photorealistic representation of the hands, pass-through video of the hands of the user, or a view of the hands of the user through a transparent portion of the display generation component. In some embodiments, the input is a direct or indirect interaction with the user interface element, such as described with reference to methods 800, 1200, 1400, 1600, 1800 and/or 2000.

In some embodiments, in response to detecting the first input directed to the first user interface element (e.g., 903) (1002c), in accordance with a determination that the first user interface element (e.g., 903) is within an attention zone (e.g., 907) associated with a user of the electronic device 101a, such as in FIG. 9A, (e.g., when the first input was detected), the electronic device 101a performs (1002d) a first operation corresponding to the first user interface element (e.g., 903). In some embodiments, the attention zone includes a region of the three-dimensional environment within a predetermined threshold distance (e.g., 5, 10, 30, 50, 100, etc. centimeters) and/or threshold angle (e.g., 5, 10, 15, 20, 30, 45, etc. degrees) of a location in the three-dimensional environment to which the user's gaze is directed. In some embodiments, the attention zone includes a region of the three-dimensional environment between the location in the three-dimensional environment towards which the user's gaze is directed and one or more physical features of the user (e.g., the user's hands, arms, shoulders, torso, etc.). In some embodiments, the attention zone is a three-dimensional region of the three-dimensional environment. For example, the attention zone is cone-shaped, with the tip of the cone corresponding to the eyes/viewpoint of the user and the base of the cone corresponding to the area of the three-dimensional environment towards which the user's gaze is directed. In some embodiments, the first user interface element is within the attention zone associated with the user while the user's gaze is directed towards the first user interface element and/or when the first user interface element falls within the conical volume of the attention zone. In some embodiments, the first operation is one of making a selection, activating a setting of the electronic device, initiating a process to move a virtual object within the three-dimensional environment, displaying a new user interface not currently displayed, playing an item of content, saving a file, initiating communication (e.g., phone call, e-mail, message) with another user, and/or scrolling a user interface. In some embodiments, the first input is detected by detecting a pose and/or movement of a predefined portion of the user. For example, the electronic device detects the user moving their finger to a location within a threshold distance (e.g., 0.1, 0.3, 0.5, 1, 3, 5 etc. centimeters) of the first user interface element in the three-dimensional environment with their hand/finger in a pose corresponding to the index finger of the hand pointed out with other fingers curled into the hand.

In some embodiments, such as in FIG. 9A, in response to detecting the first input directed to the first user interface element (e.g., 905) (1002c), in accordance with a determination that the first user interface element (e.g., 905) is not within the attention zone associated with the user (e.g., when the first input was detected), the electronic device 101a forgoes (1002e) performing the first operation. In some embodiments, the first user interface element is not within the attention zone associated with the user if the user's gaze is directed towards a user interface element other than the first user interface element and/or if the first user interface element does not fall within the conical volume of the attention zone.

The above-described manner of performing or not performing the first operation depending on whether or not the first user interface element is within the attention zone associated with the user provides an efficient way of reducing accidental user inputs, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, the first input directed to the first user interface element (e.g., 903) is an indirect input directed to the first user interface element (e.g., 903 in FIG. 9C) (1004a). In some embodiments, an indirect input is an input provided by a predefined portion of the user (e.g., a hand, finger, arm, etc. of the user) while the predefined portion of the user is more than a threshold distance (e.g., 0.2, 1, 2, 3, 5, 10, 30, 50 etc. centimeters) from the first user interface element. In some embodiments, the indirect input is similar to the indirect inputs discussed with reference to methods 800, 1200, 1400, 1600, 1800 and/or 2000.

In some embodiments, such as in FIG. 9B, while displaying the first user interface element (e.g., 905), the electronic device 101a detects (1004b), via the one or more input devices, a second input, wherein the second input corresponds to a direct input directed toward a respective user interface element (e.g., 903). In some embodiments, the direct input is similar to direct inputs discussed with reference to methods 800, 1200, 1400, 1600, 1800 and/or 2000. In some embodiments, the direct input is provided by a predefined portion of the user (e.g., hand, finger, arm) while the predefined portion of the user is less than a threshold distance (e.g., 0.2, 1, 2, 3, 5, 10, 30, 50 etc. centimeters) away from the first user interface element. In some embodiments, detecting the direct input includes detecting the user perform a predefined gesture with their hand (e.g., a press gesture in which the user moves an extended finger to the location of a respective user interface element while the other fingers are curled towards the palm of the hand) after detecting the ready state of the hand (e.g., a pointing hand shape in which one or more fingers are extended and one or more fingers are curled towards the palm). In some embodiments, the ready state is detected according to one or more steps of method 800.

In some embodiments, such as in FIG. 9B, in response to detecting the second input, the electronic device 101a performs (1004c) an operation associated with the respective user interface element (e.g., 903) without regard to whether the respective user interface element is within the attention zone (e.g., 907) associated with the user (e.g., because it is a direct input). In some embodiments, the electronic device only performs the operation associated with the first user interface element in response to an indirect input if the indirect input is detected while the gaze of the user is directed towards the first user interface element. In some embodiments, the electronic device performs an operation associated with a user interface element in the user's attention zone in response to a direct input regardless of whether or not the gaze of the user is directed to the user interface element when the direct input is detected.

The above-described manner of forgoing performing the second operation in response to detecting the indirect input while the gaze of the user is not directed to the first user interface element provides a way of reducing or preventing performance of operations not desired by the user, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 9B, the attention zone (e.g., 907) associated with the user is based on a direction (and/or location) of a gaze (e.g., 901b) of the user of the electronic device (1006a). In some embodiments, the attention zone is defined as a cone-shaped volume (e.g., extending from a point at the viewpoint of the user out into the three-dimensional environment) including a point in the three-dimensional environment at which the user is looking and the locations in the three-dimensional environment between the point at which the user is looking and the user within a predetermined threshold angle (e.g., 5, 10, 15, 20, 30, 45, etc. degrees) of the gaze of the user. In some embodiments, in addition or alternatively to being based on the user's gaze, the attention zone is based on the orientation of a head of the user. For example, the attention zone is defined as a cone-shaped volume including locations in the three-dimensional environment within a predetermined threshold angle (e.g., 5, 10, 15, 20, 30, 45, etc. degrees) of a line normal to the face of the user. As another example, the attention zone is a cone centered around an average of a line extending from the gaze of the user and a line normal to the face of the user or a union of a cone centered around the gaze of the user and the cone centered around the line normal to the face of the user.

The above-described manner of basing the attention zone on the orientation of the gaze of the user provides an efficient way of directing user inputs based on gaze without additional inputs (e.g., to move the input focus, such as moving a cursor) which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, while the first user interface element (e.g., 903) is within the attention zone (e.g., 907) associated with the user, such as in FIG. 9A, the electronic device 101a detects (1008a) that one or more criteria for moving the attention zone (e.g., 903) to a location at which the first user interface element (e.g., 903) is not within the attention zone are satisfied. In some embodiments, the attention zone is based on the gaze of the user and the one or more criteria are satisfied when the gaze of the user moves to a new location such that the first user interface element is no longer in the attention zone. For example, the attention zone includes regions of the user interface within 10 degrees of a line along the user's gaze and the user's gaze moves to a location such that the first user interface element is more than 10 degrees from the line of the user's gaze.

In some embodiments, such as in FIG. 9B, after detecting that the one or more criteria are satisfied (1008b), the electronic device 101a detects (1008c) a second input directed to the first user interface element (e.g., 903). In some embodiments, the second input is a direct input in which the hand of the user is within a threshold distance (e.g., 0.2, 1, 2, 3, 5, 10, 30, 50, etc. centimeters) of the first user interface element.

In some embodiments, after detecting that the one or more criteria are satisfied (1008b), such as in FIG. 9B, in response to detecting the second input directed to the first user interface element (e.g., 903) (1008d), in accordance with a determination that the second input was detected within a respective time threshold (e.g., 0.01, 0.02, 0.05, 0.1, 0.2, 0.3, 0.5, 1 etc. seconds) of the one or more criteria being satisfied, the electronic device 101a performs (1008e) a second operation corresponding to the first user interface element (e.g., 903). In some embodiments, the attention zone of the user does not move until the time threshold (e.g., 0.01, 0.02, 0.05, 0.1, 0.2, 0.3, 0.5, 1 etc. seconds) has passed since the one or more criteria were satisfied.

In some embodiments, after detecting that the one or more criteria are satisfied (1008b), such as in FIG. 9B, in response to detecting the second input directed to the first user interface element (e.g., 903) (1008d), in accordance with a determination that the second input was detected after the respective time threshold (e.g., 0.01, 0.02, 0.05, 0.1, 0.2, 0.3, 0.5, 1 etc. seconds) of the one or more criteria being satisfied, the electronic device 101a forgoes (1008f) performing the second operation. In some embodiments, once the time threshold (e.g., 0.01, 0.02, 0.05, 0.1, 0.2, 0.3, 0.5, 1 etc. seconds) has passed since the one or more criteria for moving the attention zone were satisfied, the electronic device updates the position of the attention zone associated with the user (e.g., based on the new gaze location of the user). In some embodiments, the electronic device moves the attention zone gradually over the time threshold and initiates the movement with or without a time delay after detecting the user's gaze move. In some embodiments, the electronic device forgoes performing the second operation in response to an input detected while the first user interface element is not in the attention zone of the user.

The above-described manner of performing the second operation in response to the second input in response to the second input received within the time threshold of the one or more criteria for moving the attention zone being satisfied provides an efficient way of accepting user inputs without requiring the user to maintain their gaze for the duration of the input and avoiding accidental inputs by preventing activations of the user interface element after the attention zone has moved once the predetermined time threshold has passed, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIGS. 9A-9B, the first input includes a first portion followed by a second portion (1010a). In some embodiments, detecting the first portion of the input includes detecting a ready state of a predefined portion of the user as described with reference to method 800. In some embodiments, in response to the first portion of the input, the electronic device moves the input focus to a respective user interface element. For example, the electronic device updates the appearance of the respective user interface element to indicate that the input focus is directed to the respective user interface element. In some embodiments, the second portion of the input is a selection input. For example, the first portion of an input includes detecting the hand of the user within a first threshold distance (e.g., 3, 5, 10, 15, etc. centimeters) of a respective user interface element while making a predefined hand shape (e.g., a pointing hand shape in which one or more fingers are extended and one or more fingers are curled towards the palm) and the second portion of the input includes detecting the hand of the user within a second, lower threshold distance (e.g., touching, 0.1, 0.3, 0.5, 1, 2, etc. centimeters) of the respective user interface element while maintaining the pointing hand shape.

In some embodiments, such as in FIG. 9A, while detecting the first input (1010b), the electronic device 101a detects (1010c) the first portion of the first input while the first user interface element (e.g., 903) is within the attention zone (e.g., 907).

In some embodiments, such as in FIG. 9A, while detecting the first input (1010b), in response to detecting the first portion of the first input, the electronic device 101a performs (1010d) a first portion of the first operation corresponding to the first user interface element (e.g., 903). In some embodiments, the first portion of the first operation includes identifying the first user interface element as having the input focus of the electronic device and/or updating an appearance of the first user interface element to indicate that the input focus is directed to the first user interface element. For example, in response to detecting the user making a pre-pinch hand shape within a threshold distance (e.g., 1, 2, 3, 5, 10, etc. centimeters) of the first user interface element, the electronic device changes the color of the first user interface element to indicate that the input focus is directed to the first user interface element (e.g., analogous to cursor “hover” over a user interface element). In some embodiments, the first portion of the input includes selection of scrollable content in the user interface and a first portion of movement of the predefined portion of the user. In some embodiments, in response to the first portion of the movement of the predefined portion of the user, the electronic device scrolls the scrollable content by a first amount.

In some embodiments, such as in FIG. 9B, while detecting the first input (1010b), the electronic device 101a detects (1010e) the second portion of the first input while the first user interface element (e.g., 903) is outside of the attention zone. In some embodiments, after detecting the first portion of the first input and before detecting the second portion of the second input, the electronic device detects that the attention zone no longer includes the first user interface element. For example, the electronic device detects the gaze of the user directed to a portion of the user interface such that the first user interface element is outside of a distance or angle threshold of the attention zone of the user. For example, the electronic device detects the user making a pinch hand shape within the threshold distance (e.g., 1, 2, 3, 5, 10, etc. centimeters) of the first user interface element while the attention zone does not include the first user interface element. In some embodiments, the second portion of the first input includes continuation of movement of the predefined portion of the user. In some embodiments, in response to the continuation of the movement of the predefined portion of the user, the electronic device continues scrolling the scrollable content. In some embodiments, the second portion of the first input is detected after a threshold time (e.g., a threshold time in which an input must be detected after the ready state was detected for the input to cause an action as described above) has passed since detecting the first portion of the input.

In some embodiments, such as in FIG. 9B, while detecting the first input (1010b), in response to detecting the second portion of the first input, the electronic device 101a performs (1010f) a second portion of the first operation corresponding to the first user interface element (e.g., 903). In some embodiments, the second portion of the first operation is the operation performed in response to detecting selection of the first user interface element. For example, if the first user interface element is an option to initiate playback of an item of content, the electronic device initiates playback of the item of content in response to detecting the second portion of the first operation. In some embodiments, the electronic device performs the operation in response to detecting the second portion of the first input after a threshold time (e.g., a threshold time in which an input must be detected after the ready state was detected for the input to cause an action as described above) has passed since detecting the first portion of the input.

The above-described manner of performing the second portion of the first operation corresponding to the first user interface element in response to detecting the second portion of the input while the first user interface element is outside the attention zone provides an efficient way of performing operations in response to inputs that started while the first user interface element was in the attention zone, even if the attention zone moves away from the first user interface element before the input is complete, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIGS. 9A-9B, the first input corresponds to a press input, the first portion of the first input corresponds to an initiation of the press input, and the second portion of the first input corresponds to a continuation of the press input (1012a). In some embodiments, detecting a press input includes detecting the user make a predetermined shape (e.g., a pointing shape in which one or more fingers are extended and one or more fingers are curled towards the palm) with their hand. In some embodiments, detecting the initiation of the press input includes detecting the user making the predetermined shape with their hand while the hand or a portion of the hand (e.g., a tip of one of the extended fingers) is within a first threshold distance (e.g., 3, 5, 10, 15, 30, etc. centimeters) of the first user interface element. In some embodiments, detecting the continuation of the press input includes detecting the user making the predetermined shape with their hand while the hand or a portion of the hand (e.g., a tip of one of the extended fingers) is within a second threshold distance (e.g., 0.1, 0.5, 1, 2, etc. centimeters) of the first user interface element. In some embodiments, the electronic device performs the second operation corresponding to the first user interface element in response to detecting the initiation of the press input while the first user interface element is within the attention zone followed by a continuation of the press input (while or not while the first user interface element is within the attention zone). In some embodiments, in response to the first portion of the press input, the electronic device pushes the user interface element away from the user by less than a full amount needed to cause an action in accordance with the press input. In some embodiments, in response to the second portion of the press input, the electronic device continues pushing the user interface element to the full amount needed to cause the action and, in response, performs the action in accordance with the press input.

The above-described manner of performing the second operation in response to detecting the imitation of the press input while the first user interface element is in the attention zone followed by the continuation of the press input provides an efficient way of detecting user inputs with a hand tracking device (and optionally an eye tracking device) without additional input devices, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, the first input corresponds to a drag input, the first portion of the first input corresponds to an initiation of the drag input, and the second portion of the first input corresponds to a continuation of the drag input (1014a). For example, if the user were to move hand 909 while selecting user interface element 903 in FIG. 9B, the input would be a drag input. In some embodiments, a drag input includes selection of a user interface element, a movement input, and an end of the drag input (e.g., release of the selection input, analogous to de-clicking a mouse or lifting a finger off of a touch sensor panel (e.g., trackpad, touch screen)). In some embodiments, the initiation of the drag input includes selection of a user interface element towards which the drag input will be directed. For example, the electronic device selects a user interface element in response to detecting the user make a pinch hand shape while the hand is within a threshold distance (e.g., 1, 2, 5, 10, 15, 30, etc. centimeters) of the user interface element. In some embodiments, the continuation of the drag input includes a movement input while selection is maintained. For example, the electronic device detects the user maintain the pinch hand shape while moving the hand and moves the user interface element in accordance with the movement of the hand. In some embodiments, the continuation of the drag input includes an end of the drag input. For example, the electronic device detects the user cease to make the pinch hand shape, such as by moving the thumb away from the finger. In some embodiments, the electronic device performs an operation in response to the drag input (e.g., moving the first user interface element, scrolling the first user interface element, etc.) in response to detecting the selection of the first user interface element while the first user interface element is in the attention zone and detecting the movement input and/or the end of the drag input while or not while the first user interface element is in the attention zone. In some embodiments, the first portion of the input includes selection of the user interface element and a portion of movement of the predefined portion of the user. In some embodiments, in response to the first portion of the input, the electronic device moves the user interface element by a first amount in accordance with the amount of movement of the predefined portion of the electronic device in the first portion of the input. In some embodiments, the second portion of the input includes continued movement of the predefined portion of the user. In some embodiments, in response to the second portion of the input, the electronic device continues moving the user interface element by an amount in accordance with the movement of the predefined portion of the user in the second portion of the user input.

The above-described manner of performing an operation in response to detecting the initiation of the drag input while the first user interface element is in the attention zone and detecting the continuation of the drag input while the first user interface element is not in the attention zone provides an efficient way of performing operations in response to drag inputs that started while the first user interface element was in the attention zone, even if the attention zone moves away from the first user interface element before the drag input is complete, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIGS. 9A-9B, the first input corresponds to a selection input, the first portion of the first input corresponds to an initiation of the selection input, and the second portion of the first input corresponds to a continuation of the selection input (1016a). In some embodiments, a selection input includes detecting the input focus being directed to the first user interface element, detecting an initiation of a request to select the first user interface element, and detecting an end of the request to select the first user interface element. In some embodiments, the electronic device directs the input focus to the first user interface element in response to detecting the hand of the user in the ready state according to method 800 directed to the first user interface element. In some embodiments, the request to direct the input focus to the first user interface element is analogous to cursor hover. For example, the electronic device detects the user making a pointing hand shape while the hand is within a threshold distance (e.g., 1, 2, 3, 5, 10, 15, 30, etc. centimeters) of the first user interface element. In some embodiments, the initiation of the request to select the first user interface element includes detecting a selection input analogous to a click of a mouse or touchdown on a touch sensor panel. For example, the electronic device detects the user maintaining the pointing hand shape while the hand is within a second threshold distance (e.g., 0.1, 0.2, 0.3, 0.5, 1, etc. centimeters) of the first user interface element. In some embodiments, the end of the request to select the user interface element is analogous to de-clicking a mouse or liftoff from a touch sensor panel. For example, the electronic device detects the user move their hand away from the first user interface element by at least the second threshold distance (e.g., 0.1, 0.2, 0.3, 0.5, 1, etc. centimeters). In some embodiments, the electronic device performs the selection operation in response to detecting the input focus being directed to the first user interface element while the first user interface element is in the attention zone and detecting the initiation and end of the request to select the first user interface element while or not while the first user interface element is in the attention zone.

The above-described manner of performing an operation in response to detecting imitation of a selection input while the first user interface element is in the attention zone irrespective of whether the continuation of the selection input is detected while the first user interface element is in the attention zone provides an efficient way of performing operations in response to selection inputs that started while the first user interface element was in the attention zone, even if the attention zone moves away from the first user interface element before the selection input is complete, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 9A, detecting the first portion of the first input includes detecting a predefined portion (e.g., 909) of the user having a respective pose (e.g., a hand shape including a pointing hand shape in which one or more fingers are extended and one or more fingers are curled towards the palm, such as a ready state described with reference to method 800) and within a respective distance (e.g., 1, 2, 3, 5, 10, 15, 30, etc. centimeters) of a location corresponding to the first user interface element (e.g., 903) without detecting a movement of the predefined portion (e.g., 909) of the user, and detecting the second portion of the first input includes detecting the movement of the predefined portion (e.g., 909) of the user, such as in FIG. 9B (1018a). In some embodiments, detecting the predefined portion of the user having the respective pose and being within the respective distance of the first user interface element includes detecting the ready state according to one or more steps of method 800. In some embodiments, the movement of the predefined portion of the user includes movement from the respective pose to a second pose associated with selection of the user interface element and/or movement from the respective distance to a second distance associated with selection of the user interface element. For example, making a pointing hand shape within the respective distance of the first user interface element is the first portion of the first input and maintaining the pointing hand shape while moving the hand to a second distance (e.g., within 0.1, 0.2, 0.3, 0.5, 1, etc. centimeters) from the first user interface element is the second portion of the first input. As another example, making a pre-pinch hand shape in which a thumb of the hand is within a threshold distance (e.g., 0.1, 0.2, 0.3, 0.5, 1, 2, 3 etc. centimeters) of another finger on the hand is the first portion of the first input and detecting movement of the hand from the pre pinch shape to a pinch shape in which the thumb is touching the other finger is the second portion of the first input. In some embodiments, the electronic device detects further movement of the hand following the second portion of the input, such as movement of the hand corresponding to a request to drag or scroll the first user interface element. In some embodiments, the electronic device performs an operation in response to detecting the predefined portion of the user having the respective pose while within the respective distance of the first user interface element while the first user interface element is in the attention zone associated with the user followed by detecting the movement of the predefined portion of the user while or not while the first user interface element is in the attention zone.

The above-described manner of performing an operation in response to detecting the respective pose of a predefined portion of the user within the respective distance of the first user interface element while the first user interface element is in the attention zone followed by detecting the movement of the predefined portion of the user while or not while the first user interface element is in the attention zone provides an efficient way of performing operations in response to inputs that started while the first user interface element was in the attention zone, even if the attention zone moves away from the first user interface element before the input is complete, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 9B, the first input is provided by a predefined portion (e.g., 909) of the user (e.g., a finger, hand, arm, or head of the user), and detecting the first input includes detecting the predefined portion (e.g., 909) of the user within a distance threshold (e.g., 1, 2, 3, 5, 10, 15, 30, etc. centimeters) of a location corresponding to the first user interface element (e.g., 903) (1020a)

In some embodiments, such as in FIG. 9C, while detecting the first input directed to the first user interface element (e.g., 903) and before performing the first operation, the electronic device 101a detects (1020b), via the one or more input devices, movement of the predefined portion (e.g., 909) of the user to a distance greater than the distance threshold from the location corresponding to the first user interface element (e.g., 903).

In some embodiments, such as in FIG. 9C, in response to detecting the movement of the predefined portion (e.g., 909) to the distance greater than the distance threshold from the location corresponding to the first user interface element (e.g., 903), the electronic device 101a forgoes (1020c) performing the first operation corresponding to the first user interface element (e.g., 903). In some embodiments, in response to detecting the user begin to provide an input directed to the first user interface element and then move the predefined portion of the user more than the threshold distance away from the location corresponding to the user interface element before completing the input, the electronic device forgoes performing the first operation corresponding to the input directed to the first user interface element. In some embodiments, the electronic device forgoes performing the first operation in response to the user moving the predefined portion of the user at least the distance threshold away from the location corresponding to the first user interface element even if the user had performed one or more portions of the first input without performing the full first input while the predefined portion of the user was within the distance threshold of the location corresponding to the first user interface element. For example, a selection input includes detecting the user making a pre-pinch hand shape (e.g., a hand shape where the thumb is within a threshold (e.g., 0.1, 0.2, 0.5, 1, 2, 3, etc. centimeters), followed by a pinch hand shape (e.g., the thumb touches the finger), followed by the end of the pinch hand shape (e.g., the thumb no longer touches the finger, the thumb is at least 0.1, 0.2, 0.5, 1, 2, 3, etc. centimeters from the finger). In this example, the electronic device forgoes performing the first operation if the end of the pinch gesture is detected while the hand is more than the threshold distance (e.g., 1, 2, 3, 5, 10, 15, 30, etc. centimeters) from the location corresponding to the first user interface element even if the hand was within the threshold distance when the pre-pinch hand shape and/or pinch hand shape were detected.

The above-described manner of forgoing performing the first operation in response to detecting the movement of the predefined portion of the user to the distance greater than the distance threshold provides an efficient way of canceling the first operation after part of the first input has been provided, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 9A, the first input is provided by a predefined portion (e.g., 909) of the user (e.g., a finger, hand, arm, or head of the user), and detecting the first input includes detecting the predefined portion (e.g., 909) of the user at a respective spatial relationship with respect to a location corresponding to the first user interface element (e.g., 903) (1022a) (e.g., detecting the predefined portion of the user within a predetermined threshold distance (e.g., 1, 2, 3, 5, 10, 15, 20, 30, etc. centimeters) of the first user interface element, with a predetermined orientation or pose relative to the user interface element). In some embodiments, the respective spatial relationship with respect to the location corresponding to the first user interface is the portion of the user being in a ready state according to one or more steps of method 800.

In some embodiments, while the predefined portion (e.g., 909) of the user is at the respective spatial relationship with respect to the location corresponding to the first user interface element (e.g., 903) during the first input and before performing the first operation, such as in FIG. 9A, the electronic device 101a detects (1022b), via the one or more input devices, that the predefined portion (e.g., 909) of the user has not engaged with (e.g., provided additional input directed towards) the first user interface element (e.g., 903) within a respective time threshold (e.g., 1, 2, 3, 5, etc. seconds) of coming into the respective spatial relationship with respect to the location corresponding to the first user interface element (e.g., 903). In some embodiments, the electronic device detects the ready state of the predefined portion of the user according to one or more steps of method 800 without detecting further input within the time threshold. For example, the electronic device detects the hand of the user in a pre-pinch hand shape (e.g., the thumb is within a threshold distance (e.g., 0.1, 0.2, 0.3, 0.5, 1, 2, 3, etc.) of another finger on the hand of the thumb) while the hand is within a predetermined threshold distance (e.g., 1, 2, 3, 5, 10, 15, 20, 30, etc. centimeters) of the first user interface element without detecting a pinch hand shape (e.g., thumb and finger are touching) within the predetermined time period.

In some embodiments, in response to detecting that the predefined portion (e.g., 909) of the user has not engaged with the first user interface element (e.g., 903) within the respective time threshold of coming into the respective spatial relationship with respect to the location corresponding to the first user interface element (e.g., 903), the electronic device 101a forgoes (1022c) performing the first operation corresponding to the first user interface element (e.g., 903), such as in FIG. 9C. In some embodiments, in response to detecting the predefined portion of the user engaged with the first user interface element after the respective time threshold has passed, the electronic device forgoes performing the first operation corresponding to the first user interface element. For example, in response to detecting the predetermined time threshold pass between detecting the hand of the user in a pre-pinch hand shape (e.g., the thumb is within a threshold distance (e.g., 0.1, 0.2, 0.3, 0.5, 1, 2, 3, etc.) of another finger on the hand of the thumb) while the hand is within a predetermined threshold distance (e.g., 1, 2, 3, 5, 10, 15, 20, 30, etc. centimeters) of the first user interface element before detecting a pinch hand shape (e.g., thumb and finger are touching), the electronic device forgoes performing the first operation even if the pinch hand shape is detected after the predetermined threshold time passes. In some embodiments, in response to detecting the predefined portion of the user at the respective spatial relationship relative to the location corresponding to the user interface element, the electronic device updates the appearance of the user interface element (e.g., updates the color, size, translucency, position, etc. of the user interface element). In some embodiments, after the respective time threshold without detecting further input from the predefined portion of the user, the electronic device reverts the updated appearance of the user interface element.

The above-described manner of forgoing the first operation in response to detecting the threshold time pass without the predefined portion of the user engaging with the first user interface element provides an efficient way of canceling the request to perform the first operation, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, a first portion of the first input is detected while a gaze of the user is directed to the first user interface element (e.g., such as if gaze 901a in FIG. 9A were directed to user interface element 903), and a second portion of the first input following the first portion of the first input is detected while the gaze (e.g., 901b) of the user is not directed to the first user interface element (e.g., 903) (1024a), such as in FIG. 9B. In some embodiments, in response to detecting the first portion of the first input while the gaze of the user is directed to the first user interface element followed by the second portion of the first input while the gaze of the user is not directed to the first user interface element, the electronic device performs the action associated with the first user interface element. In some embodiments, in response to detecting the first portion of the first input while the first user interface element is in the attention zone followed by the second portion of the first input while the first user interface element is not in the attention zone, the electronic device performs the action associated with the first user interface element.

The above-described manner of performing the operation in response to detecting the first portion of the first input while the gaze of the user is directed towards the first user interface element followed by detecting the second portion of the first input while the gaze of the user is not directed towards the first user interface element provides an efficient way of allowing the user to look away from the first user interface element without canceling the first input, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 9B, the first input is provided by a predefined portion (e.g., 909) of the user (e.g., finger, hand, arm, etc.) moving to a location corresponding to the first user interface element (e.g., 903) from within a predefined range of angles with respect to the first user interface element (e.g., 903) (1026a) (e.g., the first user interface object is a three-dimensional virtual object accessible from multiple angles). For example, the first user interface object is a virtual video player including a face on which content is presented and the first input is provided by moving the hand of the user to the first user interface object by touching the face of the first user interface object on which the content is presented before touching any other face of the first user interface object.

In some embodiments, the electronic device 101a detects (1026b), via the one or more input devices, a second input directed to the first user interface element (e.g., 903), wherein the second input includes the predefined portion (e.g., 909) of the user moving to the location corresponding to the first user interface element (e.g., 903) from outside of the predefined range of angles with respect to the first user interface element (e.g., 903), such as if hand (e.g., 909) in FIG. 9B were to approach user interface element (e.g., 903) from the side of user interface element (e.g., 903) opposite the side of the user interface element (e.g., 903) visible in FIG. 9B. For example, the electronic device detects the hand of the user touch a face of the virtual video player other than the face on which the content is presented (e.g., touching the “back” face of the virtual video player).

In some embodiments, in response to detecting the second input, the electronic device 101a forgoes (1026c) interacting with the first user interface element (e.g., 903) in accordance with the second input. For example, if hand (e.g., 909) in FIG. 9B were to approach user interface element (e.g., 903) from the side of user interface element (e.g., 903) opposite the side of the user interface element (e.g., 903) visible in FIG. 9B, the electronic device 101a would forgo performing the selection of the user interface element (e.g., 903) shown in FIG. 9B. In some embodiments, if the predefined portion of the user had moved to the location corresponding to the first user interface element from within the predefined range of angles, the electronic device would interact with the first user interface element. For example, in response to detecting the hand of the user touch the face of the virtual video player on which the content is presented by moving the hand through a face of the virtual video player other than the face on which the content is presented, the electronic device forgoes performing the action corresponding to the region of the video player touched by the user on the face of the virtual video player on which content is presented.

The above-described manner of forgoing interacting with the first user interface element in response to an input provided outside of the predefined range of angles provides an efficient way of preventing accidental inputs caused by the user inadvertently touching the first user interface element from an angle outside of the predefined range of angles which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 9A, the first operation is performed in response to detecting the first input without detecting that a gaze (e.g., 901a) of the user is directed to the first user interface element (e.g., 903) (1028a). In some embodiments, the attention zone includes a region of the three-dimensional environment towards which the gaze of the user is directed plus additional regions of the three-dimensional environment within a predefined distance or angle of the gaze of the user. In some embodiments, the electronic device performs an action in response to an input directed to the first user interface element while the first user interface element is within the attention zone (which is broader than the gaze of the user) even if the gaze of the user is not directed towards the first user interface element and even if the gaze of the user was never directed towards the first user interface element while the user input. In some embodiments, indirect inputs require the gaze of the user to be directed to the user interface element to which the input is directed and direct inputs do not require the gaze of the user to be directed to the user interface element to which the input is directed.

The above-described manner of performing an action in response to an input directed to the first user interface element while the gaze of the user is not directed to the first user interface element provides an efficient way of allowing the user to look at regions of the user interface other than the first user interface element while providing an input directed to the first user interface element which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

FIGS. 11A-11C illustrate examples of how an electronic device enhances interactions with user interface elements at different distances and/or angles with respect to a gaze of a user in a three-dimensional environment in accordance with some embodiments.

FIG. 11A illustrates an electronic device 101 displaying, via a display generation component 120, a three-dimensional environment 1101 on a user interface. It should be understood that, in some embodiments, electronic device 101 utilizes one or more techniques described with reference to FIGS. 11A-11C in a two-dimensional environment or user interface without departing from the scope of the disclosure. As described above with reference to FIGS. 1-6, the electronic device 101 optionally includes a display generation component 120 (e.g., a touch screen) and a plurality of image sensors 314. The image sensors optionally include one or more of a visible light camera, an infrared camera, a depth sensor, or any other sensor the electronic device 101 would be able to use to capture one or more images of a user or a part of the user while the user interacts with the electronic device 101. In some embodiments, display generation component 120 is a touch screen that is able to detect gestures and movements of a user's hand. In some embodiments, the user interfaces shown below could also be implemented on a head-mounted display that includes a display generation component that displays the user interface to the user, and sensors to detect the physical environment and/or movements of the user's hands (e.g., external sensors facing outwards from the user), and/or gaze of the user (e.g., internal sensors facing inwards towards the face of the user).

As shown in FIG. 11A, the three-dimensional environment 1101 includes two user interface objects 1103a and 1103b located within a region of the three-dimensional environment 1101 that is a first distance from a viewpoint of the three-dimensional environment 1101 that is associated with the user of the electronic device 101, two user interface objects 1105a and 1105b located within a region of the three-dimensional environment 1101 that is a second distance, greater than the first distance, from the viewpoint of the three-dimensional environment 1101 that is associated with the user of the electronic device 101, two user interface objects 1107a and 1107b located within a region of the three-dimensional environment 1101 that is a third distance, greater than the second distance, from the viewpoint of the three-dimensional environment 1101 that is associated with the user of the electronic device 101, and user interface object 1109. In some embodiments, three-dimensional environment includes representation 604 of a table in a physical environment of the electronic device 101 (e.g., such as described with reference to FIG. 6B). In some embodiments, the representation 604 of the table is a photorealistic video image of the table displayed by the display generation component 120 (e.g., video or digital passthrough). In some embodiments, the representation 604 of the table is a view of the table through a transparent portion of the display generation component 120 (e.g., true or physical passthrough).

FIGS. 11A-11C illustrate concurrent or alternative inputs provided by hands of the user based on concurrent or alternative locations of the gaze of the user in the three-dimensional environment. In particular, in some embodiments, the electronic device 101 directs indirect inputs (e.g., as described with reference to method 800) from hands of the user of the electronic device 101 to different user interface objects depending on the distance of the user interface objects from the viewpoint of the three-dimensional environment associated with the user. For example, in some embodiments, when indirect inputs from a hand of the user are directed to user interface objects that are relatively close to the viewpoint of the user in the three-dimensional environment 1101, the electronic device 101 optionally directs detected indirect inputs to the user interface object at which the gaze of the user is directed, because at relatively close distances, the device 101 is optionally able to relatively accurately determine to which of two (or more) user interface objects the gaze of the user is directed, which is optionally used to determine the user interface object to which the indirect input should be directed.

In FIG. 11A, user interface objects 1103a and 1103b are relatively close to (e.g., less than a first threshold distance, such as 1, 2, 5, 10, 20, 50 feet, from) the viewpoint of the user in the three-dimensional environment 1101 (e.g., objects 1103a and 1103b are located within a region of the three-dimensional environment 1101 that is relatively close to the viewpoint of the user). Therefore, an indirect input provided by hand 1113a that is detected by device 101 is directed to user interface object 1103a as indicated by the check mark in the figure (e.g., and not user interface object 1103b), because gaze 1111a of the user is directed to user interface object 1103a when the indirect input provided by hand 1113a is detected. In contrast, in FIG. 11B, gaze 1111d of the user is directed to user interface object 1103b when the indirect input provided by hand 1113a is detected. Therefore, device 101 directs that indirect input from hand 1113a to user interface object 1103b as indicated by the check mark in the figure (e.g., and not user interface object 1103a).

In some embodiments, when one or more user interface objects are relatively far from the viewpoint of the user in the three-dimensional environment 1101, device 101 optionally prevents indirect inputs to be directed to such one or more user interface objects and/or visually deemphasizes such one or more user interface objects, because at relatively far distances, the device 101 is optionally not able to relatively accurately determine whether the gaze of the user is directed to one or more user interface objects. For example, in FIG. 11A, user interface objects 1107a and 1107b are relatively far from (e.g., greater than a second threshold distance, greater than the first threshold distance, from, such as 10, 20, 30, 50, 100, 200 feet) the viewpoint of the user in the three-dimensional environment 1101 (e.g., objects 1107a and 1107b are located within a region of the three-dimensional environment 1101 that is relatively far from the viewpoint of the user). Therefore, an indirect input provided by hand 1113c that is detected by device 101 while gaze 1111c of the user is (e.g., ostensibly) directed to user interface object 1107b (or 1107a) is ignored by device 101, and is not directed to user interface object 1107b (or 1107a), as reflected by no check mark shown in the figure. In some embodiments, device 101 additionally or alternatively visually deemphasizes (e.g., greys out) user interface objects 1107a and 1107b to indicate that user interface objects 1107a and 1107b are not available for indirect interaction.

In some embodiments, when one or more user interface objects are greater than a threshold angle from the gaze of the user of the electronic device 101, device 101 optionally prevents indirect inputs to be directed to such one or more user interface objects and/or visually deemphasizes such one or more user interface objects to, for example, prevent accidental interaction with such off-angle one or more user interface objects. For example, in FIG. 11A, user interface object 1109 is optionally more than a threshold angle (e.g., 10, 20, 30, 45, 90, 120, etc. degrees) from gazes 1111a, 1111b and/or 1111c of the user. Therefore, device 101 optionally visually deemphasizes (e.g., greys out) user interface object 1109 to indicate that user interface object 1109 is not available for indirect interaction.

However, in some embodiments, when indirect inputs from a hand of the user are directed to user interface objects that are moderately distanced from the viewpoint of the user in the three-dimensional environment 1101, the electronic device 101 optionally directs detected indirect inputs to a user interface object based on a criteria other than the gaze of the user, because at moderate distances, the device 101 is optionally able to relatively accurately determine that the gaze of the user is directed to a collection of two or more user interface objects, but is optionally not able to relatively accurately determine to which of those collection of two or more user interface objects the gaze is directed. In some embodiments, if the gaze of the user is directed to a moderately-distanced user interface object that is not positioned with other user interface objects (e.g., is more than a threshold distance, such as 1, 2, 5, 10, 20 feet, from any other interactable user interface objects), device 101 optionally directs indirect inputs to that user interface object without performing the various disambiguation techniques described herein and with reference to method 1200. Further, in some embodiments, the electronic device 101 performs the various disambiguation techniques described herein and with reference to method 1200 for user interface objects that are located within a region (e.g., volume and/or surface or plane) in the three-dimensional environment that is defined by the gaze of the user (e.g., the gaze of the user defines the center of that volume and/or surface or plane), and not for user interface objects (e.g., irrespective of their distance from the viewpoint of the user) that are not located within the region. In some embodiments, the size of the region varies based on the distance of the region and/or user interface objects that it contains from the viewpoint of the user in the three-dimensional environment (e.g., within the moderately-distanced region of the three-dimensional environment). For example, in some embodiments, the size of the region decreases as the region is further from the viewpoint (and increases as the region is closer to the viewpoint), and in some embodiments, the size of the region increases as the region is further from the viewpoint (and decreases as the region is closer to the viewpoint).

In FIG. 11A, user interface objects 1105a and 1105b are moderately distanced from (e.g., greater than the first threshold distance from, and less than the second threshold distance from) the viewpoint of the user in the three-dimensional environment 1101 (e.g., objects 1105a and 1105b are located within a region of the three-dimensional environment 1101 that is moderately distanced from the viewpoint of the user). In FIG. 11A, (e.g., device 101 detects that) gaze 1111b is directed to user interface object 1105a when device 101 detects an indirect input from hand 1113b. Because user interface objects 1105a and 1105b are moderately distanced from the viewpoint of the user, device 101 determines which of user interface object 1105a and 1105b will receive the input based on a characteristic other than gaze 1111b of the user. For example, in FIG. 11A, because user interface object 1105b is closer to the viewpoint of the user in the three-dimensional environment 1101, device 101 directs the input from hand 1113b to user interface object 1105b as indicated by the check mark in the figure (e.g., and not to user interface object 1105a to which gaze 1111b of the user is directed). In FIG. 11B, gaze 1111e of the user is directed to user interface object 1105b (rather than user interface object 1105a in FIG. 11A) when the input from hand 1113b is detected, and device 101 still directs the indirect input from hand 1113b to user interface object 1105b as indicated by the check mark in the figure, optionally not because gaze 1111e of the user is directed to user interface object 1105b, but rather because user interface object 1105b is closer to the viewpoint of the user in the three-dimensional environment than is user interface object 1105a.

In some embodiments, criteria additional or alternative to distance are used to determine to which user interface object to direct indirect inputs (e.g., when those user interface objects are moderately distanced from the viewpoint of the user). For example, in some embodiments, device 101 directs the indirect input to one of the user interface objects based on which of the user interface objects is an application user interface object or a system user interface object. For example, in some embodiments, device 101 favors system user interface objects, and directs the indirect input from hand 1113b in FIG. 11C to user interface object 1105c as indicated by the check mark, because it is a system user interface object and user interface object 1105d (to which gaze 1111f of the user is directed) is an application user interface object. In some embodiments, device 101 favors application user interface objects, and would direct the indirect input from hand 1113b in FIG. 11C to user interface object 1105d, because it is an application user interface object and user interface object 1105c is a system user interface object (e.g., and not because gaze 1111f of the user is directed to user interface object 1105d). Additionally or alternatively, in some embodiments, the software, application(s) and/or operating system associated with the user interface objects define a selection priority for the user interface objects such that if the selection priority gives one user interface object higher priority than the other user interface object, the device 101 directs the input to that one user interface object (e.g., user interface object 1105c), and if the selection priority gives the other user interface object higher priority than the one user interface object, the device 101 directs the input to the other user interface object (e.g., user interface object 1105d).

FIGS. 12A-12F is a flowchart illustrating a method 1200 of enhancing interactions with user interface elements at different distances and/or angles with respect to a gaze of a user in a three-dimensional environment in accordance with some embodiments. In some embodiments, the method 1200 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, a projector, etc.) and one or more cameras (e.g., a camera (e.g., color sensors, infrared sensors, and other depth-sensing cameras) that points downward at a user's hand or a camera that points forward from the user's head). In some embodiments, the method 1200 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1200 are, optionally, combined and/or the order of some operations is, optionally, changed.

In some embodiments, method 1200 is performed by an electronic device in communication with a display generation component and one or more input devices, including an eye tracking device. For example, a mobile device (e.g., a tablet, a smartphone, a media player, or a wearable device), or a computer. In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. In some embodiments, the one or more input devices include an electronic device or component capable of receiving a user input (e.g., capturing a user input, detecting a user input, etc.) and transmitting information associated with the user input to the electronic device. Examples of input devices include a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera, a depth sensor, an eye tracking device, and/or a motion sensor (e.g., a hand tracking device, a hand motion sensor), etc. In some embodiments, the hand tracking device is a wearable device, such as a smart glove. In some embodiments, the hand tracking device is a handheld input device, such as a remote control or stylus.

In some embodiments, the electronic device displays (1202a), via the display generation component, a user interface that includes a first region including a first user interface object and a second user interface object, such as objects 1105a and 1105b in FIG. 11A. In some embodiments, the first and/or second user interface objects are interactive user interface objects and, in response to detecting an input directed towards a given object, the electronic device performs an action associated with the user interface object. For example, a user interface object is a selectable option that, when selected, causes the electronic device to perform an action, such as displaying a respective user interface, changing a setting of the electronic device, or initiating playback of content. As another example, a user interface object is a container (e.g., a window) in which a user interface/content is displayed and, in response to detecting selection of the user interface object followed by a movement input, the electronic device updates the position of the user interface object in accordance with the movement input. In some embodiments, the first user interface object and the second user interface object are displayed in a three-dimensional environment (e.g., the user interface is the three-dimensional environment and/or is displayed within a three-dimensional environment) that is generated, displayed, or otherwise caused to be viewable by the device (e.g., a computer-generated reality (CGR) environment such as a virtual reality (VR) environment, a mixed reality (MR) environment, or an augmented reality (AR) environment, etc. In some embodiments, the first region, and thus the first and second user interface objects, are remote from (e.g., away from, such as more than a threshold distance of 2, 5, 10, 15, 20 feet away from) a location corresponding to the location of the user/electronic device in the three-dimensional environment, and/or from a viewpoint of the user in the three-dimensional environment.

In some embodiments, while displaying the user interface and while detecting, via the eye tracking device, a gaze of the user directed to the first region of the user interface, such as gaze 1111b in FIG. 11A (e.g., the gaze of the user intersects with the first region, the first user interface object and/or the second user interface object, or the gaze of the user is within a threshold distance such as 1, 2, 5, 10 feet of intersecting with the first region, the first user interface object and/or the second user interface object. In some embodiments, the first region, first user interface object and/or the second user interface object are sufficiently far away from the position of the user/electronic device such that the electronic device is not able to determine which of the first or second user interface objects to which the gaze of the user is directed, and/or is only able to determine that the gaze of the user is directed to the first region of the user interface), the electronic device detects (1202b), via the one or more input devices, a respective input provided by a predefined portion of the user, such as an input from hand 1113b in FIG. 11A (e.g., a gesture performed by a finger, such as the index finger or forefinger, of a hand of the user pointing and/or moving towards the first region, optionally with movement more than a threshold movement (e.g., 0.5, 1, 3, 5, 10 cm) and/or speed more than a threshold speed (e.g., 0.5, 1, 3, 5, 10 cm/s), or the thumb of the hand being pinched together with another finger of that hand). In some embodiments, during the respective input, a location of the predefined portion of the user is away from a location corresponding to the first region of the user interface (e.g., the predefined portion of the user remains more than the threshold distance of 2, 5, 10, 15, 20 feet away from the first region, first user interface object and/or second user interface object throughout the respective input. The respective input is optionally an input provided by the predefined portion of the user and/or interaction with a user interface object such as described with reference to methods 800, 1000, 1600, 1800 and/or 2000).

In some embodiments, in response to detecting the respective input (1202c), in accordance with a determination that one or more first criteria are satisfied (e.g., the first user interface object is closer than the second user interface object to a viewpoint of the user in the three-dimensional environment, the first user interface object is a system user interface object (e.g., a user interface object of the operating system of the electronic device, rather than a user interface object of an application on the electronic device) and the second user interface object is an application user interface object (e.g., a user interface object of an application on the electronic device, rather than a user interface object of the operating system of the electronic device), etc. In some embodiments, the one or more first criteria are not satisfied based on the gaze of the user (e.g., whether the one or more first criteria are satisfied is independent of to what the gaze of the user is directed in the first region of the user interface)), the electronic device performs (1202d) an operation with respect to the first user interface object based on the respective input, such as with respect to user interface object 1105b in FIG. 11A (e.g., and without performing an operation based on the respective input with respect to the second user interface object). For example, selecting the first user interface object for further interaction (e.g., without selecting the second user interface object for further interaction), transitioning the first user interface object to a selected state such that further input will interact with the first user interface object (e.g., without transitioning the second user interface object to the selected state)), selecting, as a button, the first user interface object (e.g., without selecting, as a button, the second user interface object), etc.

In some embodiments, in accordance with a determination that one or more second criteria, different from the first criteria, are satisfied (e.g., the second user interface object is closer than the first user interface object to a viewpoint of the user in the three-dimensional environment, the second user interface object is a system user interface object (e.g., a user interface object of the operating system of the electronic device, rather than a user interface object of an application on the electronic device) and the first user interface object is an application user interface object (e.g., a user interface object of an application on the electronic device, rather than a user interface object of the operating system of the electronic device), etc. In some embodiments, the one or more second criteria are not satisfied based on the gaze of the user (e.g., whether the one or more second criteria are satisfied is independent of to what the gaze of the user is directed in the first region of the user interface)), the electronic device performs (1202e) an operation with respect to the second user interface object based on the respective input, such as with respect to user interface object 1105c in FIG. 11C (e.g., and without performing an operation based on the respective input with respect to the first user interface object). For example, selecting the second user interface object for further interaction (e.g., without selecting the first user interface object for further interaction), transitioning the second user interface object to a selected state such that further input will interact with the second user interface object (e.g., without transitioning the first user interface object to the selected state)), selecting, as a button, the second user interface object (e.g., without selecting, as a button, the first user interface object), etc. The above-described manner of disambiguating to which user interface object a particular input is directed provides an efficient way of facilitating interaction with user interface objects when uncertainty may exist as to which user interface object a given input is directed, without the need for further user input to designate a given user interface object as the target of the given input, which simplifies the interaction between the user and the electronic device and enhances the operability of the electronic device and makes the user-device interface more efficient (e.g., by not requiring additional user input for further designation), which additionally reduces power usage and improves battery life of the electronic device by enabling the user to use the electronic device more quickly and efficiently.

In some embodiments, the user interface comprises a three-dimensional environment (1204a), such as environment 1101 (e.g., the first region is a respective volume and/or surface that is located at some x, y, z coordinate in the three-dimensional environment in which a viewpoint of the three-dimensional environment associated with the electronic device is located. In some embodiments, the first and second user interface objects are positioned within the respective volume and/or surface), and the first region is a respective distance from a viewpoint associated with the electronic device in the three-dimensional environment (1204b) (e.g., the first region is at a location in the three-dimensional environment that is some distance, angle, position, etc. relative to the location of the viewpoint in the three-dimensional environment). In some embodiments, in accordance with a determination that the respective distance is a first distance (e.g., 1 foot, 2 feet, 5 feet, 10 feet, 50 feet), the first region has a first size in the three-dimensional environment (1204c), and in accordance with a determination that the respective distance is a second distance (e.g., 10 feet, 20 feet, 50 feet, 100 feet, 500 feet), different from the first distance, the first region has a second size, different from the first size, in the three-dimensional environment (1204d). For example, the size of the region within which the electronic device initiates operations with respect to the first and second user interface objects within the region based on the one or more first or second criteria (e.g., and not based on the gaze of the user being directed to the first or second user interface objects) changes based on the distance of that region from the viewpoint associated with the electronic device. In some embodiments, the size of the region decreases as the region of interest is further from the viewpoint, and in some embodiments, the size of the region increases as the region of the interest is further from the viewpoint. For example, in FIG. 11A, if objects 1105a and 1105 were further away from the viewpoint of the user than what is illustrated in FIG. 11A, the region that includes objects 1105a and 1105b and within which the herein-described criteria-based disambiguation is performed would be different (e.g., larger), and if objects 1105a and 1105 were closer to the viewpoint of the user than what is illustrated in FIG. 11A, the region that includes objects 1105a and 1105b and within which the herein-described criteria-based disambiguation is performed would be different (e.g., smaller). The above-described manner of operating with respect to regions of different size depending on the distance of the region from the viewpoint associated with the electronic device provides an efficient way ensuring that operation of the device with respect to the potential uncertainty of input accurately corresponds to that potential uncertainty of input, without the need for further user input to manually change the size of the region of interest, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, and reduces erroneous operation of the device.

In some embodiments, a size of the first region in the three-dimensional environment increases as the respective distance increases (1206a), such as described with reference to FIGS. 11A-11C. For example, as the region of interest is further from the viewpoint associated with the electronic device, the size of that region within which the electronic device initiates operations with respect to the first and second user interface objects within the region based on the one or more first or second criteria (e.g., and not based on the gaze of the user being directed to the first or second user interface objects) increases, which optionally corresponds with the uncertainty of determining to what the gaze of the user is directed as the potentially relevant user interface objects are further away from the viewpoint associated with the electronic device (e.g., the further two user interface objects are from the viewpoint, the more difficult it may be to determine whether the gaze of the user is directed to the first or the second of the two user interface object—therefore, the electronic device optionally operates based on the one or more first or second criteria with respect to those two user interface objects). The above-described manner of operating with respect to a region of increasing size as that region is further from the viewpoint associated with the electronic device provides an efficient way of avoiding erroneous response of the device to gaze-based inputs directed to objects as those objects are further away from the viewpoint associated with the electronic device, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, and reduces erroneous operation of the device.

In some embodiments, the one or more first criteria are satisfied when the first object is closer than the second object to a viewpoint of the user in the three-dimensional environment, such as user interface object 1105b in FIG. 11A, and the one or more second criteria are satisfied when the second object is closer than the first object to the viewpoint of the user in the three-dimensional environment (1208a), such as if user interface object 1105a were closer than user interface object 1105b in FIG. 11A. For example, in accordance with a determination that the first user interface object is closer to a viewpoint associated with the electronic device in a three-dimensional environment than the second user interface object, the one or more first criteria are satisfied and the one or more second criteria are not satisfied, and in accordance with a determination that the second user interface object is closer to the viewpoint in the three-dimensional environment than the first user interface object, the one or more second criteria are satisfied and the one or more first criteria are not satisfied. Thus, in some embodiments, whichever user interface object in the first region is closest to the viewpoint is the user interface object to which the device directs the input (e.g., independent of whether the gaze of the user is directed to another user interface object in the first region). The above-described manner of directing input to the user interface objects based on their distances from the viewpoint associated with the electronic device provides an efficient and predictable way of selecting user interface objects for input, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, and reduces erroneous operation of the device.

In some embodiments, the one or more first criteria are satisfied or the one or more second criteria are satisfied based on a type (e.g., user interface object of the operating system of the electronic device, or user interface object of an application rather than of the operating system of the electronic device) of the first user interface object and a type (e.g., user interface object of the operating system of the electronic device, or user interface object of an application rather than of the operating system of the electronic device) of the second user interface object (1210a). For example, in accordance with a determination that the first user interface object is a system user interface object and the second user interface object is not a system user interface object (e.g., is an application user interface object), the one or more first criteria are satisfied and the one or more second criteria are not satisfied, and in accordance with a determination that the second user interface object is a system user interface object and the first user interface object is not a system user interface object (e.g., is an application user interface object), the one or more second criteria are satisfied and the one or more first criteria are not satisfied. Thus, in some embodiments, whichever user interface object in the first region is a system user interface object is the user interface object to which the device directs the input (e.g., independent of whether the gaze of the user is directed to another user interface object in the first region). For example, in FIG. 11A, if user interface object 1105b was a system user interface object, and user interface object 1105a was an application user interface object, device 101 could direct the input of FIG. 11A to object 1105b instead of object 1105a (e.g., even if object 1105b was further from the viewpoint of the user than object 1105a). The above-described manner of directing input to the user interface objects based on their type provides an efficient and predictable way of selecting user interface objects for input, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, and reduces erroneous operation of the device.

In some embodiments, the one or more first criteria are satisfied or the one or more second criteria are satisfied based on respective priorities defined for the first user interface object and the second user interface object by the electronic device (1212a) (e.g., by software of the electronic device such as an application or operating system of the electronic device). For example, in some embodiments, the application(s) and/or operating system associated with the first and second user interface objects define a selection priority for the first and second user interface objects such that if the selection priority gives the first user interface object higher priority than the second user interface object, the device directs the input to the first user interface object (e.g., independent of whether the gaze of the user is directed to another user interface object in the first region), and if the selection priority gives the second user interface object higher priority than the first user interface object, the device directs the input to the second user interface object (e.g., independent of whether the gaze of the user is directed to another user interface object in the first region). For example, in FIG. 11A, if user interface object 1105b was assigned a higher selection priority (e.g., by software of device 101), and user interface object 1105a was assigned a lower selection priority, device 101 could direct the input of FIG. 11A to object 1105b instead of object 1105a (e.g., even if object 1105b was further from the viewpoint of the user than object 1105a). In some embodiments, the relative selection priorities of the first and second user interface objects change over time based on what the respective user interface objects are currently displaying (e.g., a user interface object that is currently displaying video/playing content has a higher selection priority than that same user interface object that is displaying paused video content or other content other than video/playing content). The above-described manner of directing input to the user interface objects based on operating system and/or application priorities provides a flexible manner of selecting a user interface object for input, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently.

In some embodiments, in response to detecting the respective input (1214a), in accordance with a determination that one or more third criteria are satisfied, including a criterion that is satisfied when the first region is greater than a threshold distance (e.g., 5, 10, 15, 20, 30, 40, 50, 100, 150 feet) from a viewpoint associated with the electronic device in a three-dimensional environment, the electronic device forgoes performing (1214b) the operation with respect to the first user interface object and forgoing performing the operation with respect to the second user interface object, such as described with reference to user interface objects 1107a and 1107b in FIG. 11A. For example, the electronic device optionally disables interaction with user interface objects that are within a region that is more than the threshold distance from the viewpoint associated with the electronic device. In some embodiments, the one or more first criteria and the one or more second criteria both include a criterion that is satisfied when the first region is less than the threshold distance from the viewpoint associated with the electronic device. In some embodiments, when the first region is more than the threshold distance from the viewpoint associated with the electronic device, the certainty with which the device determines that the gaze of the user is directed to the first region (e.g., rather than a different region) in the user interface is relatively low—therefore, the electronic device disables gaze-based interaction with objects within that first region to avoid erroneous interaction with such objects. The above-described manner of disabling interaction with objects within a distant region avoids erroneous gaze-based interaction with such objects, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently while avoiding errors in usage.

In some embodiments, in accordance with a determination that the first region is greater than the threshold distance from the viewpoint associated with the electronic device in the three-dimensional environment, the electronic device visually deemphasizes (1216a) (e.g., blurring, dimming, displaying with less color (e.g., more grayscale), ceasing display of, etc.) the first user interface object and the second user interface object relative to a region of the user interface outside of the first region, such as described with reference to user interface objects 1107a and 1107b in FIG. 11A (e.g., the region and or objects outside of the first region that are less than the threshold distance from the viewpoint associated with the electronic device are displayed with less or no blurring, less or no dimming, more or full color, etc.). In some embodiments, in accordance with a determination that the first region is less than the threshold distance from the viewpoint associated with the electronic device in the three-dimensional environment, the electronic device forgoes (1216b) visually deemphasizing the first user interface object and the second user interface object relative to the region of the user interface outside of the first region, such as for user interface objects 1103a,b and 1105a,b in FIG. 11A. For example, in some embodiments, the electronic device visually deemphasizes the first region and/or objects within the first region when the first region is more than the threshold distance from the viewpoint associated with the electronic device. The above-described manner of visually deemphasizing region(s) of the user interface that are not interactable because of their distance from the viewpoint provides a quick and efficient way of conveying that such regions are not interactable due to their distance from the viewpoint, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently while avoiding providing unnecessary inputs for interacting with the non-interactive region of the user interface.

In some embodiments, while displaying the user interface, the electronic device detects (1218a), via the one or more input devices, a second respective input provided by the predefined portion of the user (e.g., a gesture performed by a finger, such as the index finger or forefinger, of a hand of the user pointing and/or moving towards the first region, optionally with movement more than a threshold movement (e.g., 0.5, 1, 3, 5, 10 cm) and/or speed more than a threshold speed (e.g., 0.5, 1, 3, 5, 10 cm/s), or the thumb of the hand being pinched together with another finger of that hand). In some embodiments, in response to detecting the second respective input (1220b), in accordance with a determination that one or more third criteria are satisfied, including a criterion that is satisfied when the first region is greater than a threshold angle from the gaze of the user in a three-dimensional environment, such as described with reference to user interface object 1109 in FIG. 11A (e.g., the gaze of the user defines a reference axis, and the first region is more than 10, 20, 30, 45, 90, 120, etc. degrees separated from that reference axis. In some embodiments, the gaze of the user is not directed to the first region when the second respective input is detected), the electronic device forgoes performing (1220c) a respective operation with respect to the first user interface object and forgoing performing a respective operation with respect to the second user interface object, such as described with reference to user interface object 1109 in FIG. 11A. For example, the electronic device optionally disables interaction with user interface objects that are more than the threshold angle from the gaze of the user. In some embodiments, the device directs the second respective input to a user interface object outside of the first region and performs a respective operation with respect to that user interface object based on the second respective input. The above-described manner of disabling interaction with objects that are sufficiently off-angle from the gaze of the user avoids erroneous gaze-based interaction with such objects, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently while avoiding errors in usage.

In some embodiments, in accordance with a determination that the first region is greater than the threshold angle from the viewpoint associated with the electronic device in the three-dimensional environment, the electronic device visually deemphasizes (1222a) (e.g., blurring, dimming, displaying with less color (e.g., more grayscale), ceasing display of, etc.) the first user interface object and the second user interface object relative to a region of the user interface outside of the first region, such as described with reference to user interface object 1109 in FIG. 11A (e.g., the region and or objects outside of the first region that are less than the threshold angle from the gaze of the user are displayed with less or no blurring, less or no dimming, more or full color, etc.). In some embodiments, if the direction of the gaze of the user changes, the first and/or second user interface objects will be more deemphasized relative to the region of the user interface if the gaze of the user moves to a greater angle away from the first and/or second user interface objects, and will be less deemphasized (e.g., emphasized) relative to the region of the user interface if the gaze of the user moves to a smaller angle away from the first and/or second user interface objects. In some embodiments, in accordance with a determination that the first region is less than the threshold angle from the viewpoint associated with the electronic device in the three-dimensional environment, the electronic device forgoes (1222b) visually deemphasizing the first user interface object and the second user interface object relative to the region of the user interface outside of the first region, such as with respect to user interface objects 1103a,b and 1105a,b in FIG. 11A. For example, in some embodiments, the electronic device visually deemphasizes the first region and/or objects within the first region when the first region is more than the threshold angle from the gaze of the user. The above-described manner of visually deemphasizing region(s) of the user interface that are not interactive because of their angle from the gaze of the user provides a quick and efficient way of conveying that such regions are not interactive due to their distance from the viewpoint, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently while avoiding providing unnecessary inputs for interacting with the non-interactive region of the user interface.

In some embodiments, the one or more first criteria and the one or more second criteria include a respective criterion that is satisfied when the first region is more than a threshold distance (e.g., 3, 5, 10, 20, 30, 50 feet) from a viewpoint associated with the electronic device in a three-dimensional environment, and not satisfied when the first region is less than the threshold distance from the viewpoint associated with the electronic device in the three-dimensional environment (1224a) (e.g., the electronic device directs the respective input according to the one or more first or second criteria with respect to the first and second user interface objects if the first region is more than the threshold distance from the viewpoint associated with the electronic device). For example, in FIG. 11A, objects 1105a,b are optionally further than the threshold distance from the viewpoint of the user. In some embodiments, in response to detecting the respective input and in accordance with a determination that the first region is less than the threshold distance from the viewpoint associated with the electronic device in the three-dimensional environment (1224b), in accordance with a determination that the gaze of the user is directed to the first user interface object (e.g., and independent of whether the one or more first criteria or the one or more second criteria other than the respective criterion are satisfied), the electronic device performs (1224b) the operation with respect to the first user interface object based on the respective input, such as described with reference to user interface objects 1103a,b in FIGS. 11A and 11B. In some embodiments, in accordance with a determination that the gaze of the user is directed to the second user interface object (e.g., and independent of whether the one or more first criteria or the one or more second criteria other than the respective criterion are satisfied), the electronic device performs (1224d) the operation with respect to the second user interface object based on the respective input, such as described with reference to user interface objects 1103a,b in FIGS. 11A and 11B. For example, when the first region is within the threshold distance of the viewpoint associated with the electronic device, the device directs the respective input to the first or second user interface objects based on the gaze of the user being directed to the first or second, respectively, user interface objects, rather than based on the one or more first or second criteria. The above-described manner of performing gaze-based direction of inputs to the first region when the first region is within the threshold distance of the viewpoint of the user provides a quick and efficient way of allowing the user to indicate to which user interface object the input should be directed when the user interface objects are at distances at which gaze location/direction is able to be determined by the device with relatively high certainty, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently.

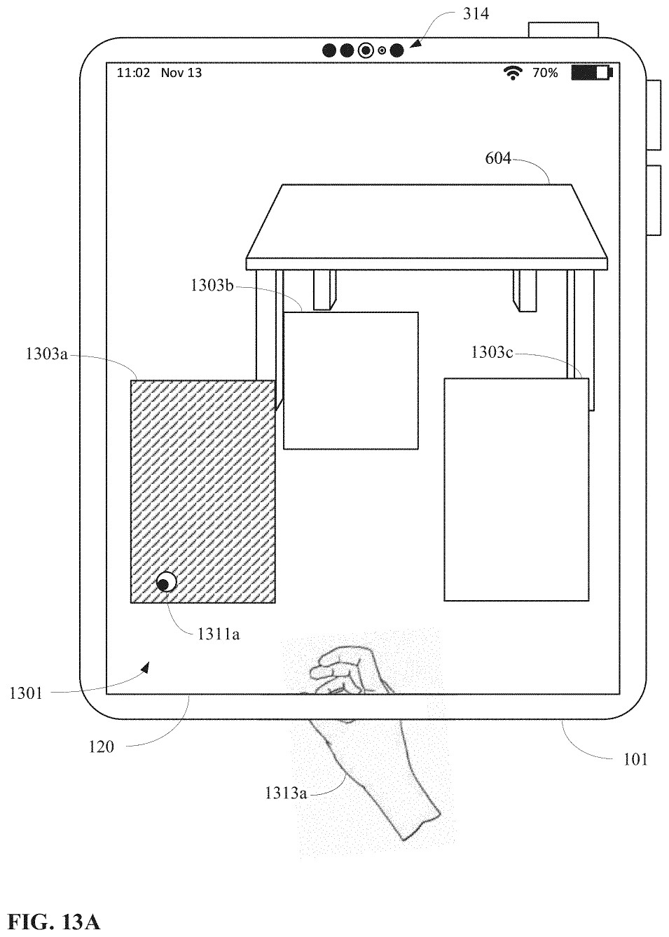

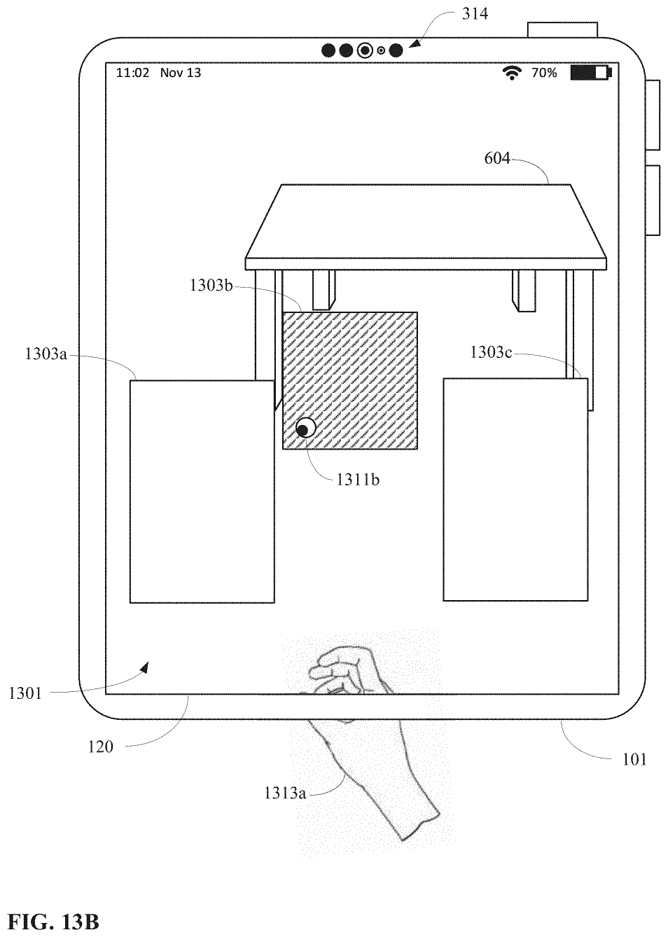

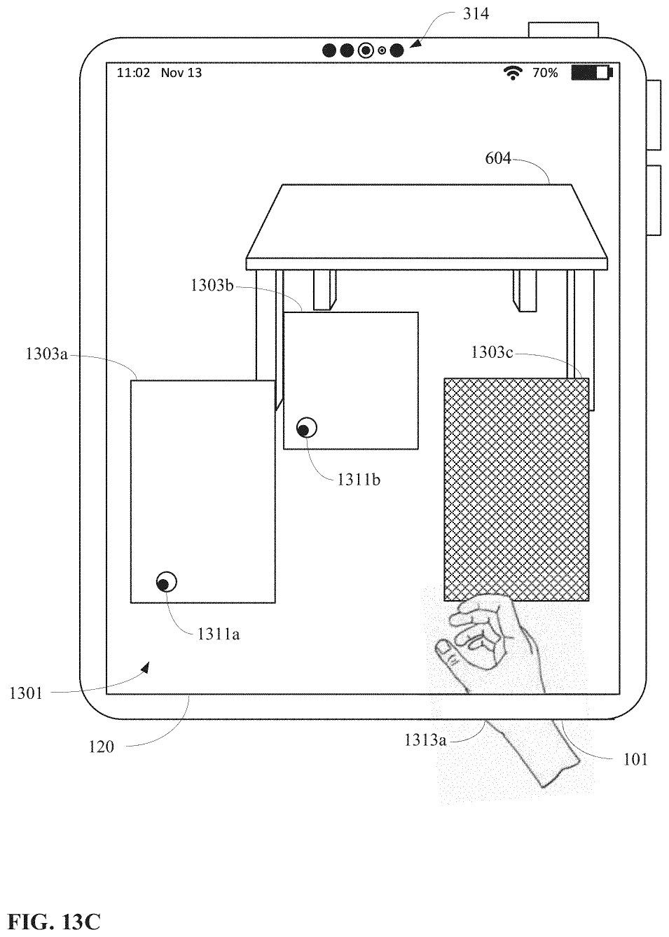

FIGS. 13A-13C illustrate examples of how an electronic device enhances interactions with user interface elements for mixed direct and indirect interaction modes in accordance with some embodiments.

FIG. 13A illustrates an electronic device 101 displaying, via a display generation component 120, a three-dimensional environment 1301 on a user interface. It should be understood that, in some embodiments, electronic device 101 utilizes one or more techniques described with reference to FIGS. 13A-13C in a two-dimensional environment or user interface without departing from the scope of the disclosure. As described above with reference to FIGS. 1-6, the electronic device 101 optionally includes a display generation component 120 (e.g., a touch screen) and a plurality of image sensors 314. The image sensors optionally include one or more of a visible light camera, an infrared camera, a depth sensor, or any other sensor the electronic device 101 would be able to use to capture one or more images of a user or a part of the user while the user interacts with the electronic device 101. In some embodiments, display generation component 120 is a touch screen that is able to detect gestures and movements of a user's hand. In some embodiments, the user interfaces shown below could also be implemented on a head-mounted display that includes a display generation component that displays the user interface to the user, and sensors to detect the physical environment and/or movements of the user's hands (e.g., external sensors facing outwards from the user), and/or gaze of the user (e.g., internal sensors facing inwards towards the face of the user).

As shown in FIG. 13A, the three-dimensional environment 1301 includes three user interface objects 1303a, 1303b and 1303c that are interactable (e.g., via user inputs provided by hand 1313a of the user of device 101). For example, device 101 optionally directs direct or indirect inputs (e.g., as described with reference to methods 800, 1000, 1200, 1400, 1600, 1800 and/or 2000) provided by hand 1313a to user interface objects 1303a, 1303b and/or 1303c based on various characteristics of such inputs. In FIG. 13A, three-dimensional environment 1301 also includes representation 604 of a table in a physical environment of the electronic device 101 (e.g., such as described with reference to FIG. 6B). In some embodiments, the representation 604 of the table is a photorealistic video image of the table displayed by the display generation component 120 (e.g., video or digital passthrough). In some embodiments, the representation 604 of the table is a view of the table through a transparent portion of the display generation component 120 (e.g., true or physical passthrough).

In some embodiments, as discussed for example with reference to method 800, when device 101 detects the hand of the user in an indirect ready state at an indirect interaction distance from one or more user interface objects, the device 101 assigns the indirect hover state to a user interface object based on the gaze of the user (e.g., displays the user interface object at which the gaze of the user is directed with the indirect hover state appearance) to indicate which user interface object will receive indirect inputs from the hand of the user if the hand of the user provides such inputs. Similarly, in some embodiments, as discussed for example with reference to method 800, when device 101 detects the hand of the user in a direct ready state at a direct interaction distance from a user interface object, the device assigns the direct hover state to that user interface object to indicate that that user interface object will receive direct inputs from the hand of the user if the hand of the user provides such inputs.

In some embodiments, device 101 detects that the inputs provided by the hand of the user transition from being indirect inputs to being direct inputs and/or vice versa. FIGS. 13A-13C illustrate example responses of device 101 to such transitions. For example, in FIG. 13A, device 101 detects hand 1313a further than a threshold distance (e.g., at an indirect interaction distance), such as 3 inches, 6 inches, 1 foot, 2 feet, 5 feet, 10 feet, from all of user interface objects 1303a, 1303b, and 1303c (e.g., hand 1313a is not within the threshold distance of any user interface objects in three-dimensional environment 1301 that are interactable by hand 1313a). Hand 1313a is optionally in an indirect ready state hand shape (e.g., as described with reference to method 800). In FIG. 13A, the gaze 1311a of the user of the electronic device 101 is directed to user interface object 1303a. Therefore, device 101 displays user interface object 1303a with an indirect hover state appearance (e.g., indicated by the shading of user interface object 1303a), and device 101 displays user interface objects 1303b and 1303c without the indirect hover state appearance (e.g., displays the user interface objects in a non-hover state, such as indicated by the lack of shading of user interface objects 1303b and 1303c). If hand 1313a were to move within the threshold distance of user interface object 1303a, and optionally if hand 1313a were to be in a direct ready state hand shape (e.g., as described with reference to method 800), device 101 would optionally maintain user interface object 1303a with the hover state (e.g., display user interface object 1303a with a direct hover state appearance). In some embodiments, if in FIG. 13A hand 1313a were not in the indirect ready state hand shape, device 101 would optionally display user interface object 1303a without the indirect hover state appearance (e.g., and would optionally display all of user interface objects 1303a, 1303b and 1303c without the indirect hover state if device 101 did not detect at least one hand of the user in the indirect ready state hand shape). In some embodiments, the indirect hover state appearance is different depending on with which hand the indirect hover state corresponds. For example, in FIG. 13A, hand 1313a is optionally the right hand of the user of the electronic device 101, and results in the indirect hover state appearance for user interface object 1303a as shown and described with reference to FIG. 13A. However, if hand 1313a had instead been the left hand of the user, device 101 would optionally display user interface object 1303a with a different (e.g., different color, different shading, different size, etc.) indirect hover state appearance. Displaying user interface objects with different indirect hover state appearances optionally indicates to the user from which hand of the user device 101 will direct inputs to those user interface objects.

In FIG. 13B, device 101 detects that gaze 1311b of the user has moved away from user interface object 1303a and has moved to user interface object 1303b. In FIG. 13B, hand 1313a optionally remains in the indirect ready state hand shape, and optionally remains further than the threshold distance from all of user interface objects 1303a, 1303b, and 1303c (e.g., hand 1313a is not within the threshold distance of any user interface objects in three-dimensional environment 1301 that are interactable by hand 1313a). In response, device 101 has moved the indirect hover state to user interface object 1303b from user interface object 1303a, and displays user interface object 1303b with the indirect hover state appearance, and displays user interface objects 1303a and 1303c without the indirect hover state appearance (e.g., displays user interface objects 1303a and 1303c in a non-hover state).

In FIG. 13C, device 101 detects that hand 1313a has moved (e.g., from its position in FIGS. 13A and/or 13B) to within the threshold distance (e.g., at a direct interaction distance) of user interface object 1303c. Device 101 optionally also detects that hand 1313a is in a direct ready state hand shape (e.g., as described with reference to method 800). Therefore, whether the gaze of the user is directed to user interface object 1303a (e.g., gaze 1311a) or user interface object 1303b (e.g., gaze 1311b), device 101 moves the direct hover state to user interface object 1303c (e.g., moving the hover state away from user interface objects 1303a and/or 1303b), and is displaying user interface object 1303c with the direct hover state appearance (e.g., indicated by the shading of user interface object 1303c), and is displaying user interface objects 1303a and 1303b without a (e.g., direct or indirect) hover state appearance (e.g., in a non-hover state). In some embodiments, changes in the gaze of the user (e.g., to be directed to different user interface objects) do not move the direct hover state away from user interface object 1303c while hand 1313a is within the threshold distance of user interface object 1303c (e.g., and is optionally in the direct ready state hand shape). In some embodiments, device 101 requires that user interface object 1303c is within the attention zone of the user (e.g., as described with reference to method 1000) for user interface object 1303c to receive the hover state in response to the hand movement and/or shape of FIG. 13C. For example, if device 101 detected the hand 1313a position and/or shape of FIG. 13C, but detected that the attention zone of the user did not include user interface object 1303c, device 101 would optionally not move the hover state to user interface object 1303c, and would instead maintain the hover state with the user interface object that previously had the hover state. If device 101 then detected the attention zone of the user move to include user interface object 1303c, device 101 would optionally move the hover state to user interface object 1303c, as long as hand 1313a was within the threshold distance of user interface object 1303c, and optionally was in a direct ready state hand shape. If device 101 subsequently detected the attention zone of the user move again to not include user interface object 1303c, device 101 would optionally maintain the hover state with user interface object 1303c as long as hand 1313a was still engaged with user interface object 1303c (e.g., within the threshold distance of user interface object 1303c and/or in a direct ready state hand shape and/or directly interacting with user interface object 1303c, etc.). If hand 1313a was no longer engaged with user interface object 1303c, device 101 would optionally move the hover state to user interface objects based on the gaze of the user of the electronic device.

In some embodiments, the direct hover state appearance is different depending on with which hand the direct hover state corresponds. For example, in FIG. 13C, hand 1313a is optionally the right hand of the user of the electronic device 101, and results in the direct hover state appearance for user interface object 1303c as shown and described with reference to FIG. 13C. However, if hand 1313a had instead been the left hand of the user, device 101 would optionally display user interface object 1303c with a different (e.g., different color, different shading, different size, etc.) direct hover state appearance. Displaying user interface objects with different direct hover state appearances optionally indicates to the user from which hand of the user device 101 will direct inputs to those user interface objects.

In some embodiments, the appearance of the direct hover state (e.g., shown on user interface object 1303c in FIG. 13C) is different from the appearance of the indirect hover state (e.g., shown on user interface objects 1303a and 1303b in FIGS. 13A and 13B, respectively). Thus, in some embodiments, a given user interface object is displayed by device 101 differently (e.g., different color, different shading, different size, etc.) depending on whether the user interface object has a direct hover state or an indirect hover state.

If in FIG. 13C, device 101 had detected that hand 1313a had moved within the threshold distance of (e.g., within a direct interaction distance of) two interactable user interface objects (e.g., 1303b and 1303c), and optionally if hand 1313a was in the direct ready state shape, device 101 would optionally move the hover state to the user interface object that is closer to hand 1313a—for example, to user interface object 1303b if hand 1313a was closer to user interface object 1303b, and to user interface object 1303c if hand 1313a was closer to user interface object 1303c.

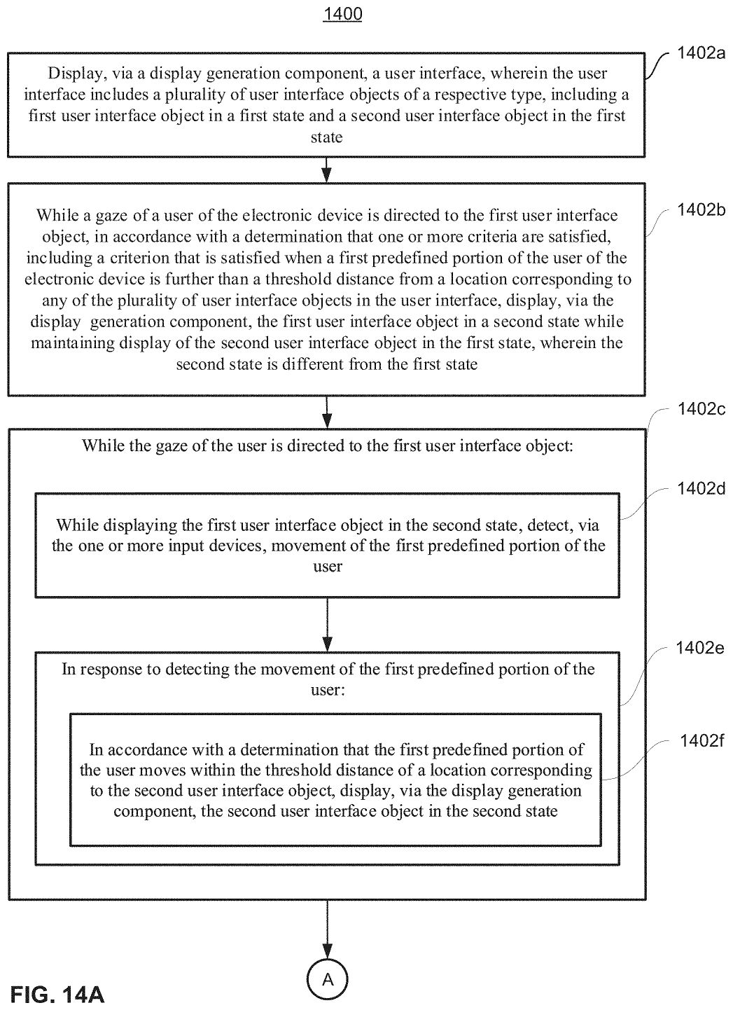

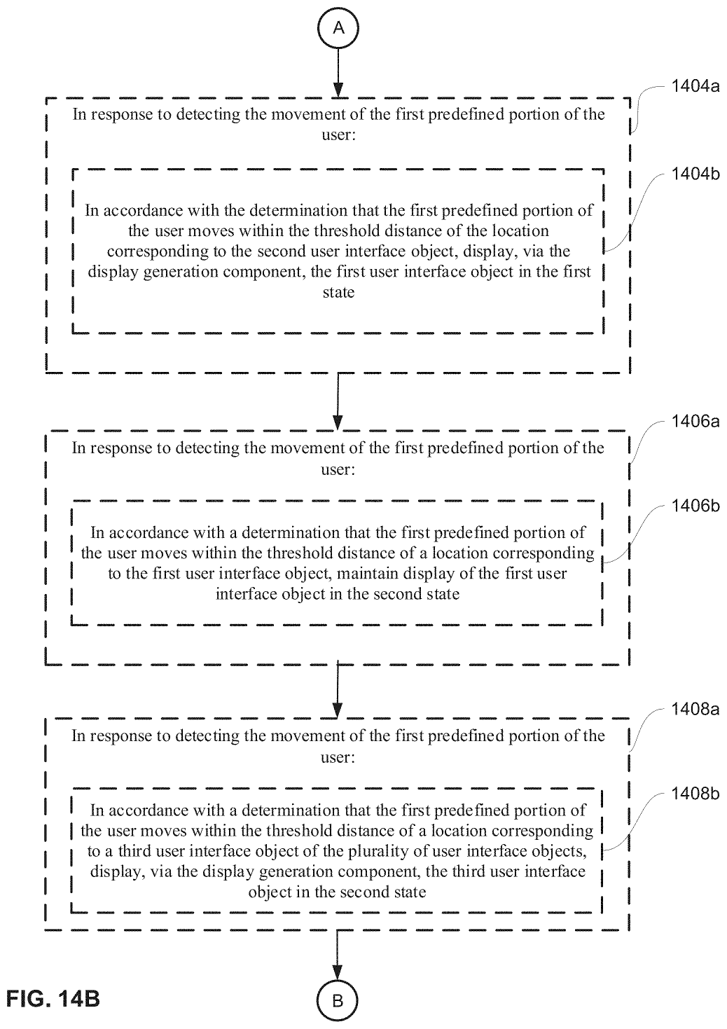

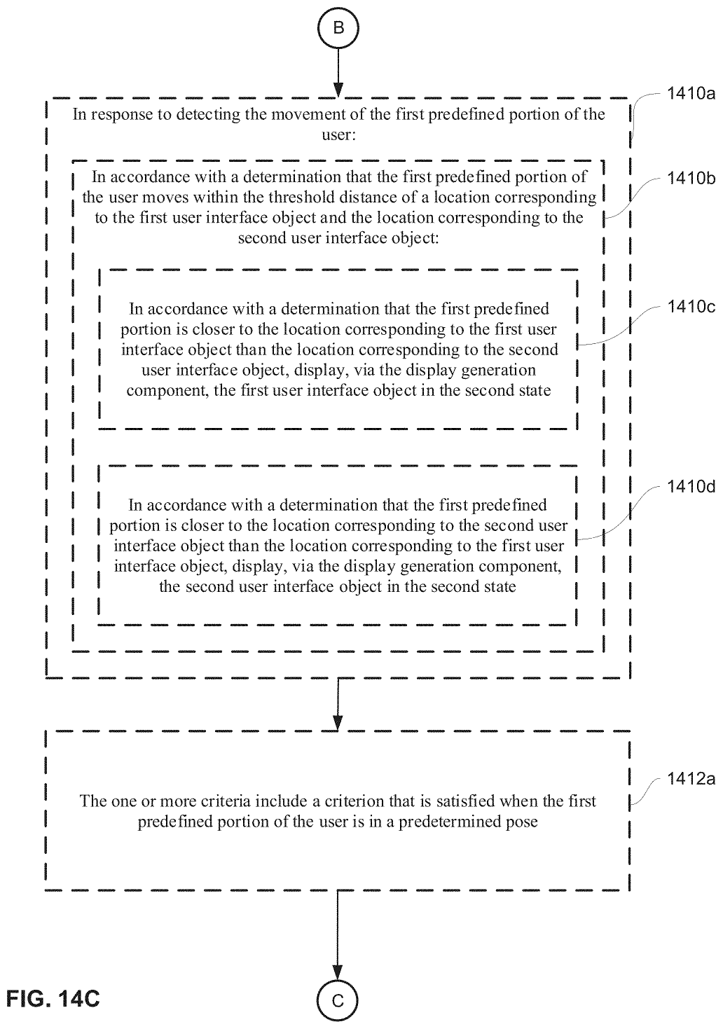

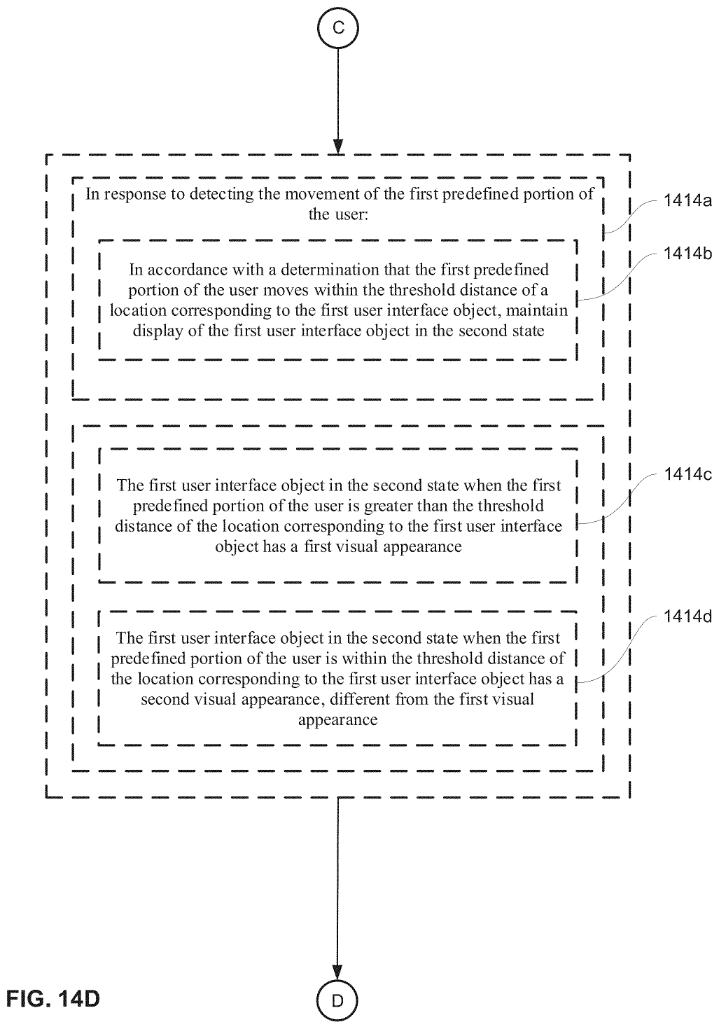

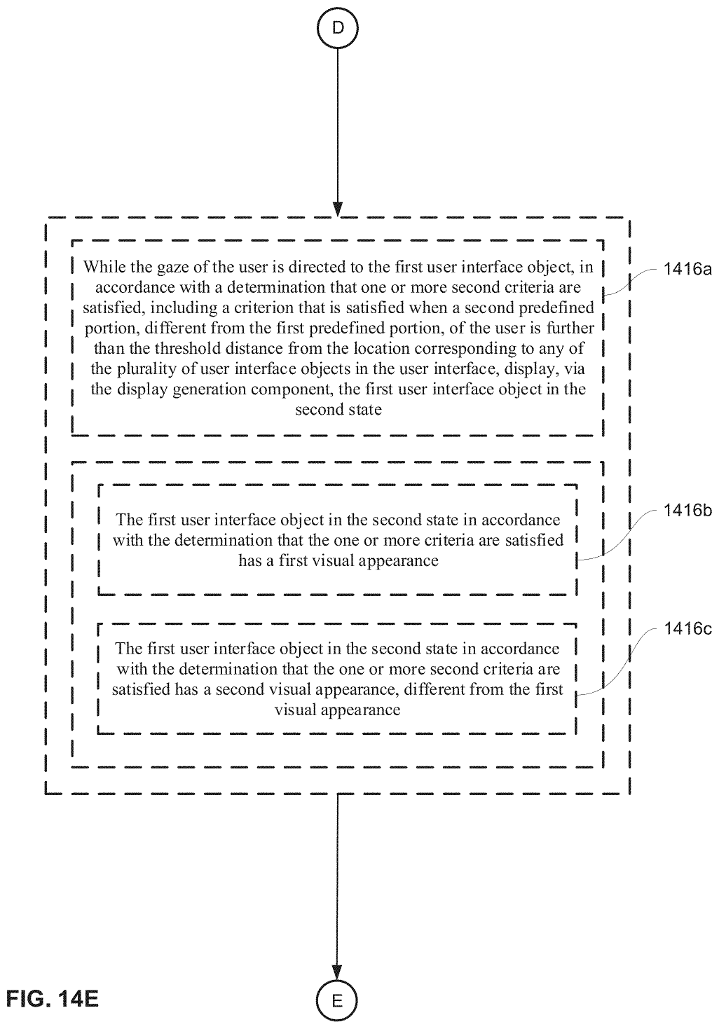

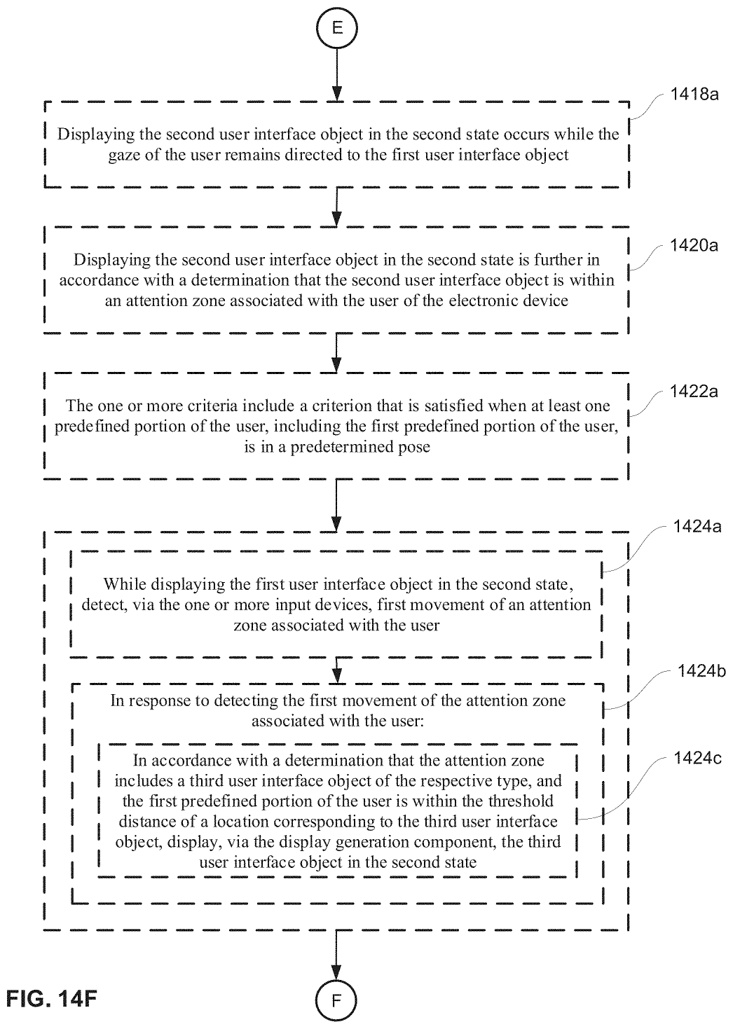

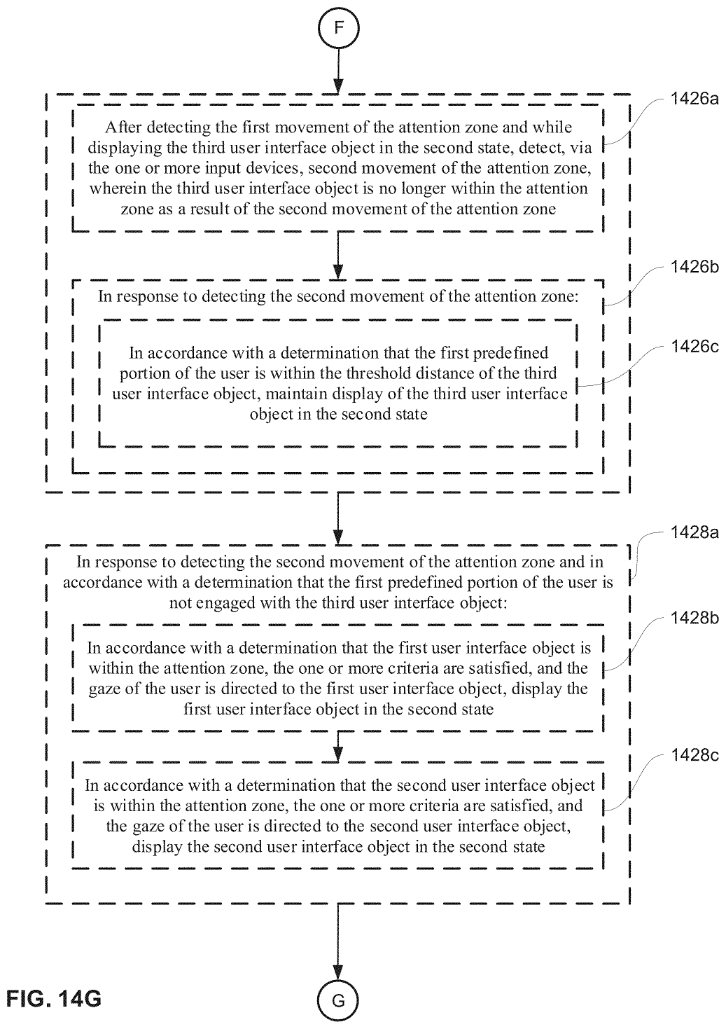

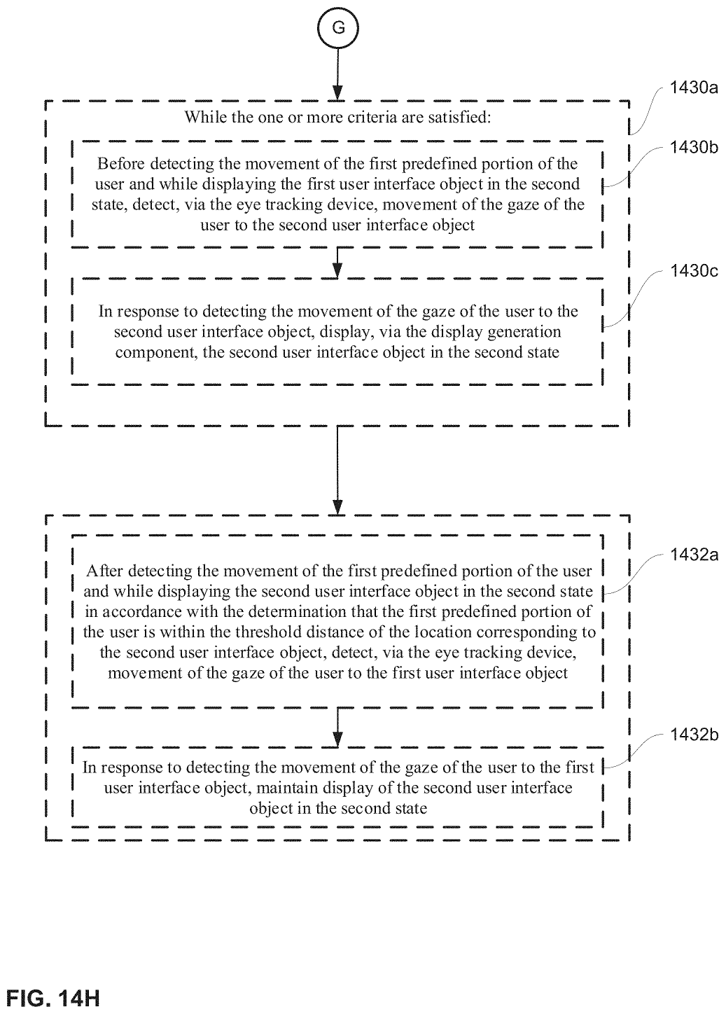

FIGS. 14A-14H is a flowchart illustrating a method 1400 of enhancing interactions with user interface elements for mixed direct and indirect interaction modes in accordance with some embodiments. In some embodiments, the method 1400 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, a projector, etc.) and one or more cameras (e.g., a camera (e.g., color sensors, infrared sensors, and other depth-sensing cameras) that points downward at a user's hand or a camera that points forward from the user's head). In some embodiments, the method 1400 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1400 are, optionally, combined and/or the order of some operations is, optionally, changed.

In some embodiments, method 1400 is performed at an electronic device in communication with a display generation component and one or more input devices, including an eye tracking device. For example, a mobile device (e.g., a tablet, a smartphone, a media player, or a wearable device), or a computer. In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. In some embodiments, the one or more input devices include an electronic device or component capable of receiving a user input (e.g., capturing a user input, detecting a user input, etc.) and transmitting information associated with the user input to the electronic device. Examples of input devices include a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera, a depth sensor, an eye tracking device, and/or a motion sensor (e.g., a hand tracking device, a hand motion sensor), etc. In some embodiments, the hand tracking device is a wearable device, such as a smart glove. In some embodiments, the hand tracking device is a handheld input device, such as a remote control or stylus.

In some embodiments, the electronic device displays (1402a), via the display generation component, a user interface, wherein the user interface includes a plurality of user interface objects of a respective type, such as user interface objects 1303a,b,c in FIG. 13A (e.g., user interface objects that are selectable via one or more hand gestures such as a tap or pinch gesture), including a first user interface object in a first state (e.g., a non-hover state such as an idle or non-selected state) and a second user interface object in the first state (e.g., a non-hover state such as an idle or non-selected state). In some embodiments, the first and/or second user interface objects are interactive user interface objects and, in response to detecting an input directed towards a given object, the electronic device performs an action associated with the user interface object. For example, a user interface object is a selectable option that, when selected, causes the electronic device to perform an action, such as displaying a respective user interface, changing a setting of the electronic device, or initiating playback of content. As another example, a user interface object is a container (e.g., a window) in which a user interface/content is displayed and, in response to detecting selection of the user interface object followed by a movement input, the electronic device updates the position of the user interface object in accordance with the movement input. In some embodiments, the first user interface object and the second user interface object are displayed in a three-dimensional environment (e.g., the user interface is the three-dimensional environment and/or is displayed within a three-dimensional environment) that is generated, displayed, or otherwise caused to be viewable by the device (e.g., a computer-generated reality (CGR) environment such as a virtual reality (VR) environment, a mixed reality (MR) environment, or an augmented reality (AR) environment, etc.

In some embodiments, while a gaze of a user of the electronic device is directed to the first user interface object, such as gaze 1311a in FIG. 13A (e.g., the gaze of the user intersects with the first user interface object, or the gaze of the user is within a threshold distance such as 1, 2, 5, 10 feet of intersecting with the first user interface object), in accordance with a determination that one or more criteria are satisfied, including a criterion that is satisfied when a first predefined portion of the user of the electronic device is further than a threshold distance from a location corresponding to any of the plurality of user interface objects in the user interface, such as hand 1313a in FIG. 13A (e.g., a location of a hand or finger, such as the forefinger, of the user is not within 3 inches, 6 inches, 1 foot, 2 feet, 5 feet, 10 feet of the location corresponding to any of the plurality of user interface objects in the user interface, such that input provided by the first predefined portion of the user to a user interface object will be in an indirect interaction manner such as described with reference to methods 800, 1000, 1200, 1600, 1800 and 2000), the electronic device displays (1402b), via the display generation component, the first user interface object in a second state (e.g., a hover state) while maintaining display of the second user interface object in the first state (e.g., a non-hover state such as an idle or non-selected state), wherein the second state is different from the first state, such as user interface objects 1303a and 1303b in FIG. 13A (e.g., if a user interface object is in a hover state, further input from the predefined portion of the user (e.g., a movement of the forefinger of the hand towards the user interface object) when that predefined portion of the user is further than the threshold distance from the location corresponding to that object is optionally recognized by the device as input directed to that user interface object (e.g., selecting the user interface object that was in the hover state)). Examples of such input are described with reference to methods 800, 1000, 1200, 1600, 1800 and 2000. In some embodiments, such further input from the predefined portion of the user is optionally recognized as not being directed to a user interface object that is in a non-hover state. In some embodiments, displaying the first user interface object in the second state includes updating the appearance of the first user interface object to change its color, highlight it, lift/move it towards the viewpoint of the user, etc. to indicate that the first user interface object is in the hover state (e.g., ready for further interaction), and displaying the second user interface object in the first state includes displaying the second user interface object without changing its color, highlighting it, lifting/moving it towards the viewpoint of the user, etc. In some embodiments, the one or more criteria include a criterion that a satisfied when the predefined portion of the user is in a particular pose, such as described with reference to method 800. In some embodiments, if the gaze of the user had been directed to the second user interface object (rather than the first) when the one or more criteria are satisfied, the second user interface object would have been displayed in the second state, and the first user interface object would have been displayed in the first state.

In some embodiments, while the gaze of the user is directed to the first user interface object (1402c) (e.g., the gaze of the user remains directed to the first user interface object during/after the movement of the predefined portion of the user described below), while displaying the first user interface object in the second state (e.g., a hover state), the electronic device detects (1402d), via the one or more input devices, movement of the first predefined portion of the user (e.g., movement of the hand and/or finger of the user away from a first location to a second location). In some embodiments, in response to detecting the movement of the first predefined portion of the user (1402e), in accordance with a determination that the first predefined portion of the user moves within the threshold distance of a location corresponding to the second user interface object, such as hand 1313a in FIG. 13C (e.g., before detecting the movement of the first predefined portion of the user, the first predefined portion of the user was not within the threshold distance of locations corresponding to any of the plurality of user interface objects in the user interface, but after detecting the movement of the first predefined portion of the user, the first predefined portion of the user is within the threshold distance of the location corresponding to the second user interface object. The first predefined portion of the user is optionally not within the threshold distance of locations corresponding to any other of the plurality of user interface objects in the user interface), the electronic device displays (1402f), via the display generation component, the second user interface object in the second state (e.g., a hover state), such as displaying user interface object 1303c in the hover state in FIG. 13C. For example, moving the hover state from the first user interface object to the second user interface object, because the hand and/or finger of the user is within the threshold distance of the location corresponding to the second user interface object, even though the gaze of the user continues to be directed to the first user interface object, and not directed to the second user interface object. In some embodiments, the pose of the first predefined portion of the user needs to be a particular pose, such as described with reference to method 800, to move the hover state to the second user interface object when the first predefined portion of the user is within the threshold distance of the location corresponding to the second user interface object. When the first predefined portion of the user is within the threshold distance of the location corresponding to the second user interface object, input provided by the first predefined portion of the user to the second user interface object will optionally be in a direct interaction manner such as described with reference to methods 800, 1000, 1200, 1600, 1800 and 2000. The above-described manner of moving the second state to the second user interface object provides an efficient way of facilitating interaction with user interface objects most likely to be interacted with based on one or more of hand and gaze positioning, without the need for further user input to designate a given user interface object as the target of further interaction, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently.

In some embodiments, in response to detecting the movement of the first predefined portion of the user (1404a), in accordance with the determination that the first predefined portion of the user moves within the threshold distance of the location corresponding to the second user interface object (e.g., before detecting the movement of the first predefined portion of the user, the first predefined portion of the user was not within the threshold distance of locations corresponding to any of the plurality of user interface objects in the user interface, but after detecting the movement of the first predefined portion of the user, the first predefined portion of the user is within the threshold distance of the location corresponding to the second user interface object. The first predefined portion of the user is optionally not within the threshold distance of locations corresponding to any other of the plurality of user interface objects in the user interface), the electronic device displays (1404b), via the display generation component, the first user interface object in the first state, such as displaying user interface objects 1303a and/or b in the non-hover state in FIG. 13C (e.g., a non-hover state such as an idle or non-selected state). For example, because the first predefined portion of the user has now moved to within the threshold distance of the second user interface object, the first predefined portion of the user is now determined by the electronic device to be interacting with the second user interface object, and is no longer available for interaction with the first user interface object. As such, the electronic device optionally displays the first user interface object in the first state (e.g., rather than maintaining display of the first user interface object in the second state). The above-described manner of displaying the first user interface object in the first state provides an efficient way of indicating that the first predefined portion of the user is no longer determined to be interacting with the first user interface object, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently (e.g., by avoiding erroneous inputs provided by the first predefined portion of the user to incorrect user interface objects).

In some embodiments, in response to detecting the movement of the first predefined portion of the user (1406a), in accordance with a determination that the first predefined portion of the user moves within the threshold distance of a location corresponding to the first user interface object (e.g., before detecting the movement of the first predefined portion of the user, the first predefined portion of the user was not within the threshold distance of locations corresponding to any of the plurality of user interface objects in the user interface, but after detecting the movement of the first predefined portion of the user, the first predefined portion of the user is within the threshold distance of the location corresponding to the first user interface object. The first predefined portion of the user is optionally not within the threshold distance of locations corresponding to any other of the plurality of user interface objects in the user interface), the electronic device maintains (1406b) display of the first user interface object in the second state (e.g., a hover state) (e.g., and maintaining display of the second user interface object in the first state). For example, in FIG. 13A, if hand 1313a moved to within the threshold distance of object 1303a, device 101 would maintain display of object 1303a in the second state. For example, because the electronic device was already displaying the first user interface object in the second state before the first predefined portion of the user moved to within the threshold distance of the location corresponding to the first user interface object, and because after the first predefined portion of the user moved to within the threshold distance of the location corresponding to the first user interface object the device determines that the first predefined portion of the user is still interacting with the first user interface object, the electronic device maintains displaying the first user interface object in the second state. In some embodiments, the gaze of the user continues to be directed to the first user interface object, and in some embodiments, the gaze of the user no longer is directed to the first user interface object. When the first predefined portion of the user is within the threshold distance of the location corresponding to the first user interface object, input provided by the first predefined portion of the user to the first user interface object will optionally be in a direct interaction manner such as described with reference to methods 800, 1000, 1200, 1600, 1800 and 2000. The above-described manner of maintaining display of the first user interface object in the second state provides an efficient way of indicating that the first predefined portion of the user is still determined to be interacting with the first user interface object, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently (e.g., by avoiding erroneous inputs provided by the first predefined portion of the user to incorrect user interface objects).

In some embodiments, in response to detecting the movement of the first predefined portion of the user (1408a), in accordance with a determination that the first predefined portion of the user moves within the threshold distance of a location corresponding to a third user interface object of the plurality of user interface objects (e.g., different from the first and second user interface objects. For example, before detecting the movement of the first predefined portion of the user, the first predefined portion of the user was not within the threshold distance of locations corresponding to any of the plurality of user interface objects in the user interface, but after detecting the movement of the first predefined portion of the user, the first predefined portion of the user is within the threshold distance of the location corresponding to the third user interface object. The first predefined portion of the user is optionally not within the threshold distance of locations corresponding to any other of the plurality of user interface objects in the user interface), the electronic device displays (1408b), via the display generation component, the third user interface object in the second state (e.g., a hover state) (e.g., and displaying the first and second user interface objects in the first state). For example, moving the hover state from the first user interface object to the third user interface object, because the hand and/or finger of the user is within the threshold distance of the location corresponding to the third user interface object, even though the gaze of the user continues to be directed to the first user interface object, and not directed to the third user interface object (e.g., in FIG. 13C, instead of the hand 1313a moving to within the threshold distance of object 1303c, the hand 1313a moves to within the threshold distance of object 1303b, device 101 would display object 1303b in the second state, instead of displaying object 1303c in the second state). In some embodiments, the pose of the first predefined portion of the user needs to be a particular pose, such as described with reference to method 800, to move the hover state to the third user interface object when the first predefined portion of the user is within the threshold distance of the location corresponding to the third user interface object. When the first predefined portion of the user is within the threshold distance of the location corresponding to the third user interface object, input provided by the first predefined portion of the user to the third user interface object will optionally be in a direct interaction manner such as described with reference to methods 800, 1000, 1200, 1600, 1800 and 2000. The above-described manner of moving the second state to a user interface object when the first predefined portion of the user is within the threshold distance of the location corresponding to that user interface object provides an efficient way of indicating that the first predefined portion of the user is still determined to be interacting with that user interface object, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently (e.g., by avoiding erroneous inputs provided by the first predefined portion of the user to incorrect user interface objects).

In some embodiments, in response to detecting the movement of the first predefined portion of the user (1410a), in accordance with a determination that the first predefined portion of the user moves within the threshold distance of a location corresponding to the first user interface object and the location corresponding to the second user interface object (1410b) (e.g., the first predefined portion of the user is now within the threshold distance of the locations corresponding to two or more user interface objects of the plurality of user interface objects, such as in FIG. 13C, hand 1313a had moved to within the threshold distance of objects 1303b and 1303c), in accordance with a determination that the first predefined portion is closer to the location corresponding to the first user interface object than the location corresponding to the second user interface object (e.g., closer to object 1303b than object 1303c), the electronic device displays (1410c), via the display generation component, the first user interface object (e.g., 1303b) in the second state (e.g., a hover state) (e.g., and displaying the second user interface object in the first state). In some embodiments, in accordance with a determination that the first predefined portion is closer to the location corresponding to the second user interface object than the location corresponding to the first user interface object (e.g., closer to object 1303c than object 1303b), the electronic device displays (1410d), via the display generation component, the second user interface object (e.g., 1303c) in the second state (e.g., a hover state) (e.g., and displaying the first user interface object in the first state). For example, when the first predefined portion of the user is within the threshold distance of multiple user interface objects of the plurality of user interface objects, the electronic device optionally moves the second state to the user interface object to whose corresponding location the first predefined portion of the user is closer. In some embodiments, the electronic device moves the second state as described above irrespective of whether the gaze of the user is directed to the first or the second (or other) user interface objects, because the first predefined portion of the user is within the threshold distance of a location corresponding to at least one of the user interface objects of the plurality of user interface objects. The above-described manner of moving the second state to a user interface object closest to the first predefined portion of the user when the first predefined portion of the user is within the threshold distance of locations corresponding to multiple user interface objects provides an efficient way of selecting (e.g., without additional user input) a user interface object for interaction, and indicating the same to the user, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently (e.g., by avoiding erroneous inputs provided by the first predefined portion of the user to incorrect user interface objects).

In some embodiments, the one or more criteria include a criterion that is satisfied when the first predefined portion of the user is in a predetermined pose (1412a), such as described with reference to hand 1313a in FIG. 13A. For example, with the hand in a shape corresponding to the beginning of a gesture in which the thumb and forefinger of the hand come together, or in a shape corresponding to the beginning of a gesture in which the forefinger of the hand moves forward in space in a tapping gesture manner (e.g., as if the forefinger is tapping an imaginary surface 0.5, 1, 2, 3 cm in front of the forefinger). The predetermined pose of the first predefined portion of the user is optionally as described with reference to method 800. The above-described manner of requiring the first predefined portion of the user to be in a particular pose before a user interface object will have the second state (e.g., and ready to accept input from the first predefined portion of the user) provides an efficient way of preventing accidental input/interaction with user interface elements by the first predefined portion of the user, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently.

In some embodiments, in response to detecting the movement of the first predefined portion of the user (1414a), in accordance with a determination that the first predefined portion of the user moves within the threshold distance of a location corresponding to the first user interface object (e.g., before detecting the movement of the first predefined portion of the user, the first predefined portion of the user was not within the threshold distance of locations corresponding to any of the plurality of user interface objects in the user interface, but after detecting the movement of the first predefined portion of the user, the first predefined portion of the user is within the threshold distance of the location corresponding to the first user interface object. The first predefined portion of the user is optionally not within the threshold distance of locations corresponding to any other of the plurality of user interface objects in the user interface), the electronic device maintains (1414b) display of the first user interface object in the second state (e.g., a hover state) (e.g., and maintaining display of the second user interface object in the first state). For example, if hand 1313a had moved to within the threshold distance of object 1303a after the state illustrated in FIG. 13A, device 101 would optionally maintain display of object 1303a in the second state. In some embodiments, the first user interface object is in the second state (e.g., a hover state) when the first predefined portion of the user is greater than the threshold distance of the location corresponding to the first user interface object has a first visual appearance (1414c), and the first user interface object in the second state (e.g., a hover state) when the first predefined portion of the user is within the threshold distance of the location corresponding to the first user interface object has a second visual appearance, different from the first visual appearance (1414d), such as described with reference to user interface object 1303c in FIG. 13C. For example, the visual appearance of the hover state for direct interaction with the first predefined portion of the user (e.g., when the first predefined portion of the user is within the threshold distance of a location corresponding to the first user interface object, such as described with reference to methods 800, 1000, 1200, 1600, 1800 and 2000) is optionally different from the visual appearance of the hover state for indirect interaction with the first predefined portion of the user (e.g., when the first predefined portion of the user is further than the threshold distance from a location corresponding to the first user interface object, such as described with reference to methods 800, 1000, 1200, 1600, 1800 and 2000). In some embodiments, the different visual appearance is one or more of a different amount of separation of the first user interface object from a backplane over which it is displayed (e.g., displayed with no or less separation when not in the hover state), a different color and/or highlighting with which the first user interface object is displayed when in the hover state (e.g., displayed without the color and/or highlighting when not in the hover state), etc. The above-described manner of displaying the second state differently for direct and indirect interaction provides an efficient way of indicating according to what manner of interaction to which the device is responding and/or operating, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently (e.g., by avoiding erroneous inputs that are not compatible with the currently-active manner of interaction with the user interface object).

In some embodiments, while the gaze of the user is directed to the first user interface object (e.g., the gaze of the user intersects with the first user interface object, or the gaze of the user is within a threshold distance such as 1, 2, 5, 10 feet of intersecting with the first user interface object), in accordance with a determination that one or more second criteria are satisfied, including a criterion that is satisfied when a second predefined portion, different from the first predefined portion, of the user is further than the threshold distance from the location corresponding to any of the plurality of user interface objects in the user interface (e.g., a location of a hand or finger, such as the forefinger, of the user is not within 3 inches, 6 inches, 1 foot, 2 feet, 5 feet, 10 feet of the location corresponding to any of the plurality of user interface objects in the user interface, such that input provided by the second predefined portion of the user to a user interface object will be in an indirect interaction manner such as described with reference to methods 800, 1000, 1200, 1600, 1800 and 2000. In some embodiments, the first predefined portion of the user (e.g., right hand/finger) is engaged or not engaged with another user interface object of the plurality of user interface objects (e.g., as described with reference to method 1600) while the second predefined portion of the user (e.g., left hand/finger) is engaged with the first user interface object. In some embodiments, the one or more second criteria include a criterion that a satisfied when the second predefined portion of the user is in a particular pose, such as described with reference to method 800. In some embodiments, if the gaze of the user had been directed to the second user interface object (rather than the first) when the one or more second criteria are satisfied, the second user interface object would have been displayed in the second state, and the first user interface object would have been displayed in the first state), the electronic device displays (1416a), via the display generation component, the first user interface object in the second state, such as displaying user interface objects 1303a and/or b in FIGS. 13A and 13B in a hover state (e.g., displaying the first user interface object in the hover state based on the second predefined portion of the user). In some embodiments, the first user interface object in the second state (e.g., a hover state) in accordance with the determination that the one or more criteria are satisfied has a first visual appearance (1416b), and the first user interface object in the second state (e.g., a hover state) in accordance with the determination that the one or more second criteria are satisfied has a second visual appearance, different from the first visual appearance (1416c). For example, the hover states for user interface objects optionally have different visual appearances (e.g., color, shading, highlighting, separation from backplanes, etc.) depending on whether the hover state is based on the first predefined portion engaging with the user interface object or the second predefined portion engaging with the user interface object. In some embodiments, the direct interaction hover state based on the first predefined portion of the user has a different visual appearance than the direct interaction hover state based on the second predefined portion of the user, and the indirect interaction hover state based on the first predefined portion of the user has a different visual appearance than the indirect interaction hover state based on the second predefined portion of the user. In some embodiments, the two predefined portions of the user are concurrently engaged with two different user interface objects with different hover state appearances as described above. In some embodiments, the two predefined portions of the user are not concurrently (e.g., sequentially) engaged with different or the same user interface objects with different hover state appearances as described above. The above-described manner of displaying the second state differently for different predefined portions of the user provides an efficient way of indicating which predefined portion of the user the device is responding to for a given user interface object, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently (e.g., by avoiding erroneous inputs by the wrong predefined portion of the user).

In some embodiments, displaying the second user interface object in the second state (e.g., a hover state) occurs while the gaze of the user remains directed to the first user interface object (1418a), such as gaze 1311a or 1311b in FIG. 13C. For example, even though the gaze of the user remains directed to the first user interface object, when the first predefined portion of the user moves to within the threshold distance of the location corresponding to the second user interface object, the electronic device displays the second user interface object in the second state, and/or the first user interface object in the first state. In some embodiments, the gaze of the user is directed to the second user interface object. The above-described manner of moving the second state independent of gaze provides an efficient way of selecting a user interface object for direct interaction without an additional gaze input being required, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently.

In some embodiments, displaying the second user interface object in the second state (e.g., a hover state) is further in accordance with a determination that the second user interface object is within an attention zone associated with the user of the electronic device (1420a), such as object 1303c in FIG. 13C being within the attention zone associated with the user of the electronic device (e.g., if the second user interface object is not within the attention zone associated with the user, the second user interface object would not be displayed in the second state (e.g., would continue to be displayed in the first state). In some embodiments, the first user interface object would continue to be displayed in the second state, and in some embodiments, the first user interface object would be displayed in the first state). For example, the attention zone is optionally an area and/or volume of the user interface and/or three-dimensional environment that is designated based on the gaze direction/location of the user and is a factor that determines whether user interface objects are interactable by the user under various conditions, such as described with reference to method 1000. The above-described manner of moving the second state only if the second user interface object is within the attention zone of the user provides an efficient way of preventing unintentional interaction with user interface objects that the user may not realize are being potentially interacted with, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently.

In some embodiments, the one or more criteria include a criterion that is satisfied when at least one predefined portion of the user, including the first predefined portion of the user, is in a predetermined pose (1422a), such as described with reference to hand 1313a in FIG. 13A (e.g., a ready state pose, such as those described with reference to method 800). For example, gaze-based display of user interface objects in the second state optionally requires that at least one predefined portion of the user is in the predetermined pose before a user interface object to which the gaze is directed is displayed in the second state (e.g., to be able to interact with the user interface object that is displayed in the second state). The above-described manner of requiring a predefined portion of the user to be in a particular pose before displaying a user interface object in the second state provides an efficient way of preventing unintentional interaction with user interface objects when the user is providing only gaze input without a corresponding input with a predefined portion of the user, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently.

In some embodiments, while displaying the first user interface object in the second state (e.g., a hover state), the electronic device detects (1424a), via the one or more input devices, first movement of an attention zone associated with the user (e.g., without detecting movement of first predefined portion of the user. In some embodiments, the attention zone is an area and/or volume of the user interface and/or three-dimensional environment that is designated based on the gaze direction/location of the user and is a factor that determines whether user interface objects are interactable by the user under various conditions, such as described with reference to method 1000. In some embodiments, while the first user interface object was displayed in the second state (e.g., before the movement of the attention zone), it was within the attention zone associated with the user). In some embodiments, in response to detecting the first movement of the attention zone associated with the user (1424b), in accordance with a determination that the attention zone includes a third user interface object of the respective type (e.g., in some embodiments, the first user interface object is no longer within the attention zone associated with the user. In some embodiments, the gaze of the user is directed to the third user interface object. In some embodiments, the gaze of the user is not directed to the third user interface object), and the first predefined portion of the user is within the threshold distance of a location corresponding to the third user interface object, the electronic device displays (1424c), via the display generation component, the third user interface object in the second state (e.g., a hover state) (e.g., and displaying the first user interface object in the first state). Therefore, in some embodiments, even if the first predefined portion of the user does not move, but the gaze of the user moves such that the attention zone moves to a new location that includes a user interface object corresponding to a location that is within the threshold distance of the first predefined portion of the user, the electronic device moves the second state away from the first user interface object to the third user interface object. For example, in FIG. 13C, if the attention zone did not include object 1303c initially, but later included it, device 101 would optionally display object 1303 in the second state, such as shown in FIG. 13C, when the attention zone moved to include object 1303c. In some embodiments, the second state only moves to the third user interface object if the first user interface object had the second state while the first predefined portion of the user was further than the threshold distance from the location corresponding to the first user interface object, and not if the first user interface object had the second state while and/or because the first predefined portion of the user is within (and continues to be within) the threshold distance of the location corresponding to the first user interface object. The above-described manner of moving the second state based on changes in the attention zone provides an efficient way of ensuring that the user interface object(s) with the second state (and thus those that are being interacted with or potentially interacted with) are those towards which the user is directing attention, and not those towards which the user is not directing attention, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently (e.g., by avoiding erroneous inputs directed to user interface objects that are no longer within the attention of the user).

In some embodiments, after detecting the first movement of the attention zone and while displaying the third user interface object in the second state (e.g., a hover state) (e.g., because the first predefined portion of the user is within the threshold distance of the location corresponding to the third user interface object), the electronic device detects (1426a), via the one or more input devices, second movement of the attention zone, wherein the third user interface object is no longer within the attention zone as a result of the second movement of the attention zone (e.g., the gaze of the user moves away from the region including the third user interface object such that the attention zone has moved to no longer include the third user interface object). In some embodiments, in response to detecting the second movement of the attention zone (1426b), in accordance with a determination that the first predefined portion of the user is within the threshold distance of the third user interface object (e.g., in some embodiments, also that the first predefined portion of the user is/remains directly or indirectly engaged with the third user interface object as described with reference to methods 800, 1000, 1200, 1600, 1800 and 2000 and/or the first predefined portion of the user is in a predetermined pose as described with reference to method 800), the electronic device maintains (1426c) display of the third user interface object in the second state (e.g., a hover state). For example, in FIG. 13C, if after the attention zone moved to include object 1303c and device 101 displayed object 1303c in the second state, device 101 detected the attention zone move again to not include object 1303c, device 101 would optionally maintain display of object 1303c in the second state. For example, the second state optionally does not move away from a user interface object as a result of the attention zone moving away from that user interface object if the first predefined portion of the user remains within the threshold distance of the location corresponding to that user interface object. In some embodiments, had the first predefined portion of the user been further than the threshold distance from the location corresponding to the third user interface object, the second state would have moved away from the third user interface object (e.g., and the third user interface object would have been displayed in the first state). The above-described manner of maintaining the second state of the user interface object when the first predefined portion of the user is within the threshold distance of that user interface object provides an efficient way for the user to continue interacting with that user interface object while looking and/or interacting with other parts of the user interface, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently.

In some embodiments, in response to detecting the second movement of the attention zone and in accordance with a determination that the first predefined portion of the user is not engaged with the third user interface object (1428a) (e.g., the first predefined portion of the user has ceased to be directly or indirectly engaged with the third user interface object, such as described with reference to methods 800, 1000, 1200, 1600, 1800 and 2000 when or after the attention zone has moved), in accordance with a determination that the first user interface object is within the attention zone, the one or more criteria are satisfied, and the gaze of the user is directed to the first user interface object, the electronic device displays (1428b) the first user interface object in the second state (e.g., a hover state), similar to as illustrated and described with reference to FIG. 13A. In some embodiments, in accordance with a determination that the second user interface object is within the attention zone, the one or more criteria are satisfied, and the gaze of the user is directed to the second user interface object, the electronic device displays (1428c) the second user interface object in the second state (e.g., a hover state). For example, when or after the attention zone moves away from the third user interface object, the electronic device optionally no longer maintains the third user interface object in the second state if the first predefined portion of the user is no longer engaged with the third user interface object. In some embodiments, the electronic device moves the second state amongst the user interface objects of the plurality of user interface objects based on the gaze of the user. The above-described manner of moving the second state if the first predefined portion of the user is no longer engaged with the third user interface object provides an efficient way for the user to be able to interact/engage with other user interface objects, and not locking-in interaction with the third user interface object when the first predefined portion of the user has ceased engagement with the third user interface object, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently.

In some embodiments, while the one or more criteria are satisfied (1430a), before detecting the movement of the first predefined portion of the user and while displaying the first user interface object in the second state (e.g., a hover state), the electronic device detects (1430b), via the eye tracking device, movement of the gaze of the user to the second user interface object, such as gaze 1311b in FIG. 13B (e.g., the gaze of the user intersects with the second user interface object and not the first user interface object, or the gaze of the user is within a threshold distance such as 1, 2, 5, 10 feet of intersecting with the second user interface object and not the first user interface object). In some embodiments, in response to detecting the movement of the gaze of the user to the second user interface object, the electronic device displays (1430c), via the display generation component, the second user interface object in the second state (e.g., a hover state), such as shown with user interface object 1303b in FIG. 13B (e.g., and displaying the first user interface object in the first state). Therefore, in some embodiments, while the first predefined portion of the user is further than the threshold distance from locations corresponding to any user interface objects of the plurality of user interface objects, the electronic device moves the second state from user interface object to user interface object based on the gaze of the user. The above-described manner of moving the second state based on user gaze provides an efficient way for the user to be able to designate user interface objects for further interaction, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently.

In some embodiments, after detecting the movement of the first predefined portion of the user and while displaying the second user interface object in the second state (e.g., a hover state) in accordance with the determination that the first predefined portion of the user is within the threshold distance of the location corresponding to the second user interface object, the electronic device detects (1432a), via the eye tracking device, movement of the gaze of the user to the first user interface object (e.g., and not being directed to the second user interface object), such as gaze 1311a or 1311b in FIG. 13C. In some embodiments, in response to detecting the movement of the gaze of the user to the first user interface object, the electronic device maintains (1432b) display of the second user interface object in the second state (e.g., a hover state), such as shown with user interface object 1303c in FIG. 13C (and maintaining display of the first user interface object in the first state). Therefore, in some embodiments, the electronic device does not move the second state based on user gaze when the second state is based on the first predefined portion of the user being within the threshold distance of the location corresponding to the relevant user interface object. In some embodiments, had the first predefined portion of the user not been within the threshold distance of the location corresponding to the relevant user interface object, the electronic device would have optionally moved the second state to the first user interface object in accordance with the gaze being directed to the first user interface object. The above-described manner of maintaining the second state of the user interface object when the first predefined portion of the user is within the threshold distance of that user interface object provides an efficient way for the user to continue interacting with that user interface object while looking and/or interacting with other parts of the user interface, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently.

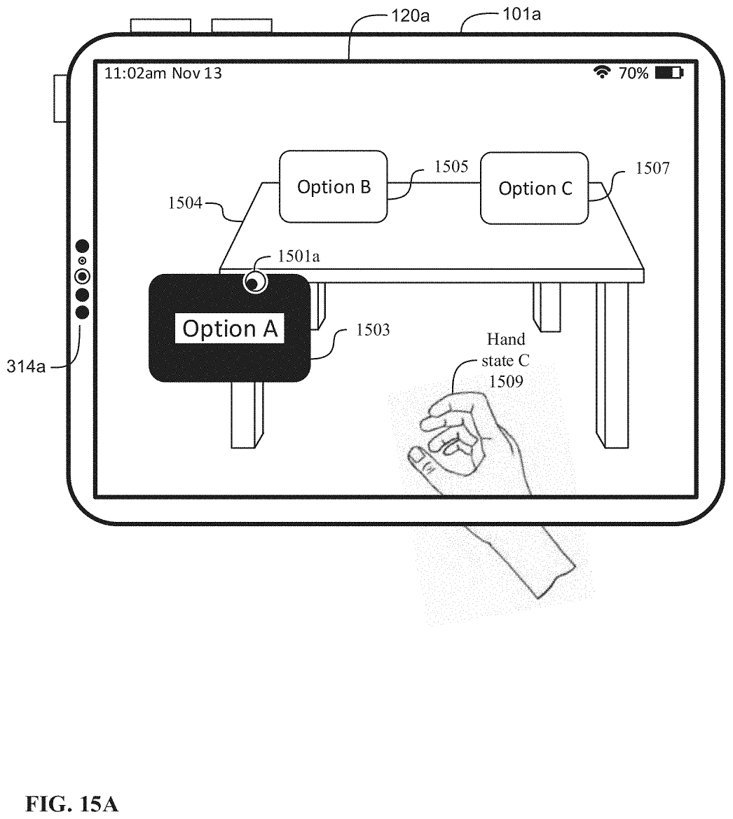

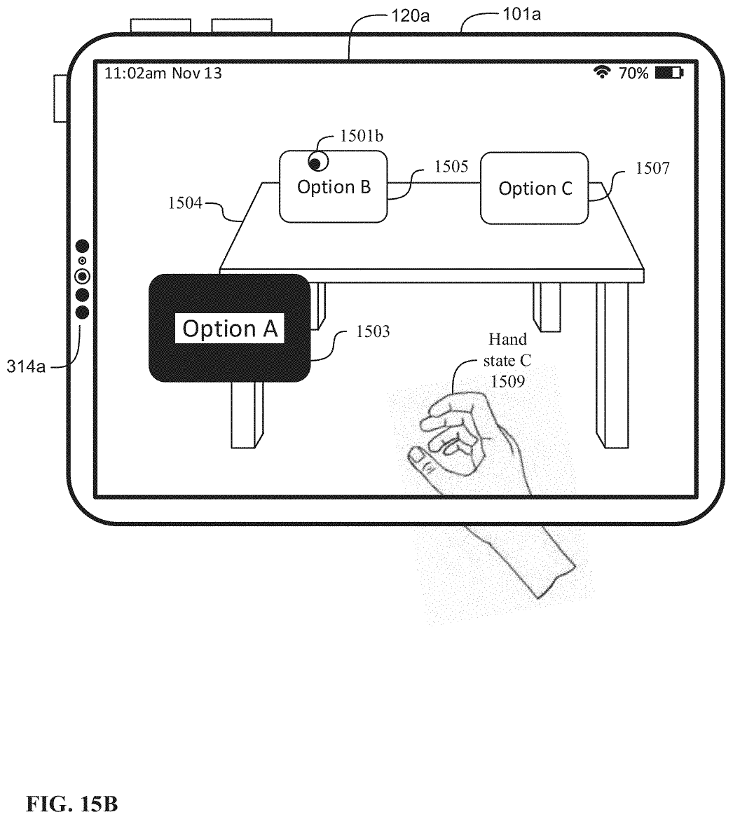

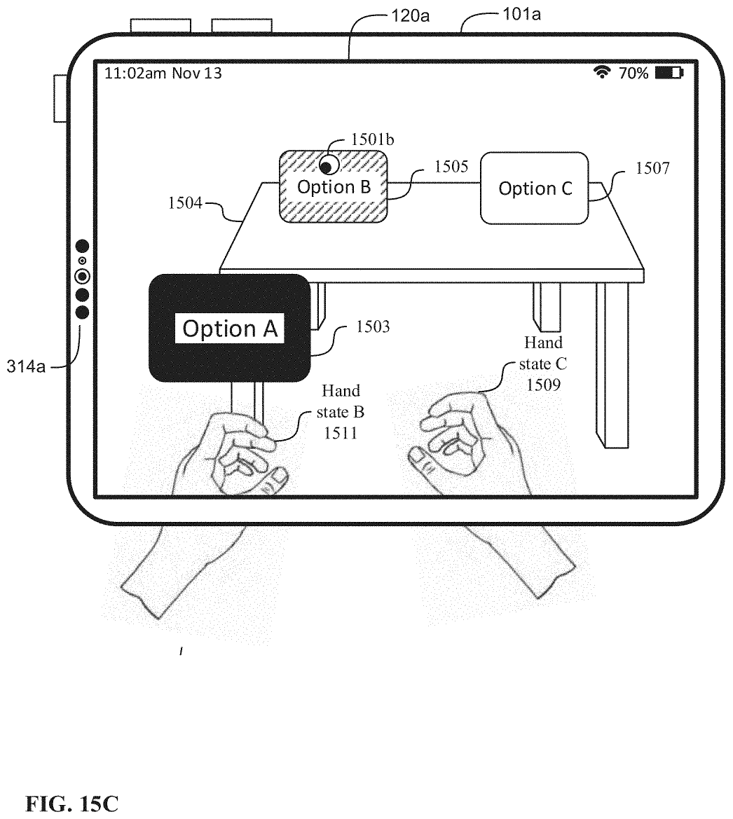

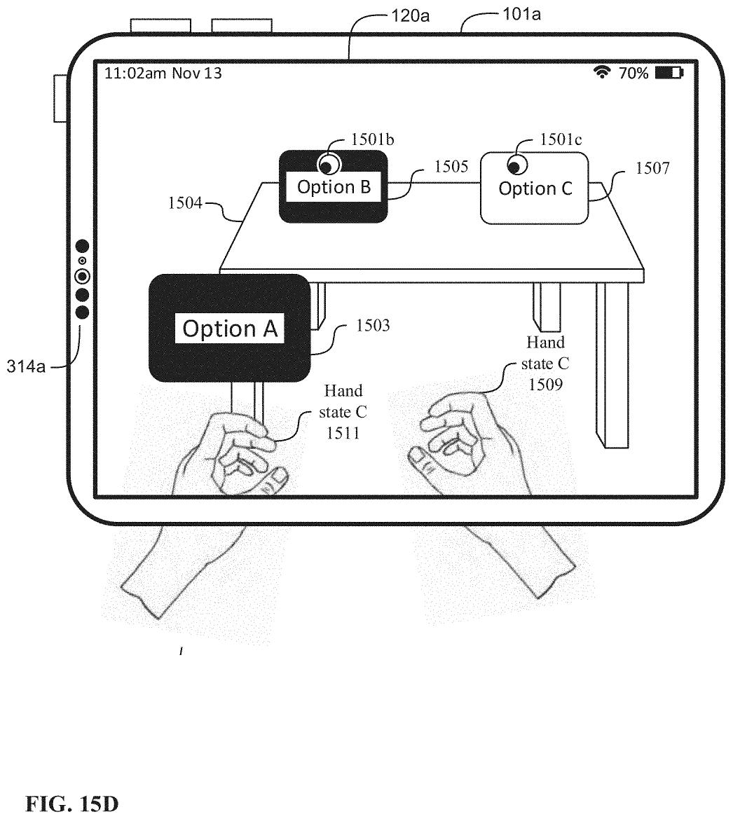

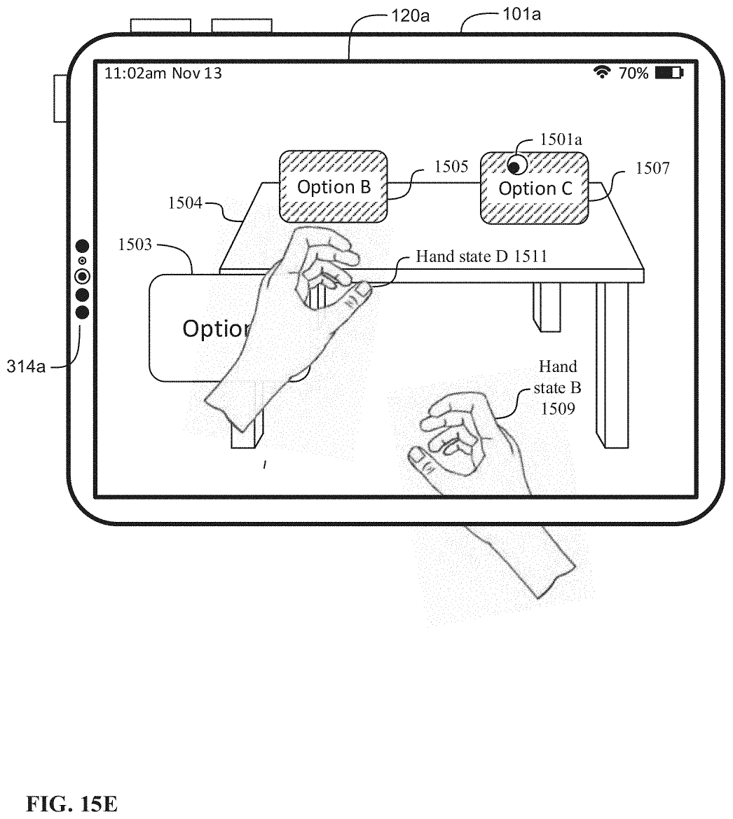

FIGS. 15A-15E illustrate exemplary ways in which an electronic device 101a manages inputs from two of the user's hands according to some embodiments.

FIG. 15A illustrates an electronic device 101a, via display generation component 120a, a three-dimensional environment. It should be understood that, in some embodiments, electronic device 101a utilizes one or more techniques described with reference to FIGS. 15A-15E in a two-dimensional environment or user interface without departing from the scope of the disclosure. As described above with reference to FIGS. 1-6, the electronic device optionally includes display generation component 120a (e.g., a touch screen) and a plurality of image sensors 314a. The image sensors optionally include one or more of a visible light camera, an infrared camera, a depth sensor, or any other sensor the electronic device 101a would be able to use to capture one or more images of a user or a part of the user while the user interacts with the electronic device 101a. In some embodiments, display generation component 120a is a touch screen that is able to detect gestures and movements of a user's hand. In some embodiments, the user interfaces described below could also be implemented on a head-mounted display that includes a display generation component that displays the user interface to the user, and sensors to detect the physical environment and/or movements of the user's hands (e.g., external sensors facing outwards from the user), and/or gaze of the user (e.g., internal sensors facing inwards towards the face of the user).

FIG. 15A illustrates the electronic device 101a displaying a three-dimensional environment. The three-dimensional environment includes a representation 1504 of a table in the physical environment of the electronic device 101a (e.g., such as table 604 in FIG. 6B), a first selectable option 1503, a second selectable option 1505, and a third selectable option 1507. In some embodiments, the representation 1504 of the table is a photorealistic image of the table displayed by display generation component 120a (e.g., video or digital passthrough). In some embodiments, the representation 1504 of the table is a view of the table through a transparent portion of display generation component 120a (e.g., true or physical passthrough). In some embodiments, in response to detecting selection of a respective one of the selectable options 1503, 1505, and 1507, the electronic device 101a performs an action associated with the respective selected option. For example, the electronic device 101a activates a setting, initiates playback of an item of content, navigates to a user interface, initiates communication with another electronic device, or performs another operation associated with the respective selected option.

In FIG. 15A, the user is providing an input directed to the first selectable option 1503 with their hand 1509. The electronic device 101a detects the input in response to detecting the gaze 1501a of the user directed to the first selectable option 1503 and the hand 1509 of the user in a hand state that corresponds to providing an indirect input. For example, the electronic device 101a detects the hand 1509 in a hand shape corresponding to an indirect input, such as a pinch hand shape in which the thumb of hand 1509 is in contact with another finger of the hand 1509. In response to the user input, the electronic device 101a updates display of the first selectable option 1503, which is why the first selectable option 1503 is a different color than the other selectable options 1505 and 1507 in FIG. 15A. In some embodiments, the electronic device 101a does not perform the action associated with the selection input unless and until detecting the end of the selection input, such as detecting the hand 1509 cease making the pinch hand shape.

In FIG. 15B, the user maintains the user input with hand 1509. For example, the user continues to make the pinch hand shape with hand 1509. As shown in FIG. 15B, the user's gaze 1501b is directed to the second selectable option 1505 instead of continuing to be directed to the first selectable option 1503. Even though the gaze 1501b of the user is no longer directed to the first selectable option 1503, the electronic device 101a optionally continues to detect the input from hand 1509 and would optionally perform the action associated with selectable option 1503 in accordance with the input in response to detecting the end of the input (e.g., the user no longer performing the pinch hand shape with hand 1509).

As shown in FIG. 15B, although the gaze 1501b of the user is directed to the second selectable option 1505, the electronic device 101a forgoes updating the appearance of the second option 1505 and does direct input (e.g., from hand 1509) to the second selectable option 1505. In some embodiments, the electronic device 101a does direct input to the second selectable option 1505 because it does not detect a hand of the user (e.g., hand 1509 or the user's other hand) in a hand state that satisfies the ready state criteria. For example, in FIG. 15B, no hands satisfy the ready state criteria because hand 1509 is already indirectly engaged with (e.g., providing an indirect input to) the first user interface element 1503, and thus is not available for input to selectable option 1505, and the user's other hand is not visible to the electronic device 101a (e.g., not detected by the various sensors of device 101a). The ready state criteria are described in more detail above with reference to FIGS. 7A-8K.

In FIG. 15C, the electronic device 101a detects the hand 1511 of the user satisfying the ready state criteria while the gaze 1501b of the user is directed to the second selectable option 1505 and hand 1509 continues to be indirectly engaged with option 1503. For example, the hand 1511 is in a hand shape that corresponds to the indirect ready state (e.g., hand state B), such as the pre-pinch hand shape in which the thumb of hand 1511 is within a threshold distance (e.g., 0.1, 0.5, 1, 2, 3, 5, 10, etc. centimeters) of another finger of hand 1511 without touching the finger. Because the gaze 1501b of the user is directed to the second selectable option 1505 while the hand 1511 satisfies the ready state criteria, the electronic device 101a updates the second selectable option 1505 to indicate that further input provided by hand 1511 will be directed to the second selectable option 1505. In some embodiments, the electronic device 101a detects the ready state of hand 1511 and prepares to direct indirect inputs of hand 1511 to option 1505 while continuing to detect inputs from hand 1509 directed to option 1503.

In some embodiments, the electronic device 500 detects hand 1511 in the indirect ready state (e.g., hand state B) while the gaze 1501a of the user is directed to option 1503 as shown in FIG. 15A and subsequently detects the gaze 1501b of the user on option 1505 as shown in FIG. 15C. In this situation, in some embodiments, the electronic device 101a does not update the appearance of option 1505 and prepare to accept indirect inputs from hand 1511 directed towards option 1505 until the gaze 1501b of the user is directed to option 1505 while hand 1511 is in the indirect ready state (e.g., hand state B). In some embodiments, the electronic device 500 detects the gaze 1501b of the user directed to the option 1505 before detecting hand 1511 in the indirect ready state (e.g., hand state B) as shown in FIG. 15B and then detects hand 1511 in the indirect ready state as shown in FIG. 15C. In this situation, in some embodiments, the electronic device does not update the appearance of option 1505 and prepare to accept indirect inputs from hand 1511 directed towards option 1505 until the hand 1511 in the ready state is detected while the gaze 1501b is directed towards option 1505.

In some embodiments, if the gaze 1501b of the user moves to the third selectable option 1507, the electronic device 101b would revert the second selectable option 1505 to the appearance illustrated in FIG. 15B and would update the third selectable option 1507 to indicate that further input provided by hand 1511 (e.g., and not hand 1509, because hand 1509 is already engaged with and/or providing input to selectable option 1503) would be directed to the third selectable option 1507. Similarly, in some embodiments, if hand 1509 were not engaged with the first selectable option 1503 and was instead in a hand shape that satisfies the indirect ready state criteria (e.g., making the pre-pinch hand shape), the electronic device 101a would direct the ready state of hand 1509 to the selectable option 1503, 1505, or 1507 at which the user is looking (e.g., irrespective of the state of hand 1511). In some embodiments, if only one hand satisfies the indirect ready state criteria (e.g., is in the pre-pinch hand shape) and the other hand is not engaged with a user interface element and does not satisfy the ready state criteria, the electronic device 101a would direct the ready state of the hand in the ready state to the selectable option 1503, 1505, or 1507 at which the user is looking.

In some embodiments, as described above with reference to FIGS. 7A-8K, in addition to detecting indirect ready states, the electronic device 101a also detects direct ready states in which one of the hands of the user is within a threshold distance (e.g., 1, 2, 3, 5, 10, 15, 30, etc.) of a user interface element while in a hand shape corresponding to direct manipulation, such as a pointing hand shape in which one or more fingers are extended and one or more fingers are curled towards the palm of the hand. In some embodiments, the electronic device 101a is able to track a direct ready state associated with each of the user's hands. For example, if hand 1511 were within the threshold distance of the first selectable option 1503 while in the pointing hand shape and hand 1509 were within the threshold distance of the second selectable option 1505 while in the pointing hand shape, the electronic device 101a would direct the direct ready state and any subsequent direct input(s) of hand 1511 to the first selectable option 1503 and direct the direct ready state and any subsequent direct input(s) of hand 1509 to the second selectable option 1505. In some embodiments, the direct ready state is directed to the user interface element of which the hand is within the threshold distance, and moves in accordance with movement of the hand. For example, if hand 1509 moves from being within the threshold distance of the second selectable option 1505 to being within the threshold distance of the third selectable option 1507, the electronic device 101a would move the direct ready state from the second selectable option 1505 to the third selectable option 1507 and direct further direct input of hand 1509 to the third selectable option 1509.

In some embodiments, the electronic device 101a is able to detect a direct ready state (or direct input) from one hand and an indirect ready state from the other hand that is directed to the user interface element to which the user is looking when the other hand satisfies the indirect ready state criteria. For example, if hand 1511 were in the direct ready state or providing a direct input to the third selectable option 1503 and hand 1509 were in the hand shape that satisfies the indirect ready state criteria (e.g., pre-pinch hand shape), the electronic device 101a would direct the indirect ready state of hand 1509 and any subsequent indirect input(s) of hand 1509 detected while the gaze of the user continues to be directed to the same user interface element to the user interface element to which the user is looking. Likewise, for example, if hand 1509 were in the direct ready state or providing a direct input to the third selectable option 1503, and hand 1511 were in the hand shape that satisfies the indirect ready state criteria (e.g., pre-pinch hand shape), the electronic device 101a would direct the indirect ready state of hand 1511 and any subsequent indirect input(s) of hand 1511 detected while the gaze of the user continues to be directed to the same user interface element to the user interface element to which the user is looking.

In some embodiments, the electronic device 101a ceases to direct an indirect ready state to the user interface element towards which the user is looking in response to detecting a direct input. For example, in FIG. 15C, if hand 1511 were to initiate a direct interaction with the third selectable option 1507 (e.g., after having been in an indirect interaction state with selectable option 1505), the electronic device 101a would cease displaying the second selectable option 1505 with the appearance that indicates that the indirect ready state of hand 1511 is directed to the second selectable option 1505, and would update the third selectable option 1507 in accordance with the direct input provided. For example, if the hand 1511 were within the direct ready state threshold distance (e.g., 1, 2, 3, 5, 10, 15, 30, etc. centimeters) of the third selectable option 1507, the electronic device 101a would update the third selectable option 1507 to indicate that further direct input of hand 1511 will be directed to the third selectable option 1507. As another example, if the hand 1511 were within the direct input threshold distance (e.g., 0.05, 0.1, 0.3, 0.5, 1, 2, etc. centimeters) of the third selectable option 1507 and directly engaged with (e.g., providing a direct input to) the third selectable option 1507, the electronic device 101a would update the appearance of the third selectable option 1507 to indicate that the direct input is being provided to the third selectable option 1507.

In some embodiments, if the hand 1511 no longer satisfies the ready state criteria, the electronic device 101a would cease to direct the ready state to the user interface element at which the user is looking. For example, if the hand 1511 is neither engaged with one of the selectable options 1503, 1505, and 1507 nor in a hand shape that satisfies the indirect ready state criteria, the electronic device 101a ceases to direct the ready state associated with hand 1511 to the selectable option 1503, 1505, or 1507 at which the user is looking but would continue to maintain the indirect interaction of hand 1509 with option 1503. For example, if the hand 1511 is no longer visible to the electronic device 101b such as in FIG. 15B, the electronic device 101a would revert the appearance of the second selectable option 1505 as shown in FIG. 15B. As another example, if the hand 1511 is indirectly engaged with one of the user interface elements while hand 1509 is engaged with the first selectable option 1503, the electronic device 101a would not direct the ready state to another user interface element based on the gaze of the user, as will be described below with reference to FIG. 15D.

For example, in FIG. 15D, the electronic device 101a detects indirect inputs directed to the first selectable option 1503 (e.g., provided by hand 1509) and the second selectable option 1505 (e.g., provided by hand 1511). As shown in FIG. 15D, the electronic device 101a updates the appearance of the second selectable option 1505 from the appearance of the second selectable option 1505 in FIG. 15C to indicate that an indirect input is being provided to the second selectable option 1505 by hand 1513. In some embodiments, the electronic device 101a directs the input to the second selectable option 1505 in response to detecting the gaze 1501b of the user directed to the second selectable option 1505 while detecting the hand 1513 of the user in a hand shape that corresponds to an indirect input (e.g., a pinch hand shape). In some embodiments, the electronic device 101a performs an action in accordance with the input directed to the second selectable option 1505 when the input is complete. For example, an indirect selection input is complete after detecting the hand 1513 ceasing to make the pinch gesture.

In some embodiments, when both hands 1513 and 1509 are engaged with user interface elements (e.g., the second selectable option 1505 and the first selectable option 1503, respectively), the electronic device 101a does not direct a ready state to another user interface element in accordance with the gaze of the user (e.g., because device 101a does not detect any hands available for interaction with selectable option 1507). For example, in FIG. 15D, the user directs their gaze 1501c to the third selectable option 1507 while hands 1509 and 1513 are indirectly engaged with other selectable options, and the electronic device 101a forgoes updating the third selectable option 1507 to indicate that further input will be directed to the third selectable option 1507.

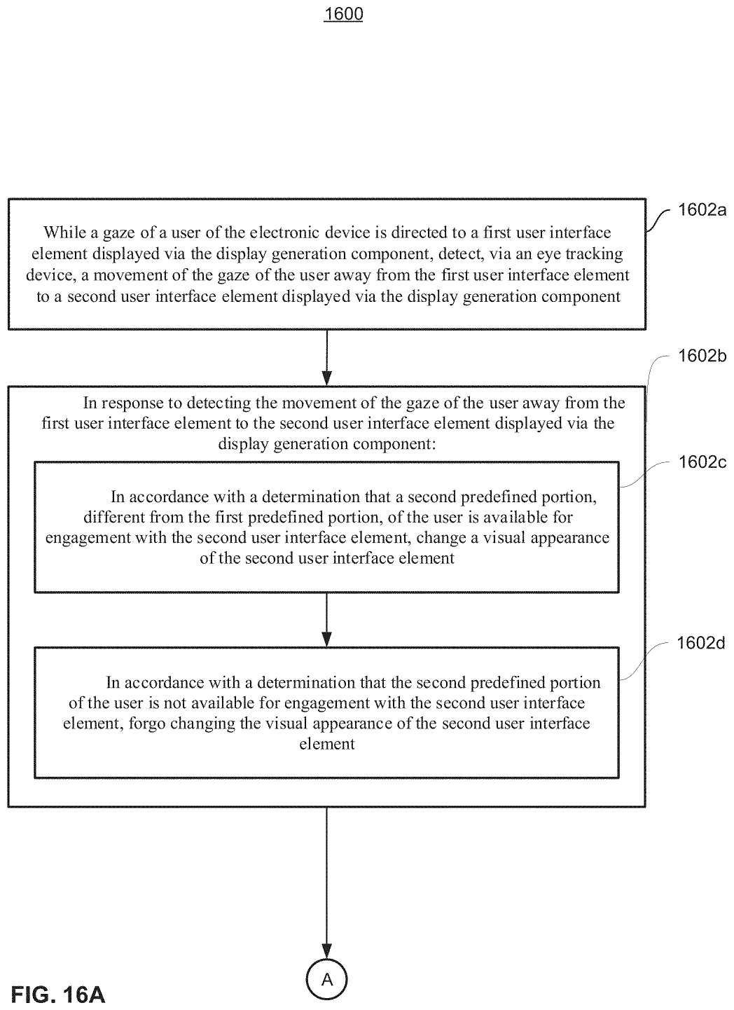

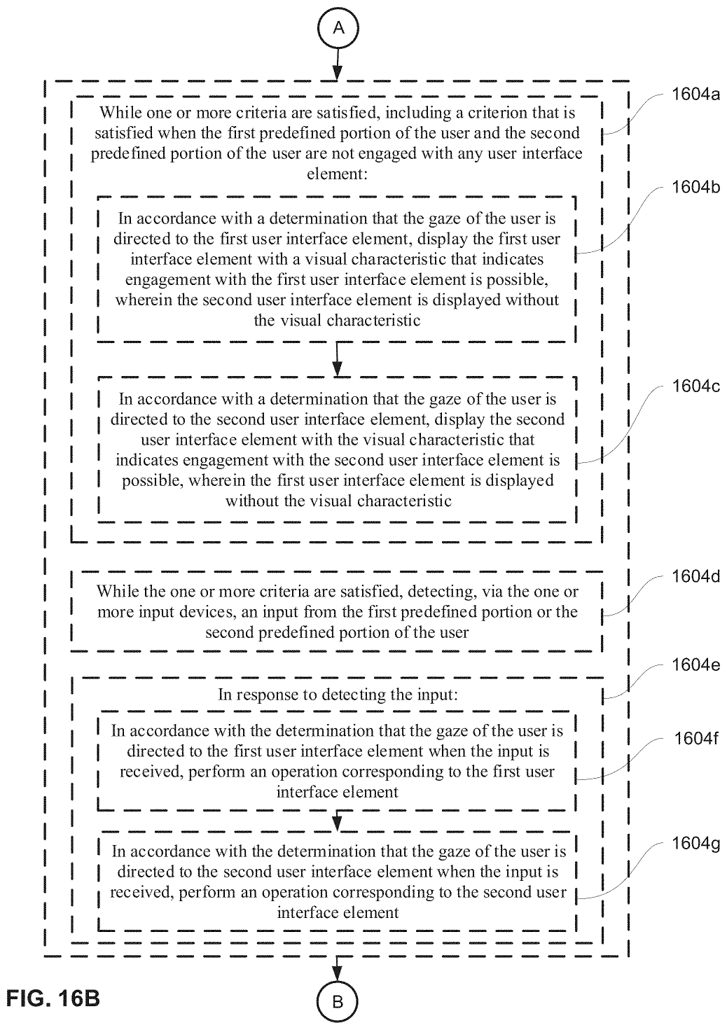

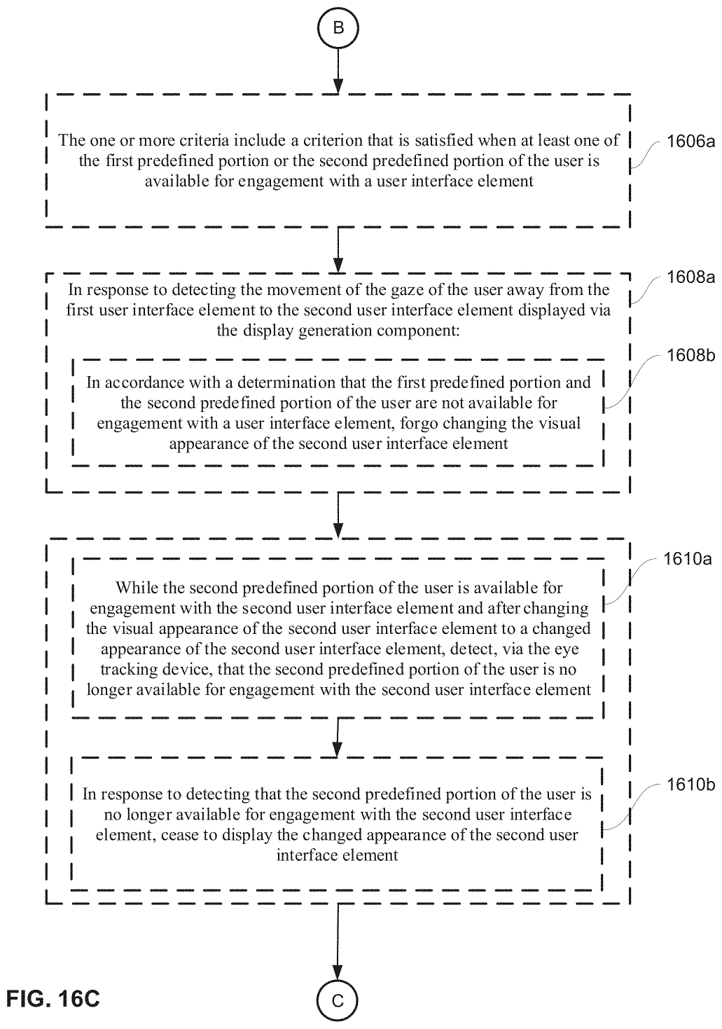

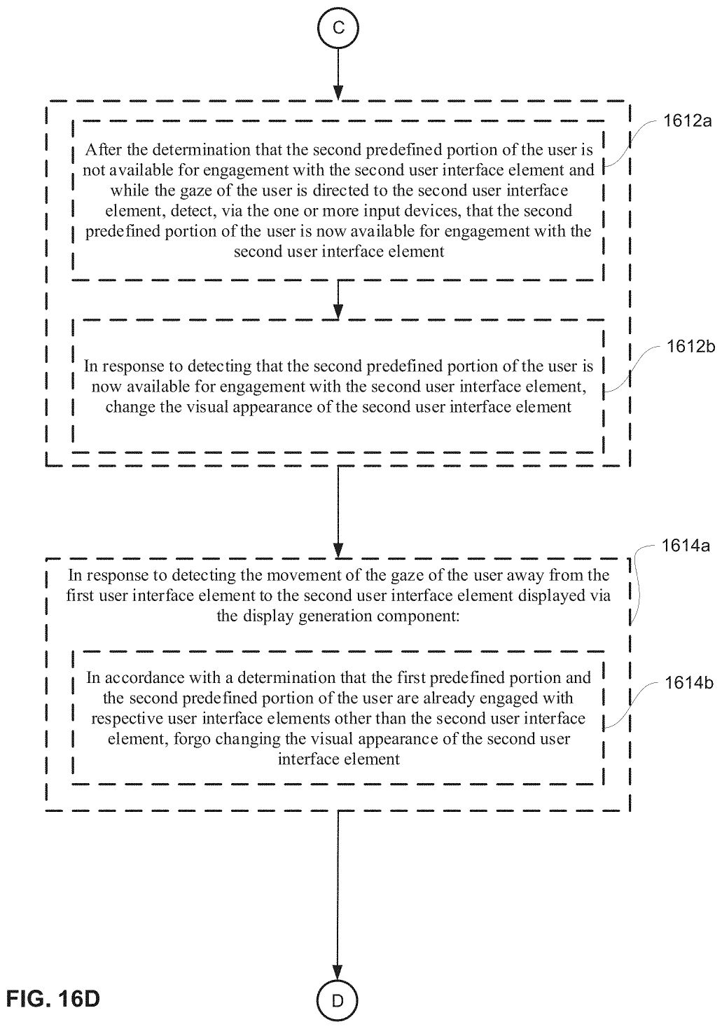

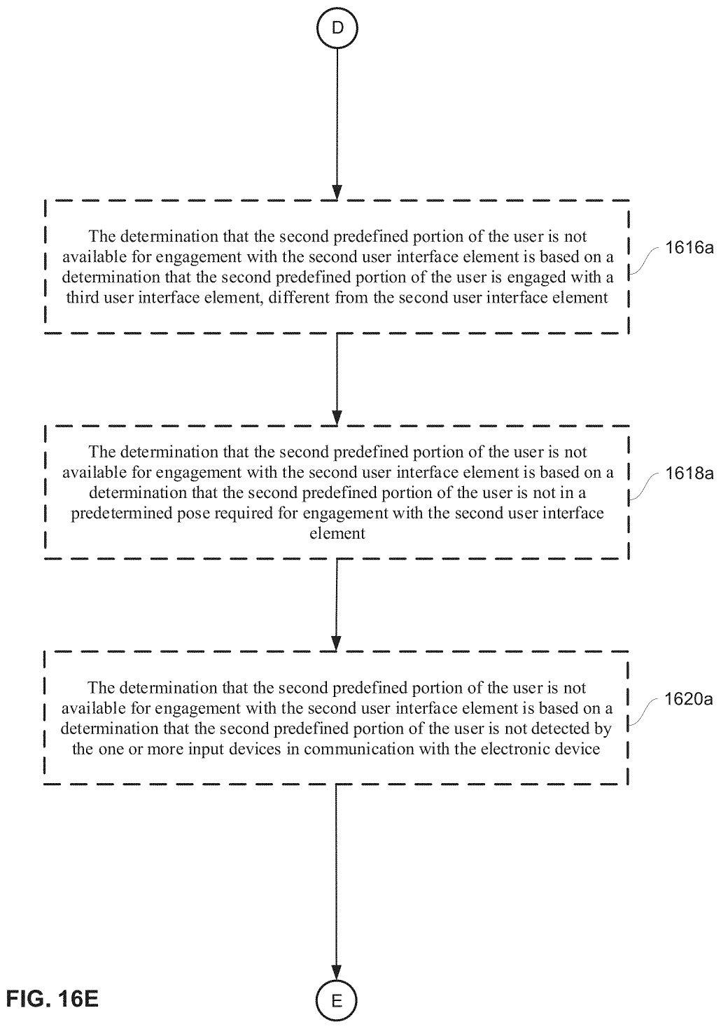

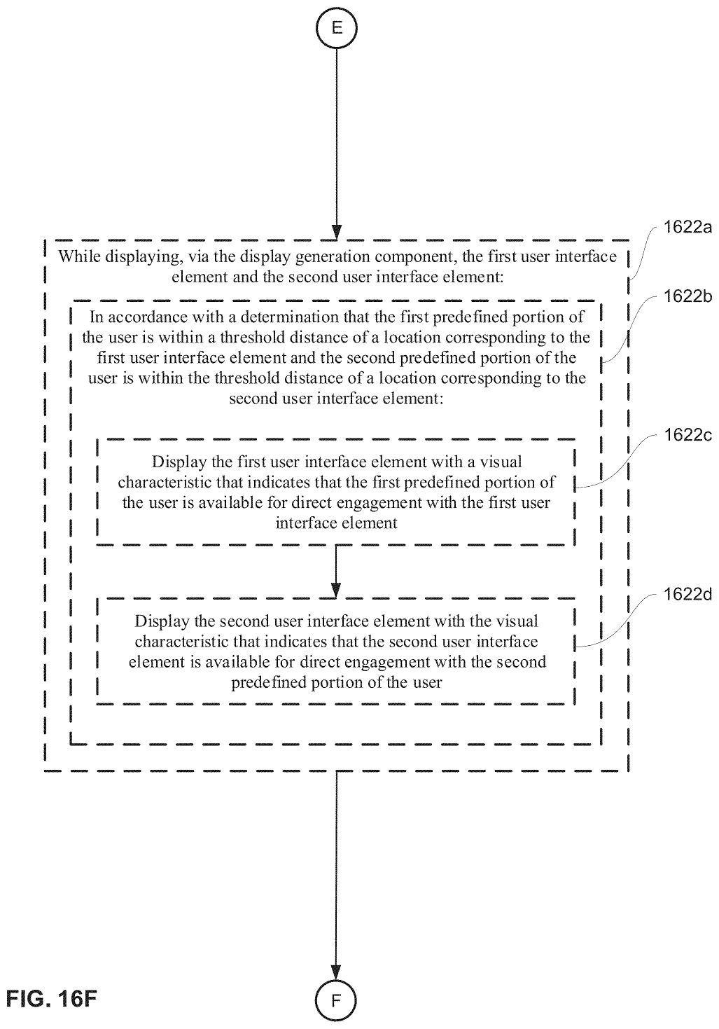

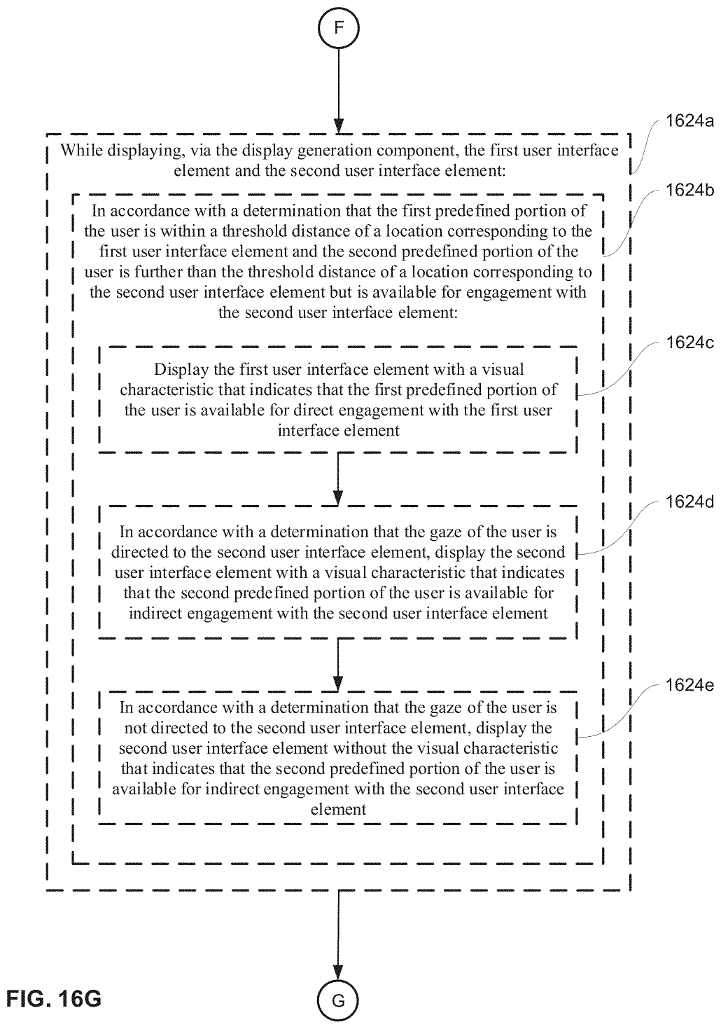

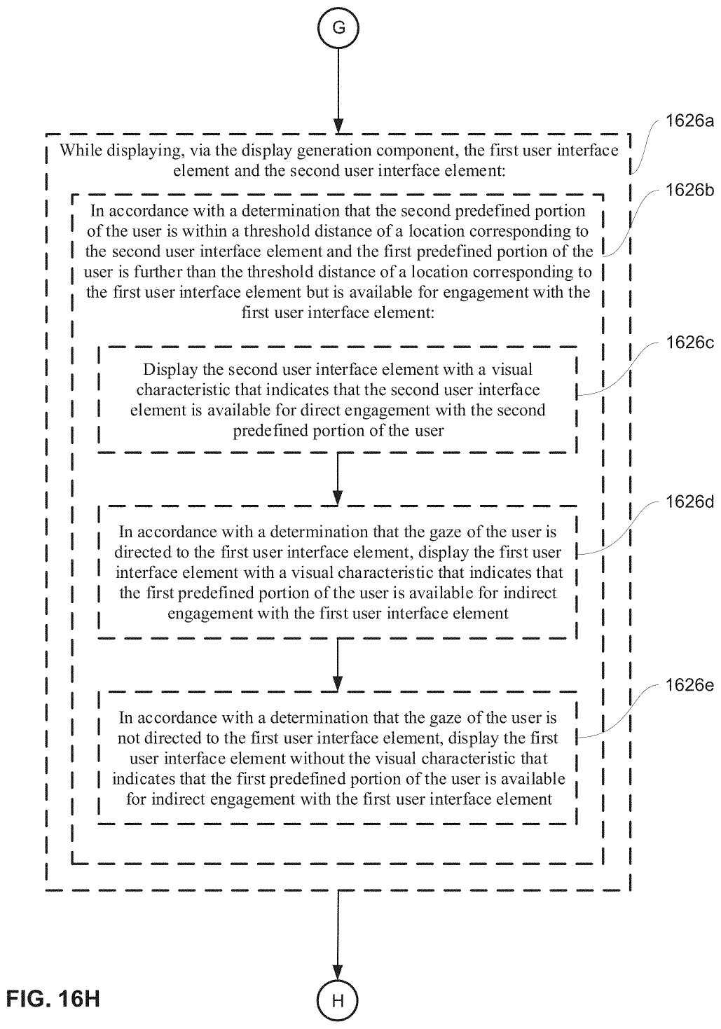

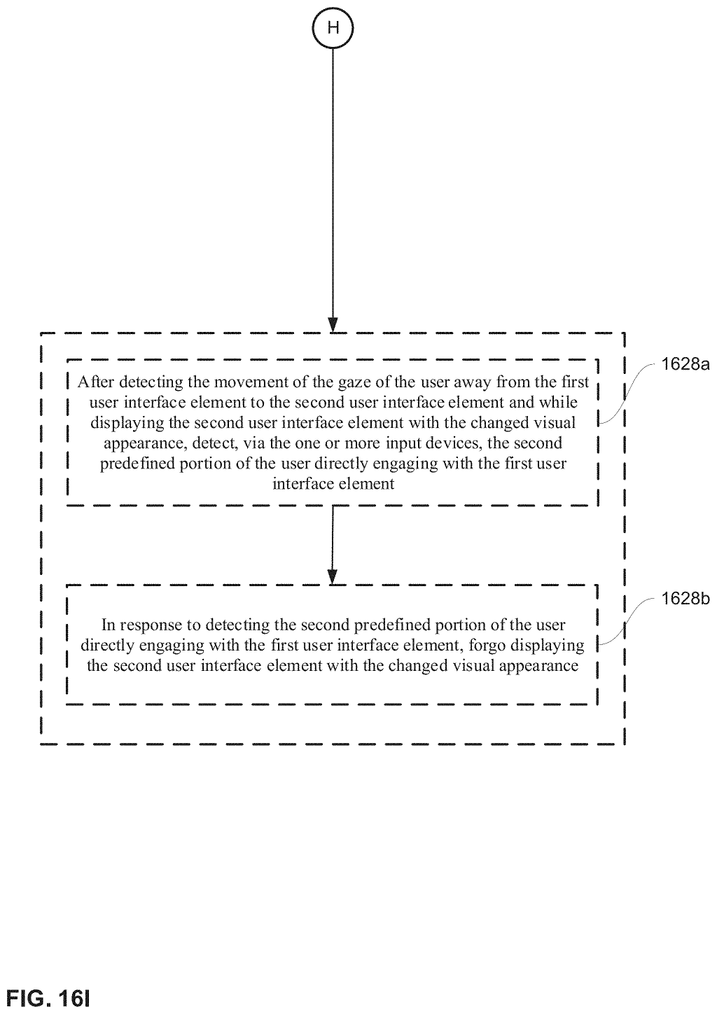

FIGS. 16A-16I is a flowchart illustrating a method 1600 of managing inputs from two of the user's hands according to some embodiments. In some embodiments, the method 1600 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, a projector, etc.) and one or more cameras (e.g., a camera (e.g., color sensors, infrared sensors, and other depth-sensing cameras) that points downward at a user's hand or a camera that points forward from the user's head). In some embodiments, the method 1600 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1600 are, optionally, combined and/or the order of some operations is, optionally, changed.

In some embodiments, method 1600 is performed at an electronic device in communication with a display generation component and one or more input devices, including an eye tracking device (e.g., a mobile device (e.g., a tablet, a smartphone, a media player, or a wearable device), or a computer). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. In some embodiments, the one or more input devices include an electronic device or component capable of receiving a user input (e.g., capturing a user input, detecting a user input, etc.) and transmitting information associated with the user input to the electronic device. Examples of input devices include a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera, a depth sensor, an eye tracking device, and/or a motion sensor (e.g., a hand tracking device, a hand motion sensor), etc. In some embodiments, the electronic device is in communication with a hand tracking device (e.g., one or more cameras, depth sensors, proximity sensors, touch sensors (e.g., a touch screen, trackpad). In some embodiments, the hand tracking device is a wearable device, such as a smart glove. In some embodiments, the hand tracking device is a handheld input device, such as a remote control or stylus.

In some embodiments, while a gaze (e.g., 1501a) of a user of the electronic device 101a is directed to a first user interface element (e.g., 1503) displayed via the display generation component, such as in FIG. 15A (e.g., and while a first predefined portion of the user (e.g., a first hand, finger, or arm of the user, such as the right hand of the user) is engaged with the first user interface element (e.g., such as described with reference to methods 800, 1000, 1200, 1400, 1800, and/or 2000)), the electronic device 101a detects (1602a), via the eye tracking device, a movement of the gaze (e.g., 1501b) of the user away from the first user interface element (e.g., 1503) to a second user interface element (e.g., 1505) displayed via the display generation component. In some embodiments, the predefined portion of the user is indirectly engaged with the first user interface element in accordance with a determination that a pose (e.g., position, orientation, hand shape) of the predefined portion of the user satisfies one or more criteria. For example, a hand of the user is indirectly engaged with the first user interface element in response to detecting that the hand of the user is oriented with the palm away from the user's torso, positioned at least a threshold distance (e.g., 3, 5, 10, 20, 30, etc. centimeters) away from the first user interface element, and making a predetermined hand shape or in a predetermined pose. In some embodiments, the predetermined hand shape is a pre-pinch hand shape in which the thumb of the hand is within a threshold distance (e.g., 0.5, 1, 2, etc. centimeters) of another finger (e.g., index, middle, ring, little finger) of the same hand without touching the finger. In some embodiments, the predetermined hand shape is a pointing hand shape in which one or more fingers of the hand are extended and one or more fingers of the hand are curled towards the palm. In some embodiments, detecting the pointing hand shape includes detecting that the user is pointing at the second user interface element. In some embodiments, the pointing hand shape is detected irrespective of where the user is pointing (e.g., the input is directed based on the user's gaze rather than based on the direction in which the user is pointing). In some embodiments, the first user interface element and second user interface element are interactive user interface elements and, in response to detecting an input directed towards the first user interface element or the second user interface element, the electronic device performs an action associated with the first user interface element of the second user interface element, respectively. For example, the first user interface element is a selectable option that, when selected, causes the electronic device to perform an action, such as displaying a respective user interface, changing a setting of the electronic device, or initiating playback of content. As another example, the second user interface element is a container (e.g., a window) in which a user interface is displayed and, in response to detecting selection of the second user interface element followed by a movement input, the electronic device updates the position of the second user interface element in accordance with the movement input. In some embodiments, the first user interface element and the second user interface element are the same types of user interface elements (e.g., selectable options, items of content, windows, etc.). In some embodiments, the first user interface element and second user interface element are different types of user interface elements. In some embodiments, in response to detecting the indirect engagement of the predetermined portion of the user with the first user interface element while the user's gaze is directed to the first user interface element, the electronic device updates the appearance (e.g., color, size, position) of the user interface element to indicate that additional input (e.g., a selection input) will be directed towards the first user interface element, such as described with reference to methods 800, 1200, 1800, and/or 2000. In some embodiments, the first user interface element and the second user interface element are displayed in a three-dimensional environment (e.g., a user interface including the elements is the three-dimensional environment and/or is displayed within a three-dimensional environment) that is generated, displayed, or otherwise caused to be viewable by the device (e.g., a computer-generated reality (CGR) environment such as a virtual reality (VR) environment, a mixed reality (MR) environment, or an augmented reality (AR) environment, etc.

In some embodiments, such as in FIG. 15C, in response to detecting the movement of the gaze (e.g., 1501b) of the user away from the first user interface element (e.g., 1503) to the second user interface element (e.g., 1505) displayed via the display generation component (1602b), in accordance with a determination that a second predefined portion (e.g., 1511) (e.g., a second finger, hand, or arm of the user, such as the left hand of the user), different from the first predefined portion (e.g., 1509), of the user is available for engagement with the second user interface element (e.g., 1505) (e.g., such as described with reference to method 800), the electronic device 101a changes (1602c) a visual appearance (e.g., color, size, position) of the second user interface element (e.g., 1505). In some embodiments, the first predefined portion of the user is a first hand of the user and the second predefined portion of the user is a second hand of the user. In some embodiments, in response to detecting the first predefined portion of the user indirectly engaged with the first user interface element while the gaze of the user is directed towards the first user interface element, the electronic device changes the visual appearance of the first user interface element. In some embodiments, the second predefined portion of the user is available for engagement with the second user interface element in response to detecting a pose of the second predefined portion that satisfies one or more criteria while the second predefined portion is not already engaged with another (e.g., a third) user interface element. In some embodiments, the pose and location of the first predefined portion of the user is the same before and after detecting the movement of the gaze of the user away from the first user interface element to the second user interface element. In some embodiments, the first predefined portion of the user remains engaged with the first user interface element (e.g., input provided by the first predefined portion of the user still interacts with the first user interface element) while and after changing the visual appearance of the second user interface element. In some embodiments, in response to detecting the gaze of the user move from the first user interface element to the second user interface element, the first predefined portion of the user is no longer engaged with the first user interface element (e.g., input provided by the first predefined portion of the user does not interact with the first user interface element). For example, while the first predefined portion of the user is no longer engaged with the first user interface element, the electronic device forgoes performing operations in response to input provided by the first predefined portion of the user or performs operations with the second user interface element in response to input provided by the first predefined portion of the user. In some embodiments, in response to detecting the user's gaze on the second user interface element and that the second predefined portion of the user is available for engagement with the second user interface element, the second predefined portion of the user becomes engaged with the second user interface element. In some embodiments, while the second predefined portion of the user is engaged with the second user interface element, inputs provided by the second predefined portion of the user cause interactions with the second user interface element.

In some embodiments, such as in FIG. 15B, in response to detecting the movement of the gaze (e.g., 1501b) of the user away from the first user interface element (e.g., 1503) to the second user interface element (e.g., 1505) displayed via the display generation component (1602b), in accordance with a determination that the second predefined portion of the user is not available for engagement with the second user interface element (e.g., 1501b) (e.g., such as described with reference to method 800), the electronic device 101a forgoes (1602d) changing the visual appearance of the second user interface element (e.g., 1501b). In some embodiments, the electronic device maintains display of the second user interface element without changing the visual appearance of the second user interface element. In some embodiments, the second predefined portion of the user is not available for engagement with the second user interface element if the electronic device is unable to detect the second predefined portion of the user, if a pose of the second predefined portion of the user fails to satisfy one or more criteria, or if the second predefined portion of the user is already engaged with another (e.g., a third) user interface element. In some embodiments, the pose and location of the first predefined portion of the user is the same before and after detecting the movement of the gaze of the user away from the first user interface element to the second user interface element. In some embodiments, the first predefined portion of the user remains engaged with the first user interface element (e.g., input provided by the first predefined portion of the user still interacts with the first user interface element) while and after detecting the gaze of the user move from the first user interface element to the second user interface element. In some embodiments, in response to detecting the gaze of the user move from the first user interface element to the second user interface element, the first predefined portion of the user is no longer engaged with the first user interface element (e.g., input provided by the first predefined portion of the user does not interact with the first user interface element). For example, while the first predefined portion of the user is no longer engaged with the first user interface element, the electronic device forgoes performing operations in response to input provided by the first predefined portion of the user or performs operations with the second user interface element in response to input provided by the first predefined portion of the user. In some embodiments, in response to detecting the user's gaze on the second user interface element and that the second predefined portion of the user is not available for engagement with the second user interface element, the second predefined portion of the user does not become engaged with the second user interface element. In some embodiments, while the second predefined portion of the user is not engaged with the second user interface element, inputs provided by the second predefined portion of the user do not cause interactions with the second user interface element. In some embodiments, in response to detecting inputs provided by the second predefined portion of the user while the second predefined portion of the user is not engaged with the second user interface element, the electronic device forgoes performing an operation in response to the input if the second predefined portion of the user is not engaged with any user interface elements presented by the electronic device. In some embodiments, if the second predefined portion of the user is not engaged with the second user interface element because it is engaged with a third user interface element, in response to detecting an input provided by the second predefined portion of the user, the electronic device performs an action in accordance with the input with the third user interface element.

The above-described manner of changing the visual appearance of the second user interface element in response to detecting the gaze of the user move from the first user interface element to the second user interface element while the second predefined portion of the user is available for engagement provides an efficient way of using multiple portions of the user to engage with multiple user interface elements, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, while one or more criteria are satisfied, including a criterion that is satisfied when the first predefined portion of the user (e.g., 1509) and the second predefined portion (e.g., 1511) of the user are not engaged with any user interface element (1604a) (e.g., the electronic device is not currently detecting direct or indirect inputs provided by the first or second predefined portions of the user), in accordance with a determination that the gaze (e.g., 1501b) of the user is directed to the first user interface element (e.g., 1505), the electronic device 101a displays (1604b) the first user interface element (e.g., 1505) with a visual characteristic that indicates engagement (e.g., direct or indirect engagement) with the first user interface element (e.g., 1505) is possible, wherein the second user interface element (e.g., 1507) is displayed without the visual characteristic, such as in FIG. 15C. In some embodiments, displaying the first user interface element with the visual characteristic that indicates that engagement with the first user interface element is possible includes updating a size, color, position, or other visual characteristic of the first user interface element compared to the appearance of the first user interface element prior to detecting the gaze of the user directed to the first user interface element while the one or more criteria are satisfied. In some embodiments, in response to detecting the one or more criteria are satisfied and the gaze of the user is directed to the first user interface element, the electronic device maintains display of the second user interface element with the visual characteristics with which the second user interface element was displayed prior to detecting the gaze of the user directed to the first user interface element while the one or more criteria are satisfied. In some embodiments, in response to detecting the gaze of the user move from the first user interface element to the second user interface element while the one or more criteria are satisfied, the electronic device displays the second user interface element with the visual characteristic that indicates engagement with the second user interface element is possible and displays the first user interface element without the visual characteristic. In some embodiments, the one or more criteria further include a criterion that is satisfied when the electronic device detects the first or second predefined portions of the user in the ready state according to one or more steps of method 800.

In some embodiments, while one or more criteria are satisfied, including a criterion that is satisfied when the first predefined portion (e.g., 1509) of the user and the second predefined portion (e.g., 1511) of the user are not engaged with any user interface element (1604a), in accordance with a determination that the gaze (e.g., 1501b) of the user is directed to the second user interface element (e.g., 1505), the electronic device 101a displays (1604c) the second user interface element (e.g., 1505) with the visual characteristic that indicates engagement (e.g., direct or indirect engagement) with the second user interface element is possible, wherein the first user interface element (e.g., 1507) is displayed without the visual characteristic, such as in FIG. 15C. In some embodiments, displaying the second user interface element with the visual characteristic that indicates that engagement with the second user interface element is possible includes updating a size, color, position, or other visual characteristic of the second user interface element compared to the appearance of the second user interface element prior to detecting the gaze of the user directed to the second user interface element while the one or more criteria are satisfied. In some embodiments, in response to detecting the one or more criteria are satisfied and the gaze of the user is directed to the second user interface element, the electronic device maintains display of the first user interface element with the visual characteristics with which the first user interface element was displayed prior to detecting the gaze of the user directed to the second user interface element while the one or more criteria are satisfied. In some embodiments, in response to detecting the gaze of the user move from the second user interface element to the first user interface element while the one or more criteria are satisfied, the electronic device displays the first user interface element with the visual characteristic that indicates engagement with the first user interface element is possible and displays the second user interface element without the visual characteristic.

In some embodiments, such as in FIG. 15C, while the one or more criteria are satisfied, the electronic device 101a detects (1604d), via the one or more input devices, an input (e.g., a direct or indirect input) from the first predefined portion (e.g., 1509) or the second predefined portion of the user (e.g., 1511). In some embodiments, prior to detecting an input from the first or second predefined portions of the user, the electronic device detects that the same predefined portion of the user is in the ready state according to method 800. For example, the electronic device detects the user making a pre-pinch hand shape with their right hand while the right hand is further than a threshold distance (e.g., 1, 3, 5, 10, 15, 30, etc. centimeters) from the user interface elements followed by detecting the user making a pinch hand shape with their right hand while the right hand is further than the threshold distance from the user interface elements. As another example, the electronic device detects the user making a pointing hand shape with their left hand while the left hand is within a first threshold distance (e.g., 1, 3, 5, 10, 15, 30, etc. centimeters) of a respective user interface element followed by detecting the user move their left hand within a second threshold distance (e.g., 0.1, 0.2, 0.3, 0.5, 1, 2, 3, etc. centimeters) of the respective user interface element while maintaining the pointing hand shape.

In some embodiments, such as in FIG. 15A, in response to detecting the input (1604e), in accordance with the determination that the gaze (e.g., 1501a) of the user is directed to the first user interface element (e.g., 1503) when the input is received, the electronic device 101a performs (1604f) an operation corresponding to the first user interface element (e.g., 1503) (e.g., selecting the first user interface element, navigating to a user interface associated with the first user interface element, initiating playback of an item of content, activating or deactivating a setting, initiating or terminating communication with another electronic device, scrolling the content of the first user interface element, etc.).

In some embodiments, such as in FIG. 15A, in response to detecting the input (1604e), in accordance with the determination that the gaze (e.g., 1501a) of the user is directed to the second user interface element (e.g., 1503) when the input is received, the electronic device 101a performs (1604g) an operation corresponding to the second user interface element (e.g., 1503) (e.g., selecting the first user interface element, navigating to a user interface associated with the first user interface element, initiating playback of an item of content, activating or deactivating a setting, initiating or terminating communication with another electronic device, scrolling the content of the second user interface element, etc.). In some embodiments, the electronic device directs the input to the user interface element towards which the user is looking when the input is received.

The above-described manner of updating the visual characteristic of the user interface element towards which the user is looking and directing an input towards the user interface element towards which the user is looking provides an efficient way of allowing the user to use either hand to interact with the user interface, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 15C, the one or more criteria include a criterion that is satisfied when at least one of the first predefined portion (e.g., 1511) or the second predefined portion (e.g., 1509) of the user is available for engagement (e.g., direct or indirect engagement) with a user interface element (e.g., 1606a). In some embodiments, the criterion is satisfied when the first and/or second predefined portions of the user are in the ready state according to method 800. In some embodiments, the one or more criteria are satisfied regardless of whether one or both of the first and second predefined portions of the user are available for engagement. In some embodiments, the first and second predefined portions of the user are the hands of the user.

The above-described manner of indicating that one of the user interface elements is available for engagement in response to one or more criteria including a criterion that is satisfied when the first or second predefined portion of the user is available for engagement with a user interface element provides an efficient way of indicating which user interface element an input will be directed towards when a predefined portion of the user is available to provide the input, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 15B, in response to detecting the movement of the gaze (e.g., 1501b) of the user away from the first user interface element (e.g., 1503) to the second user interface element (e.g., 1505) displayed via the display generation component (1608a), in accordance with a determination that the first predefined portion (e.g., 1509) and the second predefined portion (e.g., 1511 in FIG. 15C) of the user are not available for engagement (e.g., direct or indirect engagement) with a user interface element, the electronic device 101a forgoes (1608b) changing the visual appearance of the second user interface element (e.g., 1501b), such as in FIG. 15B. In some embodiments, a predefined portion of the user is not available for engagement when the input devices (e.g., hand tracking device, one or more cameras, etc.) in communication with the electronic device do not detect the predefined portion of the user, when the predefined portion(s) of the user are engaged with (e.g., providing an input directed towards) another user interface element(s), or is/are not in the ready state according to method 800. For example, if the right hand of the user is currently providing a selection input to a respective user interface element and the left hand of the user is not detected by the input devices in communication with the electronic device, the electronic device forgoes updating the visual appearance of the second user interface element in response to detecting the gaze of the user move from the first user interface element to the second user interface element.

The above-described manner of forgoing updating the visual appearance of the second user interface element when neither predefined portion of the user is available for engagement provides an efficient way of only indicating that an input will be directed to the second user interface element if a predefined portion of the user is available to provide an input, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, while the second predefined portion (e.g., 1511) of the user is available for engagement (e.g., direct or indirect engagement) with the second user interface element, such as in FIG. 15C, and after changing the visual appearance of the second user interface element (e.g., 1505) to a changed appearance of the second user interface element (e.g., 1505), the electronic device 101a detects (1610a), via the eye tracking device, that the second predefined portion (e.g., 1511) of the user is no longer available for engagement (e.g., direct or indirect engagement) with the second user interface element (e.g., 1505), such as in FIG. 15B (e.g., while the gaze of the user remains on the second user interface element). In some embodiments, the second predefined portion of the user is no longer available for engagement because the input devices in communication with the electronic device no longer detect the second predefined portion of the user (e.g., the second predefined portion of the user is outside of the “field of view” of the one or more input devices that detect the second predefined portion of the user), the second predefined portion of the user becomes engaged with a different user interface element, or the second predefined portion of the user ceases to be in the ready state according to method 800. For example, in response to detecting the hand of the user transitions from making a hand shape associated with the ready state to making a hand shape not associated with the ready state, the electronic device determines that the hand of the user is not available for engagement with the second user interface element.

In some embodiments, such as in FIG. 15B, in response to detecting that the second predefined portion (e.g., 1511 in FIG. 15C) of the user is no longer available for engagement (e.g., direct or indirect engagement) with the second user interface element (e.g., 1505), the electronic device 101a ceases (1610b) to display the changed appearance of the second user interface element (e.g., 1505) (e.g., displaying the second user interface element without the changed appearance and/or displaying the second user interface element with the appearance it had before it was displayed with the changed appearance). In some embodiments, the electronic device displays the second user interface element with the same visual appearance with which the second user interface element was displayed prior to detecting the gaze of the user directed to the second user interface element while the second predefined portion of the user is available for engagement with the second user interface element.

The above-described manner of reversing the change to the visual appearance of the second user interface element in response to detecting that the second predefined portion of the user is no longer available for engagement with the second user interface element provides an efficient way of indicating that the electronic device will not perform an action with respect to the second user interface element in response to an input provided by the second predefined portion of the electronic device, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, after the determination that the second predefined portion (e.g., 1511 in FIG. 15C) of the user is not available for engagement (e.g., direct or indirect engagement) with the second user interface element (e.g., 1505) and while the gaze (e.g., 1501b) of the user is directed to the second user interface element (e.g., 1505), such as in FIG. 15B (e.g., with an appearance such as an idle state appearance that indicates that there is not a predefined portion of the user that is available for engagement with the second user interface element), the electronic device 101a detects (1612a), via the one or more input devices, that the second predefined portion (e.g., 1511) of the user is now available for engagement (e.g., direct or indirect engagement) with the second user interface element (e.g., 1505), such as in FIG. 15C. In some embodiments, detecting that the second predefined portion of the user is available for engagement includes detecting that the second predefined portion of the user is in the ready state according to method 800. For example, the electronic device detects a hand of the user in a pointing hand shape within a predefined distance (e.g., 1, 2, 3, 5, 10, 15, 30, etc. centimeters) of the second user interface element.

In some embodiments, such as in FIG. 15C, in response to detecting that the second predefined portion (e.g., 1511) of the user is now available for engagement (e.g., direct or indirect engagement) with the second user interface element (e.g., 1505) (e.g., while detecting the gaze of the user directed towards the second user interface element), the electronic device 101a changes (1612b) the visual appearance (e.g., size, color, position, text or line style, etc.) of the second user interface element (e.g., 1505). In some embodiments, in response to detecting the second predefined portion of the user is now available for engagement with a different user interface element while the user looks at the different user interface element, the electronic device updates the visual appearance of the different user interface element and maintains the visual appearance of the second user interface element.

The above-described manner of changing the visual appearance of the second user interface element in response to detecting that the second predefined portion of the user is ready for engagement with the second user interface element provides an efficient way of indicating to the user that an input provided by the second predefined portion of the user will cause an action directed to the second user interface element, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 15D, in response to detecting the movement of the gaze (e.g., 1501c) of the user away from the first user interface element (e.g., 1503) to the second user interface element (e.g., 1507) displayed via the display generation component (1614a), in accordance with a determination that the first predefined portion (e.g., 1509) and the second predefined portion (e.g., 1511) of the user are already engaged with (e.g., providing direct or indirect inputs directed to) respective user interface elements other than the second user interface element (e.g., 1507), the electronic device 101a forgoes (1614b) changing the visual appearance of the second user interface element (e.g., 1507). In some embodiments, the first and/or second predefined portions of the user are already engaged with a respective user interface element if the predefined portion(s) of the user is/are providing an input (e.g., direct or indirect) directed to the respective user interface element (e.g., a selection input or a selection portion of another input, such as a drag or scroll input) or if the predefined portion(s) of the user is/are in a direct ready state directed towards the respective user interface element according to method 800. For example, the right hand of the user is in a pinch hand shape that corresponds to initiation of a selection input directed to a first respective user interface and the left hand of the user is in a pointing hand shape within a distance threshold (e.g., 1, 3, 5, 10, 15, 30, etc. centimeters) of a second respective user interface element that corresponds to the left hand being in the direct ready state directed towards the second respective user interface element. In some embodiments, in response to detecting the gaze of the user on a respective user interface element other than the second user interface element while the first and second predefined portions of the user are already engaged with other user interface elements, the electronic device forgoes changing the visual appearance of the respective user interface element.

The above-described manner of forgoing changing the visual appearance of the second user interface element in response to the gaze of the user being directed towards the second user interface element while the first and second predefined portions of the user are already engaged with respective user interface elements provides an efficient way of indicating to the user that inputs provided by the first and second predefined portions of the user will not be directed towards the second user interface element, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 15D, the determination that the second predefined portion (e.g., 1511) of the user is not available for engagement with the second user interface element (e.g., 1507) is based on a determination that the second predefined portion (e.g., 1511) of the user is engaged with (e.g., providing direct or indirect input to) a third user interface element (e.g., 1505), different from the second user interface element (e.g., 1507) (1616a). In some embodiments, the second predefined portion of the user is engaged with the third user interface element when the second predefined portion of the user is providing an input (e.g., direct or indirect) to the third user interface element or when the second predefined portion of the user is in a direct ready state associated with the third user interface element according to method 800. For example, if the hand of the user is in a pinch hand shape or a pre-pinch hand shape providing a selection input to the third user interface element directly or indirectly, the hand of the user is engaged with the third user interface element and not available for engagement with the second user interface element. As another example, if the hand of the user is in a pointing hand shape within a ready state threshold (e.g., 1, 2, 3, 5, 10, 15, 30, etc. centimeters) or a selection threshold (e.g., 0.1, 0.2, 0.3, 0.5, 1, 2, 3, etc. centimeters) of the third user interface element, the hand of the user is engaged with the third user interface element and not available for engagement with the second user interface element.

The above-described manner of determining that the second predefined portion of the user is not available for engagement with the second user interface element based on the determination that the second predefined portion of the user is engaged with the third user interface element provides an efficient way of maintaining engagement with the third user interface element even when the user looks at the second user interface element, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 15D, the determination that the second predefined portion (e.g., 1511) of the user is not available for engagement (e.g., direct or indirect engagement) with the second user interface element (e.g., 1507) is based on a determination that the second predefined portion (e.g., 1511) of the user is not in a predetermined pose (e.g., location, orientation, hand shape) required for engagement with the second user interface element (e.g., 1507) (1618a). In some embodiments, the predetermined pose is a pose associated with the ready state in method 800. In some embodiments, the predefined portion of the user is a hand of the user and the predetermined pose is the hand in a pointing gesture with the palm facing a respective user interface element while the hand is within a threshold distance (e.g., 1, 2, 3, 5, 10, 15, 30) of the respective user interface element. In some embodiments, the predefined portion of the user is a hand of the user and the predetermined pose is the hand with the palm facing the user interface in a pre-pinch hand shape in which the thumb and another finger are within a threshold distance (e.g., 0.1, 0.2, 0.3, 0.5, 1, 2, 3, etc. centimeters) of each other without touching. In some embodiments, if the pose of the second predefined portion does not match one or more predetermined poses required for engagement with the second user interface element, the electronic device forgoes changing the visual appearance of the second user interface element in response to detecting the gaze of the user on the second user interface element.

The above-described manner of determining that the predefined portion of the user is not available for engagement when the pose of the predefined portion is not a predetermined pose provides an efficient way of allowing the user to make the predetermined pose to initiate an input and forgo making the pose when input is not desired, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, the determination that the second predefined portion (e.g., 1511 in FIG. 15C) of the user is not available for engagement (e.g., direct or indirect engagement) with the second user interface element (e.g., 1505) is based on a determination that the second predefined portion (e.g., 1511) of the user is not detected by the one or more input devices (e.g., one or more cameras, range sensors, hand tracking devices, etc.) in communication with the electronic device (1620a), such as in FIG. 15B. In some embodiments, the one or more input devices are able to detect the second predefined portion of the user while the second predefined portion of the user has a position relative to the one or more input devices that is within a predetermined region (e.g., “field of view”) relative to the one or more input devices and are not able to detect the second predefined portion of the user while the second predefined portion of the user has a position relative to the one or more input devices that is outside of the predetermined region. For example, a hand tracking device including a camera, range sensor, or other image sensor has a field of view that includes regions captured by the camera, range sensor, or other image sensor. In this example, while the hands of the user are not in the field of view of the hand tracking device, the hands of the user are not available for engagement with the second user interface element because the electronic device is unable to detect inputs from the hands of the user while the hands of the user are outside of the field of view of the hand tracking device.

The above-described manner of determining that the predefined portion of the user is not available for engagement with the second user interface element based on the determination that the predefined portion of the user is not detected by the one or more input devices in communication with the electronic device provides an efficient way of changing the visual characteristic of the second user interface element in response to gaze only when the electronic device which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, while displaying, via the display generation component, the first user interface element (e.g., 1505) and the second user interface element (e.g., 1507) (1622a), such as in FIG. 15E, in accordance with a determination that the first predefined portion (e.g., 1511) of the user is within a threshold distance (e.g., 0.5, 1, 2, 3, 5, 10, 15, 30, 50, etc. centimeters corresponding to direct interaction with user interface element(s), such as described with reference to methods 800, 1000, 1200, 1400, 1800 and/or 2000) of a location corresponding to the first user interface element (e.g., 1505) and the second predefined portion (e.g., 1509) of the user is within the threshold distance of a location corresponding to the second user interface element (e.g., 1507) (1622b), the electronic device 101a displays (1622c) the first user interface element (e.g., 1505) with a visual characteristic (e.g., color, position, size, line or text style) that indicates that the first predefined portion (e.g., 1511) of the user is available for direct engagement with the first user interface element (e.g., 1505) (e.g., In some embodiments, in response to receiving an input provided by the first predefined portion of the user to the first user interface element, the electronic device performs a corresponding action associated with the first user interface element. In some embodiments, if the first predefined portion of the user does not have a pose that corresponds to a predefined pose, the electronic device forgoes displaying the first user interface element with the visual characteristic that indicates that the first user interface element is available for direct engagement with the first predefined portion of the user. In some embodiments, the first and second predefined portions of the user have poses that correspond to a predetermined pose, such as described with reference to methods 800, 1000, 1200, 1400, 1800 and/or 2000.

In some embodiments, such as in FIG. 15E, while displaying, via the display generation component, the first user interface element (e.g., 1505) and the second user interface element (e.g., 1507) (1622a), in accordance with a determination that the first predefined portion (e.g., 1511) of the user is within a threshold distance (e.g., 0.5, 1, 2, 3, 5, 10, 15, 30, 50, etc. centimeters corresponding to direct interaction with user interface element(s), such as described with reference to methods 800, 1000, 1200, 1400, 1800 and/or 2000) of a location corresponding to the first user interface element (e.g., 1505) and the second predefined portion (e.g., 1509) of the user is within the threshold distance of a location corresponding to the second user interface element (e.g., 1507) (1622b), the electronic device 101a displays (1622d) the second user interface element (e.g., 1507) with the visual characteristic that indicates that the second user interface element (e.g., 1507) is available for direct engagement with the second predefined portion of the user (e.g., 1509). In some embodiments, in response to receiving an input provided by the second predefined portion of the user to the second user interface element, the electronic device performs a corresponding action associated with the second user interface element. In some embodiments, if the second predefined portion of the user does not have a pose that corresponds to a predefined pose (e.g., such as described with reference to methods 800, 1000, 1200, 1400, 1800 and/or 2000), the electronic device forgoes displaying the second user interface element with the visual characteristic that indicates that the second user interface element is available for direct engagement with the second predefined portion of the user.

The above-described manner of displaying the first user interface element with the visual characteristic that indicates that the first user interface element is available for direct engagement and displaying the second user interface element with the visual characteristic that indicates that the second user interface element is available for engagement provides an efficient way of enabling the user to direct inputs to the first and second user interface elements simultaneously with the first and second predefined portions of the user, respectively, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 15E, while displaying, via the display generation component, the first user interface element (e.g., 1505) and the second user interface element (e.g., 1507) (1624a), in accordance with a determination that the first predefined portion (e.g., 1515) of the user is within a threshold distance (e.g., 0.5, 1, 2, 3, 5, 10, 15, 30, 50, etc. centimeters corresponding to direct interaction with user interface element(s), such as described with reference to methods 800, 1000, 1200, 1400, 1800 and/or 2000) of a location corresponding to the first user interface element (e.g., 1505) and the second predefined portion (e.g., 1509) of the user is further than the threshold distance of a location corresponding to the second user interface element (e.g., 1507) but is available for engagement (e.g., indirect engagement) with the second user interface element (e.g., 1507) (1624b), such as in FIG. 15E, the electronic device 101a displays (1624c) the first user interface element (e.g., 1505) with a visual characteristic (e.g., color, size, location, transparency, shape, line and/or text style) that indicates that the first predefined portion (e.g., 1515) of the user is available for direct engagement with the first user interface element (e.g., 1505). In some embodiments, a pose of the first predefined portion of the user corresponds to a predefined pose associated with the ready state according to method 800. In some embodiments, in accordance with a determination that the location of the first predefined portion changes from being within the threshold distance of the location corresponding to the first user interface element to being within the threshold distance of a location corresponding to a third user interface element, the electronic device ceases displaying the first user interface element with the visual characteristic and displays the third user interface element with the visual characteristic. In some embodiments, the second predefined portion of the user is in a predetermined pose associated with the ready state described with reference to method 800. In some embodiments, the second predefined portion of the user is at a distance from the second user interface element corresponding to indirect interaction with the second user interface element, such as described with reference to methods 800, 1000, 1200, 1400, 1800 and/or 2000. In some embodiments, the first predefined portion of the user has a pose that corresponds to a predetermined pose, such has described with reference to methods 800, 1000, 1200, 1400, 1800, and/or 2000.

In some embodiments, such as in FIG. 15E, while displaying, via the display generation component, the first user interface element (e.g., 1505) and the second user interface element (e.g., 1507) (1624a), in accordance with a determination that the first predefined portion (e.g., 1511) of the user is within a threshold distance (e.g., 0.5, 1, 2, 3, 5, 10, 15, 30, 50, etc. centimeters corresponding to direct interaction with user interface element(s), such as described with reference to methods 800, 1000, 1200, 1400, 1800 and/or 2000) of a location corresponding to the first user interface element (e.g., 1505) and the second predefined portion (e.g., 1509) of the user is further than the threshold distance of a location corresponding to the second user interface element (e.g., 1507) but is available for engagement (e.g., indirect engagement) with the second user interface element (e.g., 1507) (1624b), such as in FIG. 15E, in accordance with a determination that the gaze (e.g., 1501a) of the user is directed to the second user interface element (e.g., 1507), the electronic device 101a displays (1624d) the second user interface element (e.g., 1507) with a visual characteristic that indicates that the second predefined portion (e.g., 1509) of the user is available for indirect engagement with the second user interface element (e.g., 1507). In some embodiments, if the gaze of the user moves from being directed to the second user interface element to being directed to a third user interface element, the electronic device ceases displaying the second user interface element with the visual characteristic and displays the third user interface element with the visual characteristic.

In some embodiments, while displaying, via the display generation component, the first user interface element and the second user interface element (1624a), in accordance with a determination that the first predefined portion of the user is within a threshold distance (e.g., 0.5, 1, 2, 3, 5, 10, 15, 30, 50, etc. centimeters corresponding to direct interaction with user interface element(s), such as described with reference to methods 800, 1000, 1200, 1400, 1800 and/or 2000) of a location corresponding to the first user interface element and the second predefined portion of the user is further than the threshold distance of a location corresponding to the second user interface element but is available for engagement (e.g., indirect engagement) with the second user interface element (1624b), in accordance with a determination that the gaze of the user is not directed to the second user interface element, the electronic device 101a displays (1624e) the second user interface element without the visual characteristic that indicates that the second predefined portion of the user is available for indirect engagement with the second user interface element. For example, if, in FIG. 15E, the gaze 1501a of the user were not directed to user interface element 1507, user interface element 1507 would not be displayed with the visual characteristic (e.g., shading in FIG. 15E) that indicates that the hand 1509 is available for indirect engagement with the user interface element 1507. In some embodiments, the electronic device requires the gaze of the user to be directed to the second user interface element in order for the second user interface element to be available for indirect engagement. In some embodiments, while the first predefined portion of the user is directly engaged with the first user interface element and the second predefined portion of the user is available for indirect engagement with another user interface element, the electronic device indicates that the first user interface element is available for direct engagement with the first predefined portion of the user and indicates that the user interface element to which the user's gaze is directed is available for indirect engagement with the second predefined portion of the user. In some embodiments, the indication of direct engagement is different from the indication of indirect engagement according to one or more steps of method 1400.

The above-described manner of displaying the first user interface element with the visual characteristic that indicates that the first user interface element is available for direct engagement and displaying the second user interface element with the visual characteristic that indicates that the second user interface element is available for indirect engagement provides an efficient way of enabling the user to direct inputs to the first and second user interface elements simultaneously with the first and second predefined portions of the user, respectively, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 15E, while displaying, via the display generation component, the first user interface element (e.g., 1507) and the second user interface element (e.g., 1505) (1626a), in accordance with a determination that the second predefined portion (e.g., 1511) of the user is within a threshold distance (e.g., 0.5, 1, 2, 3, 5, 10, 15, 30, 50 etc. centimeters corresponding to direct interaction with user interface element(s), such as described with reference to methods 800, 1000, 1200, 1400, 1800 and/or 2000) of a location corresponding to the second user interface element (e.g., 1505) and the first predefined portion (e.g., 1509) of the user is further than the threshold distance of a location corresponding to the first user interface element (e.g., 1507) but is available for engagement (e.g., indirect engagement) with the first user interface element (e.g., 1507) (1626b), the electronic device 101a displays (1626c) the second user interface element (e.g., 1505) with a visual characteristic that indicates that the second user interface element (e.g., 1505) is available for direct engagement with the second predefined portion (e.g., 1511) of the user, such as in FIG. 15E. In some embodiments, a pose of the second predefined portion of the user corresponds to a predefined pose associated with the ready state according to method 800. In some embodiments, in accordance with a determination that the location of the second predefined portion of the user changes from being within the threshold distance of the location corresponding to the second user interface element to being within the threshold distance of a location corresponding to a third user interface element, the electronic device ceases displaying the second user interface element with the visual characteristic and displays the third user interface element with the visual characteristic. In some embodiments, the first predefined portion of the user is in a predetermined pose associated with the ready state described with reference to method 800. In some embodiments, the first predefined portion of the user is at a distance from the first user interface element corresponding to indirect interaction with the first user interface element, such as described with reference to methods 800, 1000, 1200, 1400, 1800 and/or 2000. In some embodiments, the second predefined portion of the user has a pose that corresponds to a predetermined pose, such has described with reference to methods 800, 1000, 1200, 1400, 1800, and/or 2000.

In some embodiments, such as in FIG. 15E, while displaying, via the display generation component, the first user interface element and the second user interface element (1626a), in accordance with a determination that the second predefined portion (e.g., 1511) of the user is within a threshold distance (e.g., 0.5, 1, 2, 3, 5, 10, 15, 30, 50 etc. centimeters corresponding to direct interaction with user interface element(s), such as described with reference to methods 800, 1000, 1200, 1400, 1800 and/or 2000) of a location corresponding to the second user interface element (e.g., 1505) and the first predefined portion (e.g., 1509) of the user is further than the threshold distance of a location corresponding to the first user interface element (e.g., 1507) but is available for engagement (e.g., indirect engagement) with the first user interface element (e.g., 1507) (1626b), in accordance with a determination that the gaze (e.g., 1501a) of the user is directed to the first user interface element (e.g., 1507), the electronic device 101a displays (1626d) the first user interface element (e.g., 1507) with a visual characteristic that indicates that the first predefined portion (e.g., 1509) of the user is available for indirect engagement with the first user interface element (e.g., 1507), such as in FIG. 15E. In some embodiments, if the gaze of the user moves from being directed to the first user interface element to being directed to a third user interface element, the electronic device ceases displaying the first user interface element with the visual characteristic and displays the third user interface element with the visual characteristic.

In some embodiments, such as in FIG. 15E, while displaying, via the display generation component, the first user interface element (e.g., 1503) and the second user interface element (e.g., 1505) (1626a), in accordance with a determination that the second predefined portion (e.g., 1511) of the user is within a threshold distance (e.g., 0.5, 1, 2, 3, 5, 10, 15, 30, 50 etc. centimeters corresponding to direct interaction with user interface element(s), such as described with reference to methods 800, 1000, 1200, 1400, 1800 and/or 2000) of a location corresponding to the second user interface element (e.g., 1505) and the first predefined portion (e.g., 1509) of the user is further than the threshold distance of a location corresponding to the first user interface element (e.g., 1503) but is available for engagement (e.g., indirect engagement) with the first user interface element (e.g., 1503) (1626b), in accordance with a determination that the gaze (e.g., 1501a) of the user is not directed to the first user interface element (e.g., 1503), the electronic device 101a displays (1626e) the first user interface element (e.g., 1503) without the visual characteristic that indicates that the first predefined portion (e.g., 1509) of the user is available for indirect engagement with the first user interface element (e.g., 1503), such as in FIG. 15E. In some embodiments, the electronic device requires the gaze of the user to be directed to the first user interface element in order for the first user interface element to be available for indirect engagement. In some embodiments, while the second predefined portion of the user is directly engaged with the second user interface element and the first predefined portion of the user is available for indirect engagement with another user interface element, the electronic device indicates that the second user interface element is available for direct engagement with the second predefined portion of the user and indicates that the user interface element to which the user's gaze is directed is available for indirect engagement with the first predefined portion of the user. In some embodiments, the indication of direct engagement is different from the indication of indirect engagement according to one or more steps of method 1400. In some embodiments, in response to detecting the gaze of the user directed to a third user interface element while the first predefined portion of the user is available for indirect engagement, the electronic device displays the third user interface element with the visual characteristic that indicates that the first predefined portion of the user is available for indirect engagement with the third user interface element. In some embodiments, in response to detecting the gaze of the user directed to the second user interface object while the first predefined portion of the user is available for indirect engagement, the electronic device forgoes updating the visual characteristic of the second user interface element because the second predefined portion of the user is directly engaged with the second user interface element.

The above-described manner of displaying the first user interface element with the visual characteristic that indicates that the first user interface element is available for indirect engagement and displaying the second user interface element with the visual characteristic that indicates that the second user interface element is available for direct engagement provides an efficient way of enabling the user to direct inputs to the first and second user interface elements simultaneously with the first and second predefined portions of the user, respectively, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, after detecting the movement of the gaze (e.g., 1501b) of the user away from the first user interface element (e.g., 1503) to the second user interface element (e.g., 1505), such as in FIG. 15C, and while displaying the second user interface element (e.g., 1505) with the changed visual appearance (e.g., the second predefined portion of the user is more than a distance threshold (e.g., 0.5, 1, 2, 3, 4, 5, 10, 15, 20, 30, 50, etc. centimeters) associated with direct inputs away from the second user interface element and is available for indirect engagement with the second user interface element), the electronic device 101a detects (1628a), via the one or more input devices, the second predefined portion (e.g., 1511) of the user directly engaging with the first user interface element (e.g., 1505), such as in FIG. 15E. In some embodiments, the second predefined portion of the user is within a threshold distance (e.g., 0.5, 1, 3, 5, 10, 15, 30, 50, etc. centimeters) of the first user interface element while in a predefined pose to directly engage with the first user interface element, such as described with reference to methods 800, 1000, 1200, 1400, 1800 and/or 2000. In some embodiments, the direct engagement is the ready state according to method 800 or an input to perform an action (e.g., a selection input, a drag input, a scroll input, etc.).

In some embodiments, such as in FIG. 15E, in response to detecting the second predefined portion (e.g., 1511) of the user directly engaging with the first user interface element (e.g., 1505), the electronic device 101a forgoes (1628b) displaying the second user interface element (e.g., 1503) with the changed visual appearance. In some embodiments, the first predefined portion of the user in not available for engagement with the second user interface element. In some embodiments, the electronic device changes the visual appearance of the first user interface element to indicate that the first user interface element is in direct engagement with the second predefined portion of the user. In some embodiments, even if the first predefined portion of the user is available for indirect engagement with the second user interface element and/or the gaze of the user is directed towards the second user interface element, in response to detecting the second predefined portion of the user directly engaging with the first user interface element, the electronic device forgoes displaying the second user interface element with the changed visual appearance. In some embodiments, while indicating that the second predefined portion of the user is available for indirect engagement with the second user interface element, the electronic device detects the second predefined portion of the user directly engage with another user interface element and ceases displaying the indication that the second predefined portion of the user is available for indirect engagement with the second user interface element.

The above-described manner of ceasing to display the second user interface element with the changed appearance in response to detecting the second predefined portion of the user directly engage with the first user interface element provides an efficient way of avoiding accidental inputs directed to the second user interface element which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

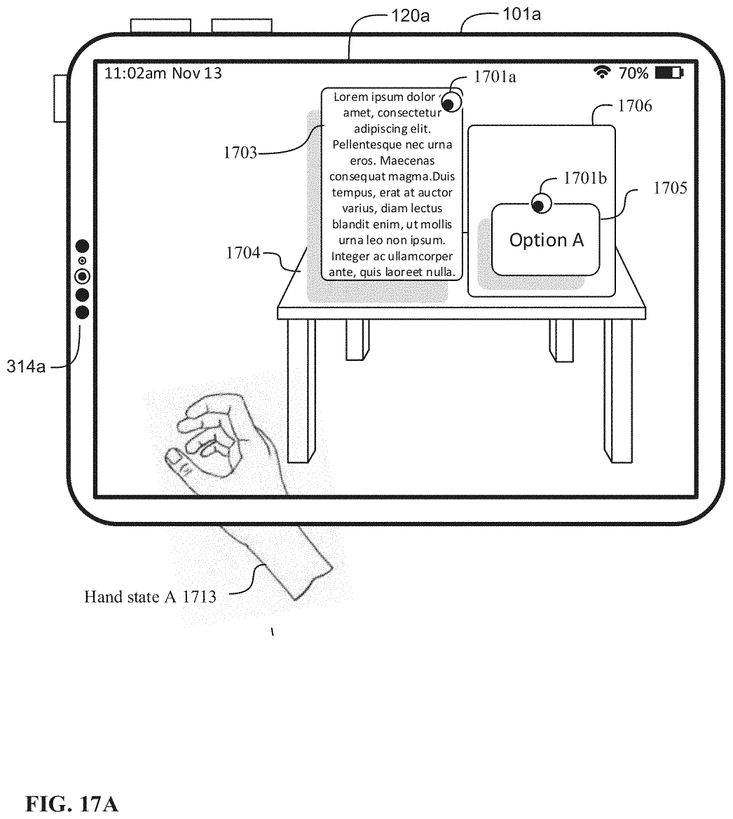

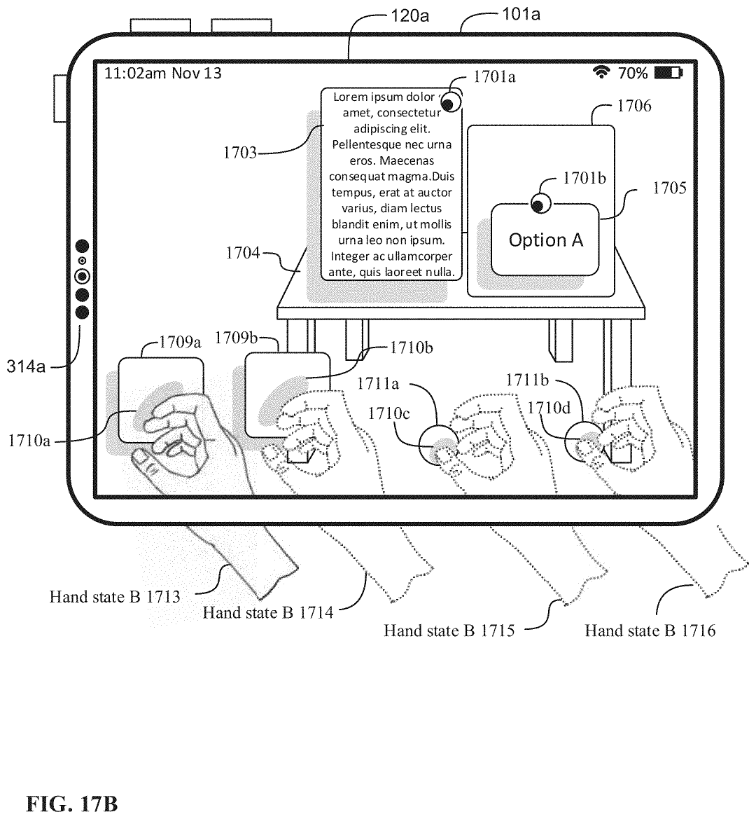

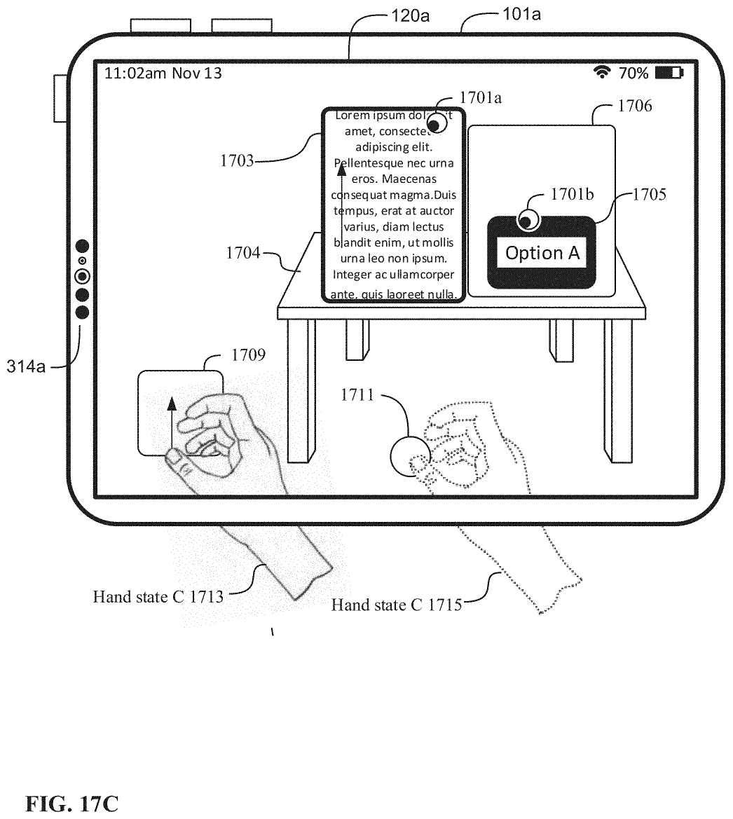

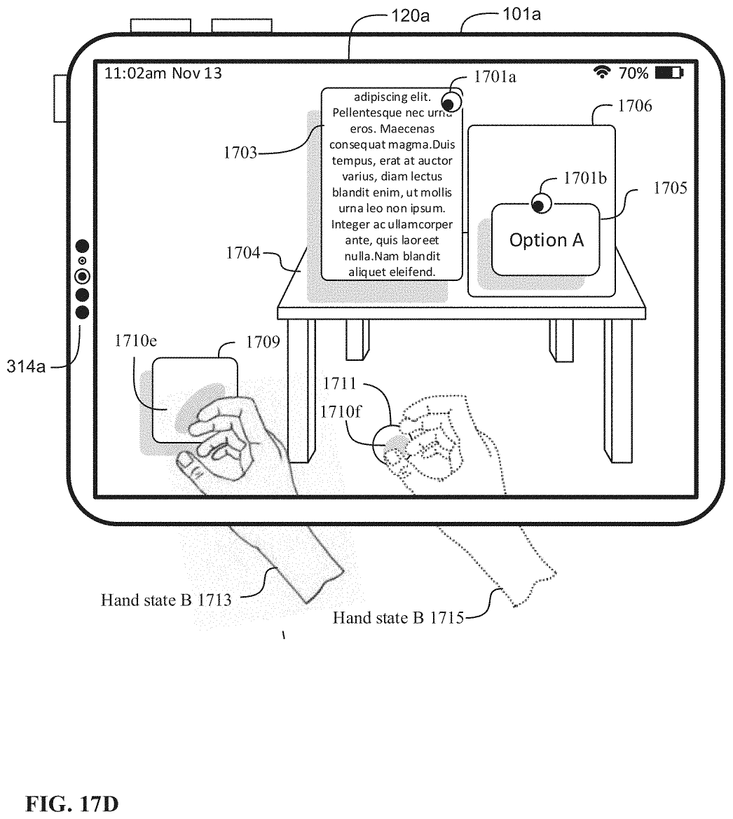

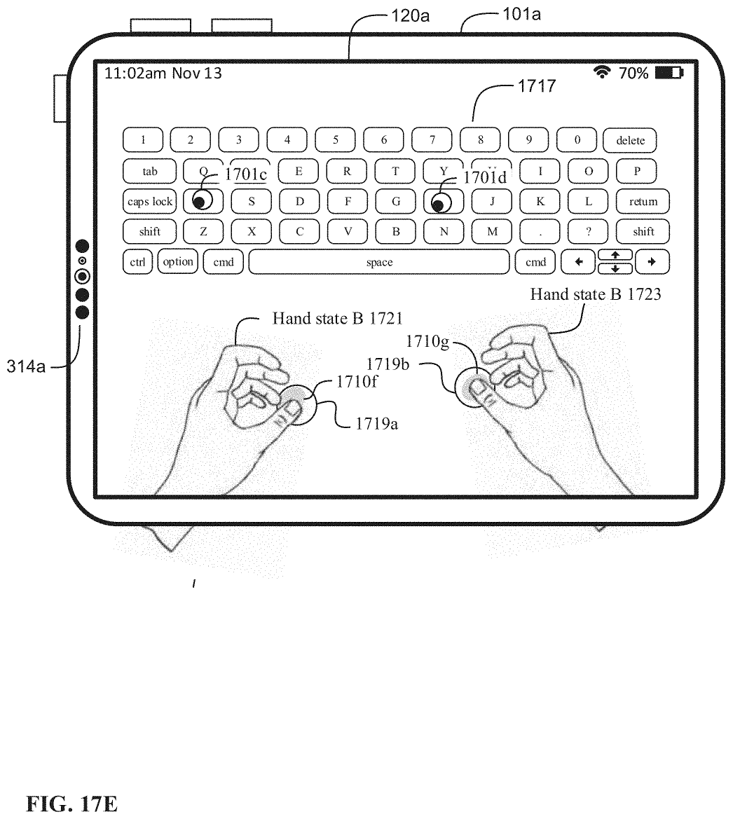

FIGS. 17A-17E illustrate various ways in which an electronic device 101a presents visual indications of user inputs according to some embodiments.

FIG. 17A illustrates an electronic device 101a, via display generation component 120a, a three-dimensional environment. It should be understood that, in some embodiments, electronic device 101a utilizes one or more techniques described with reference to FIGS. 17A-17E in a two-dimensional environment or user interface without departing from the scope of the disclosure. As described above with reference to FIGS. 1-6, the electronic device optionally includes display generation component 120a (e.g., a touch screen) and a plurality of image sensors 314a. The image sensors optionally include one or more of a visible light camera, an infrared camera, a depth sensor, or any other sensor the electronic device 101a would be able to use to capture one or more images of a user or a part of the user while the user interacts with the electronic device 101a. In some embodiments, display generation component 120a is a touch screen that is able to detect gestures and movements of a user's hand. In some embodiments, the user interfaces described below could also be implemented on a head-mounted display that includes a display generation component that displays the user interface to the user, and sensors to detect the physical environment and/or movements of the user's hands (e.g., external sensors facing outwards from the user), and/or gaze of the user (e.g., internal sensors facing inwards towards the face of the user).

In FIG. 17A, the electronic device 101a displays a three-dimensional environment that includes a representation 1704 of a table in the physical environment of the electronic device 101a (e.g., such as table 604 in FIG. 6B), a scrollable user interface element 1703, and a selectable option 1705. In some embodiments, the representation 1704 of the table is a photorealistic video image of the table displayed by the display generation component 120a (e.g., video or digital passthrough). In some embodiments, the representation 1704 of the table is a view of the table through a transparent portion of the display generation component 120a (e.g., true or physical passthrough). As shown in FIG. 17A, the selectable option 1705 is displayed within and in front of a backplane 1706. In some embodiments, the backplane 1706 is a user interface that includes content corresponding to the selectable option 1705.

As will be described in more detail herein, in some embodiments, the electronic device 101a is able to detect inputs based on the hand(s) and/or gaze of the user of device 101a. In FIG. 17A, the hand 1713 of the user is in an inactive state (e.g., hand shape) that does not correspond to a ready state or to an input. In some embodiments, the ready state is the same as or similar to the ready state described above with reference to FIGS. 7A-8K. In some embodiments, the hand 1713 of the user is visible in the three-dimensional environment displayed by device 101a. In some embodiments, the electronic device 101a displays a photorealistic representation of the finger(s) and/or hand 1713 of the user with the display generation component 120a (e.g., video passthrough). In some embodiments, the finger(s) and/or hand 1713 of the user is visible through a transparent portion of the display generation component 120a (e.g., true passthrough).

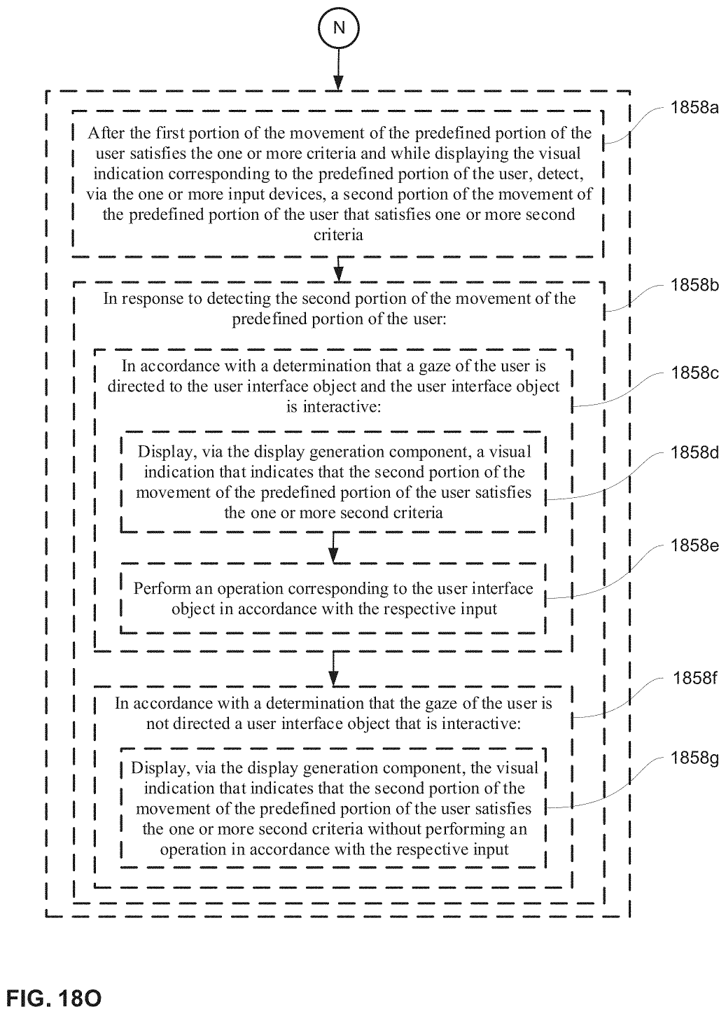

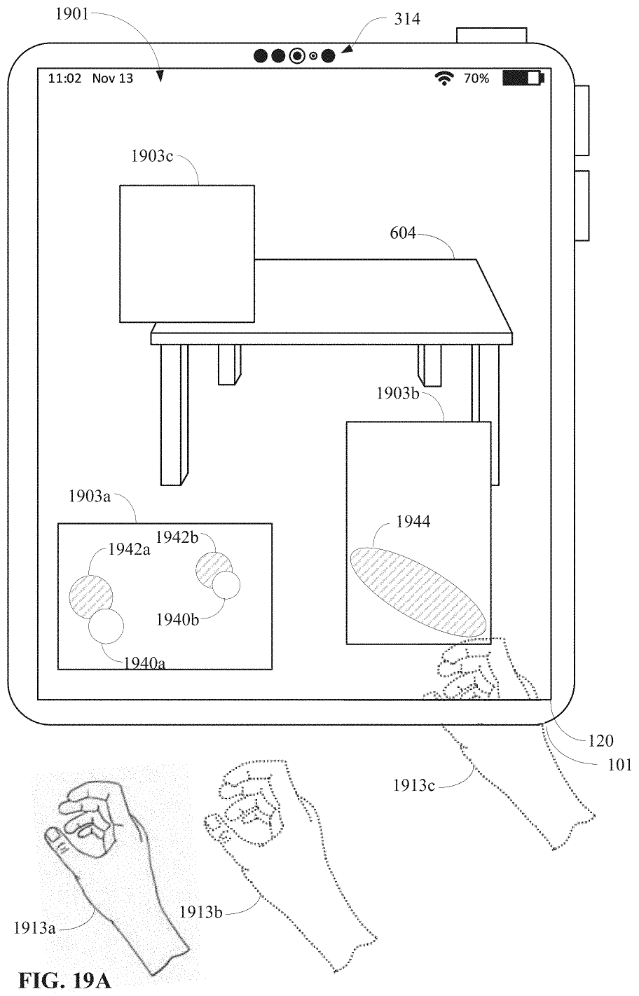

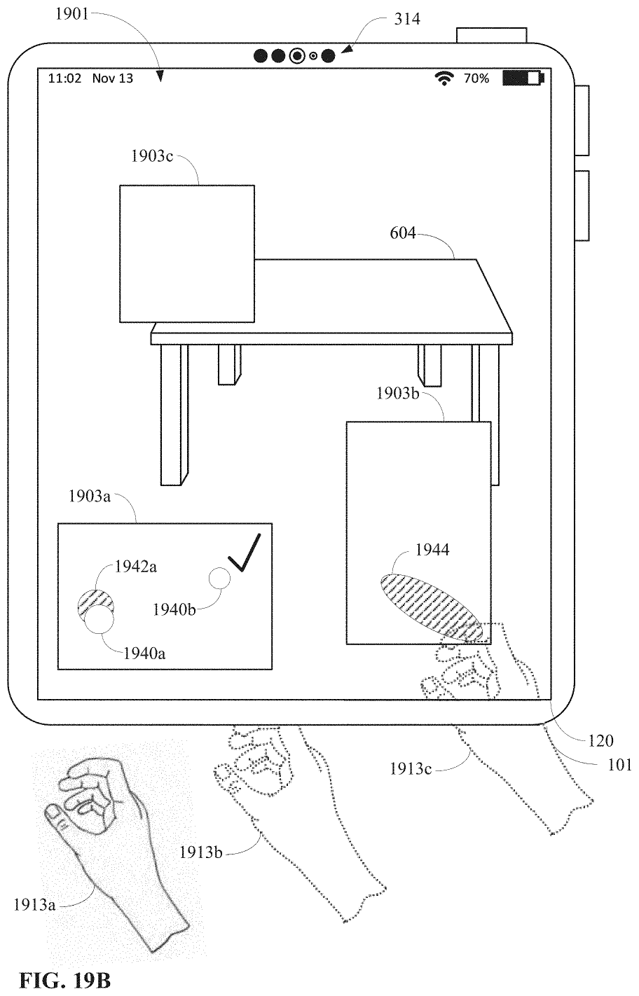

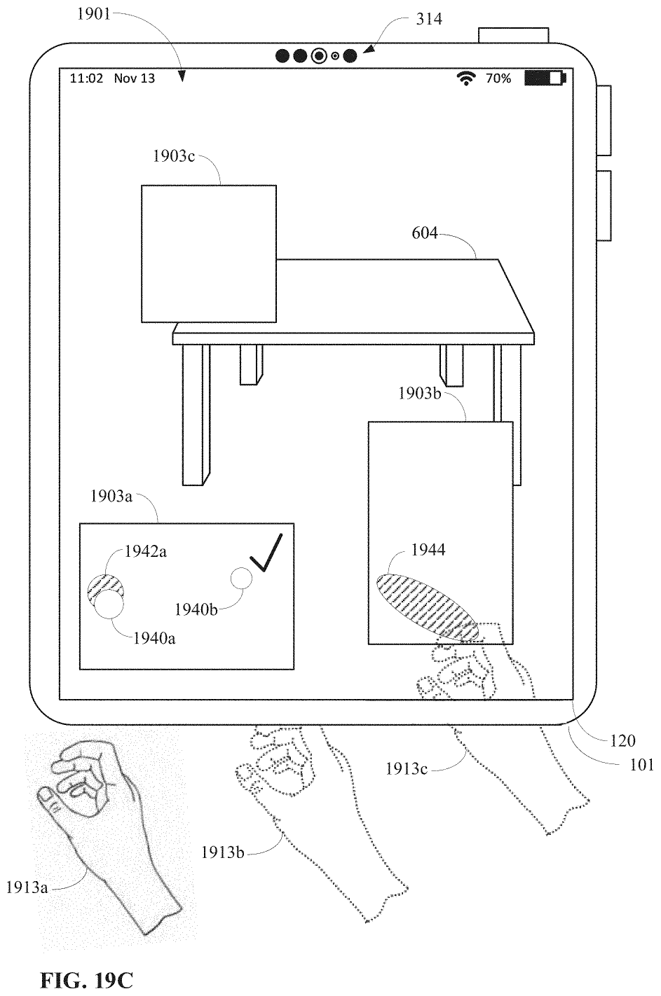

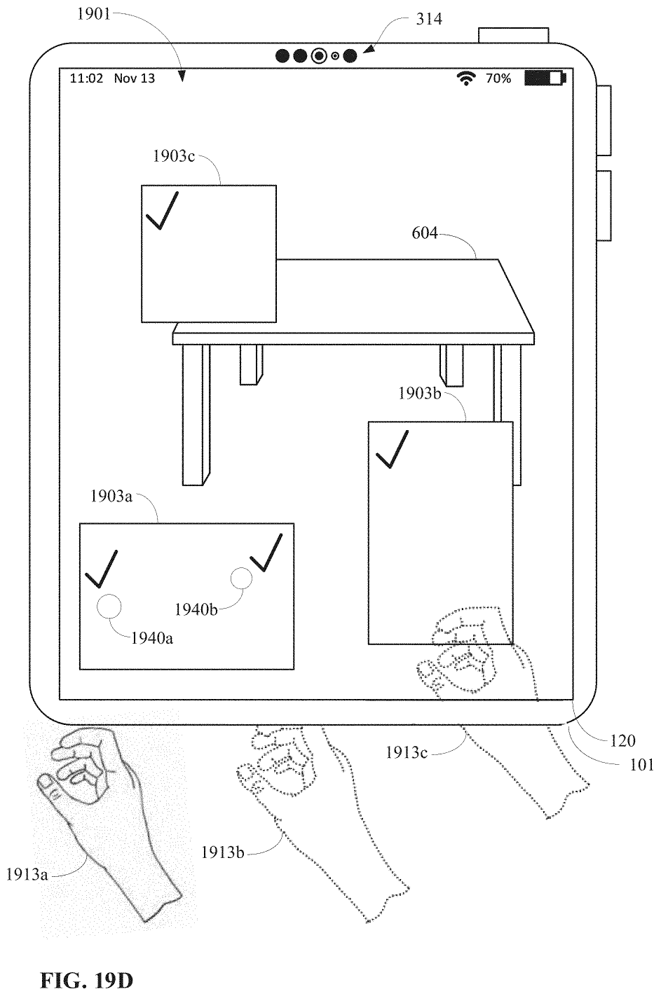

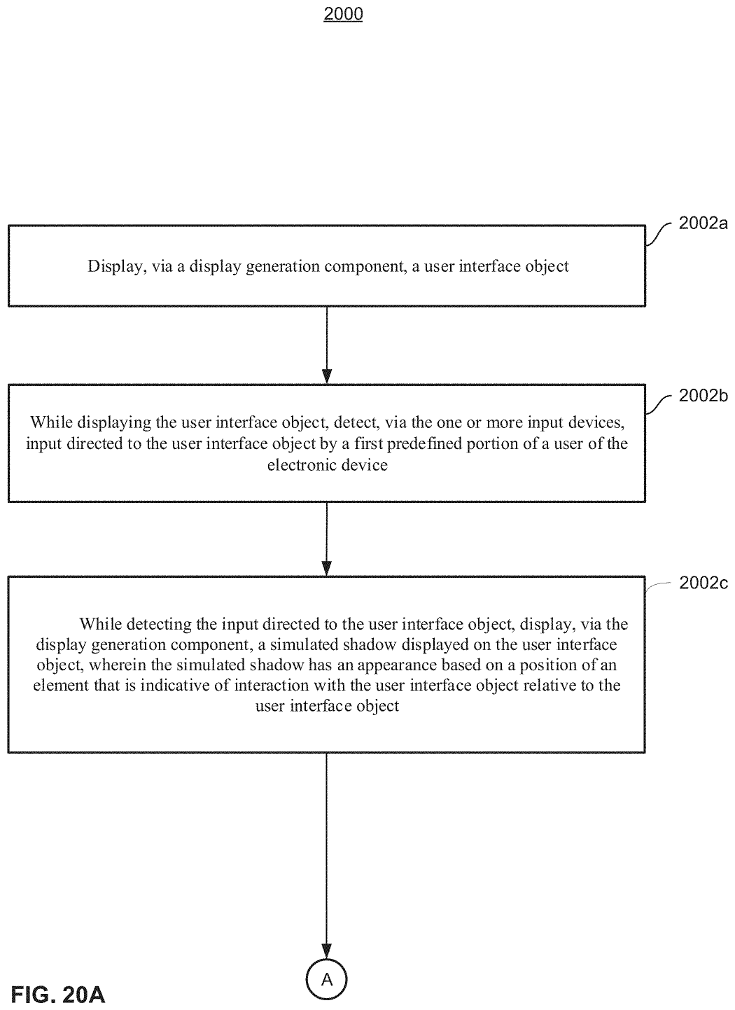

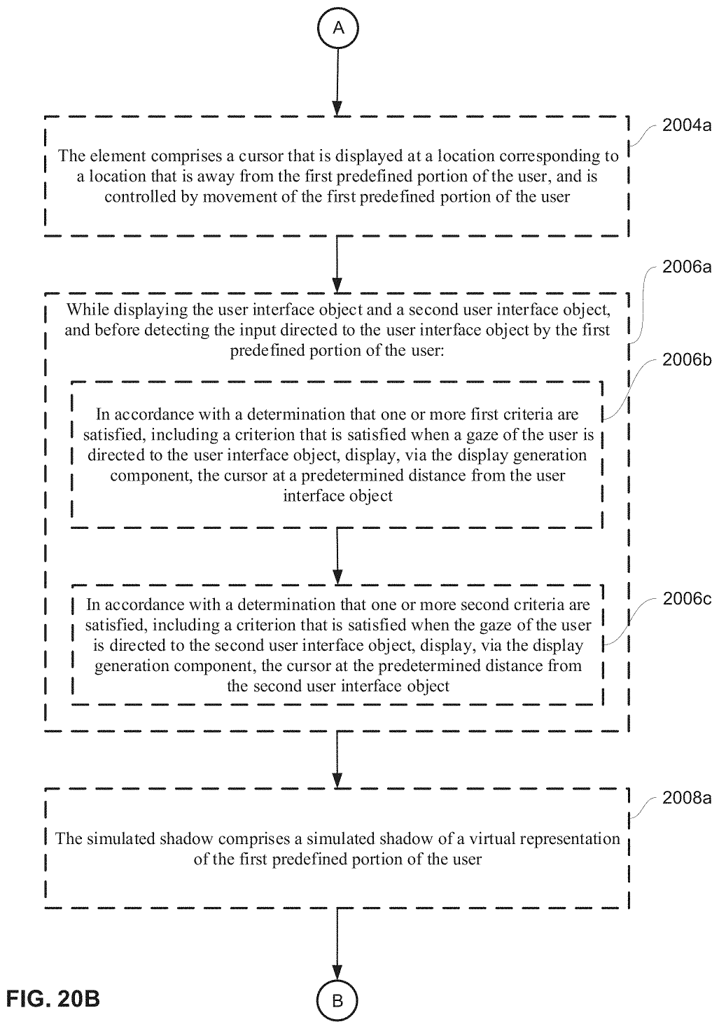

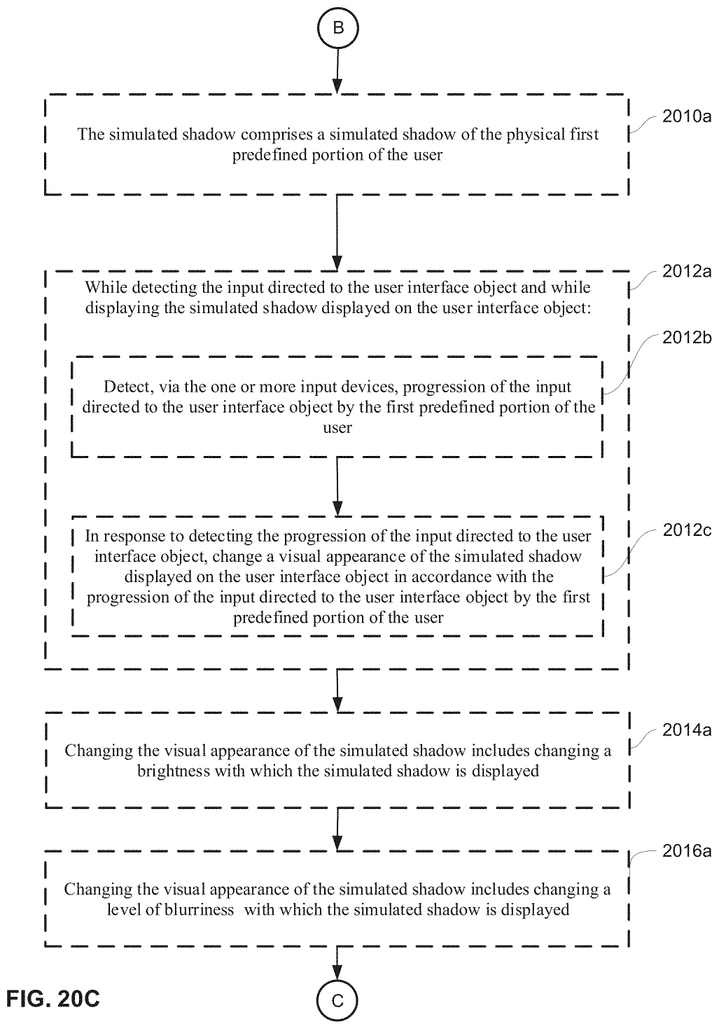

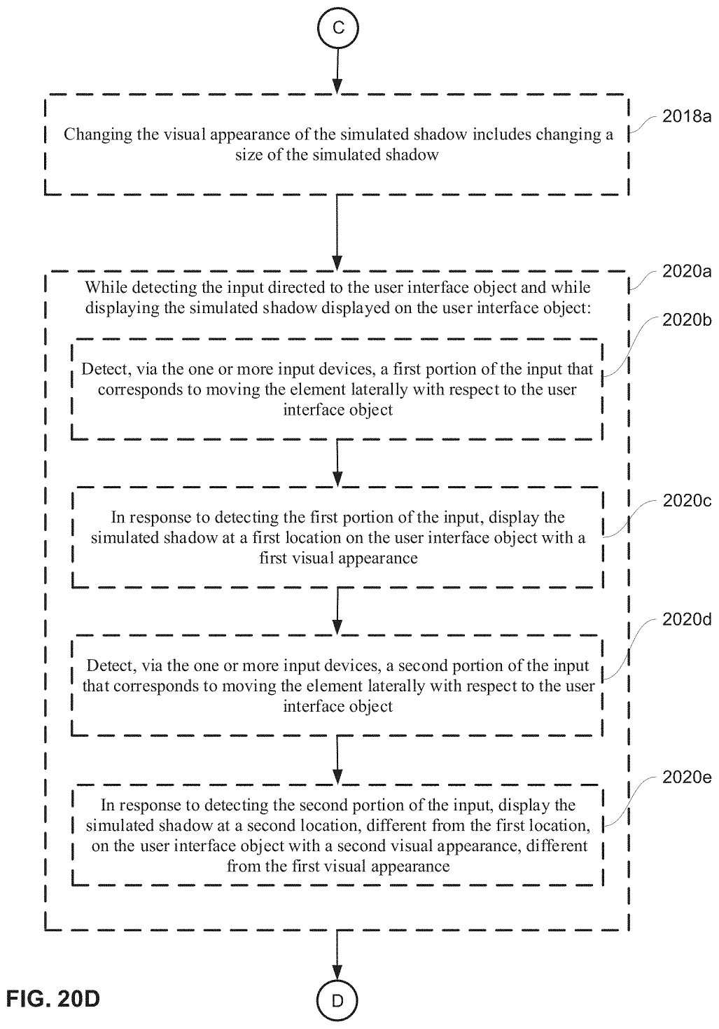

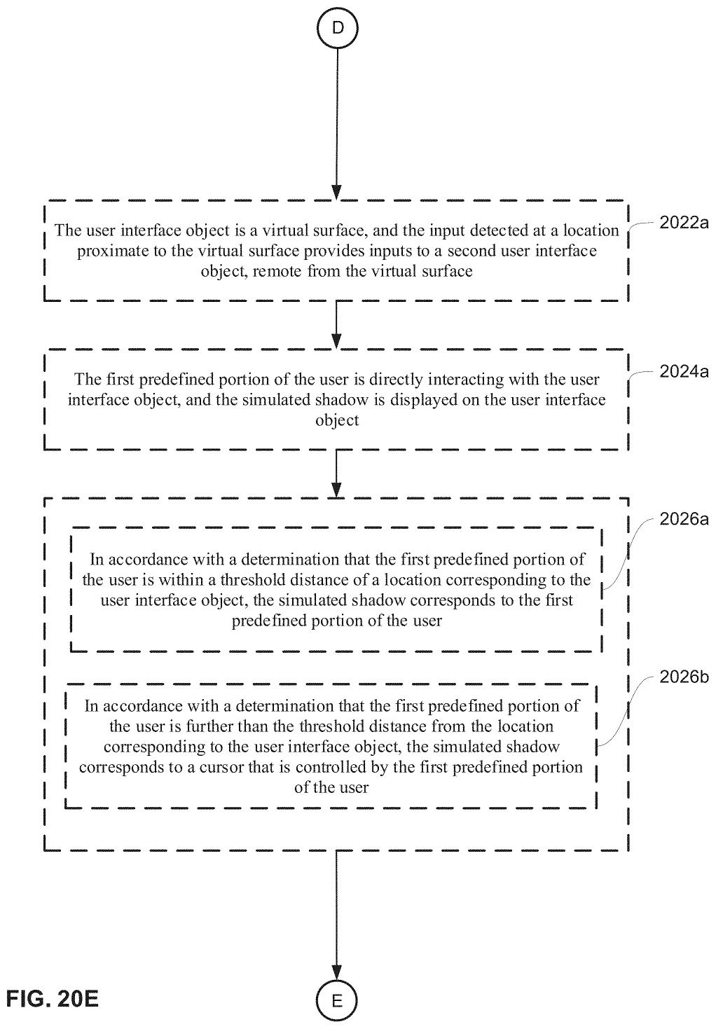

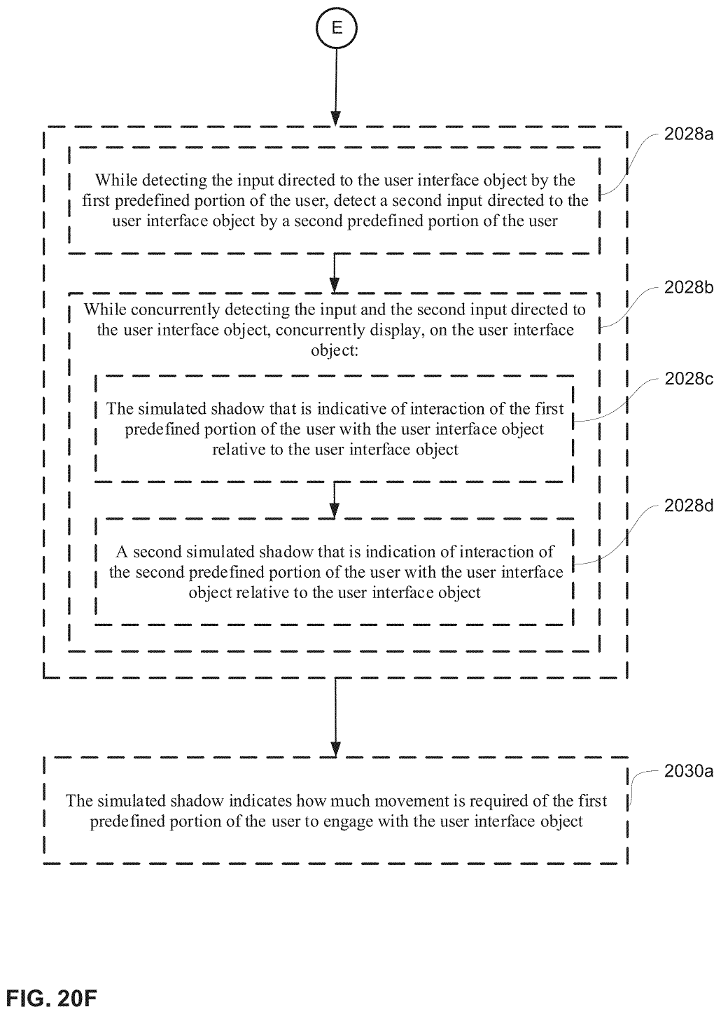

As shown in FIG. 17A, the scrollable user interface element 1703 and selectable option 1705 are displayed with simulated shadows. In some embodiments, the shadows are presented in a way similar to one or more of the ways described below with reference to FIGS. 19A-20F. In some embodiments, the shadow of the scrollable user interface element 1703 is displayed in response to detecting the gaze 1701a of the user directed to the scrollable user interface element 1703 and the shadow of the selectable option 1705 is displayed in response to detecting the gaze 1701b of the user directed to the selectable option 1705. It should be understood that, in some embodiments, gaze 1701a and 1701b are illustrated as alternatives and not meant as being concurrently detected. In some embodiments, additionally or alternatively, the electronic device 101a updates the color of the scrollable user interface element 1703 in response to detecting the gaze 1701a of the user on the scrollable user interface element 1703 and updates the color of the selectable option 1705 in response to detecting the gaze 1701b of the user directed to the selectable option 1705.

In some embodiments, the electronic device 101a displays visual indications proximate to the hand of the user in response to detecting the user beginning to provide an input with their hand. FIG. 17B illustrates exemplary visual indications of user inputs that are displayed proximate to the hand of the user. It should be understood that hands 1713, 1714, 1715, and 1716 in FIG. 17B are illustrated as alternatives and are not necessarily detected all at the same time in some embodiments.

In some embodiments, in response to detecting the user's gaze 1701a directed to the scrollable user interface element 1703 while detecting the user begin to provide an input with their hand (e.g., hand 1713 or 1714), the electronic device 101a displays a virtual trackpad (e.g., 1709a or 1709b) proximate to the hand of the user. In some embodiments, detecting the user beginning to provide an input with their hand includes detecting that the hand satisfies the indirect ready state criteria described above with reference to FIGS. 7A-8K. In some embodiments, detecting the user beginning to provide an input with their hand includes detecting the user performing a movement with their hand that satisfies one or more criteria, such as detecting the user begin a “tap” motion with an extended finger (e.g., the finger moves a threshold distance, such as 0.1, 0.2, 0.3, 0.5, 1, 2, etc. centimeters) while one or more of the other fingers are curled towards the palm.

For example, in response to detecting hand 1713 begin to provide an input while the gaze 1701a of the user is directed to the scrollable user interface element 1703, the electronic device 101a displays virtual trackpad 1709a proximate to hand 1713, and the virtual trackpad 1709a is displayed remote from the scrollable user interface element 1703. The electronic device 101a optionally also displays a virtual shadow 1710a of the user's hand 1713 on the virtual trackpad 1709a and a virtual shadow of the virtual trackpad. In some embodiments, the virtual shadows are displayed in a manner similar to one or more of the virtual shadows described below with reference to FIGS. 19A-20F. In some embodiments, the size and/or placement of the shadows indicates to the user how far the user must continue to move their finger to interact with the virtual trackpad 1709a, and thus to initiate an input directed to the scrollable user interface element 1703, such as by indicating the distance between the hand 1713 and the virtual trackpad 1709a. In some embodiments, as the user moves a finger of their hand 1713 closer to the virtual trackpad 1709a, the electronic device 101a updates the color of the virtual trackpad 1709a. In some embodiments, if the user moves their hand 1713 away from the virtual trackpad 1709a by a threshold distance (e.g., 1, 2, 3, 5, 10, 15, 20, 30, etc. centimeters) or ceases to make a hand shape corresponding to initiation of an input, the electronic device 101a ceases to display the virtual trackpad 1709a.

Similarly, in response to detecting hand 1714 begin to provide an input while the gaze 1701a of the user is directed to the scrollable user interface element 1703, the electronic device 101a displays virtual trackpad 1709b proximate to hand 1714, and the virtual trackpad 1709b is displayed remote from the scrollable user interface element 1703. The electronic device 101a optionally also displays a virtual shadow 1710b of the user's hand 1714 on the virtual trackpad 1709b and a virtual shadow of the virtual trackpad. In some embodiments, the virtual shadows are displayed in a manner similar to one or more of the virtual shadows described below with reference to FIGS. 19A-20F. In some embodiments, the size and/or placement of the shadows indicates to the user how far the user must continue to move their finger to interact with the virtual trackpad 1709a, and thus to initiate an input directed to the scrollable user interface element 1703, such as by indicating the distance between the hand 1714 and the virtual trackpad 1709b. In some embodiments, as the user moves a finger of their hand 1714 closer to the virtual trackpad 1709b, the electronic device 101a updates the color of the virtual trackpad 1709b. In some embodiments, if the user moves their hand 1714 away from the virtual trackpad 1709b by a threshold distance (e.g., 1, 2, 3, 5, 10, 15, 20, 30, etc. centimeters) or ceases to make a hand shape corresponding to initiation of an input, the electronic device 101a ceases to display the virtual trackpad 1709b.

Thus, in some embodiments, the electronic device 101a displays the virtual trackpad at a location proximate to the location of the hand of the user. In some embodiments, the user is able to provide inputs directed to the scrollable user interface element 1703 using the virtual trackpad 1709a or 1709b. For example, in response to the user moving the finger of hand 1713 or 1714 to touch the virtual trackpad 1709a or 1709b and then moving the finger away from the virtual trackpad (e.g., a virtual tap), the electronic device 101a makes a selection in the scrollable user interface element 1703. As another example, in response to detecting the user move the finger of hand 1713 or 1714 to touch the virtual trackpad 1709a or 1709b, move the finger along the virtual trackpad, and then move the finger away from the virtual trackpad, the electronic device 101a scrolls the scrollable user interface element 1703 as described below with reference to FIGS. 17C-17D.

In some embodiments, the electronic device 101a displays a visual indication of a user input provided by the user's hand in response to detecting the user begin to provide an input directed to the selectable option 1705 (e.g., based on determining that the gaze 1701b of the user is directed to option 1705 while the user begins to provide the input). In some embodiments, detecting the user beginning to provide an input with their hand includes detecting that the hand satisfies the indirect ready state criteria described above with reference to FIGS. 7A-8K. In some embodiments, detecting the user beginning to provide an input with their hand includes detecting the user performing a movement with their hand that satisfies one or more criteria, such as detecting the user begin a “tap” motion with an extended finger (e.g., the finger moves a threshold distance, such as 0.1, 0.2, 0.3, 0.5, 1, 2, etc. centimeters) while one or more of the other fingers are curled towards the palm.

For example, in response to detecting hand 1715 begin to provide an input while the gaze 1701b of the user is directed to the selectable option 1705, the electronic device 101a displays visual indication 1711a proximate to hand 1715, and the visual indication 1711a is displayed remote from selectable option 1705. The electronic device 101a also optionally displays a virtual shadow 1710c of the user's hand 1715 on the visual indication 1711a. In some embodiments, the virtual shadow is displayed in a manner similar to one or more of the virtual shadows described below with reference to FIGS. 19A-20F. In some embodiments, the size and/or placement of the shadow indicate to the user how far the user must continue to move their finger (e.g., to the location of the visual indication 1711a) to initiate an input directed to the selectable user interface element 1705, such as by indicating the distance between the hand 1715 and the visual indication 1711a.

Similarly and, in some embodiments, as an alternative to detecting hand 1715, in response to detecting hand 1716 begin to provide an input while the gaze 1701b of the user is directed to the selectable option 1705, the electronic device 101a displays visual indication 1711b proximate to hand 1716, and the visual indication 1711b is displayed remote from the selectable option 1705. The electronic device 101a optionally also displays a virtual shadow 1710d of the user's hand 1716 on the visual indication 1711b. In some embodiments, the virtual shadow is displayed in a manner similar to one or more of the virtual shadows described below with reference to FIGS. 19A-20F. In some embodiments, the size and/or placement of the shadow indicate to the user how far the user must continue to move their finger (e.g., to the location of the visual indication 1711b) to initiate an input directed to the selectable user interface element 1705, such as by indicating the distance between the hand 1716 and the visual indication 1711b. Thus, in some embodiments, the electronic device 101a displays the visual indication 1711a or 1711b at a location in the three-dimensional environment that is proximate to the hand 1715 or 1716 of the user that is beginning to provide the input.

It should be appreciated that, in some embodiments, the types of visual aids presented by the electronic device vary from the examples illustrated herein. For example, the electronic device 101a is able to display a visual indication similar to visual indications 1711a or 1711b while the user interacts with the scrollable user interface element 1703. In this example, the electronic device 101a, displays the visual indication similar to indications 1711a and 1711b in response to detecting movement of a hand (e.g., hand 1713) of the user initiating a tap while the gaze 1701a of the user is directed to the scrollable user interface element 1703 and continues to display the visual indication as the user moves a finger of hand 1713 to provide the scrolling input, updating the position of the visual indication to follow the movement of the finger. As another example, the electronic device 101a is able to display a virtual trackpad similar to virtual trackpads 1709a and 1709b while the user interacts with selectable option 1705. In this example, the electronic device 101a displays the virtual trackpad similar to virtual trackpads 1709a and 1709b in response to detecting movement of a hand (e.g., hand 1713) of the user initiating a tap while the gaze 1701b of the user is directed to the selectable option 1705.

In FIG. 17C, the electronic device 101a detects an input directed to the scrollable user interface element 1703 provided by hand 1713 and an input directed to the selectable option 1705 provided by hand 1715. It should be understood that the inputs provided by hands 1713 and 1715 and gazes 1701a and 1701b are illustrated as alternatives and, in some embodiments, are note concurrently detected. Detecting the input directed to the scrollable user interface element 1703 optionally includes detecting a finger of hand 1713 touching the virtual trackpad 1709 followed by movement of the finger and/or hand in a direction in which the scrollable user interface element 1703 scrolls (e.g., vertical movement for vertical scrolling). Detecting the input directed to the selectable option 1705 optionally includes detecting movement of a finger of hand 1715 to touch visual indication 1711. In some embodiments, detecting the input directed to option 1705 requires detecting the gaze 1701b of the user directed to option 1705. In some embodiments, the electronic device 101a detects the input directed to selectable option 1705 without requiring detecting the gaze 1701b of the user directed to the selectable option 1705.

In some embodiments, in response to detecting the input directed to the scrollable user interface element 1703, the electronic device 101a updates display of the scrollable user interface element 1703 and the virtual trackpad 1709. In some embodiments, as the input directed to the scrollable user interface element 1703 is received, the electronic device 101a moves the scrollable user interface element 1703 away from a viewpoint associated with the user in the three-dimensional environment (e.g., in accordance with the movement of the hand 1713 past and/or through the initial depth location of the virtual trackpad 1709). In some embodiments, as the hand 1713 moves closer to the virtual trackpad 1709, the electronic device 101a updates the color of the scrollable user interface element 1703. As shown in FIG. 17C, once the input is received, the scrollable user interface element 1703 is pushed back from the position shown in FIG. 17B and the shadow of the scrollable user interface element 1703 ceases to be displayed. Similarly, once the input is received, the virtual trackpad 1709 is pushed back and is no longer displayed with the virtual shadow shown in FIG. 17B. In some embodiments, the distance by which scrollable user interface element 1703 moves back corresponds to the amount of movement of the finger of hand 1713 while providing input directed to scrollable user interface element 1703. Moreover, as shown in FIG. 17C, the electronic device 101a ceases to display the virtual shadow of hand 1713 on the virtual trackpad 1709 according to one or more steps of method 2000. In some embodiments, while the hand 1713 is in contact with the virtual trackpad 1709, the electronic device 101a detects lateral movement of the hand 1713 and/or finger in contact with the trackpad 1709 in the direction in which the scrollable user interface element 1703 is scrollable and scrolls the content of the scrollable user interface element 1703 in accordance with the lateral movement of the hand 1713.

In some embodiments, in response to detecting the input directed to the selectable option 1705, the electronic device 101a updates display of the selectable option 1705 and the visual indication 1711 of the input. In some embodiments, as the input directed to the selectable option 1705 is received, the electronic device 101a moves the selectable option 1705 away from a viewpoint associated with the user in the three-dimensional environment and towards the backplane 1706 and updates the color of the selectable option 1705 (e.g., in accordance with the movement of the hand 1715 past and/or through the initial depth location of the visual indication 1711). As shown in FIG. 17C, once the input is received, the selectable option 1705 is pushed back from the position shown in FIG. 17B and the shadow of the selectable option 1705 ceases to be displayed. In some embodiments, the distance by which selectable option 1705 moves back corresponds to the amount of movement of the finger of hand 1715 while providing the input directed to selectable option 1705. Similarly, the electronic device 101a ceases to display the virtual shadow of hand 1715 on the visual indication 1711 (e.g., because a finger of hand 1715 is now in contact with the visual indication 1711) optionally according to one or more steps of method 2000. In some embodiments, after a finger of hand 1715 touches the visual indication 1711, the user moves the finger away from the visual indication 1711 to provide a tap input directed to the selectable option 1705.

In some embodiments, in response to detecting the input directed to the scrollable user interface element 1703 with hand 1713 and gaze 1701a or in response to detecting the input directed to the selectable option 1705 with hand 1715 and gaze 1701b, the electronic device 101a presents an audio indication that the input was received. In some embodiments, in response to detecting a hand movement that satisfies criteria for providing an input while the gaze of the user is not directed to an interactive user interface element, the electronic device 101a still presents the audio indication of the input and displays a virtual trackpad 1709 or visual indication 1711 proximate to the hand of the user even though touching and/or interacting with the virtual trackpad 1709 or visual indication 1711 does not cause an input to be directed to an interactive user interface element. In some embodiments, in response to a direct input directed to the scrollable user interface element 1703 or the selectable option 1705, the electronic device 101a updates the display of the scrollable user interface element 1703 or the selectable option 1705, respectively, in a manner similar to the manner described herein and, optionally, presents the same audio feedback as well. In some embodiments, a direct input is an input provided by the hand of the user when the hand of the user is within a threshold distance (e.g., 0.05, 0.1, 0.2, 0.3, 0.5, 1, etc. centimeters) of the scrollable user interface element 1703 or selectable option 1705 (e.g., similar to one or more direct inputs related to methods 800, 1000, and/or 1600).

FIG. 17D illustrates the electronic device 101a detecting the end of inputs provided to the scrollable user interface element 1703 and the selectable option 1705. It should be understood that, in some embodiments, hands 1713 and 1715 and gazes 1701a and 1701b are alternatives to each other and not necessarily detected all at the same time (e.g., the electronic device detects hand 1713 and gaze 1701a at a first time and detects hand 1715 and gaze 1701b at a second time). In some embodiments, the electronic device 101a detects the end of the input directed to the scrollable user interface element 1703 when the hand 1713 of the user moves a threshold distance (e.g., 0.05, 0.1, 0.2, 0.3, 0.5, 1, etc. centimeters) away from the virtual trackpad 1709. In some embodiments, the electronic device 101a detects the end of the input directed to the selectable option 1705 when the hand 1715 of the user moves a threshold distance (e.g., 0.05, 0.1, 0.2, 0.3, 0.5, 1, etc. centimeters) away from the visual indication 1711 of the input.

In some embodiments, in response to detecting the end of the inputs directed to the scrollable user interface element 1703 and the selectable option 1705, the electronic device 101a reverts the appearance of the scrollable user interface element 1703 and the selectable option 1705 to the appearances of these elements prior to detecting the input. For example, the scrollable user interface element 1703 moves towards the viewpoint associated with the user in the three-dimensional environment to the position at which it was displayed prior to detecting the input, and the electronic device 101a resumes displaying the virtual shadow of the scrollable user interface element 1703. As another example, the selectable option 1705 moves towards the viewpoint associated with the user in the three-dimensional environment to the position at which it was displayed prior to detecting the input and the electronic device 101a resumes display of the virtual shadow of the selectable option 1705.

Moreover, in some embodiments, the electronic device 101a reverts the appearance of the virtual trackpad 1709 or the visual indication 1711 of the input in response to detecting the end of the user input. In some embodiments, the virtual trackpad 1709 moves towards a viewpoint associated with the user in the three-dimensional environment to the position at which it was displayed prior to detecting the input directed to the scrollable user interface element 1703, and device 101a resumes display of the virtual shadow 1710e of the hand 1713 of the user on the trackpad and the virtual shadow of the virtual trackpad 1709. In some embodiments, after detecting the input directed to the scrollable user interface element 1703, the electronic device 101a ceases display of the virtual trackpad 1709. In some embodiments, the electronic device 101a continues to display the virtual trackpad 1709 after the input directed to the scrollable user interface element 1703 is provided and displays the virtual trackpad 1709 until the electronic device 101a detects the hand 1713 of the user move away from the virtual trackpad 1709 by a threshold distance (e.g., 1, 2, 3, 5, 10, 15, etc. centimeters) or at a threshold speed. Similarly, in some embodiments, the visual indication 1711 of the input moves towards a viewpoint associated with the user in the three-dimensional environment to the position at which it was displayed prior to detecting the input directed to the selectable option 1705, and device 101a resumes display of the virtual shadow 1710f of the hand 1715 of the user on the visual indication 1711. In some embodiments, after detecting the input directed to the selectable option 1705, the electronic device 101a ceases display of the visual indication 1711 of the input. In some embodiments, before ceasing to display the visual indication 1711, the electronic device 101a displays an animation of the indication 1711 expanding and fading before ceasing to be displayed. In some embodiments, the electronic device 101a resumes display of the visual indication 1711a in response to detecting the user begin to provide a subsequent input to the selectable option 1705 (e.g., moving a finger at the beginning of a tap gesture).

In some embodiments, the electronic device 101a (e.g., concurrently) accepts input from both of the user's hands in a coordinated manner. For example, in FIG. 17E, the electronic device 101a displays a virtual keyboard 1717 to which input can be provided based on the gaze of the user and movements of and/or inputs from the user's hands 1721 and 1723. For example, in response to detecting tapping gestures of the user's hands 1721 and 1723 while detecting the gaze 1701c or 1701d of the user directed to various portions of the virtual keyboard 1717, the electronic device 101a provides text input in accordance with the gazed-at keys of the virtual keyboard 1717. For example, in response to detecting a tap motion of hand 1721 while the gaze 1701c of the user is directed to the “A” key, the electronic device 101a enters the “A” character into a text entry field and in response to detecting a tap motion of hand 1723 while the gaze 1701d of the user is directed to the “H” key, the electronic device 101a enters the “H” character. While the user is providing the input with hands 1721 and 1723, the electronic device 101a displays indications 1719a and 1719b of the inputs provided by hands 1721 and 1723. In some embodiments, indications 1719a and/or 1719b for each of hands 1721 and 1723 are displayed in a similar manner and/or have one or more of the characteristics of the indications described with reference to FIGS. 17A-17D. The visual indications 1719a and 1719b optionally include virtual shadows 1710f and 1710g of the hands 1721 and 1723 of the user. In some embodiments, the shadows 1710f and 1719b indicate the distances between the hands 1721 and 1723 of the user and the visual indications 1710f and 1710g, respectively, and cease to be displayed when fingers of the hands 1721 and 1723 touch the indications 1710f and 1710g, respectively. In some embodiments, after each tap input, the electronic device 101a ceases to display the visual indication 1710f or 1710g corresponding to the hand 1721 or 1723 that provided the tap. In some embodiments, the electronic device 101a displays the indications 1710f and/or 1710g in response to detecting the beginning of a subsequent tap input by a corresponding hand 1721 or 1723.

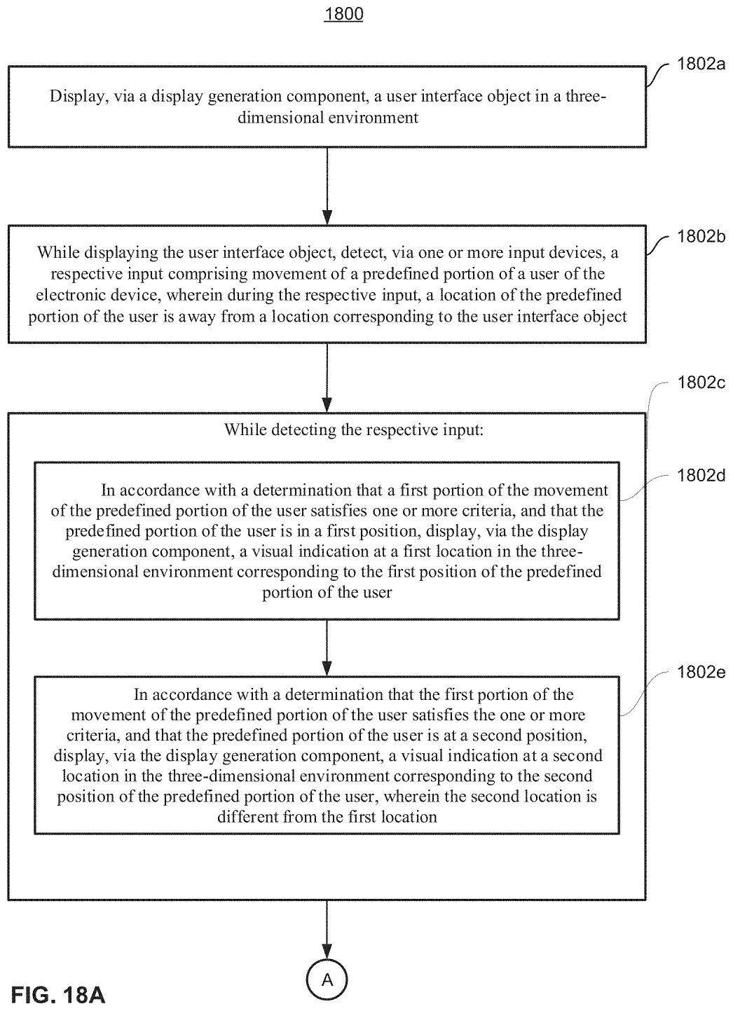

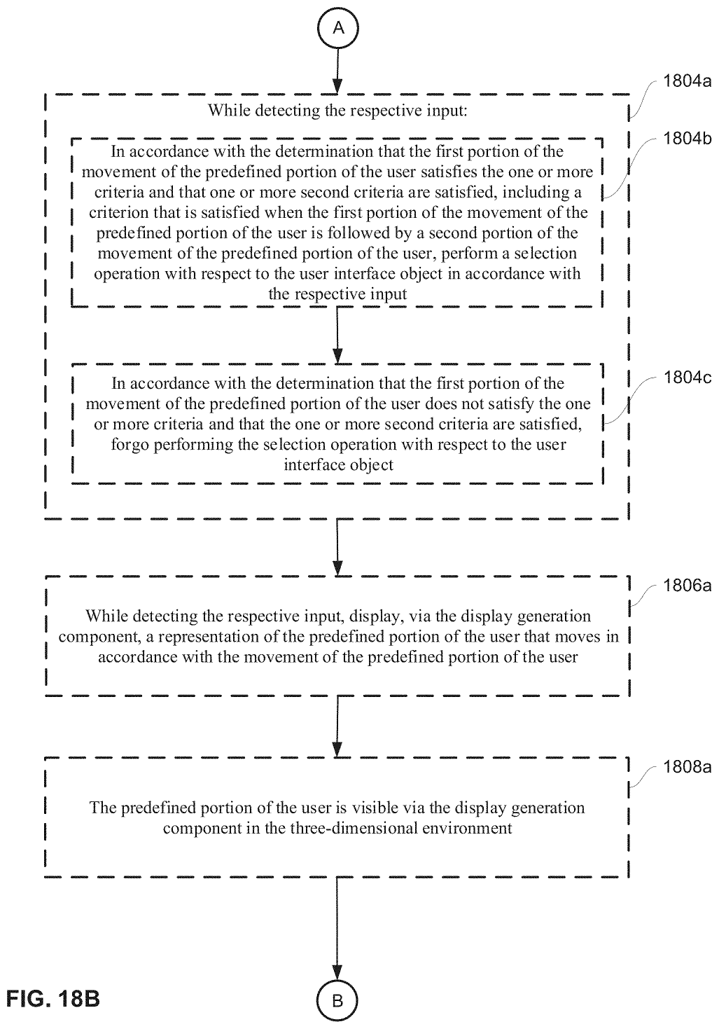

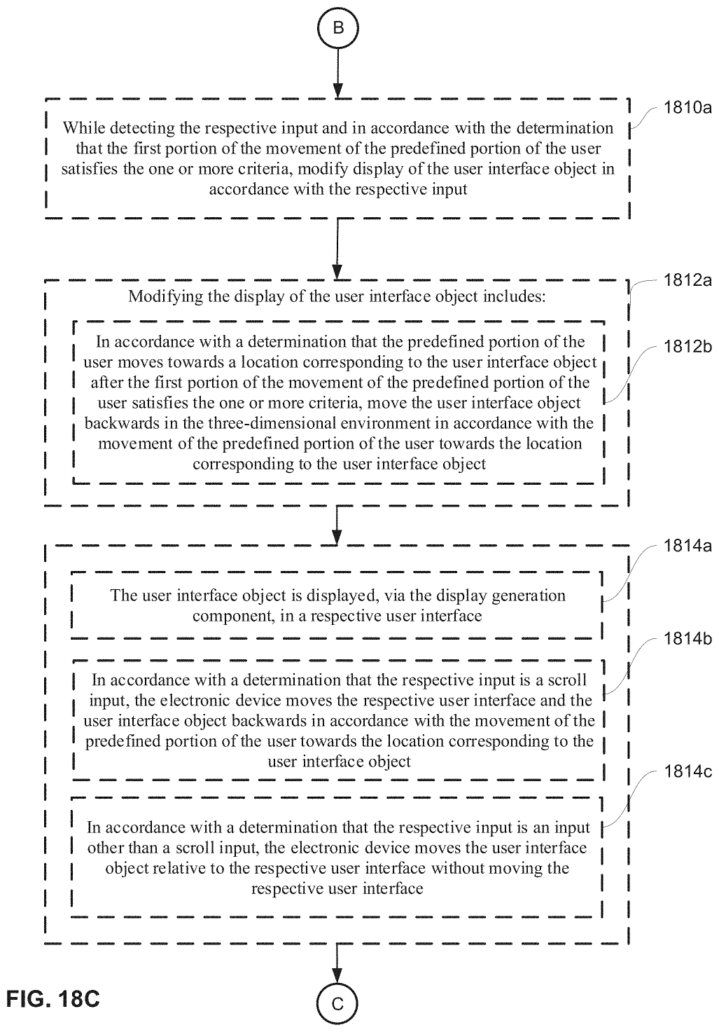

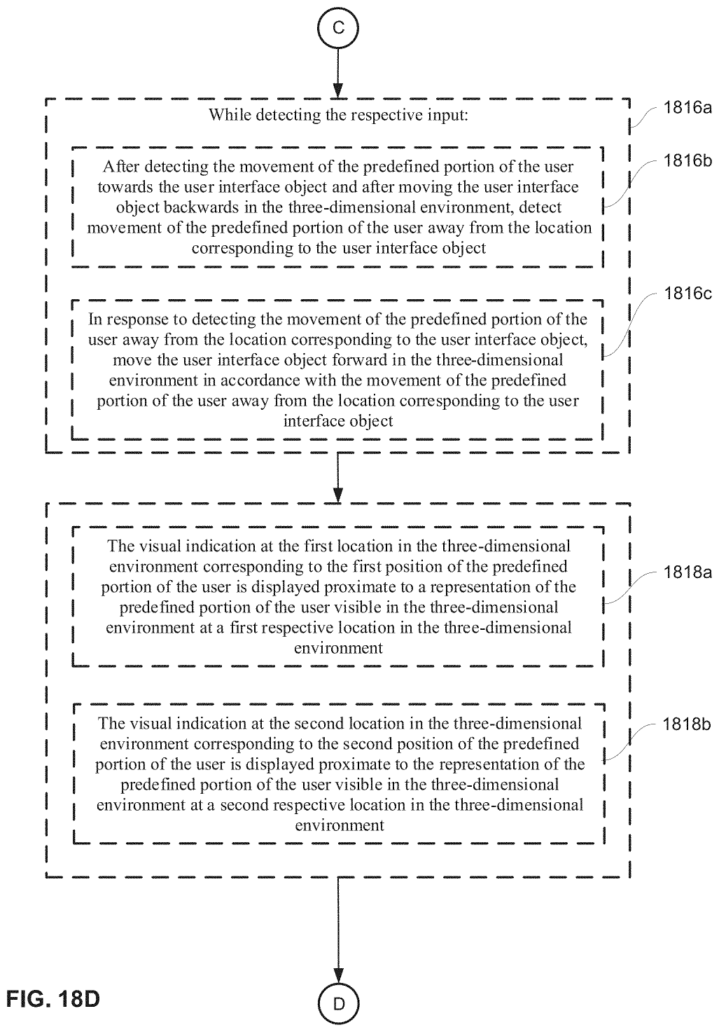

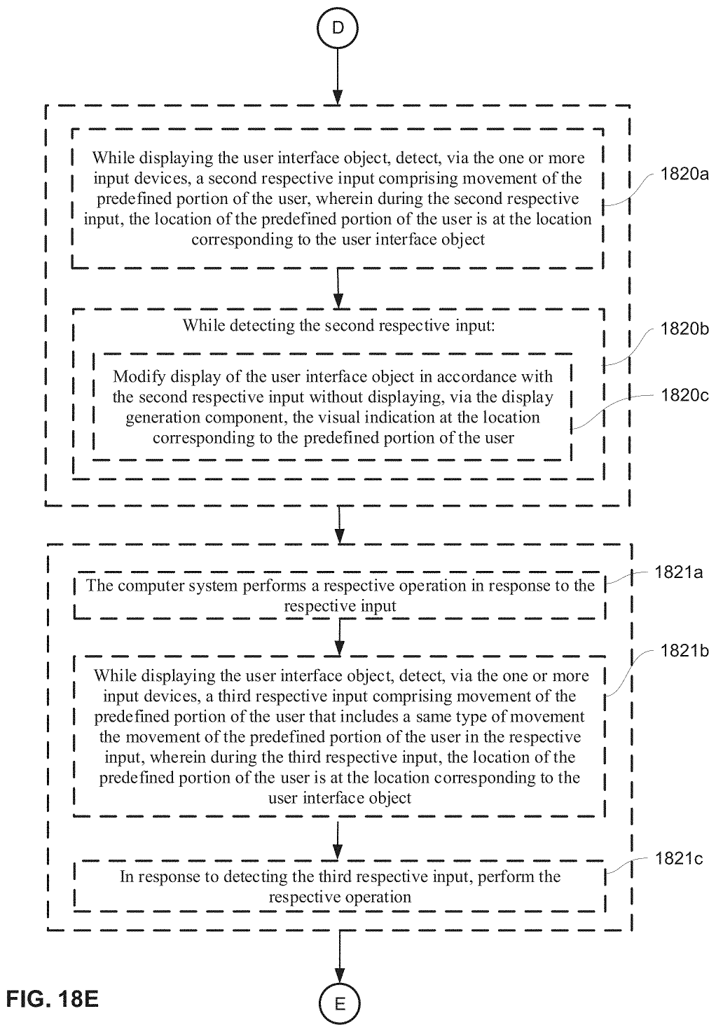

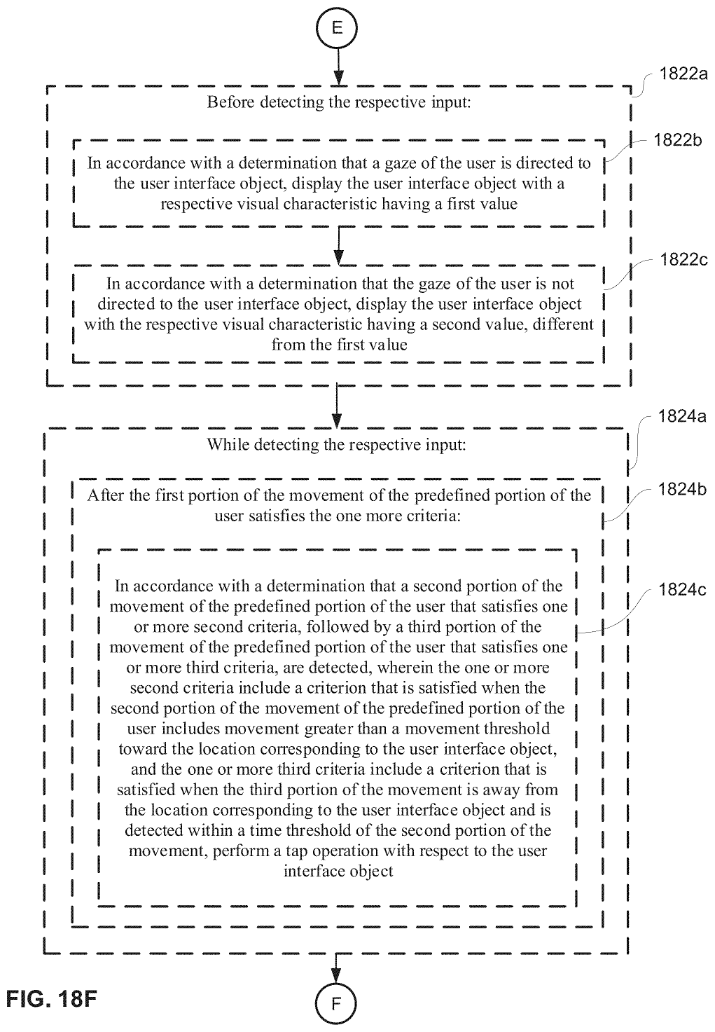

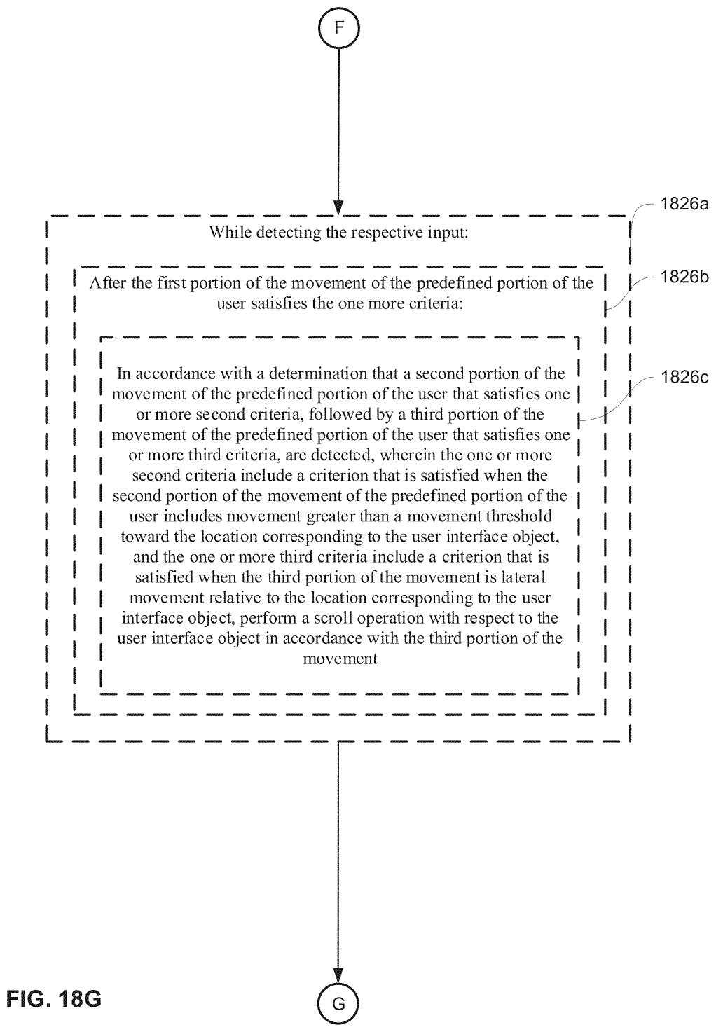

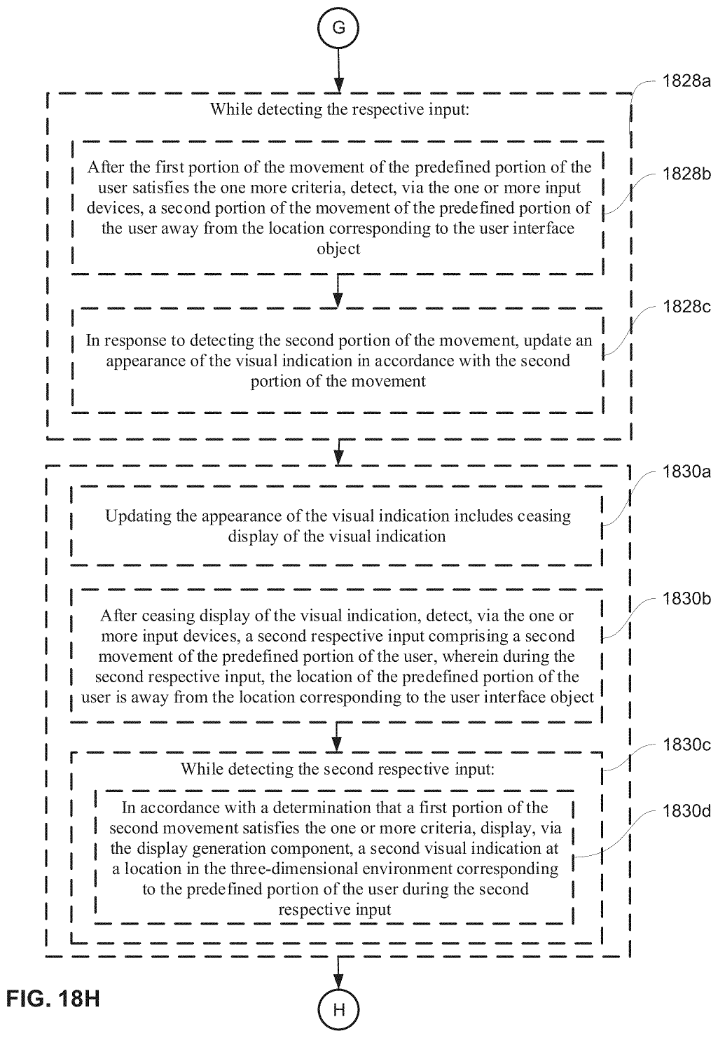

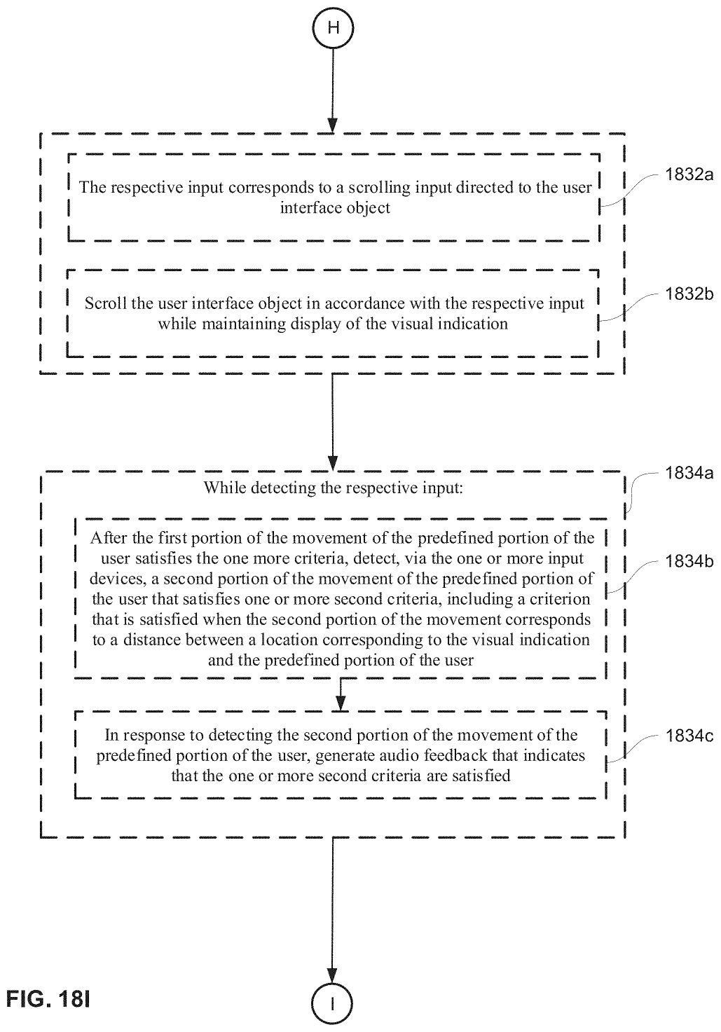

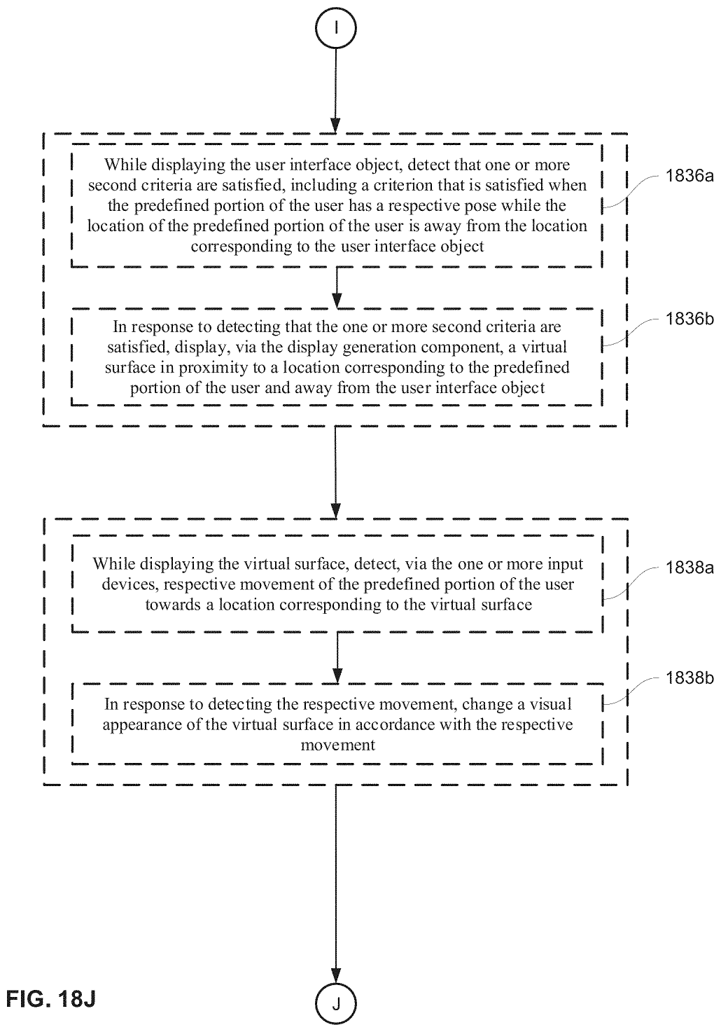

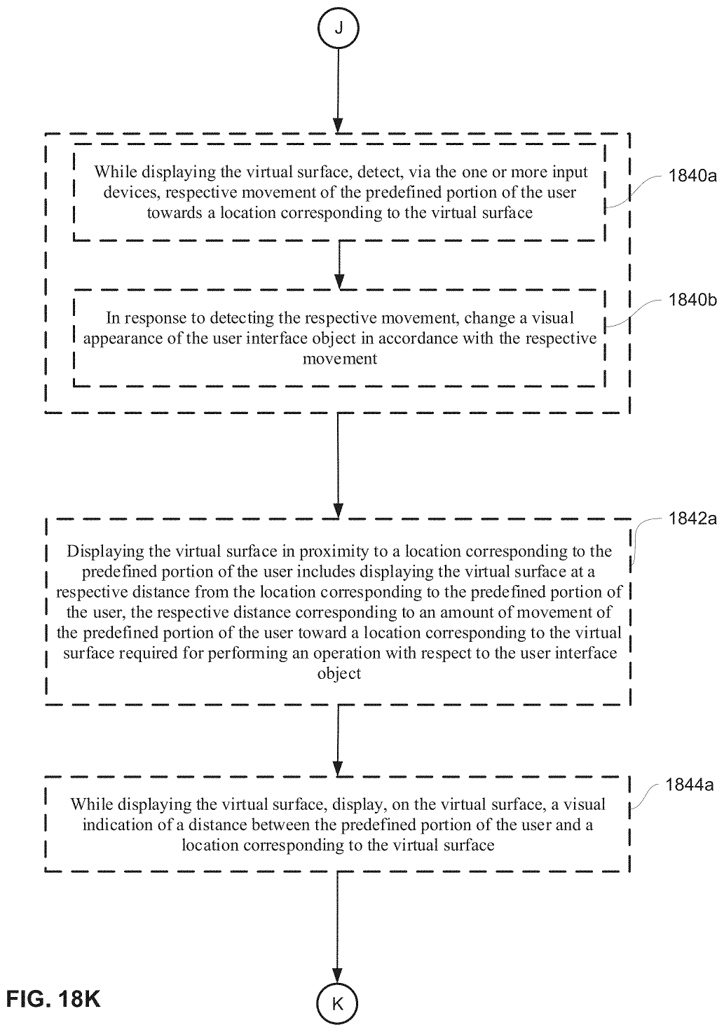

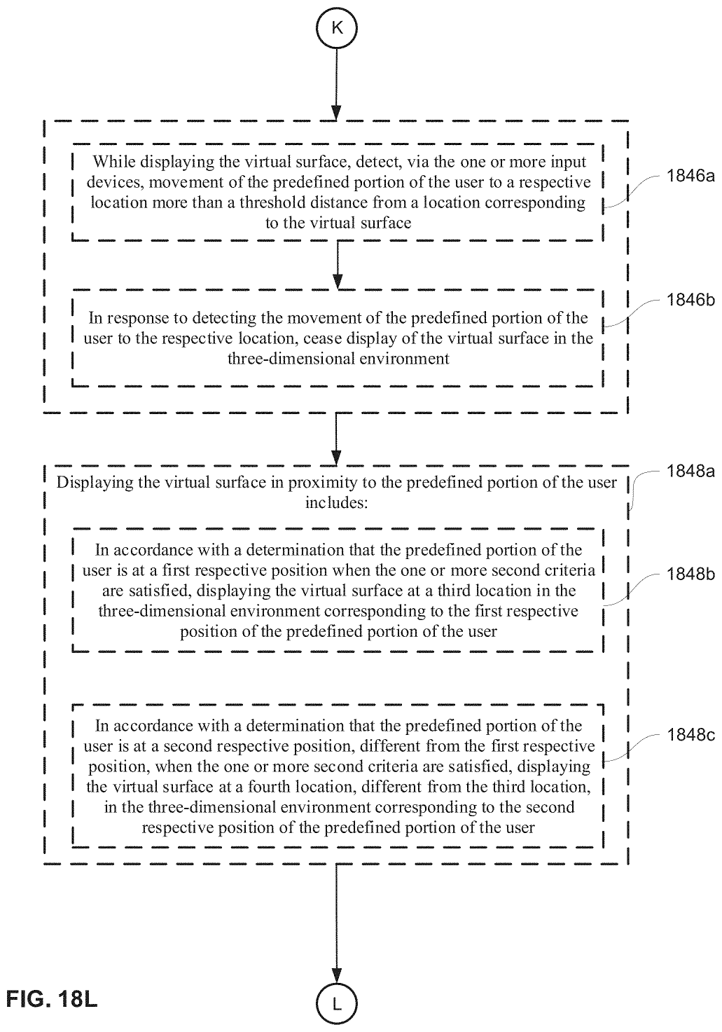

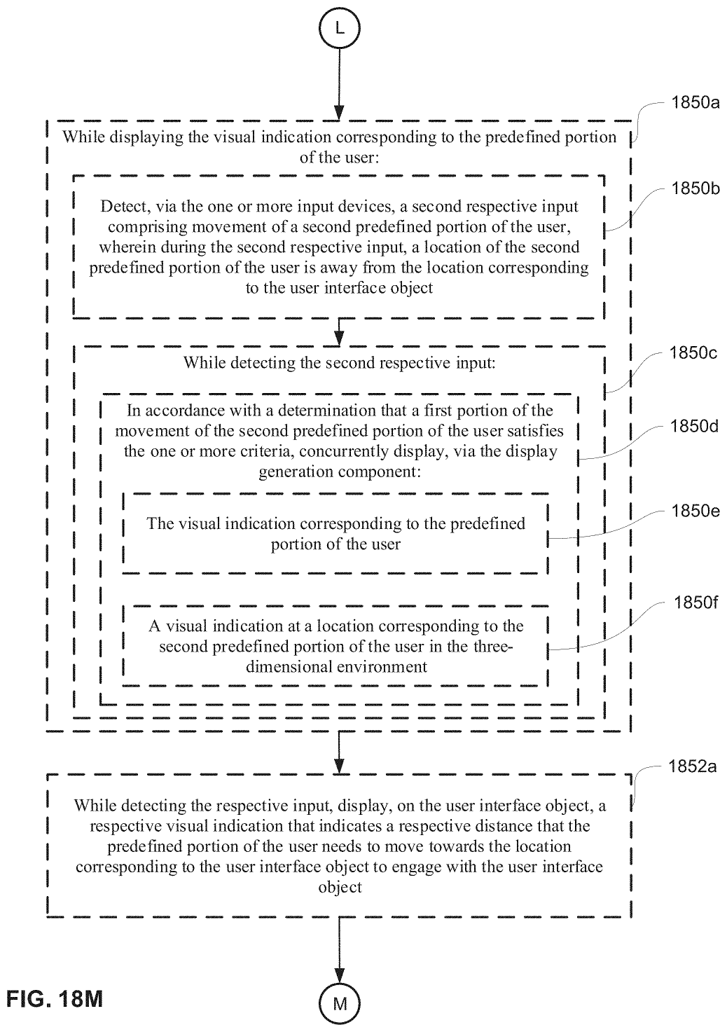

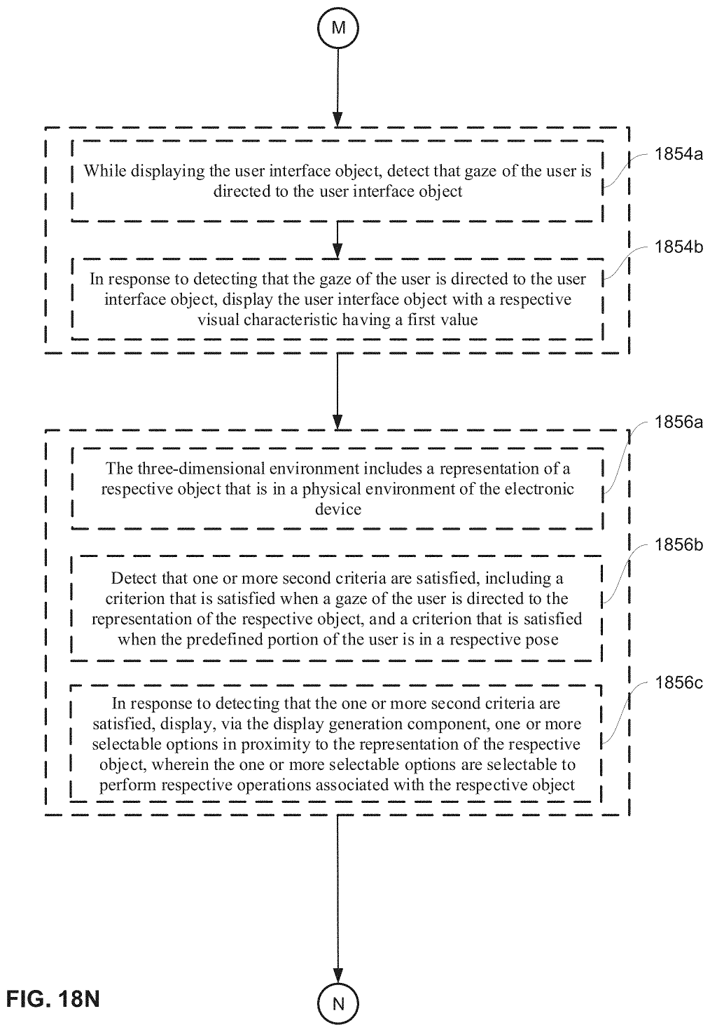

FIGS. 18A-180 is a flowchart illustrating a method 1800 of presenting visual indications of user inputs according to some embodiments. In some embodiments, the method 1800 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, a projector, etc.) and one or more cameras (e.g., a camera (e.g., color sensors, infrared sensors, and other depth-sensing cameras) that points downward at a user's hand or a camera that points forward from the user's head). In some embodiments, the method 1800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1800 are, optionally, combined and/or the order of some operations is, optionally, changed.

In some embodiments, method 1800 is performed at an electronic device in communication with a display generation component and one or more input devices (e.g., a mobile device (e.g., a tablet, a smartphone, a media player, or a wearable device), or a computer. In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc.). In some embodiments, the one or more input devices include an electronic device or component capable of receiving a user input (e.g., capturing a user input, detecting a user input, etc.) and transmitting information associated with the user input to the electronic device. Examples of input devices include a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera, a depth sensor, an eye tracking device, and/or a motion sensor (e.g., a hand tracking device, a hand motion sensor), etc. In some embodiments, the electronic device is in communication with a hand tracking device (e.g., one or more cameras, depth sensors, proximity sensors, touch sensors (e.g., a touch screen, trackpad). In some embodiments, the hand tracking device is a wearable device, such as a smart glove. In some embodiments, the hand tracking device is a handheld input device, such as a remote control or stylus.

In some embodiments, the electronic device 101a displays (1802a), such as in FIG. 17A, via the display generation component, a user interface object (e.g., 1705) in a three-dimensional environment. In some embodiments, the user interface object is an interactive user interface object and, in response to detecting an input directed towards the user interface object, the electronic device performs an action associated with the user interface object. For example, the user interface object is a selectable option that, when selected, causes the electronic device to perform an action, such as displaying a respective user interface, changing a setting of the electronic device, or initiating playback of content. As another example, the user interface object is a container (e.g., a window) in which a user interface/content is displayed and, in response to detecting selection of the user interface object followed by a movement input, the electronic device updates the position of the user interface object in accordance with the movement input. In some embodiments, the user interface object is displayed in a three-dimensional environment (e.g., a user interface including the user interface object is the three-dimensional environment and/or is displayed within a three-dimensional environment) that is generated, displayed, or otherwise caused to be viewable by the device (e.g., a computer-generated reality (CGR) environment such as a virtual reality (VR) environment, a mixed reality (MR) environment, or an augmented reality (AR) environment, etc.

In some embodiments, such as in FIG. 17B, while displaying the user interface object (e.g., 1705), the electronic device 101a detects (1802b), via the one or more input devices (e.g., a hand tracking device, a head tracking device, an eye tracking device, etc.), a respective input comprising movement of a predefined portion (e.g., 1715) (e.g., a finger, hand, arm, head, etc.) of a user of the electronic device, wherein during the respective input, a location of the predefined portion (e.g., 1715) of the user is away from (e.g., at least a threshold distance (e.g., 1, 5, 10, 20, 30, 50, 100, etc. centimeters) away from) a location corresponding to the user interface object (e.g., 1705). In some embodiments, the electronic device displays the user interface object in a three-dimensional environment that includes virtual objects (e.g., user interface objects, representations of applications, items of content) and a representation of the portion of the user. In some embodiments, the user is associated with a location in the three-dimensional environment corresponding to the location of the electronic device in the three-dimensional environment. In some embodiments, the representation of the portion of the user is a photorealistic representation of the portion of the user displayed by the display generation component or a view of the portion of the user that is visible through a transparent portion of the display generation component. In some embodiments, the respective input of the predefined portion of the user is an indirect input such as described with reference to methods 800, 1000, 1200, 1600, and/or 2000.

In some embodiments, such as in FIG. 17B, while detecting the respective input (1802c), in accordance with a determination that a first portion of the movement of the predefined portion (e.g., 1715) of the user satisfies one or more criteria, and that the predefined portion (e.g., 1715) of the user is in a first position (e.g., in the three-dimensional environment), the electronic device 101a displays (1802d), via the display generation component, a visual indication (e.g., 1711a) at a first location in the three-dimensional environment corresponding to the first position of the predefined portion (e.g., 1715) of the user. In some embodiments, the one or more criteria are satisfied when the first portion of the movement has a predetermined direction, magnitude, or speed. In some embodiments, the one or more criteria are satisfied based on a pose of the predetermined portion of the user while and/or (e.g., immediately) before the first portion of the movement is detected. For example, movement of the hand of the user satisfies the one or more criteria if the palm of the user's hand faces away from the user's torso while the hand is in a predetermined hand shape (e.g., a pointing hand shape in which one or more fingers are extended and one or more fingers are curled towards the palm) while the user moves one or more fingers of the hand away from the user's torso by a predetermined threshold distance (e.g., 0.1, 0.2, 0.3, 0.5, 1, 2, 3, etc. centimeters)). For example, the electronic device detects the user begin to perform a tapping motion by moving one or more fingers and/or the hand with one or more fingers extended. In some embodiments, in response to detecting movement of the user's finger that satisfies the one or more criteria, the electronic device displays a visual indication proximate to the finger, hand or a different predetermined portion of the hand. For example, in response to detecting the user begin to tap their index finger while their palm faces away from the torso of the user, the electronic device displays a visual indication proximate to the tip of the index finger. In some embodiments, the visual indication is positioned at a distance away from the tip of the index finger that matches or corresponds to the distance by which the user must further move the finger to cause selection of a user interface element towards which input is directed (e.g., a user interface element towards which the user's gaze is directed). In some embodiments, the visual indication is not displayed while the first portion of the movement is detected (e.g., is displayed in response to completion of the first portion of the movement that satisfies the one or more criteria). In some embodiments, the one or more criteria include a criterion that is satisfied when the portion of the user moves away from the torso of the user and/or towards the user interface object by a predetermined distance (e.g., 0.1, 0.2, 0.5, 1, 2, 3, etc. centimeters) and, in response to detecting movement of the portion of the user towards the torso of the user and/or away from the user interface object after detecting the first portion of the movement that satisfies the one or more criteria, the electronic device ceases displaying the visual indication. In some embodiments, the one or more criteria include a criterion that is satisfied when the predetermined portion of the user is in a predetermined position, such as within an area of interest within a threshold distance (e.g., 2, 3, 5, 10, 15, 30, etc. centimeters) of the gaze of the user, such as described with reference to method 1000. In some embodiments, the one or more criteria are satisfied irrespective of the position of the portion of the user relative to the area of interest.

In some embodiments, such as in FIG. 17B, while detecting the respective input (1802c), in accordance with a determination that the first portion of the movement of the predefined portion (e.g., 1716) of the user satisfies the one or more criteria, and that the predefined portion (e.g., 1716) of the user is at a second position, the electronic device 101a displays (1802e), via the display generation component, a visual indication (e.g., 1711b) at a second location in the three-dimensional environment corresponding to the second position of the predefined portion (e.g., 1716) of the user, wherein the second location is different from the first location. In some embodiments, the location in the three-dimensional environment at which the visual indication is displayed depends on the position of the predefined portion of the user. In some embodiments, the electronic device displays the visual indication with a predefined spatial relationship relative to the predefined portion of the user. In some embodiments, in response to detecting the first portion of the movement of the predefined portion of the user while the predefined portion of the user is in the first position, the electronic device displays the visual indication at a first location in the three-dimensional environment with the predefined spatial relationship relative to the predefined portion of the user and in response to detecting the first portion of the movement of the predefined portion of the user while the predefined portion of the user in in the second position, the electronic device displays the visual indication at a third location in the three-dimensional environment with the predefined spatial relationship relative to the predefined portion of the user.

The above-described manner of displaying the visual indication corresponding to the predetermined portion of the user indicating that the input was detected and the predefined portion of the user is engaged with a user interface object provides an efficient way of indicating that input from the predefined portion of the user will cause interaction with the user interface object, which simplifies the interaction between the user and the electronic device and enhances the operability of the electronic device and makes the user-device interface more efficient (e.g., by reducing unintentional inputs from the user), which additionally reduces power usage and improves battery life of the electronic device by enabling the user to use the electronic device more quickly and efficiently, while reducing errors in usage.

In some embodiments, such as in FIG. 17C, while detecting the respective input (1804a), in accordance with the determination that the first portion of the movement of the predefined portion (e.g., 1715) of the user satisfies the one or more criteria and that one or more second criteria are satisfied, including a criterion that is satisfied when the first portion of the movement of the predefined portion (e.g., 1715) of the user is followed by a second portion of the movement of the predefined portion (e.g., 1715) of the user (e.g., and the second portion of the movement of the predefined portion of the user satisfies one or more criteria, such as a distance, speed, duration, or other threshold or the second portion of movement matches a predetermined portion of movement, and the gaze of the user is directed to the user interface object), the electronic device 101a performs (1804b) a selection operation with respect to the user interface object (e.g., 1705) in accordance with the respective input. In some embodiments, performing a selection operation includes selecting the user interface object, activating or deactivating a setting associated with the user interface object, initiating, stopping, or modifying playback of an item of content associated with the user interface object, initiating display of a user interface associated with the user interface object, and/or initiating communication with another electronic device. In some embodiments, the one or more criteria include a criterion that is satisfied when the second portion of movement has a distance that meets a distance threshold (e.g., a distance between the predefined portion of the user and the visual indication in the three-dimensional environment). In some embodiments, in response to detecting that the distance of the second portion of the movement exceeds the distance threshold, the electronic device moves the visual indication (e.g., backwards) in accordance with the distance exceeding the threshold (e.g., to display the visual indication at a location corresponding to the predefined portion of the user). For example, the visual indication is initially 2 centimeters from the user's finger tip and, in response to detecting the user move their finger towards the user interface object by 3 centimeters, the electronic device moves the visual indication towards the user interface object by 1 centimeter in accordance with the movement of the finger past or through the visual indication and selects the user interface object and selection occurs once the user's finger tip moves by 2 centimeters. In some embodiments, the one or more criteria include a criterion that is satisfied in accordance with a determination that the gaze of the user is directed towards the user interface object and/or that the user interface object is in the attention zone of the user described with reference to method 1000.

In some embodiments, while detecting the respective input (1804a), in accordance with the determination that the first portion of the movement of the predefined portion (e.g., 1715 in FIG. 17C) of the user does not satisfy the one or more criteria and that the one or more second criteria are satisfied, the electronic device 101a forgoes (1804c) performing the selection operation with respect to the user interface object (e.g., 1705 in FIG. 17C). In some embodiments, even if the one or more second criteria are satisfied, including the criterion that is satisfied by detecting movement corresponding to the second portion of movement, the electronic device forgoes performing the selection operation if the first portion of the movement does not satisfy the one or more criteria. For example, the electronic device performs the selection operation in response to detecting the second portion of movement while displaying the visual indication. In this example, in response to detecting the second portion of movement while the electronic device does not display the visual indication, the electronic device forgoes performing the selection operation.

The above-described manner of performing the selection operation in response to one or more second criteria being satisfied after the first portion of movement is detected and while the visual indication is displayed provides an efficient way of accepting user inputs based on movement of a predefined portion of the user and rejecting unintentional inputs when the movement of the predefined portion of the user satisfies the second one or more criteria without first detecting the first portion of movement, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 17C, while detecting the respective input, the electronic device 101a displays (1806a), via the display generation component, a representation of the predefined portion (e.g., 1715) of the user that moves in accordance with the movement of the predefined portion (e.g., 1715) of the user. In some embodiments, the representation of the predefined portion of the user is a photorealistic representation of the portion of the user (e.g., pass-through video) displayed at a location in the three-dimensional environment corresponding to the location of the predefined portion of the user in the physical environment of the electronic device. In some embodiments, the pose of the representation of the predefined portion of the user matches the pose of the predefined portion of the user. For example, in response to detecting the user making a pointing hand shape at a first location in the physical environment, the electronic device displays a representation of a hand making the pointing hand shape at a corresponding first location in the three-dimensional environment. In some embodiments, the representation of the portion of the use is a view of the portion of the user through a transparent portion of the display generation component.

The above-described manner of displaying the representation of the predefined portion of the user that moves in accordance with the movement of the predefined portion of the user provides an efficient way of presenting feedback to the user as the user moves the predefined portion of the user to provide inputs to the electronic device, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 17C, the predefined portion (e.g., 1715) of the user is visible via the display generation component in the three-dimensional environment (1808a). In some embodiments, the display generation component includes a transparent portion through which the predefined portion of the user is visible (e.g., true passthrough). In some embodiments, the electronic device presents, via the display generation component, a photorealistic representation of the predefined portion of the user (e.g., virtual passthrough video).

The above-described manner of making the predefined portion of the user visible via the display generation component provides efficient visual feedback of the user input to the user, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 17C, while detecting the respective input and in accordance with the determination that the first portion (e.g., 1715) of the movement of the predefined portion of the user satisfies the one or more criteria, the electronic device 101a modifies (1810a) display of the user interface object (e.g., 1705) in accordance with the respective input. In some embodiments, modifying display of the user interface object includes one or more of updating a color, size, or position in the three-dimensional environment of the user interface object.

The above-described manner of modifying display of the user interface object in response to the first portion of movement provides an efficient way of indicating that further input will be directed towards the user interface object, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 17C, modifying the display of the user interface object (e.g., 1705) includes (1812a) in accordance with a determination that the predefined portion (e.g., 1715) of the user moves towards a location corresponding to the user interface object (e.g., 1705) after the first portion of the movement of the predefined portion (e.g., 1715) of the user satisfies the one or more criteria, moving the user interface object (e.g., 1705) backwards (e.g., away from the user, in the direction of movement of the predefined portion of the user) in the three-dimensional environment in accordance with the movement of the predefined portion (e.g., 1715) of the user towards the location corresponding to the user interface object (e.g., 1705) (1812b). In some embodiments, the electronic device moves the user interface object backwards by an amount proportional to the amount of movement of the predefined portion of the user following the first portion of the movement that satisfies the one or more criteria. For example, in response to detecting movement of the predefined portion of the user by a first amount, the electronic device moves the user interface object backwards by a second amount. As another example, in response to detecting movement of the predefined portion of the user by a third amount greater than the first amount, the electronic device moves the user interface object backwards by a fourth amount greater than the second amount. In some embodiments, the electronic device moves the user interface object backwards while the movement of the predefined portion of the user following the first portion of movement is detected after the predefined portion of the user has moved enough to cause selection of the user interface object.

The above-described manner of moving the user interface object backwards in accordance with the movement of the predefined portion of the user after the first portion of movement provides an efficient way of indicating to the user which user interface element the input is directed to, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 17C, the user interface object (e.g., 1705) is displayed, via the display generation component, in a respective user interface (e.g., 1706) (1814a) (e.g., in a window or other container, overlaid on a backplane, in the user interface of a respective application, etc.).

In some embodiments, such as in FIG. 17C, in accordance with a determination that the respective input is a scroll input, the electronic device 101a moves the respective user interface and the user interface object (e.g., 1703) backwards in accordance with the movement of the predefined portion (e.g., 1713) of the user towards the location corresponding to the user interface object (e.g., 1703) (1814b) (e.g., the user interface element does not move away from the user relative to the respective user interface element, but rather, moves the user interface element along with the respective user interface element).

In some embodiments, such as in FIG. 17C, in accordance with a determination that the respective input is an input other than a scroll input (e.g., a selection input, an input to move the user interface element within the three-dimensional environment), the electronic device moves the user interface object (e.g., 1705) relative to the respective user interface (e.g., 1706) (e.g., backwards) without moving the respective user interface (e.g., 1706) (1814c). In some embodiments, the user interface object moves independent from the respective user interface. In some embodiments, the respective user interface does not move. In some embodiments, in response to a scroll input, the electronic device moves the user interface object backwards with the container of the user interface object and, in response to an input other than a scroll input, the electronic device moves the user interface object backwards without moving the container of the user interface object backwards.

The above-described manner of selectively moving the respective user interface object backwards depending on the type of input of the respective input provides an efficient way of indicating to the user which user interface element the input is directed to, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 17C, while detecting the respective input (1816a), after detecting the movement of the predefined portion (e.g., 1715) of the user towards the user interface object (e.g., 1705) and after moving the user interface object backwards in the three-dimensional environment, the electronic device 101a detects (1816b) movement of the predefined portion (e.g., 1715) of the user away from the location corresponding to the user interface object (e.g., towards the torso of the user). In some embodiments, the movement of the predefined portion of the user away from the location corresponding to the user interface object is detected after performing a selection operation in response to detecting movement of the predefined portion of the user that satisfies one or more respective criteria. In some embodiments, the movement of the predefined portion of the user away from the location corresponding to the user interface object is detected after forgoing performing a selection operation in response to detecting movement of the predefined portion of the user that does not satisfy the one or more respective criteria.

In some embodiments, such as in FIG. 17D, while detecting the respective input (1816a), in response to detecting the movement of the predefined portion (e.g., 1715) of the user away from the location corresponding to the user interface object (e.g., 1705), the electronic device 101a moves (1816c) the user interface object forward (e.g., 1705) (e.g., towards the user) in the three-dimensional environment in accordance with the movement of the predefined portion (e.g., 1715) of the user away from the location corresponding to the user interface object (e.g., 1705). In some embodiments, in response to movement of the predefined portion of the user away from the user interface object by a distance that is less than a predetermined threshold, the electronic device moves the respective user interface element forward by an amount proportional to the distance of the movement of the predefined portion of the user while detecting the movement of the predefined portion of the user. In some embodiments, once the distance of the movement of the predefined portion of the user reaches the predetermined threshold, the electronic device displays the user interface element at a distance from the user at which the user interface element was displayed prior to detecting the respective input. In some embodiments, in response to detecting movement of the predefined portion of the user away from the user interface object by more than the threshold distance, the electronic device stops moving the user interface object forward and maintains display of the user interface element at the distance from the user at which the user interface object was displayed prior to detecting of the respective input.

The above-described manner of moving the user interface object forward in response to the movement of the predefined portion of the user away from the user interface object provides an efficient way of providing feedback to the user that the movement away from the user interface element was detected, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 17B, the visual indication (e.g., 1711a) at the first location in the three-dimensional environment corresponding to the first position of the predefined portion (e.g., 1715) of the user is displayed proximate to a representation of the predefined portion (e.g., 1715) of the user visible in the three-dimensional environment at a first respective location in the three-dimensional environment (1818a). In some embodiments, the representation of the predefined portion of the user is a photorealistic representation of the predefined portion of the user displayed by the display generation component (e.g., virtual pass through). In some embodiments, the representation of the predefined portion of the user is the predefined portion of the user visible through a transparent portion of the display generation component (e.g., true passthrough). In some embodiments, the predefined portion of the user is the user's hand and the visual indication is displayed proximate to the tip of the user's finger.

In some embodiments, such as in FIG. 17B, the visual indication (e.g., 1711b) at the second location in the three-dimensional environment corresponding to the second position of the predefined portion (e.g., 1715b) of the user is displayed proximate to the representation of the predefined portion (e.g., 1715b) of the user visible in the three-dimensional environment at a second respective location in the three-dimensional environment (1818b). In some embodiments, when the user moves the predefined portion of the user, the electronic device updates the position of the visual indication to continue to be displayed proximate to the predefined portion of the user. In some embodiments, after detecting the movement that satisfies the one or more criteria and before detecting the movement of the portion of the user towards the torso of the user and/or away from the user interface object, the electronic device continues to display the visual indication (e.g., at and/or proximate to the tip of the finger that performed the first portion of the movement) and updates the position of the visual indication in accordance with additional movement of the portion of the user. For example, in response to detecting a movement of the finger of the user that satisfies the one or more criteria, including movement of the finger away from the torso of the user and/or towards the user interface object, the electronic device displays the visual indication and continues to display the visual indication at the location of a portion of the hand (e.g., around a finger, such as the extended finger) if the hand of the user moves laterally or vertically without moving towards the torso of the user. In some embodiments, in accordance with a determination that the first portion of the movement does not satisfy the one or more criteria, the electronic device forgoes displaying the visual indication.

The above-described manner of displaying the visual indication proximate to the predefined portion of the user provides an efficient way of indicating that movement of the predefined portion of the user causes inputs to be detected at the electronic device, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 7C, while displaying the user interface object, the electronic device 101a detects (1820a), via the one or more input devices, a second respective input comprising movement of the predefined portion (e.g., 709) of the user, wherein during the second respective input, the location of the predefined portion (e.g., 709) of the user is at the location corresponding to the user interface object (e.g., 705) (e.g., the predefined portion of the user is within a threshold distance (e.g., 0.5, 1, 2, 3, 5, 10, 15, etc. centimeters) of the user interface object such that the predefined portion of the user is directly interacting with the user interface object, such as described with reference to methods 800, 1000, 1200, 1400, 1600 and/or 2000).

In some embodiments, such as in FIG. 7C, while detecting the second respective input (1820b), the electronic device modifies (1820c) display (e.g., a color, size, position, etc.) of the user interface object (e.g., 705) in accordance with the second respective input without displaying, via the display generation component, the visual indication at the location corresponding to the predefined portion (e.g., 709) of the user. For example, in response to detecting a predefined pose of the predefined portion of the user while the predefined portion of the user is within a threshold distance (e.g., 0.5, 1, 2, 3, 5, 10, 15, etc. centimeters) of the user interface object, the electronic device updates a color of the user interface object. In some embodiments, the electronic device detects movement of the predefined portion of the user towards the user interface object and, in response to the movement of the predefined portion of the user and once the predefined portion of the user has made contact with the user interface object, the electronic device moves the user interface object in accordance with the movement of the predefined portion of the user (e.g., in a direction, with a speed, over a distance corresponding to the direction, speed, and/or distance of the movement of the predefined portion of the user).

The above-described manner of modifying display of the user interface object in accordance with the second respective input provides an efficient way of indicating to the user which user interface element the second input is directed towards, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 17C, the electronic device (e.g., 101a) performs a respective operation in response to the respective input (e.g., 1821a).

In some embodiments, while displaying the user interface object (e.g., 1703, 1705 in FIG. 17C), the electronic device (e.g., 101a) detects (e.g., 1821b), via the one or more input devices (e.g., 314a), a third respective input comprising movement of the predefined portion (e.g., 1713, 1715 in FIG. 17C) of the user that includes a same type of movement as the movement of the predefined portion of the user in the respective input (e.g., the third respective input is a repetition or substantial repetition of the respective input), wherein during the third respective input, the location of the predefined portion of the user is at the location corresponding to the user interface object. For example, hand 1713 and/or 1715 is located at the location of option 1705 when providing the input in FIG. 17C.

In some embodiments, such as in FIG. 17C, in response to detecting the third respective input, the electronic device (e.g., 101) performs (e.g., 1821c) the respective operation (e.g., without displaying, via the display generation component, the visual indication at the location corresponding to the predefined portion of the user). In some embodiments, the electronic device performs the same operation in response to an input directed to a respective user interface element irrespective of the type of input provided (e.g., direct input, indirect input, air gesture input, etc.).

Performing the same operation in response to an input directed to a respective user interface element irrespective of the type of input received provides consistent and convenient user interactions with the electronic device, thereby enabling the user to use the electronic device quickly and efficiently.

In some embodiments, such as in FIG. 17B, before detecting the respective input (1822a), in accordance with a determination that a gaze (e.g., 1701b) of the user is directed to the user interface object (e.g., 1705), the electronic device displays (1822b) the user interface object (e.g., 1705) with a respective visual characteristic (e.g., size, position, color) having a first value. In some embodiments, while the gaze of the user is directed to the user interface object, the electronic device displays the user interface object in a first color.

In some embodiments, before detecting the respective input (1822a), such as the input in FIG. 17B, in accordance with a determination that the gaze of the user is not directed to the user interface object (e.g., 1705), the electronic device displays (1822c) the user interface object (e.g., 1705) with the respective visual characteristic having a second value, different from the first value. In some embodiments, while the gaze of the user is not directed to the user interface object, the electronic device displays the user interface object in a second color.

The above-described manner of updating the respective visual characteristic of the user interface object depending on whether the gaze of the user is directed to the user interface object or not provides an efficient way of indicating to the user which user interface element input will be directed to, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 17C, while detecting the respective input (1824a), after the first portion of the movement of the predefined portion (e.g., 1715) of the user satisfies the one more criteria (1824b), in accordance with a determination that a second portion of the movement of the predefined portion (e.g., 1715) of the user that satisfies one or more second criteria, followed by a third portion of the movement of the predefined portion (e.g., 1715) of the user that satisfies one or more third criteria, are detected, wherein the one or more second criteria include a criterion that is satisfied when the second portion of the movement of the predefined portion (e.g., 1715) of the user includes movement greater than a movement threshold toward the location corresponding to the user interface object (e.g., enough for selection), and the one or more third criteria include a criterion that is satisfied when the third portion of the movement is away from the location corresponding to the user interface object (e.g., 1705) and is detected within a time threshold (e.g., 0.1, 0.2, 0.3, 0.5, 1, 2, etc. seconds) of the second portion of the movement, the electronic device 101a performs (1824c) a tap operation with respect to the user interface object (e.g., 1705). In some embodiments, the first portion of the movement of the predefined portion of the user is movement of the predefined portion of the user towards the user interface object by a first amount, the second portion of the movement of the predefined portion of the user is further movement of the predefined portion of the user towards the user interface object by a second amount (e.g., sufficient for indirect selection of the user interface object), and the third portion of the movement of the predefined portion of the user is movement of the predefined portion of the user away from the user interface element. In some embodiments, the tap operation corresponds to selection of the user interface element (e.g., analogous to tapping a user interface element displayed on a touch screen).

The above-described manner of performing the tap operation in response to detecting the first, second, and third portions of movement provides an efficient way of receiving tap inputs while the predefined portion of the user is at a location away from the user interface object, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 17C, while detecting the respective input (1826a), after the first portion of the movement of the predefined portion (e.g., 1713) of the user satisfies the one more criteria (1826b), in accordance with a determination that a second portion of the movement of the predefined portion (e.g., 1713) of the user that satisfies one or more second criteria, followed by a third portion of the movement of the predefined portion (e.g., 1713) of the user that satisfies one or more third criteria, are detected, wherein the one or more second criteria include a criterion that is satisfied when the second portion of the movement of the predefined portion (e.g., 1713) of the user includes movement greater than a movement threshold toward the location corresponding to the user interface object (e.g., 1703) (e.g., enough for selection), and the one or more third criteria include a criterion that is satisfied when the third portion of the movement is lateral movement relative to the location corresponding to the user interface object (e.g., 1703) (e.g., movement in a direction orthogonal to a direction of movement that changes the distance between the predefined portion of the user and the location corresponding to the user interface object in the three-dimensional environment), the electronic device performs (1826c) a scroll operation with respect to the user interface object (e.g., 1703) in accordance with the third portion of the movement. In some embodiments, the scroll operation includes scrolling content (e.g., text content, images, etc.) of the user interface object in accordance with the movement of the predefined portion of the user. In some embodiments, the content of the user interface object scrolls in a direction, at a speed, and/or by an amount that corresponds to the direction, speed, and/or amount of movement of the movement of the predefined portion of the user in the third portion of the movement. For example, if the lateral movement is horizontal movement, the electronic device scrolls the content horizontally. As another example, if the lateral movement is vertical movement, the electronic device scrolls the content vertically.

The above-described manner of performing the scroll operation in response to detecting the first and second portions of the movement followed by a third portion of movement including lateral movement of the predefined portion of the user provides an efficient way of manipulating the user interface element while the predefined portion of the user is located away from the user interface element, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 17C, while detecting the respective input (1828a), after the first portion of the movement of the predefined portion (e.g., 1715) of the user satisfies the one more criteria, the electronic device detects (1828b), via the one or more input devices, a second portion of the movement of the predefined portion (e.g., 1715) of the user away from the location corresponding to the user interface object (e.g., 1705) (e.g., the user moves their finger towards the torso of the user and away from a location corresponding to the location of the user interface object in the three-dimensional environment).

In some embodiments, while detecting the respective input (1828a), such as the input in FIG. 17C, in response to detecting the second portion of the movement, the electronic device updates (1828c) an appearance of the visual indication (e.g., 1711) in accordance with the second portion of the movement. In some embodiments, updating the appearance of the visual indication includes changing a translucency, size, color, or location of the visual indication. In some embodiments, after updating the appearance of the visual indication, the electronic device ceases displaying the visual indication. For example, in response to detecting the second portion of the movement of the predefined portion of the user, the electronic device expands the visual indication and fades the color and/or display of the visual indication and then ceases displaying the visual indication.

The above-described manner of updating the appearance of the visual indication in accordance with the second portion of the movement provides an efficient way of confirming to the user that the first portion of the movement satisfied the one or more criteria when the second portion of the movement was detected, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, updating the appearance of the visual indication, such as the visual indication (e.g., 1711) in FIG. 17C, includes ceasing display of the visual indication (1830a). In some embodiments, such as in FIG. 17A, after ceasing display of the visual indication, the electronic device 101a detects (1830b), via the one or more input devices, a second respective input comprising a second movement of the predefined portion (e.g., 1713) of the user, wherein during the second respective input, the location of the predefined portion (e.g., 1713) of the user is away from the location corresponding to the user interface object (e.g., 1705) (e.g., the location in the three-dimensional environment corresponding to the location of the predefined portion of the user in the physical environment of the electronic device is further than a threshold distance (e.g., 3, 5, 10, 15, 30, etc. centimeters) away from the location of the user interface object in the three-dimensional environment). In some embodiments, the threshold distance is a threshold distance for a direct input (e.g., if the distance is less than the threshold, the electronic device optionally detects direct inputs).

In some embodiments, such as in FIG. 17B, while detecting the second respective input (1830c), in accordance with a determination that a first portion of the second movement satisfies the one or more criteria, the electronic device 101a displays (1830d), via the display generation component, a second visual indication (e.g., 1711a) at a location in the three-dimensional environment corresponding to the predefined portion (e.g., 1715) of the user during the second respective input. In some embodiments, when (e.g., each time) the electronic device detects a first portion of a respective movement that satisfies the one or more criteria, the electronic device displays a visual indication at a location in the three-dimensional environment corresponding to the predefined portion of the user.

The above-described manner of displaying the second visual indication in response to detecting the first portion of the second movement that satisfies one or more criteria after updating the appearance of and ceasing to display the first visual indication provides an efficient way of providing visual feedback to the user each time the electronic device detects a portion of movement satisfying the one or more criteria, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 17C, the respective input corresponds to a scrolling input directed to the user interface object (1832a) (e.g., after detecting the first portion of movement satisfying the one or more criteria, the electronic device detects further movement of the predefined portion of the user in a direction corresponding to a direction in which the user interface is scrollable). For example, in response to detecting upward movement of the predefined portion of the user after detecting the first portion of movement, the electronic device scrolls the user interface element vertically.

In some embodiments, such as in FIG. 17C, the electronic device 101a scrolls (1832b) the user interface object (e.g., 1703) in accordance with the respective input while maintaining display of the visual indication (e.g., 1709). In some embodiments, the visual indication is a virtual trackpad and the electronic device scrolls the user interface object in accordance with movement of the predefined portion of the user while the predefined portion of the user is at a physical location corresponding to the location of the virtual trackpad in the three-dimensional environment. In some embodiments, in response to lateral movement of the predefined portion of the user that controls the direction of scrolling, the electronic device updates the position of the visual indication to continue to be displayed proximate to the predefined portion of the user. In some embodiments, in response to lateral movement of the predefined portion of the user that controls the direction of scrolling, the electronic device maintains the position of the visual indication in the three-dimensional environment.

The above-described manner of maintaining display of the visual indication while detecting a scrolling input provides an efficient way of providing feedback to the user of where to position the predefined portion of the user to provide the scrolling input, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, while detecting the respective input (1834a), such as the inputs illustrated in FIG. 17C, after the first portion of the movement of the predefined portion (e.g., 1715) of the user satisfies the one more criteria, the electronic device detects (1834b), via the one or more input devices, a second portion of the movement of the predefined portion (e.g., 1715) of the user that satisfies one or more second criteria, including a criterion that is satisfied when the second portion of the movement corresponds to a distance between a location corresponding to the visual indication (e.g., 1711) and the predefined portion of (e.g., 1715) the user. In some embodiments, the criterion is satisfied when the second portion of the movement includes movement by an amount that is at least the distance between the predefined portion of the user and the location corresponding to the visual indication. For example, if the visual indication is displayed at a location corresponding to one centimeter away from the predefined portion of the user, the criterion is satisfied when the second portion of movement includes movement by at least a centimeter towards the location corresponding to the visual indication.

In some embodiments, while detecting the respective input (1834a), such as one of the inputs in FIG. 17C, in response to detecting the second portion of the movement of the predefined portion (e.g., 1715) of the user, the electronic device 101a generates (1834c) audio (and/or tactile) feedback that indicates that the one or more second criteria are satisfied. In some embodiments, in response to detecting the second portion of the movement of the predefined portion of the user that satisfies the one or more second criteria, the electronic device performs an action in accordance with selection of the user interface object (e.g., a user interface object towards which the input is directed).

The above-described manner of generating feedback indicating that the second portion of movement satisfies the one or more second criteria provides an efficient way of confirming to the user that the input was detected, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 17B, while displaying the user interface object (e.g., 1703), the electronic device 101a detects (1836a) that one or more second criteria are satisfied, including a criterion that is satisfied when the predefined portion (e.g., 1713) of the user has a respective pose (e.g., location, orientation, shape (e.g., hand shape)) while the location of the predefined portion (e.g., 1713) of the user is away from the location corresponding to the user interface object (e.g., 1703). In some embodiments, the respective pose includes a hand of the user being at a location corresponding to a predetermined region of the three-dimensional environment (e.g., relative to the user), the palm of the hand facing towards a location corresponding to the user interface object, and the hand being in a pointing hand shape. The respective pose optionally has one or more characteristics of a ready state pose for indirect interaction as described with reference to methods 800, 1000, 1200, 1400, 1600 and/or 2000.

In some embodiments, such as in FIG. 17B, in response to detecting that the one or more second criteria are satisfied, the electronic device 101a displays (1836b), via the display generation component, a virtual surface (e.g., 1709a) (e.g., a visual indication that looks like a trackpad) in proximity to (e.g., within a threshold distance (e.g., 1, 3, 5, 10, etc. centimeters)) a location (e.g., in the three-dimensional environment) corresponding to the predefined portion (e.g., 1713) of the user and away from the user interface object (e.g., 1703). In some embodiments, the visual indication is optionally square or rectangle—shaped with square or rounded corners in order to look like a trackpad. In some embodiments, in response to detecting the predefined portion of the user at a location corresponding to the location of the virtual surface, the electronic device performs an action with respect to the remote user interface object in accordance with the input. For example, if the user taps a location corresponding to the virtual surface, the electronic device detects a selection input directed to the remote user interface object. As another example, if the user moves their hand laterally along the virtual surface, the electronic device detects a scrolling input directed to the remote user interface object.

The above-described manner of displaying the virtual surface in response to the second criteria provides an efficient way of presenting a visual guide to the user to direct where to position the predefined portion of the user to provide inputs to the electronic device, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, while displaying the virtual surface, such as the virtual surface (e.g., 1709) in FIG. 17C, the electronic device 101a detects (1838a), via the one or more input devices, respective movement of the predefined portion (e.g., 1713) of the user towards a location corresponding to the virtual surface (e.g., 1709). In some embodiments, in response to detecting the respective movement, the electronic device changes (1838b) a visual appearance of the virtual surface, such as the virtual surface (e.g., 1709) in FIG. 17C, in accordance with the respective movement. In some embodiments, changing the visual appearance of the virtual surface includes changing the color of the virtual surface. In some embodiments, changing the visual appearance of the virtual surface includes displaying a simulated shadow of the user's hand on the virtual surface according to method 2000. In some embodiments, the color change of the virtual surface increases as the predefined portion of the user gets closer to the virtual surface and reverses as the predefine portion of the user moves away from the virtual surface.

The above-described manner of changing the visual appearance of the virtual surface in response to movement of the predefined portion of the user towards the location corresponding to the virtual surface provides an efficient way of indicating to the user that the virtual surface responds to user input provided by the predefined portion of the user, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 17C, while displaying the virtual surface (e.g., 1709), the electronic device 101a detects (1840a), via the one or more input devices, respective movement of the predefined portion (e.g., 1713) of the user towards a location corresponding to the virtual surface (e.g., 1703). In some embodiments, such as in FIG. 17C, in response to detecting the respective movement, the electronic device 101a changes (1840b) a visual appearance of the user interface object (e.g., 1703) in accordance with the respective movement. In some embodiments, the movement of the predefined portion of the user towards the location corresponding to the virtual surface includes moving the predefined portion of the user by a distance that is at least the distance between the predefined portion of the user and the location corresponding to the virtual surface. In some embodiments, in response to the movement of the predefined portion of the user, the electronic device initiates selection of the user interface object. In some embodiments, updating the visual appearance of the user interface object includes changing a color of the user interface object. In some embodiments, the color of the user interface object gradually changes as the predefined portion of the user moves closer to the virtual surface and gradually reverts as the predefined portion of the user moves away from the virtual surface. In some embodiments, the rate or degree of the change in visual appearance is based on the speed of movement, distance of movement, or distance from the virtual trackpad of the predefined portion of the user. In some embodiments, changing the visual appearance of the user interface object includes moving the user interface object away from the predefined portion of the user in the three-dimensional environment.

The above-described manner of updating the visual appearance of the user interface object in response to detecting movement of the predefined portion of the user towards the location corresponding to the virtual surface provides an efficient way of indicating to the user that input provided via the virtual surface will be directed towards the user interface object, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 17B, displaying the virtual surface (e.g., 1709a) in proximity to a location corresponding to the predefined portion (e.g., 1713) of the user includes displaying the virtual surface (e.g., 1709a) at a respective distance from the location corresponding to the predefined portion (e.g., 1713) of the user, the respective distance corresponding to an amount of movement of the predefined portion (e.g., 1713) of the user toward a location corresponding to the virtual surface (e.g., 1709a) required for performing an operation with respect to the user interface object (e.g., 1703) (1842a). For example, if one centimeter of movement is required to perform the operation with respect to the user interface object, the electronic device displays the virtual surface at a location one centimeter from the location corresponding to the predefined portion of the user. As another example, if two centimeters of movement is required to perform the operation with respect to the user interface object, the electronic device displays the virtual surface at a location two centimeters from the location corresponding to the predefined portion of the user.

The above-described manner of displaying the virtual surface at a location to indicate the amount of movement of the predefined portion of the user needed to perform an operation with respect to the user interface object provides an efficient way of indicating to the user how to interact with the user interface object with the predefined portion of the user, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 17B, while displaying the virtual surface (e.g., 1709a), the electronic device 101a displays (1844a), on the virtual surface (e.g., 1709a), a visual indication (e.g., 1710a) of a distance between the predefined portion (e.g., 1713) of the user and a location corresponding to the virtual surface (e.g., 1709a). In some embodiments, the visual indication is a simulated shadow of the predefined portion of the user on the virtual surface, such as in method 2000. In some embodiments, in response to detecting movement of the predefined portion of the user to the location corresponding to the virtual surface, the electronic device performs an operation with respect to the user interface object.

The above-described manner of displaying the visual indication of the distance between the predefined portion of the user and the location corresponding to the virtual surface provides an efficient way of indicating to the user the distance between the predefined portion of the user and the location corresponding to the virtual surface, which simplifies the interaction between the user and the electronic device and enhances the operability of the electronic device and makes the user-device interface more efficient (e.g., by showing the user how much movement of the predefined portion of the user is needed to perform an operation with respect to the user interface object, which additionally reduces power usage and improves battery life of the electronic device by enabling the user to use the electronic device more quickly and efficiently, while reducing errors in usage.

In some embodiments, while displaying the virtual surface, such as the virtual surface (e.g., 1713) in FIG. 17B, the electronic device 101a detects (1846a), via the one or more input devices, movement of the predefined portion (e.g., 1713) of the user to a respective location more than a threshold distance (e.g., 3, 5, 10, 15, etc. centimeters) from a location corresponding to the virtual surface (e.g., 1709a) (e.g., in any direction).

In some embodiments, in response to detecting the movement of the predefined portion (e.g., 1713) of the user to the respective location, the electronic device ceases (1846b) display of the virtual surface, such as the virtual surface (e.g., 1709a) in FIG. 17B, in the three-dimensional environment. In some embodiments, the electronic device also ceases display of the virtual surface in accordance with a determination that the pose of the predefined portion of the user does not satisfy one or more criteria. For example, the electronic device displays the virtual surface while the hand of the user is in a pointing hand shape and/or is positioned with the palm facing away from the user's torso (or towards the location corresponding to the virtual surface) and, in response to detecting that the pose of the hand of the user no longer meets the criteria, the electronic device ceases display of the virtual surface.

The above-described manner of ceasing display of the virtual surface in response to detecting movement of the predefined portion of the user the threshold distance away from the location corresponding to the virtual surface provides an efficient way of reducing the visual clutter of displaying the virtual surface while the user is unlikely to interact with it (because the predefined portion of the user is more than the threshold distance from the location corresponding to the virtual surface) which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 17B, displaying the virtual surface in proximity to the predefined portion (e.g., 1713) of the user includes (1848a), in accordance with a determination that the predefined portion (e.g., 1713) of the user is at a first respective position when the one or more second criteria are satisfied (e.g., the pose (e.g., hand shape, position, orientation) of the predefined portion of the user satisfy one or more criteria, the gaze of the user is directed to the user interface object), displaying the virtual surface (e.g., 1709a) at a third location in the three-dimensional environment corresponding to the first respective position of the predefined portion (e.g., 1713) of the user (1848b) (e.g., the virtual surface is displayed at a predefined position relative to the predefined portion of the user). For example, the electronic device displays the virtual surface a threshold distance (e.g., 1, 2, 3, 5, 10, etc. centimeters) from a location corresponding to the predefined portion of the user.

In some embodiments, such as in FIG. 17B, displaying the virtual surface (e.g., 1709b) in proximity to the predefined portion (e.g., 1714) of the user includes (1848a), in accordance with a determination that the predefined portion (e.g., 1714) of the user is at a second respective position, different from the first respective position, when the one or more second criteria are satisfied, displaying the virtual surface (e.g., 1709b) at a fourth location, different from the third location, in the three-dimensional environment corresponding to the second respective position (e.g., 1714) of the predefined portion of the user (1848c). In some embodiments, the location at which the virtual surface is displayed depends on the location of the predefined portion of the user when the one or more second criteria are satisfied such that the virtual surface is displayed with the predefined location relative to the predefined portion of the user irrespective of the location of the predefined portion of the user when the one or more second criteria are satisfied.

The above-described manner of displaying the virtual surface at different locations depending on the location of the predefined portion of the user provides an efficient way of displaying the virtual surface at a location that is easy for the user to interact with using the predefined portion of the user, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 17E, while displaying the visual indication (e.g., 1719a) corresponding to the predefined portion (e.g., 1721) of the user (1850a), the electronic device 101a detects (1850b), via the one or more input devices, a second respective input comprising movement of a second predefined portion (e.g., 1723) of the user (e.g., a second hand of the user), wherein during the second respective input, a location of the second predefined portion (e.g., 1723) of the user is away from (e.g., at least a threshold distance (e.g., 3, 5, 10, 15, 30, etc. centimeter) from) the location corresponding to the user interface object (e.g., 1717).

In some embodiments, such as in FIG. 17E, while displaying the visual indication (e.g., 1719a) corresponding to the predefined portion (e.g., 1721) of the user (1850a), while detecting the second respective input (1850c), in accordance with a determination that a first portion of the movement of the second predefined portion (e.g., 1723) of the user satisfies the one or more criteria, concurrently displaying, via the display generation component (1850d), the visual indication (e.g., 1719a) corresponding to the predefined portion (e.g., 1721) of the user (1850e) (e.g., displayed proximate to the predefined portion of the user) and a visual indication (e.g., 1719b) at a location corresponding to the second predefined portion (e.g., 1723) of the user in the three-dimensional environment (1850f) (e.g., displayed proximate to the second predefined portion of the user). In some embodiments, in response to detecting movement of the second predefined portion of the user without detecting movement of the first predefined portion of the user, the electronic device updates the location of the visual indication at the location corresponding to the second predefined portion of the user without updating the location of the visual indication corresponding to the predefined portion of the user. In some embodiments, in response to detecting movement of the predefined portion of the user without detecting movement of the second predefined portion of the user, the electronic device updates the location of the visual indication corresponding to the predefined portion of the user without updating the location of the visual indication at the location corresponding to the second predefined portion of the user.

The above-described manner of displaying the visual indication at the location corresponding to the second predefined portion of the user provides an efficient way of displaying visual indications for both predefined portions of the user independently, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, while detecting the respective input (e.g., and in accordance with the determination that the first portion of the movement of the predefined portion of the user satisfies the one or more criteria), such as the inputs in FIG. 17B, the electronic device 101a displays (1852a), on the user interface object (e.g., 1703, 1705), a respective visual indication (e.g., a shadow of the hand of the user according to method 2000, a cursor, a cursor and a shadow of the cursor according to method 2000, etc.) that indicates a respective distance that the predefined portion (e.g., 1713, 1714, 1715, 1716) of the user needs to move towards the location corresponding to the user interface object (e.g., 1703, 1705) to engage with the user interface object (e.g., 1703, 1705). In some embodiments, the size and/or position of the visual indication (e.g., a shadow of the hand of the user or a shadow of a cursor) updates as the additional distance of movement of the predefined portion of the user that is needed to engage with the user interface object updates. For example, once the user moves the predefined portion of the user by the amount needed to engage with the user interface object, the electronic device ceases displaying the respective visual indication.

The above-described manner of presenting a respective visual indication that indicates the amount of movement of the predefined portion of the user needed to engaged with the user interface object provides an efficient way of providing feedback to the user as the user provides an input with the predefined portion of the user, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, while displaying the user interface object, such as the user interface objects (e.g., 1703, 1705) in FIG. 17A, the electronic device 101a detects (1854a) that gaze (e.g., 1701a, 1701b) of the user is directed to the user interface object (e.g., 1703, 1705). In some embodiments, in response to detecting that the gaze (e.g., 1701a, 1701b) of the user is directed to the user interface object, such as the user interface objects (e.g., 1703, 1705) in FIG. 17A (e.g., optionally based on one or more disambiguation techniques according to method 1200), the electronic device 101a displays (1854b) the user interface object (e.g., 1703, 1705) with a respective visual characteristic (e.g., size, color, position) having a first value. In some embodiments, in accordance with a determination that the gaze of the user is not directed to the user interface object (e.g., optionally based on one or more disambiguation techniques according to method 1200), the electronic device displays the user interface object with the respective visual characteristic having a second value, different from the first value. In some embodiments, in response to detecting the gaze of the user on the user interface object, the electronic device directs inputs provided by the predetermined portion of the user to the user interface object, such as described with reference to indirect interactions with user interface objects in methods 800, 1000, 1200, 1400, 1600 and/or 2000. In some embodiments, in response to detecting the gaze of the user directed to a second user interface object, the electronic device displays the second user interface object with the respective visual characteristic having the first value.

The above-described manner of updating the value of the respective visual characteristic of the user interface object in accordance with the gaze of the user provides an efficient way of indicating to the user that the system is able to direct inputs based on the gaze of the user, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, such as in FIG. 17A, the three-dimensional environment includes a representation (e.g., 1704) of a respective object that is in a physical environment of the electronic device (1856a). In some embodiments, the representation is a photorealistic representation of the respective object displayed by the display generation component (e.g., pass-through video). In some embodiments, the representation is a view of the respective object through a transparent portion of the display generation component.

In some embodiments, the electronic device 101a detects (1856b) that one or more second criteria are satisfied, including a criterion that is satisfied when a gaze of the user is directed to the representation (e.g., 1704) of the respective object, and a criterion that is satisfied when the predefined portion (e.g., 1713) of the user is in a respective pose (e.g., position, orientation, posture, hand shape). For example, the electronic device 101a displays a representation of a speaker in a manner similar to the manner in which the electronic device 101a displays the representation 1704 of the table in FIG. 17B and detects a hand (e.g., 1713, 1714, 1715, or 1716 in FIG. 17B) in a respective pose while the gaze of the user is directed to the representation of the speaker. For example, the respective pose includes the hand of the user being within a predefined region of the three-dimensional environment, with the palm of the hand facing away from the user and/or towards the respective object while the user's hand is in a respective shape (e.g., a pointing or pinching or pre-pinching hand shape). In some embodiments, the one or more second criteria further include a criteria that is satisfied when the respective object is interactive. In some embodiments, the one or more second criteria further include a criteria that is satisfied when the object is a virtual object. In some embodiments, the one or more second criteria further include a criteria that is satisfied when the object is a real object in the physical environment of the electronic device.

In some embodiments, in response to detecting that the one or more second criteria are satisfied, the electronic device displays (1856c), via the display generation component, one or more selectable options in proximity to the representation (e.g., 1704) of the respective object, wherein the one or more selectable options are selectable to perform respective operations associated with the respective object (e.g., to control operation of the respective object). For example, in response to detecting a hand (e.g., 1713, 1714, 1715, or 1716 in FIG. 17B) in a respective pose while the gaze of the user is directed to a representation of a speaker the electronic device 101a displays in a manner similar to the manner in which the electronic device 101a displays the representation 1704 of the table in FIG. 17B, the electronic device displays one or more selectable options that are selectable to perform respective operations associated with the speaker (e.g., play, pause, fast forward, rewind, or change the playback volume of content playing on the speaker). For example, the respective object is a speaker or speaker system and the options include options to play or pause playback on the speaker or speaker system, options to skip ahead or skip back in the content or content list. In this example, the electronic device is in communication (e.g., via a wired or wireless network connection) with the respective object and able to transmit indications to the respective object to cause it to perform operations in accordance with user interactions with the one or more selectable options.

The above-described manner of presenting the selectable options that are selectable to perform respective operations associated with the respective object in response to detecting the gaze of the user on the respective object provides an efficient way of interacting with the respective object using the electronic device, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

In some embodiments, after the first portion of the movement of the predefined portion (e.g., 1713) of the user satisfies the one or more criteria and while displaying the visual indication (e.g., 1709a) corresponding to the predefined portion of the user, the electronic device detects (1858a), via the one or more input devices, a second portion of the movement of the predefined portion (e.g., 1713) of the user that satisfies one or more second criteria, such as in FIG. 17B (e.g., movement speed, distance, duration, etc. criteria).

In some embodiments, such as in FIG. 17B, in response to detecting the second portion of the movement of the predefined portion (e.g., 1713) of the user (1858b), in accordance with a determination that a gaze (e.g., 1701a) of the user is directed to the user interface object (e.g., 1703) and the user interface object is interactive (1858c) (e.g., the electronic device performs an operation in accordance with the user interface object in response to a user input directed to the user interface object), the electronic device 101a displays (1858d), via the display generation component, a visual indication (e.g., 1709a) that indicates that the second portion of the movement of the predefined portion (e.g., 1713) of the user satisfies the one or more second criteria. In some embodiments, the visual indication that indicates that the second portion of the movement satisfies the second criteria is displayed at the location of or proximate to the visual indication at the location corresponding to the predefined portion of the user. In some embodiments, the visual indication that indicates that the second portion of the movement of the predefined portion of the user satisfies the one or more second criteria is an updated version (e.g., different size, color, translucency, etc.) of the visual indication at the location corresponding to the predefined portion of the user. For example, in response to detecting movement of the predefined portion of the user that causes selection of user interface object, the electronic device expands the visual indication.

In some embodiments, such as in FIG. 17C, in response to detecting the second portion of the movement of the predefined portion (e.g., 1713) of the user (1858b), in accordance with a determination that a gaze (e.g., 1701a) of the user is directed to the user interface object (e.g., 1703) and the user interface object (e.g., 1703) is interactive (1858c) (e.g., the electronic device performs an operation in accordance with the user interface object in response to a user input directed to the user interface object), the electronic device 101a performs (1858e) an operation corresponding to the user interface object (e.g., 1703) in accordance with the respective input (e.g., selecting the user interface object, scrolling the user interface object, moving the user interface object, navigating to a user interface associated with the user interface object, initiating playback of content associated with the user interface object, or performing another operation in accordance with the user interface object).

In some embodiments, in response to detecting the second portion of the movement of the predefined portion (e.g., 1713) of the user (1858b), in accordance with a determination that the gaze of the user is not directed a user interface object (e.g., 1703) that is interactive (1858f), the electronic device displays (1858g), via the display generation component, the visual indication (e.g., 1709) that indicates that the second portion of the movement of the predefined portion of the user satisfies the one or more second criteria without performing an operation in accordance with the respective input. For example, in response to detecting hand 1713, 1714, 1715, and/or 1716 performing the second portion of the movement while the gaze 1701a or 1701b of the user is not directed to either user interface element 1703 or 1705 in FIG. 17B, the electronic device displays virtual surface 1709a or 1709b or indication 1710c or 1710d in accordance with the movement of the hand 1713, 1714, 1715, and/or 1716, respectively. In some embodiments, the visual indication that indicates that the second portion of the movement satisfies the second criteria is displayed at the location of or proximate to the visual indication at the location corresponding to the predefined portion of the user. In some embodiments, the visual indication that indicates that the second portion of the movement of the predefined portion of the user satisfies the one or more second criteria is an updated version (e.g., different size, color, translucency, etc.) of the visual indication at the location corresponding to the predefined portion of the user. In some embodiments, regardless of whether or not the gaze of the user is directed to the user interface object that is interactive, the electronic device presents the same indication that indicates that the second portion of the movement of the predefined portion of the user satisfies the one or more second criteria. For example, in response to detecting movement of the predefined portion of the user that would cause selection of the user interface object if the user interface object was interactive, the electronic device expands the visual indication.

The above-described manner of presenting the indication irrespective of whether the gaze of the user is directed to the interactive user interface element or not provides an efficient way of indicating to the user that the input provided with the predefined portion of the user was detected, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage.

FIGS. 19A-19D illustrate examples of how an electronic device enhances interactions with user interface elements in a three-dimensional environment using visual indications of such interactions in accordance with some embodiments.

FIG. 19A illustrates an electronic device 101 displaying, via a display generation component 120, a three-dimensional environment 1901 on a user interface. It should be understood that, in some embodiments, electronic device 101 utilizes one or more techniques described with reference to FIGS. 19A-19D in a two-dimensional environment or user interface without departing from the scope of the disclosure. As described above with reference to FIGS. 1-6, the electronic device 101 optionally includes a display generation component 120 (e.g., a touch screen) and a plurality of image sensors 314. The image sensors optionally include one or more of a visible light camera, an infrared camera, a depth sensor, or any other sensor the electronic device 101 would be able to use to capture one or more images of a user or a part of the user while the user interacts with the electronic device 101. In some embodiments, display generation component 120 is a touch screen that is able to detect gestures and movements of a user's hand. In some embodiments, the user interfaces shown below could also be implemented on a head-mounted display that includes a display generation component that displays the user interface to the user, and sensors to detect the physical environment and/or movements of the user's hands (e.g., external sensors facing outwards from the user), and/or gaze of the user (e.g., internal sensors facing inwards towards the face of the user).

As shown in FIG. 19A, the three-dimensional environment 1901 includes three user interface objects 1903a, 1903b and 1903c that are interactable (e.g., via user inputs provided by hands 1913a, 1913b and/or 1913c of the user of device 101). Hands 1913a, 1913b and/or 1913c are optionally hands of the user that are concurrently detected by device 101 or alternatively detected by device 101, such that the responses by device 101 to inputs from those hands that are described herein optionally occur concurrently or alternatively and/or sequentially. Device 101 optionally directs direct or indirect inputs (e.g., as described with reference to methods 800, 1000, 1200, 1400, 1600, 1800 and/or 2000) provided by hands 1913a, 1913b and/or 1913c to user interface objects 1903a, 1903b and/or 1903c based on various characteristics of such inputs. In FIG. 19A, three-dimensional environment 1901 also includes representation 604 of a table in a physical environment of the electronic device 101 (e.g., such as described with reference to FIG. 6B). In some embodiments, the representation 604 of the table is a photorealistic video image of the table displayed by the display generation component 120 (e.g., video or digital passthrough). In some embodiments, the representation 604 of the table is a view of the table through a transparent portion of the display generation component 120 (e.g., true or physical passthrough).

In FIGS. 19A-19D, hands 1913a and 1913b are indirectly interacting with (e.g., as described with reference to methods 800, 1000, 1200, 1400, 1600, 1800 and/or 2000) user interface object 1903a, and hand 1913c is directly interacting with (e.g., as described with reference to methods 800, 1000, 1200, 1400, 1600, 1800 and/or 2000) user interface object 1903b. In some embodiments, user interface object 1903b is a user interface object that, itself, responds to inputs. In some embodiments, user interface object 1903b is a virtual trackpad-type user interface object, inputs directed to which cause device 101 to direct corresponding inputs to user interface object 1903c (e.g., as described with reference to method 1800), which is remote from user interface object 1903b.

In some embodiments, in response to detecting a hand of a user in an indirect ready state hand shape and at an indirect interaction distance from a user interface object, device 101 displays a cursor that is remote from the hand of the user a predetermined distance away from the user interface object at which the gaze of the user is directed. For example, in FIG. 19A, device 101 detects hand 1913a in an indirect ready state hand shape (e.g., as described with reference to method 800) at an indirect interaction distance (e.g., as described with reference to method 800) from user interface object 1903a, and optionally detects that the gaze of the user is directed to user interface object 1903a. In response, device 101 displays cursor 1940a a predetermined distance from (e.g., 0.1, 0.5, 1, 2, 5, 10 cm in front of) user interface object 1903a, and remote from hand 1913a and/or a finger (e.g., pointer finger) on hand 1913a. The location of cursor 1940a is optionally controlled by the location of hand 1913a, such that if hand 1913a and/or a finger (e.g., pointer finger) on hand 1913a moves laterally, device 101 moves cursor 1940a laterally, and if hand 1913a and/or a finger (e.g., pointer finger) moves towards or away from the user interface object 1903a, device 101 moves cursor 1940a towards or away from user interface object 1903a. Cursor 1940a is optionally a visual indication corresponding to the location of hand 1913a and/or a corresponding finger on hand 1913a. Hand 1913a optionally interacts with (e.g., selects, scrolls, etc.) user interface object 1903a when device 101 detects hand 1913a and/or a corresponding finger on hand 1913a move sufficiently towards user interface object 1903a such that cursor 1940a touches down on user interface object 1903a in accordance with such movement.

As shown in FIG. 19A, device 101 also displays a simulated shadow 1942a on user interface object 1903a that corresponds to cursor 1940a and has a shape based on the shape of cursor 1940a as if it were being cast by cursor 1940a on user interface object 1903a. The size, shape, color, and/or location of simulated shadow 1942a optionally updates appropriately as cursor 1940a moves—corresponding to movements of hand 1913a—relative to user interface object 1903a. Simulated shadow 1942a therefore provides a visual indication of the amount of movement by hand 1913a towards user interface object 1903a required for hand 1913a to interact with (e.g., select, scroll, etc.) user interface object 1903a, which optionally occurs when cursor 1940a touches down on user interface object 1903a. Simulated shadow 1942a additionally or alternatively provides a visual indication of the type of interaction between hand 1913a and user interface object 1903a (e.g., indirect), because the size, color and/or shape of simulated shadow 1942a is optionally based on the size and/or shape of cursor 1940a, which is optionally displayed by device 101 for indirect interactions but not direct interactions, which will be described later.

In some embodiments, user interface object 1903a is a user interface object that is interactable via two hands concurrently (e.g., hands 1913a and 1913b). For example, user interface object 1903a is optionally a virtual keyboard whose keys are selectable via hand 1913a and/or hand 1913b. Hand 1913b is optionally indirectly interacting with user interface object 1903a (e.g., similar to as described with respect to hand 1913a). Therefore, device 101 displays cursor 1940b corresponding to hand 1913b, and simulated shadow 1942b corresponding to cursor 1940b. Cursor 1940b and simulated shadow 1942b optionally have one or more of the characteristics of cursor 1940a and simulated shadow 1942a, applied analogously in the context of hand 1913b. In embodiments in which device 101 is concurrently detecting hands 1913a and 1913b indirectly interacting with user interface object 1903a, device 101 optionally concurrently displays cursors 1940a and 1940b (controlled by hands 1913a and 1913b, respectively), and simulated shadows 1942a and 1942b (corresponding to cursors 1940a and 1940b, respectively). In FIG. 19A, cursor 1940a is optionally further away from user interface object 1903a than is cursor 1940b; as such, device 101 is displaying cursor 1940a as larger than cursor 1940b, and correspondingly is displaying simulated shadow 1942a as larger and laterally more offset from cursor 1940a than is simulated shadow 1942b relative to cursor 1940b. In some embodiments, the sizes of cursors 1940a and 1940b in the three-dimensional environment 1901 are the same. Cursor 1940a is optionally further away from user interface object 1903a than is cursor 1940b, because hand 1913a (corresponding to cursor 1940a) has optionally moved towards user interface object 1903a by an amount that is less than an amount that hand 1913b (corresponding to cursor 1940b) has moved towards user interface object 1903a after cursors 1940a and 1940b, respectively, were displayed by device 101.

In FIG. 19B, device 101 has detected hands 1913a and 1913b (and/or corresponding fingers on hands 1913a and 1913b) move towards user interface object 1903a. Hand 1913a optionally moved towards user interface object 1903a by an amount that is less than the amount needed for hand 1913a to indirectly interact with user interface object 1903a (e.g., less than the amount needed for cursor 1940a to touch down on user interface object 1903a). In response to the movement of hand 1913a, device 101 optionally moves cursor towards user interface object 1903a in the three-dimensional environment 1901, thus displaying cursor 1940a at a smaller size than before, displaying shadow 1942a at a smaller size than before, reducing the lateral offset between shadow 1942a and cursor 1940a, and/or displaying shadow 1942a with a visual characteristic having a value different from before (e.g., darker). Thus, device 101 has updated display of shadow 1942a to reflect the interaction of hand 1913a with user interface object 1903a, such that shadow 1942a continues to be indicative of one or more characteristics of the interaction between hand 1913a and user interface object 1903a (e.g., characteristics such as previously described, including the remaining movement towards the user interface object required by the hand of the user to interact with (e.g., select, etc.) the user interface object).

In FIG. 19B, hand 1913b optionally moved towards user interface object 1903a by an amount that is equal to or greater than the amount needed for hand 1913b to interact with user interface object 1903a (e.g., equal to or greater than the amount needed for cursor 1940b to touch down on user interface object 1903a). In response to the movement of hand 1913b, device 101 optionally moves cursor towards user interface object 1903a in the three-dimensional environment 1901 and displays cursor 1940b as touching down on user interface object 1903a, thus displaying cursor 1940b at a smaller size than before, and/or ceasing display of shadow 1942b. In response to the movement of hand 1913b and/or the touchdown of cursor 1940b on user interface object 1903a, device 101 optionally detects and directs a corresponding input from hand 1913b (e.g., a selection input, a scrolling input, a tap input, a press-hold-liftoff input, etc., as described with reference to methods 800, 1000, 1200, 1400, 1600, 1800 and/or 2000) to user interface object 1903a, as indicated by the check mark next to cursor 1940b in FIG. 19B.

In FIG. 19C, device 101 detects hand 1913a move laterally with respect to the location of hand 1913a in FIG. 19B (e.g., while hand 1913b remains at a position/state in which cursor 1940b remains touched down on user interface object 1903a). In response, device 101 moves cursor 1940a and shadow 1942a laterally relative to user interface object 1903a, as shown in FIG. 19C. In some embodiments, the display—other than lateral locations—of cursor 1940a and shadow 1942a remain unchanged from FIG. 19B to FIG. 19C if the movement of hand 1913a does not include movement towards or away from user interface object 1903a, but only includes movement that is lateral relative to user interface object 1903a. In some embodiments, device 101 maintains the display—other than the lateral location—of cursor 1940a if the movement of hand 1913a does not include movement towards or away from user interface object 1903a, but only includes movement that is lateral relative to user interface object 1903a, but does change the display of shadow 1942a based on the content or other characteristics of user interface object 1903a at the new location of shadow 1942a.

In FIG. 19D, device 101 detects hand 1913a move towards user interface object 1903a by an amount that is equal to or greater than the amount needed for hand 1913a to interact with user interface object 1903a (e.g., equal to or greater than the amount needed for cursor 1940a to touch down on user interface object 1903a). In some embodiments, the movement of hand 1913a is detected while hand 1913b remains at a position/state in which cursor 1940b remains touched down on user interface object 1903a. In response to the movement of hand 1913a, device 101 optionally moves cursor towards user interface object 1903a in the three-dimensional environment 1901 and displays cursor 1940a as touching down on user interface object 1903a, thus displaying cursor 1940a at a smaller size than before, and/or ceasing display of shadow 1942a. In response to the movement of hand 1913a and/or the touchdown of cursor 1940a on user interface object 1903a, device 101 optionally recognizes a corresponding input from hand 1913a (e.g., a selection input, a scrolling input, a tap input, a press-hold-liftoff input, etc., as described with reference to methods 800, 1000, 1200, 1400, 1600, 1800 and/or 2000) to user interface object 1903a, as indicated by the check mark next to cursor 1940a in FIG. 19D. In some embodiments, device 101 detects inputs from hands 1913a and 1913b directed to user interface object 1903a concurrently, as indicated by the concurrent check marks next to cursors 1940a and 1940b, respectively, or sequentially.

In some embodiments, in response to lateral movement of hands 1913a and/or 1913b while cursors 1940a and/or 1940b are touched down on user interface object 1903a, device 101 directs movement-based inputs to user interface object 1903a (e.g., scrolling inputs) while laterally moving cursors 1940a and/or 1940b, which remain touched down on user interface object 1903a, in accordance with the lateral movement of hands 1913a and/or 1913b (e.g., without redisplaying shadows 1942a and/or 1942b). In some embodiments, in response to movement of hands 1913a and/or 1913b away from user interface object 1903a when cursors 1940a and/or 1940b are touched down on user interface object 1903a, device 101 recognizes the ends of the corresponding inputs that were directed to user interface object 1903a (e.g., concurrent or sequential recognition of one or more of tap inputs, long press inputs, scrolling inputs, etc.) and/or moves cursors 1940a and/or 1940b away from user interface object 1903a in accordance with the movement of hands 1913a and/or 1913b. When device 101 moves cursors 1940a and/or 1940b away from user interface object 1903a in accordance with the movement of hands 1913a and/or 1913b, device optionally redisplays shadows 1942a and/or 1942b with one or more of the characteristics previously described, accordingly.

Returning to FIG. 19A, in some embodiments, device 101 concurrently and/or alternatively detects direct interaction between a hand of the user of device 101 and a user interface object. For example, in FIG. 19A, device 101 detects hand 1913c directly interacting with user interface object 1903b. Hand 1913c is optionally within a direct interaction distance of user interface object 1903b (e.g., as described with reference to method 800), and/or in a direct ready state hand shape (e.g., as described with reference to method 800). In some embodiments, when device 101 detects a hand directly interacting with a user interface object, device 101 displays a simulated shadow on that user interface object that corresponds to that hand. In some embodiments, device 101 displays a representation of that hand in the three-dimensional environment if the hand is within the field of view of the viewpoint of the three-dimensional environment displayed by device 101. It is understood that in some embodiments, device 101 similarly displays a representation of a hand that is indirectly interacting with a user interface object in the three-dimensional if the hand is within the field of view of the viewpoint of the three-dimensional environment displayed by device 101.

For example, in FIG. 19A, device 101 displays simulated shadow 1944 corresponding to hand 1913c. Simulated shadow 1944 optionally has a shape and/or size based on the shape and/or size of hand 1913c and/or a finger (e.g., pointer finger) on hand 1913c as if it were being cast by hand 1913c and/or the finger on user interface object 1903b. The size, shape, color, and/or location of simulated shadow 1944 optionally updates appropriately as hand 1913c moves relative to user interface object 1903b. Simulated shadow 1944 therefore provides a visual indication of the amount of movement by hand 1913c and/or a finger (e.g., pointer finger) on hand 1913c towards user interface object 1903b required for hand 1913c to interact with (e.g., select, scroll, etc.) user interface object 1903b, which optionally occurs when hand 1913c and/or a finger on hand 1913c touches down on user interface object 1903b (e.g., as described with reference to methods 800, 1000, 1200, 1400, 1600, 1800 and/or 2000). Simulated shadow 1944 additionally or alternatively provides a visual indication of the type of interaction between hand 1913c and user interface object 1903b (e.g., direct), because the size, color and/or shape of simulated shadow 1944 is optionally based on the size and/or shape of hand 1913c (e.g., rather than being based on the size and/or shape of a cursor, which is optionally not displayed for direct interactions with user interface objects). In some embodiments, the representation of the hand 1913c displayed by device 101 is a photorealistic video image of the hand 1913c displayed by the display generation component 120 (e.g., video or digital passthrough) at a location in the three-dimensional environment 1901 corresponding to the location of hand 1913c in the physical environment of device 101 (e.g., the display location of the representation is updated as hand 1913c moves). Thus, in some embodiments, simulated shadow 1944 is a shadow that is as if it were cast by a representation of hand 1913c displayed by device 101. In some embodiments, the representation of the hand 1913c displayed by device 101 is a view of the hand 1913c through a transparent portion of the display generation component 120 (e.g., true or physical passthrough), and thus the location of the representation of hand 1913c in three-dimensional environment 1901 changes as hand 1913c moves. Thus, in some embodiments, simulated shadow 1944 is a shadow that is as if it were cast by hand 1913c itself.

In FIG. 19B, device 101 has detected hand 1913c and/or a finger on hand 1913c move towards user interface object 1903b. Hand 1913c optionally moved towards user interface object 1903b by an amount that is less than the amount needed for hand 1913c to directly interact with user interface object 1903b. In response to the movement of hand 1913c, in FIG. 19B, device 101 displays shadow 1944 at a smaller size than before, reduces the lateral offset between shadow 1944 and hand 1913c, and/or displays shadow 1944 with a visual characteristic having a value different from before (e.g., darker). Thus, device 101 has updated display of shadow 1944 to reflect the interaction of hand 1913c with user interface object 1903b, such that shadow 1944 continues to be indicative of one or more characteristics of the interaction between hand 1913c and user interface object 1903b (e.g., characteristics such as previously described, including the remaining movement towards the user interface object required by the hand of the user to interact with (e.g., select, etc.) the user interface object).

In FIG. 19C, device 101 detects hand 1913c move laterally with respect to the location of hand 1913c in FIG. 19B. In response, device 101 moves shadow 1944 laterally relative to user interface object 1903b, as shown in FIG. 19C. In some embodiments, the display—other than lateral location—of shadow 1944 remains unchanged from FIG. 19B to FIG. 19C if the movement of hand 1913c does not include movement towards or away from user interface object 1903b, but only includes movement that is lateral relative to user interface object 1903b. In some embodiments, device 101 changes the display of shadow 1944 based on the content or other characteristics of user interface object 1903b at the new location of shadow 1944.

In FIG. 19D, device 101 detects hand 1913c move towards user interface object 1903b by an amount that is equal to or greater than the amount needed for hand 1913c to interact with user interface object 1903b (e.g., for hand 1913c or a finger on hand 1913c to touch down on user interface object 1903b). In response to the movement of hand 1913c, device 101 optionally ceases or adjusts display of shadow 1944. In response to the movement of hand 1913c and the touchdown of hand 1913c on user interface object 1903b, device 101 optionally recognizes a corresponding input from hand 1913c (e.g., a selection input, a scrolling input, a tap input, a press-hold-liftoff input, etc., as described with reference to methods 800, 1000, 1200, 1400, 1600, 1800 and/or 2000) to user interface object 1903b, as indicated by the check mark in user interface object 1903b in FIG. 19D. If user interface object 1903b is a virtual trackpad-type user interface object (e.g., as described with reference to method 1800), device 101 optionally directs an input corresponding to the interaction of hand 1913c with user interface object 1903b to remote user interface object 1903c, as indicated by the check mark in user interface object 1903c in FIG. 19D.

In some embodiments, in response to lateral movement of hand 1913c while hand 1913c and/or a finger on hand 1913c remains touched down on user interface object 1903b, device 101 directs movement-based inputs to user interface objects 1903b and/or 1903c (e.g., scrolling inputs) in accordance with the lateral movement of hand 1913c (e.g., without redisplaying or adjusting shadow 1944). In some embodiments, in response to movement of hand 1913c and/or a finger on hand 1913c away from user interface object 1903b, device 101 recognizes the end of the corresponding input that was directed to user interface objects 1903b and/or 1903c (e.g., tap inputs, long press inputs, scrolling inputs, etc.) and redisplays or adjusts shadow 1944 with one or more of the characteristics previously described, accordingly.

FIGS. 20A-20F is a flowchart illustrating a method of enhancing interactions with user interface elements in a three-dimensional environment using visual indications of such interactions in accordance with some embodiments. In some embodiments, the method 2000 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, a projector, etc.) and one or more cameras (e.g., a camera (e.g., color sensors, infrared sensors, and other depth-sensing cameras) that points downward at a user's hand or a camera that points forward from the user's head). In some embodiments, the method 2000 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 2000 are, optionally, combined and/or the order of some operations is, optionally, changed.

In some embodiments, method 2000 is performed at an electronic device (e.g., 101a) in communication with a display generation component and one or more input devices. For example, a mobile device (e.g., a tablet, a smartphone, a media player, or a wearable device), or a computer. In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. In some embodiments, the one or more input devices include an electronic device or component capable of receiving a user input (e.g., capturing a user input, detecting a user input, etc.) and transmitting information associated with the user input to the electronic device. Examples of input devices include a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera, a depth sensor, an eye tracking device, and/or a motion sensor (e.g., a hand tracking device, a hand motion sensor), etc. In some embodiments, the hand tracking device is a wearable device, such as a smart glove. In some embodiments, the hand tracking device is a handheld input device, such as a remote control or stylus.

In some embodiments, the electronic device displays (2002a), via the display generation component, a user interface object, such as user interface objects 1903a and/or 1903b in FIGS. 19A-19D. In some embodiments, the user interface object is an interactive user interface object and, in response to detecting an input directed towards a given object, the electronic device performs an action associated with the user interface object. For example, a user interface object is a selectable option that, when selected, causes the electronic device to perform an action, such as displaying a respective user interface, changing a setting of the electronic device, or initiating playback of content. As another example, a user interface object is a container (e.g., a window) in which a user interface/content is displayed and, in response to detecting selection of the user interface object followed by a movement input, the electronic device updates the position of the user interface object in accordance with the movement input. In some embodiments, the user interface object is displayed in a three-dimensional environment (e.g., a user interface including the user interface object is the three-dimensional environment and/or is displayed within a three-dimensional environment) that is generated, displayed, or otherwise caused to be viewable by the device (e.g., a computer-generated reality (CGR) environment such as a virtual reality (VR) environment, a mixed reality (MR) environment, or an augmented reality (AR) environment, etc.

In some embodiments, while displaying the user interface object, the electronic device detects (2002b), via the one or more input devices, input directed to the user interface object by a first predefined portion of a user of the electronic device, such as hands 1913a,b,c in FIGS. 19A-19D (e.g., direct or indirect interaction with the user interface object by a hand, finger, etc. of the user of the electronic device, such as described with reference to methods 800, 1000, 1200, 1400, 1600 and/or 1800).

In some embodiments, while detecting the input directed to the user interface object, the electronic device displays (2002c), via the display generation component, a simulated shadow displayed on the user interface object, such as shadows 1942a,b and/or shadow 1944, wherein the simulated shadow has an appearance based on a position of an element that is indicative of interaction with the user interface object relative to the user interface object (e.g., a simulated shadow that appears to be cast by a cursor remote from and/or corresponding to the first predefined portion of the user (e.g., such as the visual indication described with reference to method 1800), or appears to be cast by a representation of the first predefined portion of the user (e.g., a virtual representation of a hand/finger and/or the actual hand/finger as displayed via physical or digital pass-through), etc. optionally based on a simulated light source and/or a shape of the element (e.g., a shape of the cursor or portion of the user). For example, if the first predefined portion of the user is directly interacting with the user interface object, the electronic device generates a simulated shadow that appears to be cast by the first predefined portion of the user on the user interface object (e.g., and does not generate a shadow that appears to be cast by a cursor/visual indication on the user interface object), which optionally indicates that the interaction with the user interface object is a direct interaction (e.g., rather than an indirect interaction). In some embodiments, such a simulated shadow indicates the separation between the first predefined portion of the user and the user interface object (e.g., indicates the distance of movement required, toward the user interface object, for the first predefined portion of the user to interact with the user interface object). As will be described in more detail below, in some embodiments the electronic device generates a different type of simulated shadow for indirect interactions with the user interface object, which indicates that the interaction is indirect (e.g., rather than direct). The above-described manner of generating and displaying shadows indicative of interaction with the user interface object provides an efficient way of indicating the existence and/or type of interaction occurring with the user interface object, which simplifies the interaction between the user and the electronic device and enhances the operability of the electronic device and makes the user-device interface more efficient (e.g., by reducing errors of interaction with the user interface object), which additionally reduces power usage and improves battery life of the electronic device by enabling the user to use the electronic device more quickly and efficiently.

In some embodiments, the element comprises a cursor that is displayed at a location corresponding to a location that is away from the first predefined portion of the user, and is controlled by movement of the first predefined portion of the user (2004a), such as cursor 1940a and/or cursor 1940b. For example, in some embodiments, when the first predefined portion of the user (e.g., the hand of the user) is in a particular pose and at a distance from a location corresponding to the user interface object corresponding to indirect interaction with the user interface object, such as described with reference to method 800, the electronic device displays a cursor near the user interface object whose position/movement is controlled by the first predefined portion of the user (e.g., a location/movement of the user's hand and/or a finger on the user's hand). In some embodiments, in response to movement of the first predefined portion of the user towards the location corresponding to the user interface object, the electronic device decreases the separation between the cursor and the user interface object, and when the movement of the first predefined portion of the user is sufficient movement for selection of the user interface object, the electronic device eliminates the separation between the cursor and the user interface object (e.g., so that the cursor touches the user interface object). In some embodiments, the simulated shadow is a simulated shadow of the cursor on the user interface object, and the simulated shadow updates/changes as the position of the cursor changes on the user interface object and/or the distance of the cursor from the user interface object changes based on the movement/position of the first predefined portion of the user. The above-described manner of displaying a cursor and a simulated shadow of that cursor indicative of interaction with the user interface object provides an efficient way of indicating the type and/or amount of input needed from the first predefined portion of the user to interact with the user interface object, which simplifies the interaction between the user and the electronic device and enhances the operability of the electronic device and makes the user-device interface more efficient (e.g., by reducing errors of interaction with the user interface object), which additionally reduces power usage and improves battery life of the electronic device by enabling the user to use the electronic device more quickly and efficiently.

In some embodiments, while displaying the user interface object and a second user interface object, and before detecting the input directed to the user interface object by the first predefined portion of the user (2006a), in accordance with a determination that one or more first criteria are satisfied, including a criterion that is satisfied when a gaze of the user is directed to the user interface object (e.g., criteria corresponding to indirect interaction with the user interface object, including one or more criteria based on distance of the first predefined portion of the user from the user interface object, a pose of the first predefined portion of the user, etc., such as described with reference to method 800), the electronic device displays (2006b), via the display generation component, the cursor at a predetermined distance from the user interface object, such as described with reference to cursors 1940a and 1940b in FIG. 19A (e.g., the cursor is optionally not displayed in association with the user interface object before the one or more first criteria are satisfied). In some embodiments, the cursor is initially displayed as separated from the user interface object by a predetermined amount (e.g., 0.1, 0.5, 1, 5, 10 cm) when the one or more first criteria are satisfied. After the cursor is displayed, movement of the first predefined portion of the user (e.g., towards the user interface object) that corresponds to the initial separation of the cursor from the user interface object is optionally required for interaction with/selection of the user interface object by the cursor.

In some embodiments, in accordance with a determination that one or more second criteria are satisfied, including a criterion that is satisfied when the gaze of the user is directed to the second user interface object (e.g., criteria corresponding to indirect interaction with the second user interface object, including one or more criteria based on distance of the first predefined portion of the user from the second user interface object, a pose of the first predefined portion of the user, etc., such as described with reference to method 800), the electronic device displays (2006b), via the display generation component, the cursor at the predetermined distance from the second user interface object, such as if the cursor-display criteria described herein had been satisfied with respect to object 1903c in FIG. 19A (e.g., additionally or alternatively to object 1903a), which would optionally cause device 101 to display a cursor—similar to cursors 1940a and/or 1940b—for interaction with object 1903c. For example, the cursor is optionally not displayed in association with the second user interface object before the one or more second criteria are satisfied. In some embodiments, the cursor is initially displayed as separated from the second user interface object by a predetermined amount (e.g., 0.1, 0.5, 1, 5, 10 cm) when the one or more second criteria are satisfied. After the cursor is displayed, movement of the first predefined portion of the user (e.g., towards the second user interface object) that corresponds to the initial separation of the cursor from the second user interface object is optionally required for interaction with/selection of the second user interface object by the cursor. Therefore, in some embodiments, the electronic device displays a cursor for interacting with respective user interface objects based on the gaze of the user. The above-described manner of displaying a cursor for interaction with respective user interface objects based on gaze provides an efficient way of preparing for interaction with a user interface object, which simplifies the interaction between the user and the electronic device and enhances the operability of the electronic device and makes the user-device interface more efficient (e.g., by being prepared to accept interaction with a user interface object when the user is looking at that object), which additionally reduces power usage and improves battery life of the electronic device by enabling the user to use the electronic device more quickly and efficiently.

In some embodiments, the simulated shadow comprises a simulated shadow of a virtual representation of the first predefined portion of the user (2008a), such as described with reference to simulated shadow 1944 corresponding to hand 1913c. For example, the electronic device optionally captures, with one or more sensors, images/information/etc. about one or more hands of the user in the physical environment of the electronic device, and displays representations of those hands at their respective corresponding positions in the three-dimensional environment (e.g., including the user interface object) displayed by the electronic device via the display generation component. In some embodiments, the electronic device displays simulated shadow(s) of those representation(s) of the user's hand(s) or portions of the user's hands in the three-dimensional environment displayed by the electronic device (e.g., as shadow(s) displayed on the user interface object) to indicate one or more characteristics of interaction between the hand(s) of the user and the user interface object, as described herein (optionally without displaying a shadow of other portions of the user or without displaying a shadow of other portions of the users' hands). In some embodiments, the simulated shadow corresponding to the hand of the user is a simulated shadow on the user interface object during direction interaction (e.g., as described with reference to method 800) between the hand of the user and the user interface object. In some embodiments, this simulated shadow provides a visual indication of one or more of the distance between the first predefined portion of the user and the user interface object (e.g., for selection of the user interface object), the location on the user interface object with which the first predefined portion of the user will be/is interacting, etc. The above-described manner of displaying a simulated shadow corresponding to a representation of the first predefined portion of the user provides an efficient way of indicating characteristics of direct interaction with the user interface object, which simplifies the interaction between the user and the electronic device and enhances the operability of the electronic device and makes the user-device interface more efficient (e.g., by avoiding errors in interaction with the user interface object), which additionally reduces power usage and improves battery life of the electronic device by enabling the user to use the electronic device more quickly and efficiently.

In some embodiments the simulated shadow comprises a simulated shadow of the physical first predefined portion of the user (2010a), such as described with reference to simulated shadow 1944 corresponding to hand 1913c. For example, the electronic device optionally passes through (e.g., via a transparent or semi-transparent display generation component) a view of one or more hands of the user in the physical environment of the electronic device, and displays the three-dimensional environment (e.g., including the user interface object) via the display generation component, which results in the view(s) of the one or more hands to be visible in the three-dimensional environment displayed by the electronic device. In some embodiments, the electronic device displays simulated shadow(s) of those hand(s) of the user or portions of the user's hands in the three-dimensional environment displayed by the electronic device (e.g., as shadow(s) displayed on the user interface object) to indicate one or more characteristics of interaction between the hand(s) of the user and the user interface object, as described herein (optionally without displaying a shadow of other portions of the user or without displaying a shadow of other portions of the users' hands). In some embodiments, the simulated shadow corresponding to the hand of the user is a simulated shadow on the user interface object during direction interaction (e.g., as described with reference to method 800) between the hand of the user and the user interface object. In some embodiments, this simulated shadow provides a visual indication of one or more of the distance between the first predefined portion of the user and the user interface object (e.g., for selection of the user interface object), the location on the user interface object with which the first predefined portion of the user will be/is interacting, etc. The above-described manner of displaying a simulated shadow corresponding to a view of the first predefined portion of the user provides an efficient way of indicating characteristics of direct interaction with the user interface object, which simplifies the interaction between the user and the electronic device and enhances the operability of the electronic device and makes the user-device interface more efficient (e.g., by avoiding errors in interaction with the user interface object), which additionally reduces power usage and improves battery life of the electronic device by enabling the user to use the electronic device more quickly and efficiently.

In some embodiments, while detecting the input directed to the user interface object and while displaying the simulated shadow displayed on the user interface object (2012a) (e.g., while displaying the shadow of a cursor on the user interface object or while displaying the shadow of the first predefined portion of the user on the user interface object), the electronic device detects (2012b), via the one or more input devices, progression of the input directed to the user interface object by the first predefined portion of the user (e.g., the first predefined portion of the user moves towards the user interface object), such as described with reference to hand 1913a in FIG. 19B. In some embodiments, in response to detecting the progression of the input directed to the user interface object, the electronic device changes (2012c) a visual appearance of the simulated shadow (e.g., size, darkness, translucency, etc.) displayed on the user interface object in accordance with the progression of the input (e.g., based on a distance moved, based on a speed of movement, based on a direction of movement) directed to the user interface object by the first predefined portion of the user, such as described with reference to shadow 1942a in FIG. 19B. For example, in some embodiments, the visual appearance of the simulated shadow optionally changes as the first predefined portion of the user moves relative to the user interface object. For example, as the first predefined portion of the user moves towards the user interface object (e.g., towards selecting/interacting with the user interface object), the electronic device optionally changes the visual appearance of the simulated shadow in a first manner, and as the first predefined portion of the user moves away from the user interface object (e.g., away from selecting/interacting with the user interface object), the electronic device optionally changes the visual appearance of the simulated shadow in a second manner, different from the first manner (e.g., in the opposite of the first manner). The above-described manner of changing the visual appearance of the simulated shadow based on the progression of the input directed to the user interface object provides an efficient way of indicating progress towards, or regression away from, selection of the user interface object, which simplifies the interaction between the user and the electronic device and enhances the operability of the electronic device and makes the user-device interface more efficient (e.g., by avoiding errors in interaction with the user interface object), which additionally reduces power usage and improves battery life of the electronic device by enabling the user to use the electronic device more quickly and efficiently.

In some embodiments, changing the visual appearance of the simulated shadow includes changing a brightness with which the simulated shadow is displayed (2014a), such as described with reference to shadow 1942a and/or shadow 1944. For example, in some embodiments, as the first predefined portion of the user (e.g., and thus, when applicable, the cursor) moves towards the user interface object (e.g., towards selection of/interaction with the user interface object), the electronic device optionally displays the simulated shadow (e.g., of the hand and/or of the cursor) with more darkness, and as the first predefined portion of the user (e.g., and thus, when applicable, the cursor) moves away from the user interface object (e.g., away from selection of/interaction with the user interface object), the electronic device optionally displays the simulated shadow (e.g., of the hand and/or of the cursor) with less darkness. The above-described manner of changing the darkness of the simulated shadow based on the progression of the input directed to the user interface object provides an efficient way of indicating progress towards, or regression away from, selection of the user interface object, which simplifies the interaction between the user and the electronic device and enhances the operability of the electronic device and makes the user-device interface more efficient (e.g., by avoiding errors in interaction with the user interface object), which additionally reduces power usage and improves battery life of the electronic device by enabling the user to use the electronic device more quickly and efficiently.

In some embodiments, changing the visual appearance of the simulated shadow includes changing a level of blurriness (and/or diffusion) with which the simulated shadow is displayed (2016a), such as described with reference to shadow 1942a and/or shadow 1944. For example, in some embodiments, as the first predefined portion of the user (e.g., and thus, when applicable, the cursor) moves towards the user interface object (e.g., towards selection of/interaction with the user interface object), the electronic device optionally displays the simulated shadow (e.g., of the hand and/or of the cursor) with less blurriness and/or diffusion, and as the first predefined portion of the user (e.g., and thus, when applicable, the cursor) moves away from the user interface object (e.g., away from selection of/interaction with the user interface object), the electronic device optionally displays the simulated shadow (e.g., of the hand and/or of the cursor) with more blurriness and/or diffusion. The above-described manner of changing the blurriness of the simulated shadow based on the progression of the input directed to the user interface object provides an efficient way of indicating progress towards, or regression away from, selection of the user interface object, which simplifies the interaction between the user and the electronic device and enhances the operability of the electronic device and makes the user-device interface more efficient (e.g., by avoiding errors in interaction with the user interface object), which additionally reduces power usage and improves battery life of the electronic device by enabling the user to use the electronic device more quickly and efficiently.

In some embodiments, changing the visual appearance of the simulated shadow includes changing a size of the simulated shadow (2018a), such as described with reference to shadow 1942a and/or shadow 1944. For example, in some embodiments, as the first predefined portion of the user (e.g., and thus, when applicable, the cursor) moves towards the user interface object (e.g., towards selection of/interaction with the user interface object), the electronic device optionally displays the simulated shadow (e.g., of the hand and/or of the cursor) with a smaller size, and as the first predefined portion of the user (e.g., and thus, when applicable, the cursor) moves away from the user interface object (e.g., away from selection of/interaction with the user interface object), the electronic device optionally displays the simulated shadow (e.g., of the hand and/or of the cursor) with a larger size. The above-described manner of changing the size of the simulated shadow based on the progression of the input directed to the user interface object provides an efficient way of indicating progress towards, or regression away from, selection of the user interface object, which simplifies the interaction between the user and the electronic device and enhances the operability of the electronic device and makes the user-device interface more efficient (e.g., by avoiding errors in interaction with the user interface object), which additionally reduces power usage and improves battery life of the electronic device by enabling the user to use the electronic device more quickly and efficiently.

In some embodiments, while detecting the input directed to the user interface object and while displaying the simulated shadow displayed on the user interface object (2020a) (e.g., while displaying the shadow of a cursor on the user interface object or while displaying the shadow of the first predefined portion of the user on the user interface object), the electronic device detects (2020b), via the one or more input devices, a first portion of the input that corresponds to moving the element laterally with respect to the user interface object (e.g., detecting lateral movement of the first predefined portion of the user relative to the location corresponding to the user interface object), such as described with reference to hand 1913a in FIG. 19C or hand 1913c in FIG. 19C. In some embodiments, in response detecting the first portion of the input, the electronic device displays (2020c) the simulated shadow at a first location on the user interface object with a first visual appearance (e.g., a first one or more of size, shape, color, darkness, blurriness, diffusion, etc.), such as described with reference to hand 1913a in FIG. 19C or hand 1913c in FIG. 19C. In some embodiments, the electronic device detects (2020d), via the one or more input devices, a second portion of the input that corresponds to moving the element laterally with respect to the user interface object (e.g., detecting another lateral movement of the first predefined portion of the user relative to the location corresponding to the user interface object). In some embodiments, in response detecting the second portion of the input, the electronic device displays (2020e) the simulated shadow at a second location, different from the first location, on the user interface object with a second visual appearance, different from the first visual appearance (e.g., a different one or more of size, shape, color, darkness, blurriness, diffusion, etc.), such as described with reference to hand 1913a in FIG. 19C or hand 1913c in FIG. 19C. In some embodiments, the electronic device changes the visual appearance of the simulated shadow as the simulated shadow moves laterally over the user interface object (e.g., corresponding to lateral motion of the first predefined portion of the user).

In some embodiments, the difference in visual appearance is based on one or more of differences in the content of the user interface object over which the simulated shadow is displayed, the differences in distance between the first predefined portion of the user and the user interface object at the different locations of the simulated shadow on the user interface object, etc. The above-described manner of changing the visual appearance of the simulated shadow based on lateral movement of the shadow and/or first predefined portion of the user provides an efficient way of indicating one or more characteristics of the interaction with the user interface object that are relevant to different locations of the user interface object, which simplifies the interaction between the user and the electronic device and enhances the operability of the electronic device and makes the user-device interface more efficient (e.g., by avoiding errors in interaction with different locations on the user interface object), which additionally reduces power usage and improves battery life of the electronic device by enabling the user to use the electronic device more quickly and efficiently.

In some embodiments, the user interface object is a virtual surface (e.g., a virtual trackpad), and the input detected at a location proximate to the virtual surface provides inputs to a second user interface object, remote from the virtual surface (2022a), such as described with respect to user interface objects 1903b and 1903c. For example, in some embodiments, when the first predefined portion of the user (e.g., the hand of the user) is in a particular pose and at a distance corresponding to indirect interaction with a particular user interface object, such as described with reference to method 800, the electronic device displays a virtual trackpad near (e.g., a predetermined distance, such as 0.1, 0.5, 1, 5, 10 cm, away from) the first predefined portion of the user and displays a simulated shadow corresponding to the first predefined portion of the user on the virtual trackpad. In some embodiments, in response to movement of the first predefined portion of the user towards the virtual trackpad, the electronic device updates the simulated shadow based on the relative position and/or distance of the first predefined portion of the user from the virtual trackpad. In some embodiments, when the movement of the first predefined portion of the user is sufficient movement for selection of the virtual trackpad with the first predefined portion of the user, the electronic device provides input to the particular, remote user interface object based on interactions between the first predefined portion of the user and the virtual trackpad (e.g., selection inputs, tap inputs, scrolling inputs, etc.). The virtual surface has one or more characteristics of the visual indication displayed at various locations in the three-dimensional environment corresponding to the respective position of the predefined portion of the user, as described with reference to method 1800. The above-described manner of displaying a virtual trackpad and a simulated shadow on the virtual trackpad provides an efficient way of indicating one or more characteristics of the interaction with the virtual trackpad (e.g., and, therefore, the remote user interface object), which simplifies the interaction between the user and the electronic device and enhances the operability of the electronic device and makes the user-device interface more efficient (e.g., by avoiding errors in interaction with the remote user interface object via the virtual trackpad), which additionally reduces power usage and improves battery life of the electronic device by enabling the user to use the electronic device more quickly and efficiently.

In some embodiments, the first predefined portion of the user is directly interacting with the user interface object (e.g., as described with reference to method 1400), and the simulated shadow is displayed on the user interface object (2024a), such as described with reference to user interface object 1903b in FIGS. 19A-19D. For example, if the first predefined portion of the user is directly interacting with the user interface object, the electronic device generates a simulated shadow that appears to be cast by the first predefined portion of the user on the user interface object (e.g., and does not generate a shadow that appears to be cast by a cursor/visual indication on the user interface object), which optionally indicates that the interaction with the user interface object is a direct interaction (e.g., rather than an indirect interaction). In some embodiments, such a simulated shadow indicates the separation between the first predefined portion of the user and a location corresponding to the user interface object (e.g., indicates the distance of movement required, toward the user interface object, for the first predefined portion of the user to interact with the user interface object). The above-described manner of displaying the simulated shadow on the user interface object when the first predefined portion of the user is directly interacting with the user interface object provides an efficient way of indicating one or more characteristics of the interaction with the user interface object, which simplifies the interaction between the user and the electronic device and enhances the operability of the electronic device and makes the user-device interface more efficient (e.g., by avoiding errors in interaction with the user interface object), which additionally reduces power usage and improves battery life of the electronic device by enabling the user to use the electronic device more quickly and efficiently.

In some embodiments, in accordance with a determination that the first predefined portion of the user is within a threshold distance (e.g., 1, 2, 5, 10, 20, 50, 100, 500 cm) of a location corresponding to the user interface object, the simulated shadow corresponds to the first predefined portion of the user (2026a), such as shadow 1944 (e.g., if the first predefined portion of the user is directly interacting with the user interface object, such as described with reference to methods 800, 1000, 1200, 1400, 1600 and/or 1800, the electronic device displays a simulated shadow on the user interface object, where the simulated shadow corresponds to (e.g., has a shape based on) the first predefined portion of the user. In some embodiments, the electronic device does not display a cursor corresponding to the first predefined portion of the user for interaction between the first predefined portion of the user and the user interface object). In some embodiments, in accordance with a determination that the first predefined portion of the user is further than the threshold distance (e.g., 1, 2, 5, 10, 20, 50, 100, 500 cm) from the location corresponding to the user interface object, the simulated shadow corresponds to a cursor that is controlled by the first predefined portion of the user (2026b), such as shadows 1942a and/or 1942b. For example, if the first predefined portion of the user is indirectly interacting with the user interface object, such as described with reference to methods 800, 1000, 1200, 1400, 1600 and/or 1800, the electronic device displays a cursor and a simulated shadow on the user interface object, where the simulated shadow corresponds to (e.g., has a shape based on) the cursor. Example details of the cursor and/or the shadow corresponding to the cursor were described previously herein. The above-described manner of selectively displaying a cursor and its corresponding shadow provides an efficient way of facilitating the appropriate interaction with the user interface object (e.g., direct or indirect), which simplifies the interaction between the user and the electronic device and enhances the operability of the electronic device and makes the user-device interface more efficient (e.g., by avoiding errors in interaction with the user interface object), which additionally reduces power usage and improves battery life of the electronic device by enabling the user to use the electronic device more quickly and efficiently.

In some embodiments, while detecting the input directed to the user interface object by the first predefined portion of the user, the electronic device detects (2028a) a second input directed to the user interface object by a second predefined portion of the user, such as detecting hands 1913a and 1913b interacting with user interface object 1903a (e.g., both hands of the user satisfy indirect interaction criteria, such as described with reference to method 800, with the same user interface object. In some embodiments, the user interface object is a virtual keyboard displayed by the display generation component, and the electronic device is able to accept input from both hands of the user to select respective keys of the keyboard for input to the electronic device). In some embodiments, while concurrently detecting the input and the second input directed to the user interface object, the electronic device concurrently displays (2028b), on the user interface object, the simulated shadow that is indicative of interaction of the first predefined portion of the user with the user interface object relative to the user interface object (2028c), and a second simulated shadow that is indication of interaction of the second predefined portion of the user with the user interface object relative to the user interface object (2028d), such as shadows 1942a and 1942b. For example, the electronic device displays a simulated shadow on the keyboard corresponding to the first predefined portion of the user (e.g., a shadow of a cursor if the first predefined portion of the user is indirectly interacting with the keyboard, or a shadow of the first predefined portion of the user if the first predefined portion of the user is directly interacting with the keyboard) and a simulated shadow on the keyboard corresponding to the second predefined portion of the user (e.g., a shadow of a cursor if the second predefined portion of the user is indirectly interacting with the keyboard, or a shadow of the second predefined portion of the user if the second predefined portion of the user is directly interacting with the keyboard). In some embodiments, the simulated shadow corresponding to the first predefined portion of the user has one or more characteristics (e.g., as described herein) indicative of the interaction of the first predefined portion of the user with the user interface object, and the simulated shadow corresponding to the second predefined portion of the user has one or more characteristics (e.g., as described herein) indicative of the interaction of the second predefined portion of the user with the user interface object. The above-described manner of displaying simulated shadows for the multiple predefined portions of the user provides an efficient way of independently indicating characteristics of interaction between multiple predefined portions of the user and the user interface object, which simplifies the interaction between the user and the electronic device and enhances the operability of the electronic device and makes the user-device interface more efficient (e.g., by avoiding errors in interaction with the user interface object), which additionally reduces power usage and improves battery life of the electronic device by enabling the user to use the electronic device more quickly and efficiently.

In some embodiments, the simulated shadow indicates how much movement is required of the first predefined portion of the user to engage with the user interface object (2030a), such as described with reference to shadows 1942a,b and/or 1944. For example, the visual appearance of the simulated shadow is based on a distance that the first predefined portion of the user must move towards the user interface object to interact with the user interface object. Therefore, the visual appearance of the simulated shadow optionally indicates by how much the first predefined portion of the user must move to interact with and/or select the user interface object. For example, if the simulated shadow is relatively large and/or diffuse, the simulated shadow optionally indicates that the first predefined portion of the user must move a relatively large distance towards the user interface object to interact with and/or select the user interface object, and if the simulated shadow is relatively small and/or sharply defined, the simulated shadow optionally indicates that the first predefined portion of the user must move a relatively small distance towards the user interface object to interact with and/or select the user interface object. The above-described manner of the simulated shadow indicating how much the first predefined portion of the user must move to interact with the user interface object provides an efficient way of facilitating accurate interaction between the first predefined portion of the user and the user interface object, which simplifies the interaction between the user and the electronic device and enhances the operability of the electronic device and makes the user-device interface more efficient (e.g., by avoiding errors in interaction with the user interface object), which additionally reduces power usage and improves battery life of the electronic device by enabling the user to use the electronic device more quickly and efficiently.

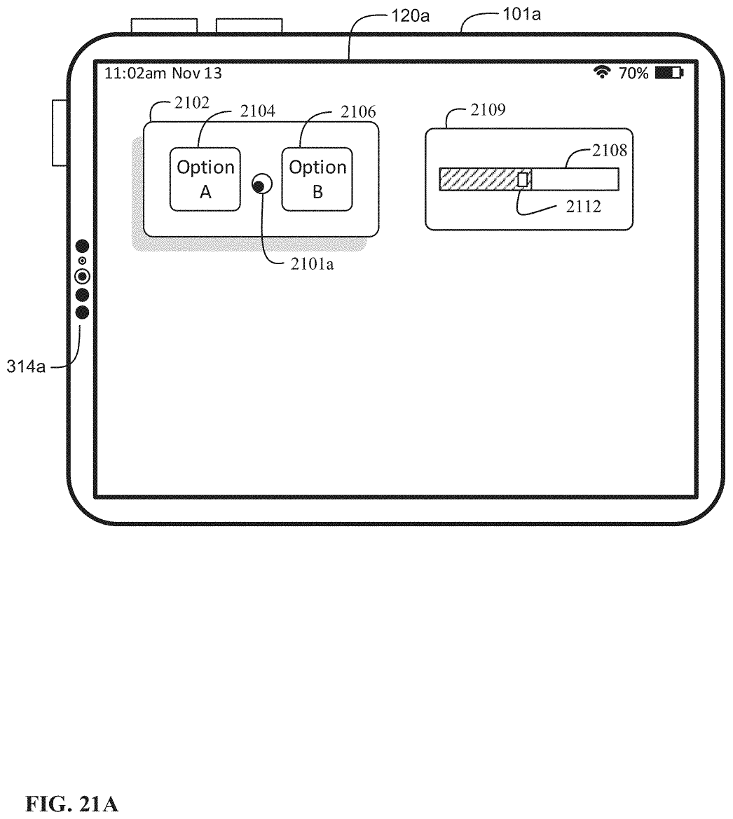

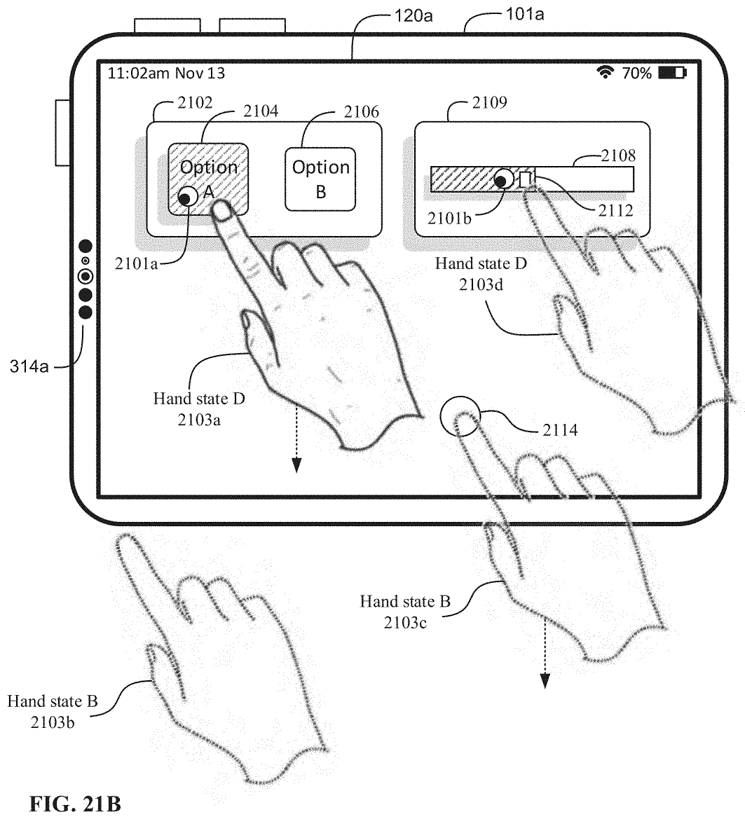

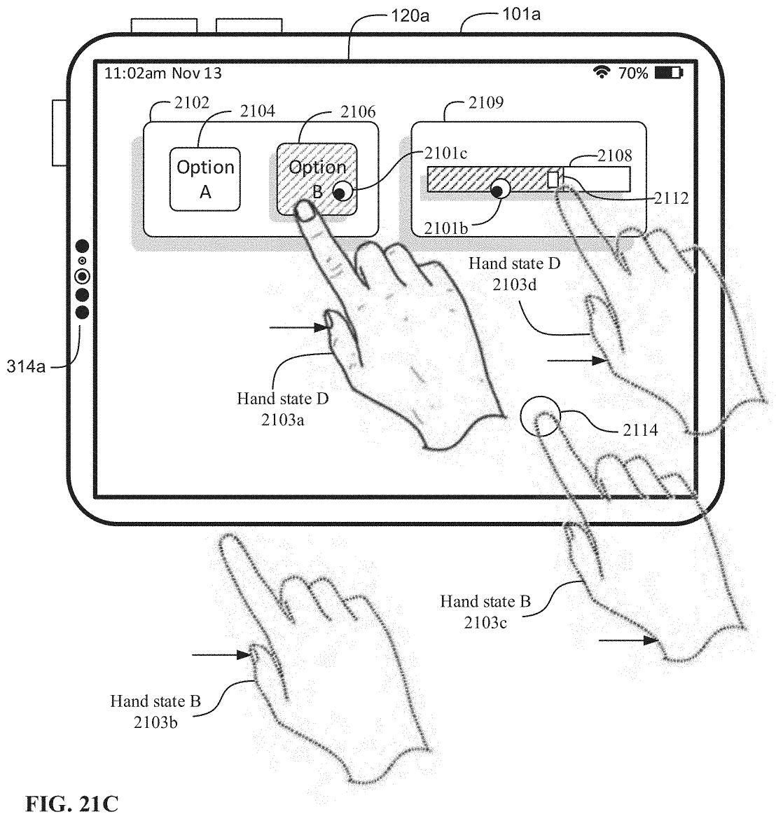

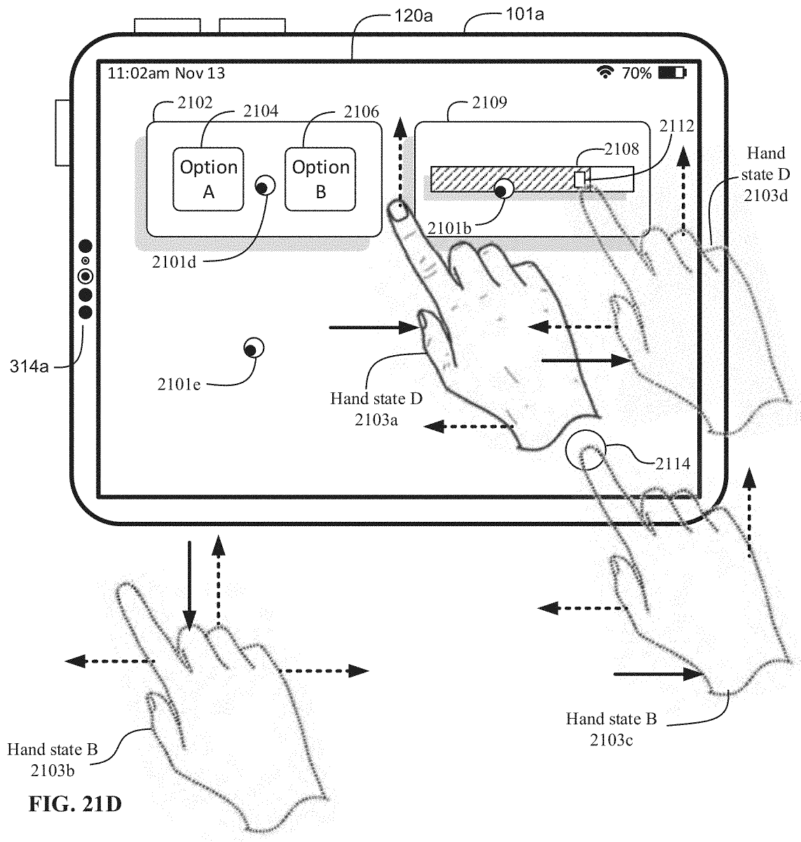

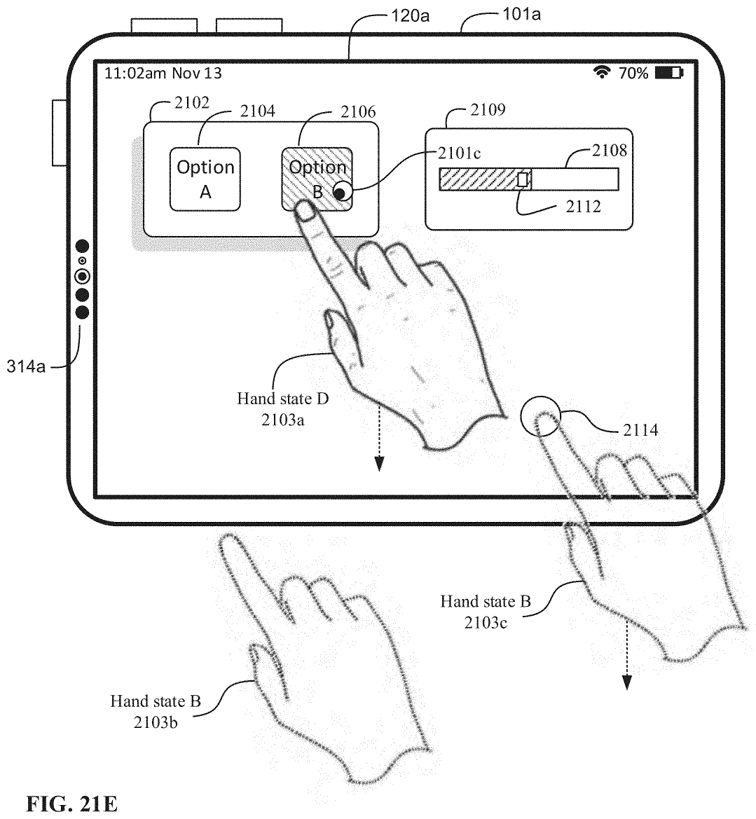

FIGS. 21A-21E illustrate examples of how an electronic device redirects an input from one user interface element to another in response to detecting movement included in the input in accordance with some embodiments.

FIG. 21A illustrates an electronic device 101a displaying, via a display generation component 120, a three-dimensional environment and/or a user interface. It should be understood that, in some embodiments, electronic device 101a utilizes one or more techniques described with reference to FIGS. 21A-21E in a two-dimensional environment without departing from the scope of the disclosure. As described above with reference to FIGS. 1-6, the electronic device 101a optionally includes a display generation component 120a (e.g., a touch screen) and a plurality of image sensors 314a. The image sensors optionally include one or more of a visible light camera, an infrared camera, a depth sensor, or any other sensor the electronic device 101a would be able to use to capture one or more images of a user or a part of the user while the user interacts with the electronic device 101a. In some embodiments, display generation component 120a is a touch screen that is able to detect gestures and movements of a user's hand. In some embodiments, the user interfaces shown and described could also be implemented on a head-mounted display that includes a display generation component that displays the user interface to the user, and sensors to detect the physical environment and/or movements of the user's hands (e.g., external sensors facing outwards from the user), and/or gaze of the user (e.g., internal sensors facing inwards towards the face of the user).

FIG. 21A illustrates an example of the electronic device 101a displaying, in the three-dimensional environment, a first selectable option 2104 and a second selectable option 2106 within container 2102 and a slider user interface element 2108 within container 2109. In some embodiments, containers 2102 and 2109 are windows, backplanes, backgrounds, platters, or other types of container user interface elements. In some embodiments, the contents of container 2102 and the contents of container 2109 are associated with the same application (e.g., or with the operating system of the electronic device 101a). In some embodiments, the contents of container 2102 and the contents of container 2109 are associated with different applications or the contents of one of the containers 2102 or 2109 are associated with the operating system. In some embodiments, in response to detecting selection of one of the selectable options 2104 or 2106, the electronic device 101a performs an action associated with the selected selectable option. In some embodiments, the slider 2108 includes an indication 2112 of a current value of the slider 2108. For example, the slider 2108 indicates a quantity, magnitude, value, etc. of a setting of the electronic device 101a or an application. In some embodiments, in response to an input to change the current value of the slider (e.g., by manipulating the indicator 2112 within slider 2108), the electronic device 101a updates the setting associated with the slider 2108 accordingly.

As shown in FIG. 21A, in some embodiments, the electronic device 101a detects the gaze 2101a of the user directed to container 2102. In some embodiments, in response to detecting the gaze 2101a of the user directed to container 2102, the electronic device 101a updates the position of the container 2102 to display the container 2102 at a location in the three-dimensional environment closer to the viewpoint of the user than the position at which the container 2102 was displayed prior to detecting the gaze 2101a directed to container 2102. For example, prior to detecting the gaze 2101a of the user directed to container 2102, the electronic device 101a displayed containers 2102 and 2109 at the same distance from the viewpoint of the user in the three-dimensional environment. In this example, in response to detecting the gaze 2101a of the user directed to container 2102 as shown in FIG. 21A, the electronic device 101a displays container 2102 closer to the viewpoint of the user than container 2109. For example, the electronic device 101a displays container 2102 at a larger size and/or with a virtual shadow and/or with stereoscopic depth information corresponding to a location closer to the viewpoint of the user.

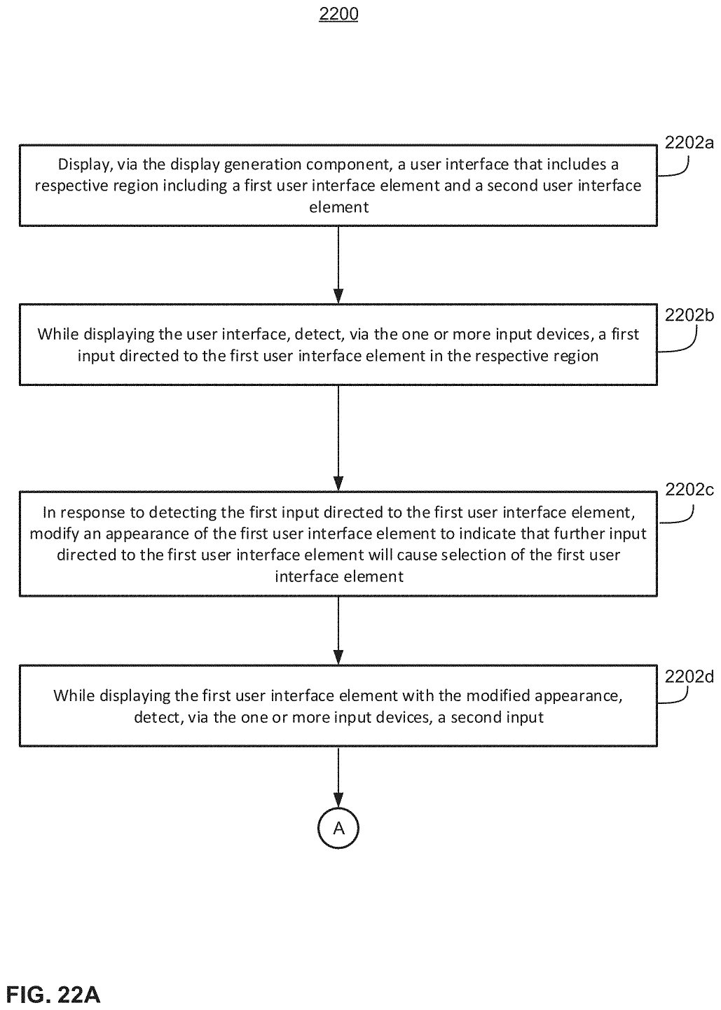

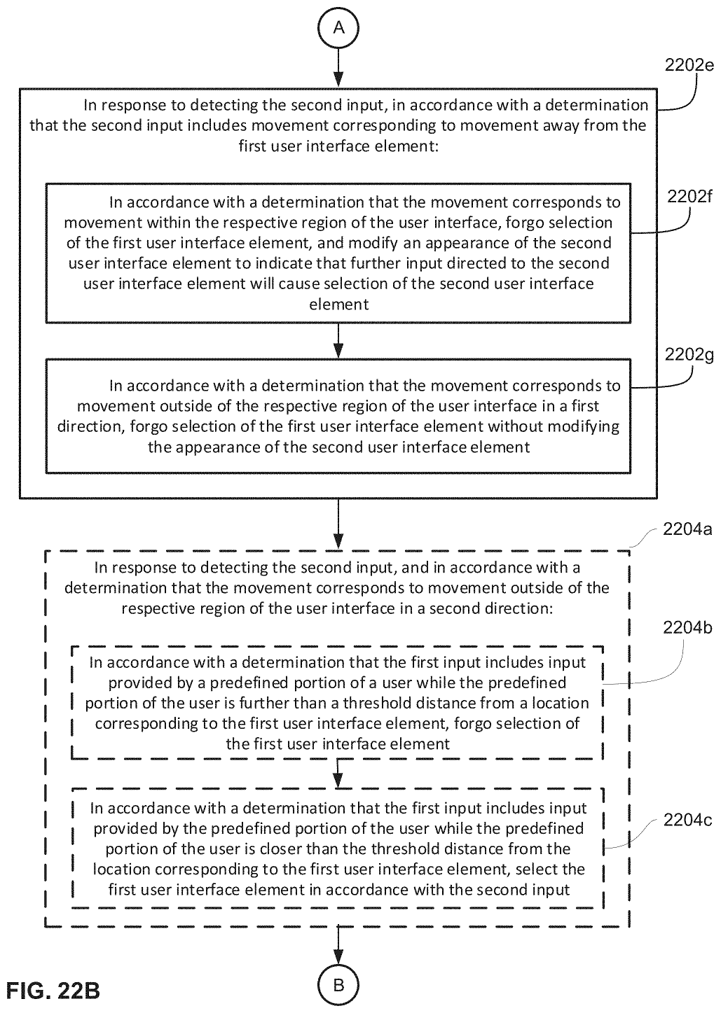

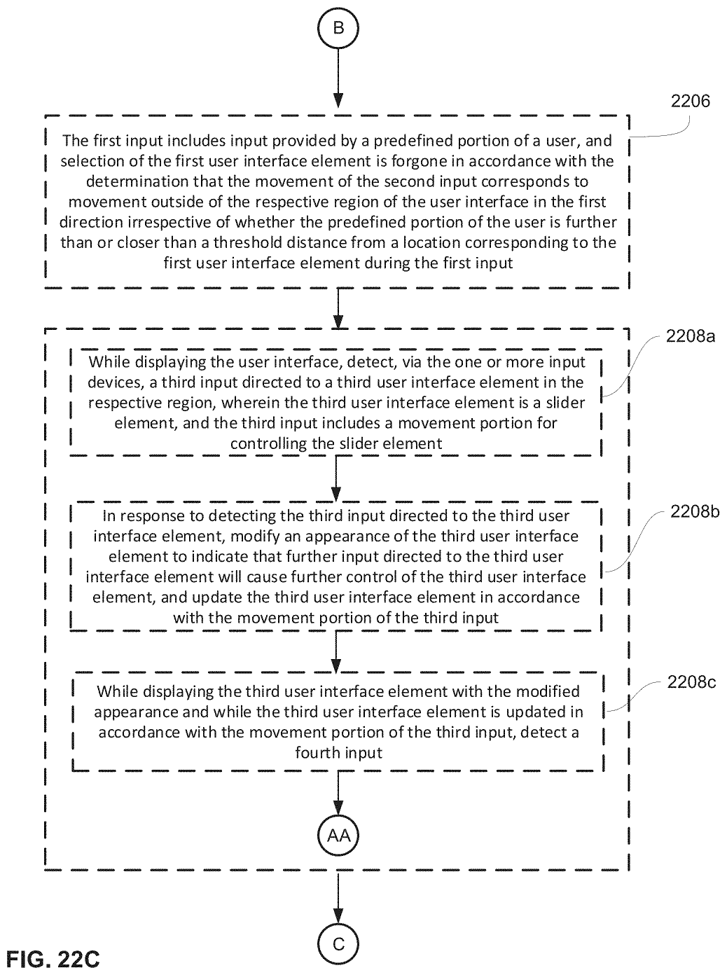

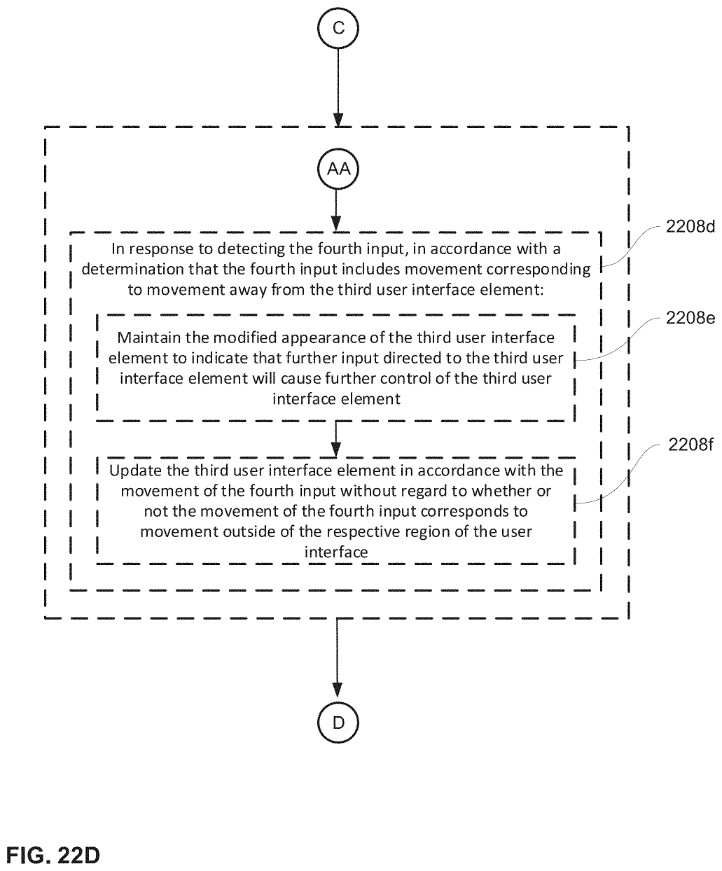

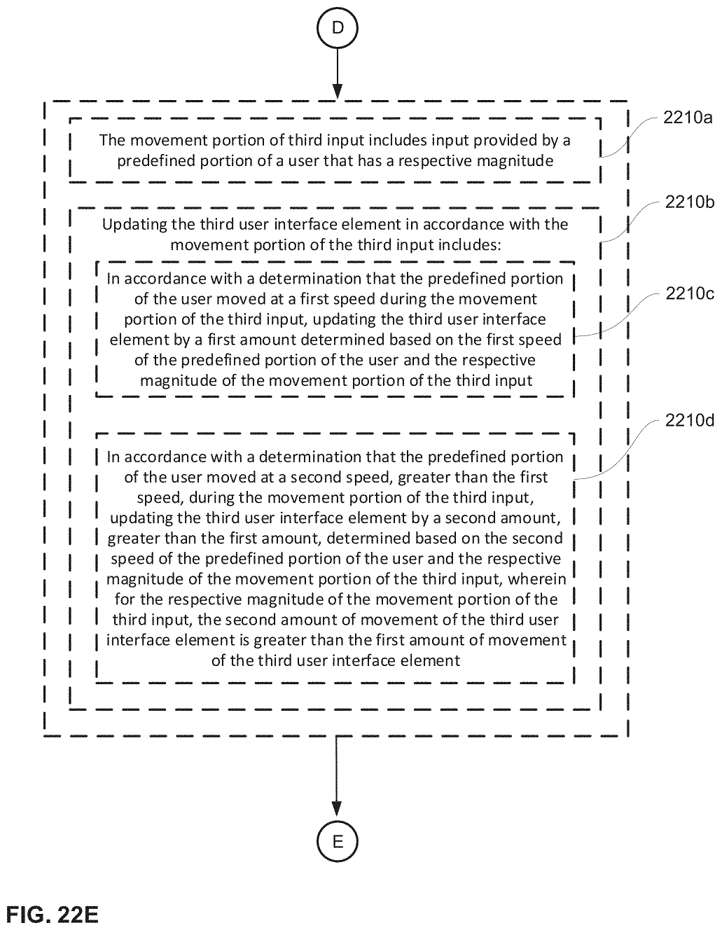

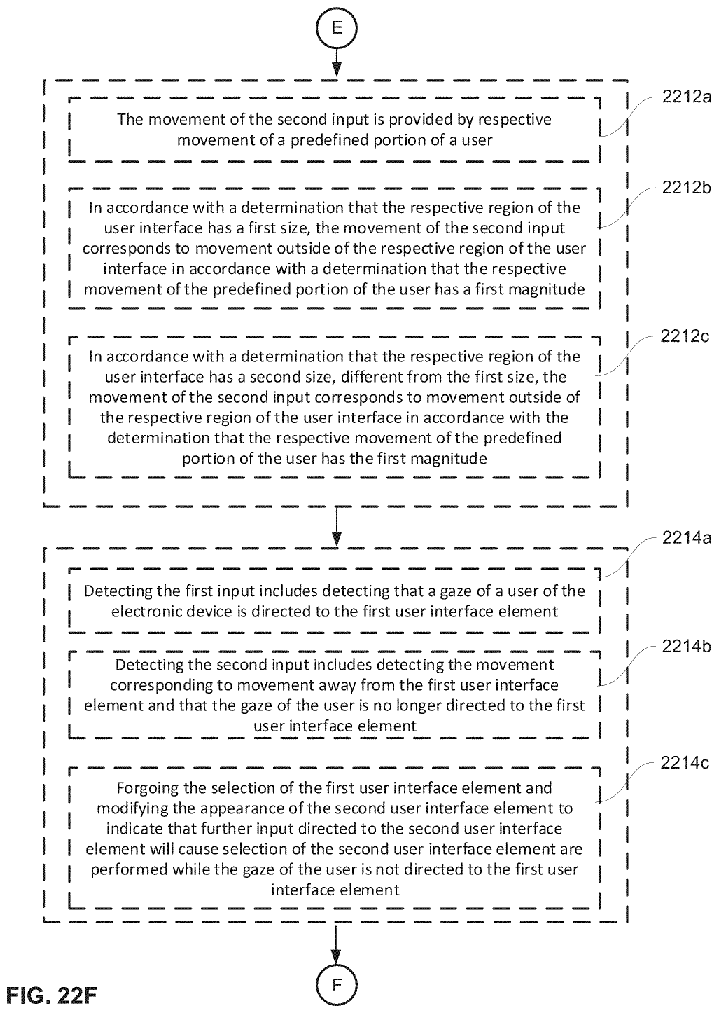

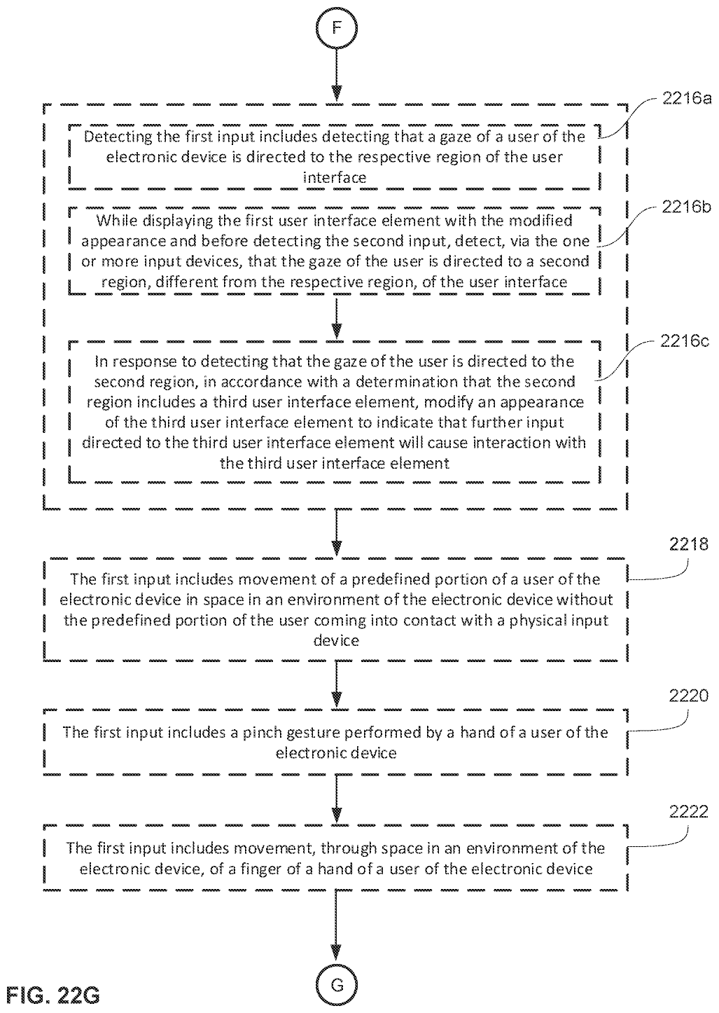

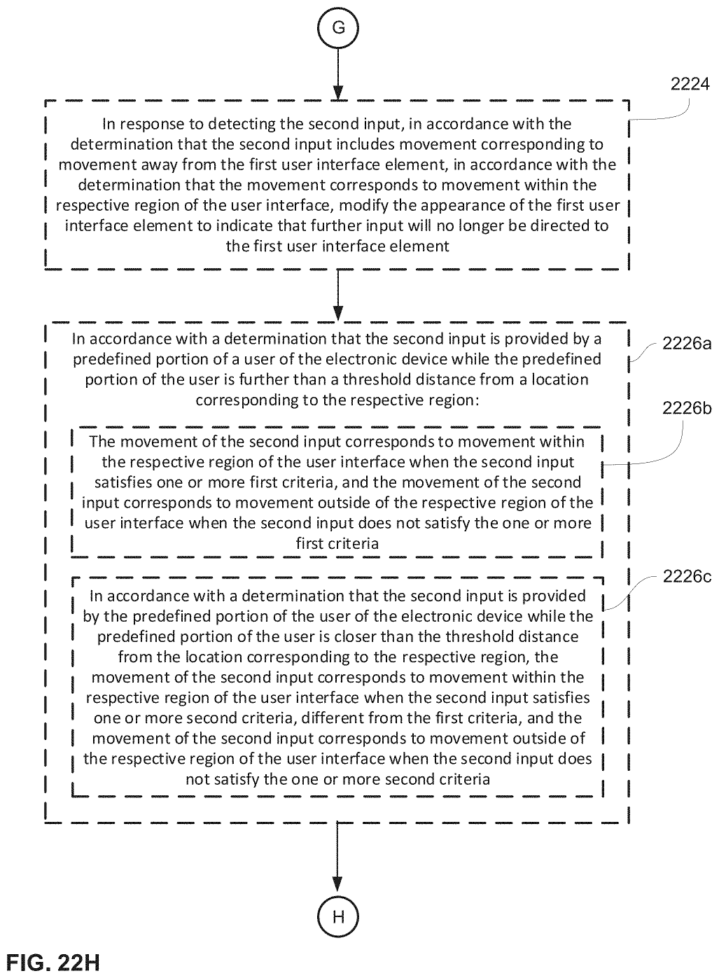

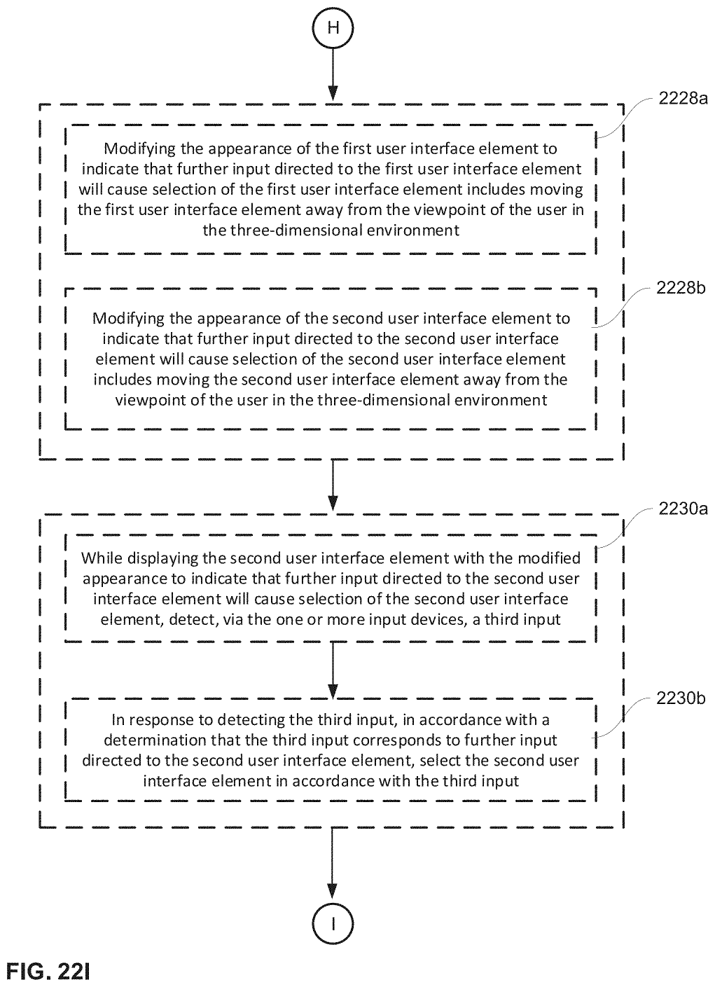

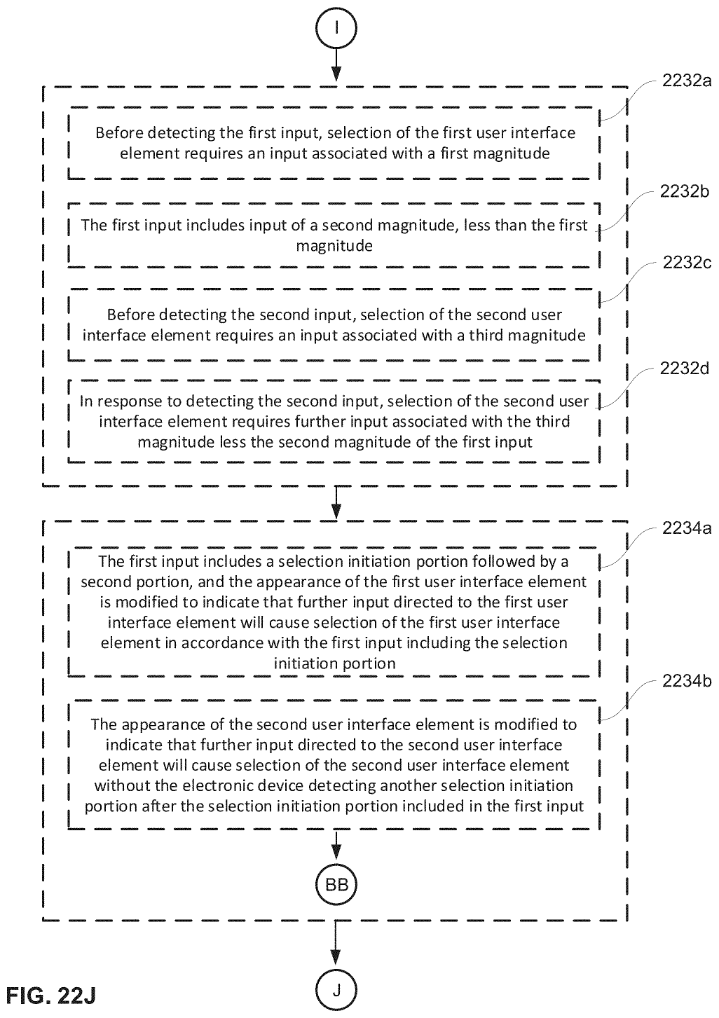

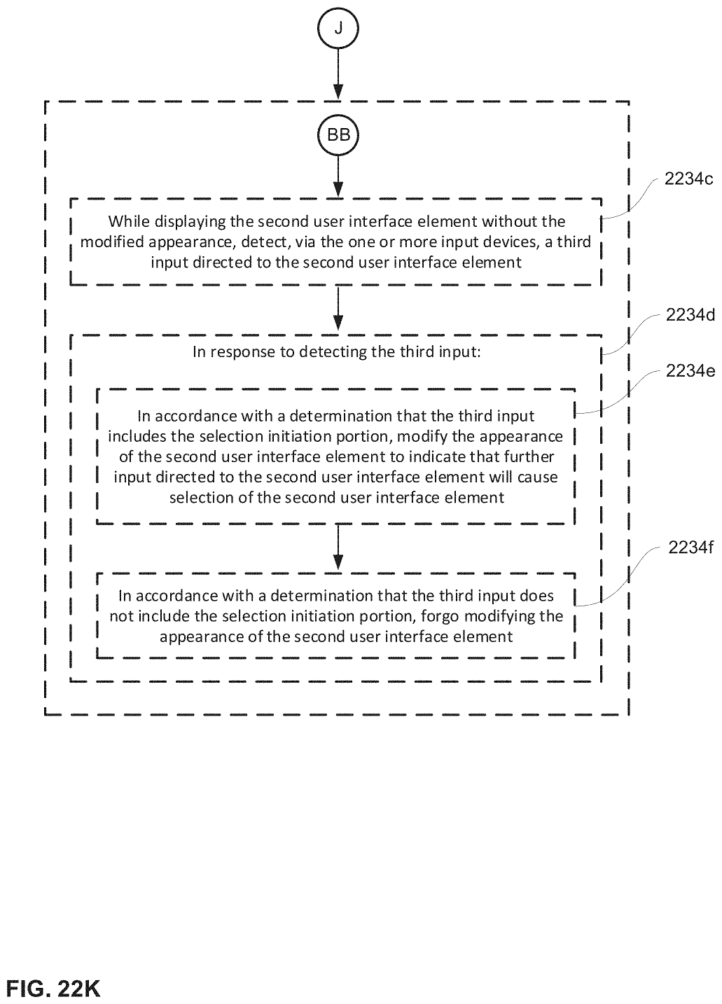

FIG. 21A illustrates an example of the electronic device 101a detecting selection inputs directed to selectable option 2104 and the slider 2108. Although FIG. 21A illustrates a plurality of selection inputs, it should be understood that, in some embodiments, the selection inputs illustrated in FIG. 22A are detected at different times, and not simultaneously.

In some embodiments, the electronic device 101a detects selection of one of the user interface elements, such as one of the selectable options 2104 or 2106 or the indicator 2112 of the slider 2108, by detecting an indirect selection input, a direct selection input, an air gesture selection input, or an input device selection input. In some embodiments, detecting selection of a user interface element includes detecting the hand of the user perform a respective gesture. In some embodiments, detecting an indirect selection input includes detecting, via input devices 314a, the gaze of the user directed to a respective user interface element while detecting the hand of the user make a selection gesture, such as a pinch hand gesture in which the user touches their thumb to another finger of the hand, causing the selectable option to move towards a container in which the selectable option is displayed with selection occurring when the selectable option reaches the container, according to one or more steps of methods 800, 1000, 1200, and/or 1600. In some embodiments, detecting a direct selection input includes detecting, via input devices 314a, the hand of the user make a selection gesture, such as the pinch gesture within a predefined threshold distance (e.g., 1, 2, 3, 5, 10, 15, or 30 centimeters) of the location of the respective user interface element or a pressing gesture in which the hand of the user “presses” into the location of the respective user interface element while in a pointing hand shape according to one or more steps of methods 800, 1400 and/or 1600. In some embodiments, detecting an air gesture input includes detecting the gaze of the user directed to a respective user interface element while detecting a pressing gesture at the location of an air gesture user interface element displayed in the three-dimensional environment via display generation component 120a according to one or more steps of methods 1800 and/or 2000. In some embodiments, detecting an input device selection includes detecting manipulation of a mechanical input device (e.g., a stylus, mouse, keyboard, trackpad, etc.) in a predefined manner corresponding to selection of a user interface element while a cursor controlled by the input device is associated with the location of the respective user interface element and/or while the gaze of the user is directed to the respective user interface element.

For example, in FIG. 21B, the electronic device 101a detects a portion of a direct selection input directed to option 2104 with hand 2103a. In some embodiments, hand 2103a is in a hand shape (e.g., “Hand State D”) included in a direct selection gesture, such as the hand being in a pointing hand shape in which one or more fingers are extended and one or more fingers are curled towards the palm. In some embodiments, the portion of the direct selection input does not include completion of the press gesture (e.g., the hand moving in the direction from option 2104 to container 2102 by a threshold distance, such as a distance corresponding to the visual separation between option 2104 and container 2102). In some embodiments, hand 2103a is within the direct selection threshold distance of the selectable option 2104.

In some embodiments, the electronic device 101a detects a portion of an input directed to the indicator 2112 of slider 2108 with hand 2103d. In some embodiments, hand 2103d is in a hand shape (e.g., “Hand State D”) included in a direct selection gesture, such as the hand being in a pointing hand shape in which one or more fingers are extended and one or more fingers are curled towards the palm. In some embodiments, the portion of the input does not include an end of the input, such as the user ceasing to make the pointing hand shape. In some embodiments, hand 2103d is within the direct selection threshold distance of the indicator 2112 of slider 2108.

In some embodiments, the electronic device 101a detects a portion of an indirect selection input directed to selectable option 2104 with hand 2103b while gaze 2101a is directed to option 2104. In some embodiments, hand 2103b is in a hand shape (e.g., “Hand State B”) included in an indirect selection gesture, such as the hand being in a pinch hand shape in which the thumb is touching another finger of the hand 2103b. In some embodiments, the portion of the indirect selection input does not include completion of the pinch gesture (e.g., the thumb moving away from the finger). In some embodiments, hand 2103b is further than the direct selection threshold distance from the selectable option 2104 while providing the portion of the indirect selection input.

In some embodiments, the electronic device 101a detects a portion of an indirect input directed to indicator 2112 of slider 208 with hand 2103b while gaze 2101b is directed to the slider 2108. In some embodiments, hand 2103b is in a hand shape (e.g., “Hand State B”) included in an indirect selection gesture, such as the hand being in a pinch hand shape in which the thumb is touching another finger of the hand 2103b. In some embodiments, the portion of the indirect input does not include completion of the pinch gesture (e.g., the thumb moving away from the finger). In some embodiments, hand 2103b is further than the direct selection threshold distance from the slider 2112 while providing the portion of the indirect input.

In some embodiments, the electronic device 101a detects a portion of an air gesture selection input directed to selectable option 2104 with hand 2103c while gaze 2101a is directed to option 2104. In some embodiments, hand 2103c is in a hand shape (e.g., “Hand State B”) included in an air gesture selection gesture, such as the hand being in the pointed hand shape within a threshold distance (e.g., 0.1, 0.3, 0.5, 1, 2, or 3 centimeters) of the air gesture element 2114 displayed by device 101. In some embodiments, the portion of the air gesture selection input does not include completion of the selection input (e.g., motion of the hand 2103c away from the viewpoint of the user by an amount corresponding to the visual separation between the selectable option 2104 and the container 2102 while the hand 2103c is within a threshold distance (e.g., 0.1, 0.3, 0.5, 1, 2, or 3 centimeters) of air gesture element 114 such that the motion corresponds to pushing option 2104 to the location of container 2102). In some embodiments, hand 2103c is further than the direct selection threshold distance from the selectable option 2104 while providing the portion of the air gesture selection input.

In some embodiments, the electronic device 101a detects a portion of an air gesture input directed to slider 2108 with hand 2103c while gaze 2101b is directed to slider 2108. In some embodiments, hand 2103c is in a hand shape (e.g., “Hand State B”) included in an air gesture selection gesture, such as the hand being in the pointed hand shape within a threshold distance (e.g., 0.1, 0.3, 0.5, 1, 2, 3, etc. centimeters) of the air gesture element 2114. In some embodiments, the portion of the air gesture input does not include completion of the air gesture input (e.g., movement of the hand 2103c away from air gesture element 2114, the hand 2103c ceasing to make the air gesture hand shape). In some embodiments, hand 2103c is further than the direct selection threshold distance from the slider 2108 while providing the portion of the air gesture input.

In some embodiments, in response to detecting the portion of (e.g., one of) the selection inputs directed to option 2104, the electronic device 101a provides visual feedback to the user that the selection input is directed to option 2104. For example, as shown in FIG. 21B, the electronic device 101a updates the color of option 2104 and increases the visual separation of the option 2104 from the container 2102 in response to detecting a portion of the selection input directed to option 2104. In some embodiments, the electronic device 101a continues to display the container 2102 at the location illustrated in FIG. 21B with visual separation from a location at which the electronic device 101a would display the container 2102 if the gaze 2101a of the user were not directed to a user interface element included in container 2102. In some embodiments, because the selection input is not directed to option 2106, the electronic device 101a maintains display of option 2106 in the same color as the color in which option 2106 was displayed in FIG. 21A prior to detecting the portion of the input directed to option 2104. Also, in some embodiments, the electronic device 101a displays the option 2106 without visual separation from container 2102 because the beginning of the selection input is not directed to option 2106.

In some embodiments, the beginning of the selection input directed to option 2104 corresponds to movement of the option 2104 towards, but not touching, the container 2102. For example, the beginning of the direct input provided by hand 2103a includes motion of the hand 2103a down or in the direction from option 2104 towards container 2102 while the hand is in the pointing hand shape. As another example, the beginning of the air gesture input provided by hand 2103c and gaze 2101a includes motion of the hand 2103c down or in the direction from option 2104 towards container 2102 while the hand is in the pointing hand shape while the hand 2103c is within the threshold distance (e.g., 0.1, 0.3, 0.5, 1, 2, or 3 centimeters) from air gesture element 2114. As another example, the beginning of the indirect selection input provided by hand 2103b and gaze 2101a includes detecting the hand 2103b maintaining the pinch hand shape for a time less than a predetermined time threshold (e.g., 0.1, 0.2, 0.3, 0.5, 1, 2, 3, 5, etc. seconds) that corresponds to motion of option 2104 towards container 2102 by an amount that corresponds to the option 2104 reaching container 2102. In some embodiments, selection of option 2104 occurs when the selection input corresponds to motion of the option 2104 towards container 2102 by an amount where the option 2104 reaches the container 2102. In FIG. 21B, the inputs correspond to partial movement of the option 2104 towards container 2102 by an amount that is less than the amount of visual separation between option 2104 and container 2102.

In some embodiments, in response to detecting the portion of (e.g., one of) the inputs directed to slider 2108, the electronic device 101a provides visual feedback to the user that the input is directed to slider 2108. For example, the electronic device 101a displays the slider 2108 with visual separation from container 2109. Also, in response to detecting the gaze 2101b of the user directed to an element within container 2109, the electronic device 101a updates the position of container 2109 to display container 2109 closer to the viewpoint of the user than the position at which container 2109 was displayed in FIG. 21A prior to detecting the beginning of the input directed to slider 2108. In some embodiments, the portion of the input directed to slider 2108 illustrated in FIG. 21B corresponds to selecting the indicator 2112 of the slider 2108 for adjustment but does not yet include a portion of the input for adjusting the indicator 2112—and, thus, the value controlled by—the slider 2108.

FIG. 21C illustrates an example of the electronic device 101a redirecting a selection input and/or adjusting the indicator 2112 of the slider 2108 in response to detecting movement included in an input. For example, in response to detecting movement of a hand of the user by an amount (e.g., of speed, distance, time) less than a threshold (e.g., a threshold corresponding to a distance from option 2104 to the boundary of container 2102) after providing the portion of the selection input described above with reference to FIG. 21B, the electronic device 101a redirects the selection input from option 2104 to option 2106, as will be described in more detail below. In some embodiments, in response to detecting movement of a hand of a user while providing an input directed to slider 2108, the electronic device 101 updates the indicator 2112 of the slider 2108 in accordance with the movement detected, as will be described in more detail below.

In some embodiments, after detecting a portion of a selection input directed to option 2104 (e.g., via hand 2103a or hand 2103b and gaze 2101c or hand 2103c and gaze 2101c) described above with reference to FIG. 21B, the electronic device 101a detects movement of the hand (e.g., 2103a, 2103b, or 2103c) in a direction from option 2104 towards option 2106. In some embodiments, the amount (e.g., speed, distance, duration) of movement corresponds to less than a distance between the option 2104 and the boundary of container 2102. In some embodiments, the electronic device 101a maps the size of container 2102 to a predetermined amount of movement (e.g., of a hand 2103a, 2103b, or 2103c providing the input) corresponding to a distance from the option 2104 to the boundary of the container 2102. In some embodiments, after detecting the portion of the selection input directed to option 2104 described above with reference to FIG. 21B, the electronic device 101a detects the gaze 2101c of the user directed to option 2106. In some embodiments, for a direct input provided by hand 2103a, in response to detecting the motion of hand 2103a, the electronic device 101a redirects the selection input from option 2104 to option 2106. In some embodiments, for an indirect input provided by hand 2103b, in response to detecting the gaze 2101c of the user directed to option 2106 and/or detecting movement of hand 2103b, the electronic device 101a redirects the selection input from option 2104 to option 2106. In some embodiments, for an air gesture input provided by hand 2103c, in response to detecting the gaze 2101c of the user directed to option 2106 and/or detecting movement of hand 2103c the electronic device 101a redirects the selection input from option 2104 to option 2106.

FIG. 21C illustrates an example of redirecting a selection input between different elements within a respective container 2102 of the user interface. In some embodiments, the electronic device 101a redirects a selection input from one container to another in response to detecting the gaze of the user directed to the other container. For example, if option 2106 were in a different container than the container of option 2104, the selection input would be directed from option 2104 to option 2106 in response to the above-described movement of the hand of the user and the gaze of the user being directed to the container of option 2104 (e.g., the gaze being directed to option 2104).

In some embodiments, if, while detecting the portion of the selection input, the electronic device 101a detects the gaze of the user directed outside of container 2102, it is still possible to redirect the selection input to one of the options 2104 or 2106 within container 2102. For example, in response to detecting the gaze 2101c of the user directed to option 2106 (after being directed away from container 2102), the electronic device 101a redirects an indirect or air gesture input from option 2104 to option 2106 as shown in FIG. 21C. As another example, in response to detecting the movement of hand 2103a described above while detecting the direct selection input, the electronic device 101a redirects the input from option 2104 to option 2106 irrespective of where the user is looking.

In some embodiments, in response to redirecting the selection input from option 2104 to option 2106, the electronic device 101a updates option 2104 to indicate that the selection input is not directed to option 2104 and updates option 2106 to indicate that the selection input is directed to option 2106. In some embodiments, updating option 2104 includes displaying option 2104 in a color that does not correspond to selection (e.g., the same color in which option 2104 was displayed in FIG. 21A prior to detecting the beginning of the selection input) and/or displaying the option 2104 without visual separation from container 2102. In some embodiments, updating option 2106 includes displaying option 2106 in a color that indicates that selection is directed to option 2106 (e.g., different from the color with which option 2106 was displayed in FIG. 21B while the input was directed to option 2104) and/or displaying option 2106 with visual separation from container 2102.

In some embodiments, the amount of visual separation between option 2106 and container 2102 corresponds to an amount of further input needed to cause selection of option 2106, such as additional motion of hand 2103a to provide direct selection, additional motion of hand 2103c to provide air gesture selection, or continuation of the pinch gesture with hand 2103b to provide indirect selection. In some embodiments, the progress of the portion of the selection input provided to option 2104 by hands 2103a, 2103b and/or 2103c before the selection input was redirected away from option 2104 applies towards selection of option 2106 when the selection input is redirected from option 2104 to option 2106, as described in more detail below with reference to method 2200.

In some embodiments, the electronic device 101 redirects the selection input from option 2104 to option 2106 without detecting another initiation of the selection input directed to option 2106. For example, the selection input is redirected without the electronic device 101a detecting the beginning of a selection gesture with one of hands 2103a, 2103b, or 2103c specifically directed to option 2106.

In some embodiments, in response to detecting motion of hand 2103d, 2103b, or 2103c while detecting input directed to slider 2108, the electronic device 101a does not redirect the input. In some embodiments, the electronic device 101a updates the position of the indicator 2112 of the slider 2108 in accordance with the (e.g., speed, distance, duration of the) motion of the hand that is providing the input directed to slider 2108, as shown in FIG. 21C.

FIG. 21D illustrates an example of the electronic device 101a canceling selection of option 2106 in response to further movement of the hand 2103a, 2103b, or 2103c providing the selection input directed to option 2106 and/or the gaze 2101e of the user being directed away from container 2102 and/or option 2106. For example, the electronic device 101a cancels a direct selection input provided by hand 2103a in response to detecting motion of the hand 2103a up or laterally by an amount corresponding to more than the distance between option 2106 and the boundary of the container 2102. As another example, the electronic device 101a cancels an air gesture input provided by hand 2103c in response to detecting motion of the hand 2103c up or laterally by an amount corresponding to more than the distance between option 2106 and the boundary of container 2102 and/or in response to detecting the gaze 2101e of the user directed outside of container 2102 or the gaze 2101d of the user away from option 2106 but within container 2102. In some embodiments, the electronic device 101a does not cancel a direct selection input or an air gesture selection input in response to downward motion of hand 2103a or 2103c, respectively, as downward motion may correspond to user intent to select the option 2106 rather than user intent to cancel the selection. As another example, the electronic device 101a cancels the indirect selection input, in response to detecting movement of hand 2103b up, down, or laterally by an amount corresponding to more than the distance between option 2106 and the boundary of container 2102 and/or in response to detecting the gaze 2101e of the user directed outside of container 2102 or the gaze 2101d of the user away from option 2106 but within container 2102. As described above, in some embodiments, the amount of movement required to cancel the input is mapped to a respective amount of movement of the hand 2103a irrespective of the size of option 2106 and container 2102.

In some embodiments, in response to canceling the selection input directed to option 2106, the electronic device 101a updates display of the option 2106 to indicate that the electronic device 101a is not receiving a selection input directed to option 2106. For example, the electronic device 101a displays option 2106 with a color not corresponding to a selection input (e.g., the same color as the color of option 2106 in FIG. 21A prior to detecting a selection input) and/or displays option 2106 without visual separation from container 2102. In some embodiments, if the gaze 2101d of the user is still directed to container 2102, the electronic device 101a displays container 2102 at the position towards the viewpoint of the user as shown in FIG. 21D. In some embodiments, if the gaze 2101e of the user is directed away from container 2102, the electronic device 101a displays the container 2102 at a position away from the viewpoint of the user (e.g., without a virtual shadow, at a smaller size, with stereoscopic depth information corresponding to a location further from the viewpoint of the user).

In some embodiments, in response to the same amount and/or direction of motion of hand 2103d, 2103b, or 2103c described above as part of an input directed to slider 2108, the electronic device 101a continues to adjust the position of the indicator 2112 of the slider 2108 without canceling the input directed to slider 2108. In some embodiments, the electronic device 101a updates the position of the indicator 2108 of the slider 2108 in accordance with the direction and amount (e.g., speed, distance, duration, etc.) of movement.

In some embodiments, if, instead of detecting a user request to cancel the selection input as shown in FIG. 21D, the electronic device 101a detects continuation of the selection input directed to option 2106, the electronic device 101a selects option 2106. For example, FIG. 21E illustrates the electronic device 101a detecting continuation of the selection input illustrated in FIG. 21C. In some embodiments, the electronic device 101a detects continuation of the direct selection input including detecting further motion of hand 2103a in the direction from option 2106 towards container 2102 by an amount corresponding to at least the amount of visual separation between option 2106 and container 2102 so option 2106 reaches container 2102. In some embodiments, the electronic device 101a detects continuation of the air gesture selection input including further motion of hand 2103c in the direction from option 2106 towards container 2102 by an amount corresponding to at least the amount of visual separation between option 2106 and container 2102 so option 2106 reaches container 2102 while the gaze 2101c of the user is directed to option 2106 while the hand 2103c is within a threshold distance (e.g., 0.1, 0.2, 0.3, 0.5, 1, 2, or 3 centimeters) from the air gesture element 2114. In some embodiments, the electronic device 101a detects continuation of the indirect input including hand 2103b remaining in the pinch hand shape for a time corresponding to option 2106 reaching container 2102 while the gaze 2101c of the user is directed to option 2106. Thus, in some embodiments, the electronic device 101a selects option 2106 in response to continuation of the selection input after redirecting the selection input from option 2104 to option 2106 without detecting an additional initiation of a selection input.

FIGS. 22A-22K is a flowchart illustrating a method 2200 of redirecting an input from one user interface element to another in response to detecting movement included in the input in accordance with some embodiments. In some embodiments, the method 2200 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, a projector, etc.) and one or more cameras (e.g., a camera (e.g., color sensors, infrared sensors, and other depth-sensing cameras) that points downward at a user's hand or a camera that points forward from the user's head). In some embodiments, the method 2200 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 2200 are, optionally, combined and/or the order of some operations is, optionally, changed.

In some embodiments, method 2200 is performed at an electronic device (e.g., 101a) in communication with a display generation component (e.g., 120a) and one or more input devices (e.g., 314a) (e.g., a mobile device (e.g., a tablet, a smartphone, a media player, or a wearable device), or a computer). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc.). In some embodiments, the one or more input devices include an electronic device or component capable of receiving a user input (e.g., capturing a user input, detecting a user input, etc.) and transmitting information associated with the user input to the electronic device. Examples of input devices include a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera, a depth sensor, an eye tracking device, and/or a motion sensor (e.g., a hand tracking device, a hand motion sensor), etc. In some embodiments, the electronic device is in communication with a hand tracking device (e.g., one or more cameras, depth sensors, proximity sensors, touch sensors (e.g., a touch screen, trackpad). In some embodiments, the hand tracking device is a wearable device, such as a smart glove. In some embodiments, the hand tracking device is a handheld input device, such as a remote control or stylus.

In some embodiments, such as in FIG. 21A, the electronic device (e.g., 101a) displays (2202a), via the display generation component (e.g., 120a), a user interface that includes a respective region (e.g., 2102) including a first user interface element (e.g., 2104) and a second user interface element (e.g., 2106). In some embodiments, the respective region is a user interface element such as a container, backplane, or (e.g., application) window. In some embodiments, the first user interface element and second user interface element are selectable user interface elements that, when selected, cause the electronic device to perform an action associated with the selected user interface element. For example, selection of the first and/or second user interface element causes the electronic device to launch an application, open a file, initiate and/or cease playback of content with the electronic device, navigate to a respective user interface, change a setting of the electronic device, initiate communication with a second electronic device or perform another action in response to selection.

In some embodiments, such as in FIG. 21B, while displaying the user interface, the electronic device (e.g., 101a) detects (2202b), via the one or more input devices (e.g., 314a), a first input directed to the first user interface element (e.g., 2104) in the respective region (e.g., 2102). In some embodiments, the first input is one or more inputs that are a subset of a sequence of inputs for causing selection of the first user interface element (e.g., without being the full sequence of inputs for causing selection of the first user interface element). For example, detecting an indirect input that corresponds to an input to select the first user interface element includes detecting, via an eye tracking device in communication with the electronic device, the gaze of the user directed to the first user interface element while detecting, via a hand tracking device, the user perform a pinch gesture in which the thumb of the user touches a finger on the same hand of the thumb, followed by the thumb and the finger moving apart from each other (e.g., such as described with reference to methods 800, 1200, 1400 and/or 1800), the electronic device selects the first user interface element. In this example, detecting the first input (e.g., as an indirect input) corresponds to detecting the gaze of the user directed to the first user interface element while detecting the thumb touch the finger on the hand of the thumb (e.g., without detecting the thumb and finger move away from each other). As another example, detecting a direct input that corresponds to an input to select the first user interface element includes detecting the user “press” the first user interface element by a predetermined distance (e.g., 0.5, 1, 2, 3, 4, 5, or 10 centimeters) with their hand and/or extending finger while the hand is in a pointing hand shape (e.g., a hand shape in which one or more fingers are extended and one or more fingers are curled towards the palm), such as described with reference to methods 800, 1200, 1400 and/or 1800. In this example, detecting the first input (e.g., as a direct input) corresponds to detecting the user “press” the first user interface element by a distance less than the predetermined distance while the hand of the user is in the pointing hand shape (e.g., without detecting continuation of the “press” input to the point that the first user interface element has been pressed by the predetermined distance threshold, and thus being selected). In some embodiments, the first user interface element can alternatively be selected with an indirect input if subsequent to the pinch described above, the device detects movement of the pinch toward the first user interface element (e.g., corresponding to movement to “push” the first user interface element) sufficient to push the first user interface element back by the predetermined distance described above. In such embodiments, the first input is optionally movement of, but insufficient movement of, the hand while holding the pinch hand shape.

In some embodiments, such as in FIG. 21B, in response to detecting the first input directed to the first user interface element (e.g., 2104), the electronic device (e.g., 101a) modifies (2202c) an appearance of the first user interface element (e.g., 2104) to indicate that further input directed to the first user interface element (e.g., 2104) will cause selection of the first user interface element (e.g., 2104). In some embodiments, modifying the appearance of the first user interface element includes displaying the first user interface element with a different color, pattern, text style, translucency, and/or line style than the color, pattern, text style, translucency, and/or line style with which the first user interface element was displayed prior to detecting the first input. In some embodiments, modifying a different visual characteristic of the first user interface element is possible. In some embodiments, the user interface and/or user interface element are displayed in a three-dimensional environment (e.g., the user interface is the three-dimensional environment and/or is displayed within a three-dimensional environment) that is generated, displayed, or otherwise caused to be viewable by the device (e.g., a computer-generated reality (CGR) environment such as a virtual reality (VR) environment, a mixed reality (MR) environment, or an augmented reality (AR) environment, etc. In some embodiments, modifying the appearance of the first user interface element includes updating the position of the first user interface element in the user interface, such as moving the first user interface element away from a viewpoint of the user in the three-dimensional environment (e.g., a vantage point within the three-dimensional environment from which the three-dimensional environment is presented via the display generation component in communication with the electronic device) and/or reducing a separation between the first user interface element and a backplane towards which the first user interface element moves when being “pushed”.

In some embodiments, such as in FIG. 21B, while displaying the first user interface element (e.g., 2104) with the modified appearance (and not yet selected), the electronic device (e.g., 101a) detects (2202d), via the one or more input devices (e.g., 314), a second input (e.g., via hand 2103a, 2103b, or 2103c and/or gaze 2102c in FIG. 21C). In some embodiments, the second input includes movement of a predefined portion of the user (e.g., the user's hand) away from the first user interface element in a predetermined direction (e.g., left, right, up, away from the first user interface element towards the torso of the user). For example, if the first input is the user looking at the first user interface element while touching their thumb to a finger on the hand of the thumb (e.g., without moving the thumb away from the finger) (e.g., the first input is an indirect input), the second input is movement of the hand of the user (e.g., left, right, up, away from the first user interface element towards the torso of the user) while the thumb continues to touch the finger. As another example, if the first input is the user “pressing” the first user interface element with their hand and/or extended finger while the hand is in the pointing hand shape (e.g., the first input is a direct input), the second input is movement of the hand (e.g., left, right, up, away from the first user interface element towards the torso of the user) while maintaining the pointing hand shape or while in a different hand shape.

In some embodiments, such as in FIG. 21C, in response to detecting the second input, in accordance with a determination that the second input includes movement corresponding to movement away from the first user interface element (e.g., 2104) (2202e), in accordance with a determination that the movement corresponds to movement within the respective region (e.g., 2102) of the user interface, the electronic device (e.g., 101a) forgoes (2202f) selection of the first user interface element (e.g., 2104), and modifies an appearance of the second user interface element (e.g., 2106) to indicate that further input directed to the second user interface element (e.g., 2106) will cause selection of the second user interface element 9eg 2106). In some embodiments, the electronic device modifies the appearance of the first user interface element to no longer indicate that further input directed to the first user interface element will cause selection of the first user interface element. For example, the electronic device reverts (e.g., one or more characteristics of) the appearance of the first user interface element to the appearance of the first user interface element prior to detecting the first input. In some embodiments, if the first input is an indirect input, the movement corresponds to movement within the respective region of the user interface if the distance, speed, duration, etc. satisfy one or more criteria (e.g., are less than predetermined threshold values). In some embodiments, if the first input is a direct input, the movement corresponds to movement within the respective region of the user interface if the hand of the user remains within the respective region of the user interface (e.g., or a region of the three-dimensional environment between the boundary of the respective region of the user interface and the viewpoint of the user in the three-dimensional environment) during the movement. In some embodiments, modifying the appearance of the second user interface element includes displaying the second user interface element with a different color, pattern, text style, translucency, and/or line style than the color, pattern, text style, translucency, and/or line style with which the second user interface element was displayed prior to detecting the second input. In some embodiments, modifying a different visual characteristic of the second user interface element is possible. In some embodiments, modifying the appearance of the second user interface element includes updating the position of the second user interface element in the user interface, such as moving the second user interface element away from the viewpoint of the user in the three-dimensional environment. In some embodiments, in response to detecting a third input (e.g., continuation of the sequence of inputs that corresponds to an input to select a user interface element, such as the remainder of the movement that was previously required for selection of the first user interface element) after the second input, the electronic device selects the second user interface element and performs the action associated with the second user interface element. In some embodiments, the electronic device updates the appearance of the second user interface element to indicate that further input directed to the second user interface element will cause selection of the second user interface element without detecting an initiation of a second selection input after detecting the second input. For example, if the first input is an indirect input, the electronic device updates the appearance of the second user interface element without detecting initiation of another pinch gesture (e.g., the user continues to touch their thumb to the other finger rather than moving the thumb away and pinching again). As another example, if the first input is a direct input, the electronic device updates the appearance of the second user interface element without detecting the user move their hand away from the first and second user interface elements (e.g., towards the viewpoint of the user) and pressing their hand towards the second user interface element again. In some embodiments, progress towards selecting the first user interface element is transferred to progress towards selecting the second user interface element when the electronic device updates the appearance of the second user interface element. For example, if the first input is an indirect input and the electronic device selects a respective user interface element if the pinch hand shape in which the thumb and finger are touching is detected for a predetermined time threshold (e.g., 0.1, 0.5, 1, 2, 3, or 5 seconds), the electronic device does not restart counting the time the pinch hand shape was maintained when the electronic device updates the appearance of the second user interface element. As another example, if the first input is a direct input and the electronic device selects a respective user interface element if it is “pushed” by a threshold distance (e.g., 0.5, 1, 2, 3, 5, or 10 centimeters), movement of the hand of the user along the direction between the second user interface element and the view point of the user during the first and second inputs counts towards meeting the threshold distance. In some embodiments, the electronic device resets the criteria for selecting the second user interface element after updating the appearance of the second user interface element. For example, if the first input is an indirect input, the electronic device does not select the second user interface element unless and until the pinch hand shape is maintained for the full threshold time from the time the electronic device updates the appearance of the second user interface element. As another example, if the first input is a direct input, the electronic device does not select the second user interface element unless and until the electronic device detects the user “push” the second user interface element by the threshold distance after the electronic device updates the appearance of the second user interface element.

In some embodiments, such as in FIG. 21D, in response to detecting the second input, in accordance with a determination that the second input includes movement corresponding to movement away from the first user interface element (e.g., 2104) (2202e), in accordance with a determination that the movement corresponds to movement outside of the respective region (e.g., 2102) of the user interface in a first direction, the electronic device (e.g., 120a) forgoes (2202g) selection of the first user interface element (e.g., 2104) without modifying the appearance of the second user interface element (e.g., 2106). In some embodiments, the electronic device modifies the appearance of the first user interface element to no longer indicate that further input directed to the first user interface element will cause selection of the first user interface element. For example, the electronic device reverts (e.g., one or more characteristics of) the appearance of the first user interface element to the appearance of the first user interface element prior to detecting the first input. In some embodiments, if the first input is an indirect input, the movement corresponds to movement outside the respective region of the user interface if the distance, speed, duration, etc. satisfy one or more criteria (e.g., are greater than predetermined threshold values). In some embodiments, if the first input is a direct input, the movement corresponds to movement outside the respective region of the user interface if the hand of the user exits the respective region of the user interface (e.g., or a region of the three-dimensional environment between the boundary of the respective region of the user interface and the viewpoint of the user in the three-dimensional environment) during the movement.

The above-described manner of forgoing selection of the first user interface element in response to detecting the second input provides an efficient way of reducing accidental user inputs, while allowing for modifying the target element of the input, which simplifies the interaction between the user and the electronic device and enhances the operability of the electronic device and makes the user-device interface more efficient, which additionally reduces power usage and improves battery life of the electronic device by enabling the user to use the electronic device more quickly and efficiently, while reducing errors in usage and by reducing the likelihood that the electronic device performs an operation that was not intended and will be subsequently reversed.

In some embodiments, such as in FIG. 21D, in response to detecting the second input, and in accordance with a determination that the movement corresponds to movement outside of the respective region (e.g., 2102) of the user interface in a second direction (e.g., different from the first direction, such as downward) (2204a), in accordance with a determination that the first input includes input provided by a predefined portion (e.g., one or more fingers, a hand, an arm, a head) of a user (e.g., 2103b) while the predefined portion of the user is (e.g., remains) further than a threshold distance (e.g., 5, 10, 15, 20, 30, or 50 centimeters) from a location corresponding to the first user interface element (e.g., 2104) (e.g., the input is an indirect input and the predefined portion of the user is further than the threshold distance from a virtual trackpad or input indication according to method 1800 (or while the electronic device is not displaying a virtual trackpad or input indication according to method 1800)), the electronic device (e.g., 101a) forgoes (2204b) selection of the first user interface element (e.g., 2104). In some embodiments, the movement in the second direction is movement of the predefined portion of the user. In some embodiments, in response to detecting downward movement of the predefined portion of the user, if the second input is an indirect input, the electronic device forgoes selection of the first user interface element. In some embodiments, the electronic device also forgoes selection of the second user interface element and forgoes modifying the appearance of the second user interface element. In some embodiments, the electronic device modifies the appearance of the first user interface element not to indicate that further input will cause selection of the first user interface element. In some embodiments, the electronic device maintains the appearance of the first user interface element to indicate that further input will cause selection of the first user interface element. In some embodiments, in accordance with a determination that the first input includes input provided by the predefined portion of the user while the predefined portion of the user is (e.g., remains) further than the threshold distance from the location corresponding to the first user interface element and the predefined portion of the user is within the threshold distance of a virtual trackpad or input indication according to method 1800, the electronic device selects the first user interface element in accordance with the second input. In some embodiments, in accordance with a determination that the first input includes input provided by the predefined portion of the user while the predefined portion of the user is (e.g., remains) further than the threshold distance from the location corresponding to the first user interface element and the predefined portion of the user is within the threshold distance of a virtual trackpad or input indication according to method 1800, the electronic device forgoes selection of the first user interface element.

In some embodiments, such as in FIG. 21E, in response to detecting the second input, and in accordance with a determination that the movement corresponds to movement outside of the respective region (e.g., 2102) of the user interface in a second direction (e.g., different from the first direction, such as downward) (2204a), in accordance with a determination that the first input includes input provided by the predefined portion of the user (e.g., 2103a) while the predefined portion of the user (e.g., 2103a) is closer than the threshold distance from the location corresponding to the first user interface element (e.g., 2106) (e.g., the input is a direct input), the electronic device (e.g., 101a) selects (2204c) the first user interface element (e.g., 2106) in accordance with the second input. In some embodiments, the electronic device does not select the first user interface element unless and until the second input satisfies one or more criteria. For example, the one or more criteria include a criterion that is satisfied when the predefined portion of the user “pushes” the first user interface element away from the viewpoint of the user (and/or towards a backplane of the first user interface element) by a predefined distance (e.g., 0.5, 1, 2, 3, 4, 5, or 10 centimeters).

The above-described manner of forgoing selection of the first user interface element if the input is detected while the predefined portion of the user is further than the threshold distance from the first user interface element in response to the movement in the second direction and selecting the first user interface element in accordance with the second input if the first input is detected while the predefined portion of the user is closer than the threshold distance from the location corresponding to the first user interface element provides an intuitive way of canceling or not canceling user input depending on the direction of the movement and the distance between the predefined portion of the user and the first user interface element when the input is received, which simplifies the interaction between the user and the electronic device and enhances the operability of the electronic device and makes the user-device interface more efficient, which provides additional control options to the user without cluttering the user interface with additional displayed controls.

In some embodiments, such as in FIG. 21D, the first input includes input provided by a predefined portion (e.g., one or more fingers, a hand, an arm, a head) of a user (e.g., 2103a, 2103b), and selection of the first user interface element (e.g., 2104, 2106) is forgone in accordance with the determination that the movement of the second input corresponds to movement outside of the respective region (e.g., 2102) of the user interface in the first direction (e.g., up, left, or right) irrespective of whether the predefined portion of the user (e.g., 2103a, 2103b) is further than (e.g., for an indirect input or when interacting with a virtual trackpad or input indication according to method 1800) or closer than (e.g., for a direct input) a threshold distance (e.g., 0.5, 1, 2, 3, 5, 10, or 50 centimeters) from a location corresponding to the first user interface element (e.g., 2104, 2106) during the first input (2206). In some embodiments, regardless of whether the first input is a direct input or an indirect input, detecting movement of the second input upwards, to the left, or to the right, causes the electronic device to forgo selection of the first user interface element. In some embodiments, in response to detecting downward movement of the second input, the electronic device forgoes selection of the first user interface element if the first input is an indirect input but does not forgo selection of the first user interface element if the first input is a direct input.

The above-described manner of forgoing selection of the first user interface element in response to the movement in the first direction irrespective of whether the predefined portion of the user is within the threshold distance of the first user interface element during the first input provides an efficient and consistent way of canceling selection of the first user interface element which simplifies the interaction between the user and the electronic device and enhances the operability of the electronic device and makes the user-device interface more efficient, which provides additional control options to the user without cluttering the user interface with additional displayed controls.

In some embodiments, such as in FIG. 21D, while displaying the user interface, the electronic device (e.g., 101a) detects (2208a), via the one or more input devices, a third input directed to a third user interface element (e.g., 2108) in the respective region, wherein the third user interface element (e.g., 2108) is a slider element, and the third input includes a movement portion for controlling the slider element (e.g., 2108). In some embodiments, the slider element includes a plurality of indications of values for a respective characteristic controlled by the slider and an indication of the current value of the slider element that the user is able to move by providing an input directed to the slider element, such as the third input. For example, the slider element controls the value for a characteristic such as a setting of the electronic device, such as playback volume, brightness, or a time threshold for entering a sleep mode if no inputs are received. In some embodiments, the third input includes selection of the (e.g., indication of the current value of the) slider element that causes the electronic device to update the indication of the current value of the slider element in accordance with the movement portion of the third input. In some embodiments, the third input is a direct input that includes detecting the hand of the user make a pinch gesture while the hand is within a predetermined threshold distance (e.g., 0.5, 1, 2, 3, 4, 5, 10, 15, or 30 centimeters) of the slider element followed by movement of the hand while the hand is in the pinch hand shape (e.g., a hand shape in which the thumb is still touching the other finger of the hand). In some embodiments, the third input is an indirect input that includes detecting the hand of the user make the pinch gesture while the gaze of the user is directed at the slider element followed by movement of the hand while the hand is in the pinch hand shape. In some embodiments, the third input includes interaction with a virtual trackpad or input indication according to method 1800 while the gaze of the user is directed to the slider element.

In some embodiments, such as in FIG. 21D, in response to detecting the third input directed to the third user interface element (e.g., 2108), the electronic device (e.g., 101a) modifies (2208b) an appearance of the third user interface element (e.g., 2108) to indicate that further input directed to the third user interface element (e.g., 2108) will cause further control of the third user interface element (e.g., 2108), and updates the third user interface element (e.g., 2108) in accordance with the movement portion of the third input. In some embodiments, modifying the appearance of the third user interface element includes modifying a size, color, or shape of the (e.g., indication of the current value of the) slider element and/or updating the position of the (e.g., indication of the current value of the) slider element to move the (e.g., indication of the current value of the) slider element closer to the viewpoint of the user in the three-dimensional environment. In some embodiments, updating the third user interface element in accordance with the movement portion of the third input includes updating the indication of the current value of the slider element in accordance with a magnitude and/or direction of the movement portion of the third input. For example, in response to upward, downward, rightward, or leftward movement, the electronic device moves the indication of the current value of the slider element up, down, right, or left, respectively. As another example, in response to movement that has a relatively high speed, duration, and/or distance, the electronic device moves the indication of the current value of the slider element by a relatively large amount, and in response to movement that has a relatively low speed, duration, and/or distance, the electronic device moves the indication of the current value of the slider element by a relatively small amount. In some embodiments, movement of the slider is restricted to one axis of movement (e.g., left to right, up to down) and the electronic device only updates the current value of the slider in response to movement along the axis along which the slider is adjustable. For example, in response to rightward movement directed to a slider that is adjustable from left to right, the electronic device adjusts the current value of the slider to the right, but in response to upward movement directed to the slider, the electronic device forgoes updating the current value of the slider (or updates the current value of the slider only in accordance with a leftward or rightward component of the movement).

In some embodiments, such as in FIG. 21D, while displaying the third user interface element (e.g., 2108) with the modified appearance and while the third user interface element (e.g., 2108) is updated in accordance with the movement portion of the third input (e.g., and prior to detecting termination of the third input or a respective input that terminates updating of the third user interface element, such as the release of the hand pinch shape), the electronic device (e.g., 101a) detects (2208c) a fourth input. In some embodiments, the fourth input includes a movement portion.

In some embodiments, such as in FIG. 21D, in response to detecting the fourth input, in accordance with a determination that the fourth input includes movement corresponding to movement away from the third user interface element (2208d) (e.g., in the first direction, in the second direction, in any direction), the electronic device (e.g., 101a) maintains (2208e) the modified appearance of the third user interface element (e.g., 2108) to indicate that further input directed to the third user interface element (e.g., 2108) will cause further control of the third user interface element.

In some embodiments, the movement corresponds to movement outside of the respective region of the user interface based on speed, duration, and/or distance of the movement if the third input is an indirect input or an input associated with a virtual trackpad or input indication according to method 1800. In some embodiments, the movement corresponds to movement outside of the respective region of the user interface if the movement includes moving the hand of the user outside of the respective region of the user interface (e.g., or a three-dimensional volume extruded from the respective region of the user interface towards the viewpoint of the user in the three-dimensional environment) if the third input is a direct input.

In some embodiments, such as in FIG. 21D, in response to detecting the fourth input, in accordance with a determination that the fourth input includes movement corresponding to movement away from the third user interface element (e.g., 2108) (2208d) (e.g., in the first direction, in the second direction, in any direction), the electronic device (e.g., 101a) updates (2208f) the third user interface element (e.g., 2108) in accordance with the movement of the fourth input without regard to whether or not the movement of the fourth input corresponds to movement outside of the respective region (e.g., 2109) of the user interface. In some embodiments, the electronic device updates the (e.g., indication of the current value of the) slider element in accordance with movement of the predefined portion unless and until termination of the third input is detected. For example, termination of the third input includes detecting the user move their thumb away from their finger to stop making the pinch hand shape and/or moving away from a virtual trackpad or input indication according to method 1800. In some embodiments, the electronic device does not cease directing input towards a slider element in response to a movement portion of an input that corresponds to movement outside of the respective region of the user interface.

The above-described manner of updating the slider element in response to the movement corresponding to movement away from the third user interface element outside the respective region of the user interface provides an efficient way of refining the value of the slider element with multiple movement inputs, which simplifies the interaction between the user and the electronic device and enhances the operability of the electronic device and makes the user-device interface more efficient by performing an additional operation when a set of conditions has been met without requiring further user input.

In some embodiments, such as in FIG. 21C, the movement portion of third input includes input provided by a predefined portion (e.g., one or more fingers, hand, arm, head) of a user (e.g., 2103d, 2103b, 2103c) that has a respective magnitude (2210a).

In some embodiments, such as in FIG. 21C, updating the third user interface element (e.g., 2108) in accordance with the movement portion of the third input includes (2210b), in accordance with a determination that the predefined portion of the user (e.g., 2103d, 2103b, 2103c) moved at a first speed during the movement portion of the third input, updating (2210c) the third user interface element (e.g., 2108) by a first amount determined based on the first speed of the predefined portion of the user (e.g., 2103d, 2103b, 2103c) and the respective magnitude of the movement portion of the third input.

In some embodiments, such as in FIG. 21D, updating the third user interface element (e.g., 2108) in accordance with the movement portion of the third input includes (2210b), in accordance with a determination that the predefined portion of the user (e.g., 2103d, 2103b, 2103c) moved at a second speed, greater than the first speed, during the movement portion of the third input, updating (2210d) the third user interface element (e.g., 2108) by a second amount, greater than the first amount, determined based on the second speed of the predefined portion of the user (e.g., 2103b, 2103c, 2103d) and the respective magnitude of the movement portion of the third input, wherein for the respective magnitude of the movement portion of the third input, the second amount of movement of the third user interface element (e.g., 2108) is greater than the first amount of movement of the third user interface element (e.g., 2108). In some embodiments, in response to detecting movement of the predefined portion of the user at a relatively high speed, the electronic device moves the indication of the current value of the slider element by a relatively high amount for a given distance of movement of the predefined portion of the user. In some embodiments, in response to detecting movement of the predefined portion of the user at a relatively low speed, the electronic device moves the indication of the current value of the slider element by a relatively low amount for the given distance of movement of the predefined portion of the user. In some embodiments, if the speed of the movement changes over time as the movement is detected, the electronic device similarly changes the magnitude of movement of the indication of the current value of the slider element as the movement input is received.

The above-described manner of updating the slider element by an amount corresponding to speed of movement of the predefined portion of the user provides an efficient way of quickly updating the slider element by relatively large amounts and accurately updating the slider element by relatively small amounts, which simplifies the interaction between the user and the electronic device and enhances the operability of the electronic device and makes the user-device interface more efficient, by providing additional functionality to the user without cluttering the user interface with additional controls.

In some embodiments, such as in FIG. 21D, the movement of the second input is provided by respective movement of a predefined portion (e.g., one or more fingers, a hand, an arm, a head) of a user (e.g., 2103a, 2103b, 2103c) (2212a).

In some embodiments, such as in FIG. 21D, in accordance with a determination that the respective region (e.g., 2102) of the user interface has a first size, the movement of the second input corresponds to movement outside of the respective region (e.g., 2102) of the user interface in accordance with a determination that the respective movement of the predefined portion of the user has a first magnitude (2212b). In some embodiments, the magnitude of the movement of the second input depends on the speed, distance, and duration of the movement portion of the second input. For example, relatively high speed, distance, and/or duration contribute to a relatively high magnitude of movement for the movement portion of the second input and relatively low speed, distance, and/or duration contribute to a relatively low magnitude of movement for the movement portion of the second input.

In some embodiments, in accordance with a determination that the respective region of the user interface has a second size, different from the first size (e.g., if container 2102 in FIG. 21D had a different size than the size illustrated in FIG. 21D), the movement of the second input corresponds to movement outside of the respective region (e.g., 2102) of the user interface in accordance with the determination that the respective movement of the predefined portion of the user (e.g., 2103a, 2103b, 2103c) has the first magnitude (2212c). In some embodiments, the magnitude of the movement portion of the second input corresponds or does not correspond to movement outside of the respective region of the user interface irrespective of the size of the respective region of the user interface. In some embodiments, the electronic device maps movement by the predefined portion of the user of a respective magnitude to movement corresponding to movement outside of a respective region of the user interface irrespective of the size of the respective region of the user interface.

The above-described manner of the magnitude of the movement portion of the second input corresponding or not corresponding to movement outside of the respective region irrespective of the size of the respective region provides a consistent way of canceling or not canceling inputs directed to elements in the respective region of the user interface, which simplifies the interaction between the user and the electronic device and enhances the operability of the electronic device and makes the user-device interface more efficient, which provides additional control options to the user without cluttering the user interface with additional displayed controls.

In some embodiments, such as in FIG. 21B, detecting the first input includes detecting (e.g., via an eye tracking device of the one or more input devices in communication with the electronic device) that a gaze (e.g., 2101a) of a user of the electronic device (e.g., 101a) is directed to the first user interface element (e.g., 2104) (2214a). In some embodiments, the first input includes the gaze of the user of the electronic device directed to the first user interface element if the first input is an indirect input or an input involving a virtual trackpad or input indicator according to method 1800. In some embodiments, if the first input is a direct input, the first input does not include the gaze of the user directed to the first user interface element when the first input is detected (e.g., but the first user interface element is in the attention zone according to method 1000).

In some embodiments, such as in FIG. 21C, detecting the second input includes detecting the movement corresponding to movement away from the first user interface element (e.g., 2104) and that the gaze (e.g., 2101c) of the user is no longer directed to the first user interface element (e.g., 2104) (2214b). In some embodiments, the second input is detected while the gaze of the user is directed to the first user interface element. In some embodiments, the second input is detected while the gaze of the user is directed to the second user interface element. In some embodiments, the second input is detected while the gaze of the user is directed to the respective region of the user interface (e.g., other than the first user interface element). In some embodiments, the second input is detected while the gaze of the user is directed to a location in the user interface other than the respective region of the user interface.

In some embodiments, such as in FIG. 21C, forgoing the selection of the first user interface element (e.g., 2104) and modifying the appearance of the second user interface element (e.g., 2106) to indicate that further input directed to the second user interface element (e.g., 2106) will cause selection of the second user interface element are performed while the gaze (e.g., 2101c) of the user is not directed to the first user interface element (e.g., 2106) (2214c). In some embodiments, the electronic device forgoes selection of the first user interface element and modifies the appearance of the second user interface element while the gaze of the user is directed to the first user interface element. In some embodiments, the electronic device forgoes selection of the first user interface element and modifies the appearance of the second user interface element while the gaze of the user is directed to the second user interface element. In some embodiments, the electronic device forgoes selection of the first user interface element and modifies the appearance of the second user interface element while the gaze of the user is directed to the respective region of the user interface (e.g., other than the first user interface element). In some embodiments, the electronic device forgoes selection of the first user interface element and modifies the appearance of the second user interface element while the gaze of the user is directed to a location in the user interface other than the respective region of the user interface. In some embodiments, in accordance with a determination that the gaze of the user is not directed to the first user interface element when the first input is initially detected, the electronic device forgoes updating the first user interface element to indicate that further input will cause selection of the first user interface element (e.g., the first user interface element previously had input focus, but loses input focus when the gaze of the user moves away from the first user interface element). In some embodiments, the electronic device directs further input to the second user interface element in response to the movement of the second input within the respective region of the user interface even if the gaze of the user is not directed to the first user interface element while the second input is received.

The above-described manner of forgoing selection of the first user interface element and modifying the appearance of the second user interface element while the gaze of the user is away from the first user interface element provides an efficient way of redirecting the first input while looking away from the first user interface element (e.g., while looking at a different user interface element to which to direct a respective input) which simplifies the interaction between the user and the electronic device and enhances the operability of the electronic device and makes the user-device interface more efficient, which provides additional control options to the user without cluttering the user interface with additional displayed controls.

In some embodiments, such as in FIG. 21B, detecting the first input includes detecting (e.g., via an eye tracking device of one of the one or more input devices in communication with the electronic device) that a gaze (e.g., 2101a) of a user of the electronic device (e.g., 101a) is directed to the respective region (e.g., 2102) of the user interface (2216a). In some embodiments, the first input includes the gaze of the user of the electronic device directed to the respective region of the user interface if the first input is an indirect input or an input involving a virtual trackpad or input indicator according to method 1800. In some embodiments, if the first input is a direct input, the first input does not include the gaze of the user directed to the respective region of the user interface when the first input is detected (e.g., but the respective region of the user interface is in the attention zone according to method 1000).

In some embodiments, such as in FIG. 21B, while displaying the first user interface element (e.g., 2104) with the modified appearance and before detecting the second input, the electronic device (e.g., 101a) detects (2216b), via the one or more input devices, that the gaze (e.g., 2101b) of the user is directed to (e.g., a third user interface element in) a second region (e.g., 2109), different from the respective region (e.g., 2102), of the user interface. In some embodiments, the second region of the user interface includes one or more third user interface elements. In some embodiments, the second region of the user interface is container, backplane, or (e.g., application) window.

In some embodiments, such as in FIG. 21B, in response to detecting that the gaze (e.g., 2101b) of the user is directed to (e.g., a third user interface element in) the second region (e.g., 2109), in accordance with a determination that the second region (e.g., 2109) includes a third (e.g., selectable, interactive, etc.) user interface element (e.g., 2108), the electronic device (e.g., 101a) modifies (2216c) an appearance of the third user interface element (e.g., 2108) to indicate that further input directed to the third user interface element (e.g., 2108) will cause interaction with the third user interface element (e.g., 2108) (e.g., directing the input focus to the second region and/or the third user interface element). In some embodiments, modifying the appearance of the third user interface element includes displaying the third user interface element with a different color, pattern, text style, translucency, and/or line style than the color, pattern, text style, translucency, and/or line style with which the third user interface element was displayed prior to detecting the gaze of the user directed to the second region. In some embodiments, modifying a different visual characteristic of the third user interface element is possible. In some embodiments, modifying the appearance of the third user interface element includes updating the position of the third user interface element in the user interface, such as moving the third user interface element towards or away from the viewpoint of the user in the three-dimensional environment. In some embodiments, the electronic device further updates the appearance of the first user interface element to no longer indicate that further input will cause selection of the first user interface element and forgoes selection of the first user interface element. In some embodiments, if the second region does not include any selectable and/or interactive user interface elements, the electronic device maintains the updated appearance of the first user interface element to indicate that further input will cause selection of the first user interface element.

The above-described manner of modifying the appearance of the third user interface element to indicate that further input will cause selection of the third user interface element in response to detecting the gaze of the user directed to the second region provides an efficient way of redirecting selection input from one element to another even when the elements are in different regions of the user interface, which simplifies the interaction between the user and the electronic device and enhances the operability of the electronic device and makes the user-device interface more efficient, which provides additional control options to the user without cluttering the user interface with additional displayed controls.

In some embodiments, such as in FIG. 21B, the first input includes movement of a predefined portion (e.g., one or more fingers, hand, arm, eye, head) of a user (e.g., 2103a, 2103b, 2103c) of the electronic device (e.g., 101a) in space in an environment of the electronic device (e.g., 101a) without the predefined portion of the user (e.g., 2103a, 2103b, 2103c) coming into contact with a physical input device (e.g., a trackpad, a touch screen, etc.) (2218). In some embodiments, the electronic device detects the first input using one or more of an eye tracking device that tracks the user's gaze without being in physical contact with the user, a hand tracking device that tracks the user's hand(s) without being in physical contact with the user, and/or a head tracking device that tracks the user's head without being in physical contact with the user. In some embodiments, the input device used to detect the first input includes one or more cameras, range sensors, etc. In some embodiments, the input device is incorporated into a device housing that is in contact with the user of the electronic device while the first user input is received, but the orientation of the housing with respect to the portion of the user in contact with the housing does not impact detecting of the first input. For example, the eye tracking device, hand tracking device, and/or head tracking device are incorporated into a head-mounted electronic device.

The above-described manner of detecting the first input without the predefined portion of the user being in contact with a physical input device provides an efficient way of detecting inputs without the user having to manipulate a physical input device, which simplifies the interaction between the user and the electronic device and enhances the operability of the electronic device and makes the user-device interface more efficient, which provides additional control options to the user without cluttering the user interface with additional displayed controls.

In some embodiments, such as in FIG. 21B, the first input includes a pinch gesture performed by a hand of a user (e.g., 2103a, 2103b) of the electronic device (e.g., 101a) (2220). In some embodiments, the electronic device detects the pinch gesture using a hand tracking device in communication with the electronic device. In some embodiments, detecting the pinch gesture includes detecting the user touch their thumb to another finger on the same hand as the thumb. In some embodiments, detecting the pinch gesture of the first input further includes detecting the user move the thumb away from the finger. In some embodiments, the first does not include detecting the user move the thumb away from the finger (e.g., the pinch hand shape is maintained at the end of the first input).

The above-described manner of the first input including a pinch gesture performed by the hand of the user provides an efficient way of detecting inputs without the user having to manipulate a physical input device, which simplifies the interaction between the user and the electronic device and enhances the operability of the electronic device and makes the user-device interface more efficient, which provides additional control options to the user without cluttering the user interface with additional displayed controls.

In some embodiments, such as in FIG. 21B, the first input includes movement, through space in an environment of the electronic device (e.g., 101a), of a finger of a hand of a user (e.g., 2103a, 2103b, 2103c) of the electronic device (e.g., 101a) (2222). In some embodiments, the electronic device detects the finger of the hand of the user via a hand tracking device in communication with the electronic device. In some embodiments, the first input includes detecting the finger move through space in the environment of the electronic device while the hand is in a pointing hand shape in which the finger is extended away from the user's torso and/or palm of the hand, and one or more other fingers are curled towards the palm of the user's hand. In some embodiments, the movement of the finger is in a direction from the viewpoint of the user towards the first user interface element. In some embodiments, the movement of the finger is movement caused by movement of the hand of the user that includes the finger. In some embodiments, the movement of the finger is independent of movement from the rest of the hand. For example, the movement of the finger is movement hinging at the knuckle joint of the hand. In some embodiments, the palm of the user is substantially stationary while the finger moves.

The above-described manner of the first input including movement of the finger of the hand of the user provides an efficient way of detecting inputs without the user having to manipulate a physical input device, which simplifies the interaction between the user and the electronic device and enhances the operability of the electronic device and makes the user-device interface more efficient, which provides additional control options to the user without cluttering the user interface with additional displayed controls.

In some embodiments, such as in FIG. 21C, in response to detecting the second input, in accordance with the determination that the second input includes movement corresponding to movement away from the first user interface element (e.g., 2104), in accordance with the determination that the movement corresponds to movement within the respective region (e.g., 2102) of the user interface, the electronic device (e.g., 101a) modifies (2224) the appearance of the first user interface element (e.g., 2104) to indicate that further input will no longer be directed to the first user interface element (e.g., 2104) (e.g., the first user interface element no longer has input focus). In some embodiments, the electronic device modifies the appearance of the first user interface element to indicate that further input will no longer be directed to the first user interface element because further input will be directed to the second user interface element. In some embodiments, the electronic device modifies one or more characteristics of the appearance of the first user interface element to be the same as one or more characteristics of the appearance of the first user interface element prior to detecting the first input. For example, prior to detecting the first input, the electronic device displays the first user interface element in a first color and/or separated from the respective region of the user interface by a respective distance (e.g., 1, 2, 3, 5, 10, 15, 20, or 30 centimeters). In this example, while detecting the first input, the electronic device displays the first user interface element in a second color, separated from the respective region of the user interface by a distance that is less than the respective distance. In this example, in response to detecting the second input, the electronic device displays the first user interface element in the first color, separated from the respective region of the user interface by the respective distance. In some embodiments, in response to the second input, the electronic device displays the first user interface element in the first color without being separated from the respective region of the user interface.

The above-described manner of modifying the appearance of the first user interface element to indicate that further input will no longer be directed to the first user interface element provides an efficient way of indicating to the user which user interface element has the input focus of the electronic device, which simplifies the interaction between the user and the electronic device and enhances the operability of the electronic device and makes the user-device interface more efficient, and provides enhanced visual feedback to the user.

In some embodiments, such as in FIGS. 21C-21D, in accordance with a determination that the second input is provided by a predefined portion (e.g., one or more fingers, a hand, an arm, a head) of a user (e.g., 2103b, 2103c) of the electronic device while the predefined portion of the user is further than a threshold distance (e.g., 1, 2, 3, 5, 10, 15, 30, or 50 centimeters) from a location corresponding to the respective region (e.g., 2102) (e.g., the second input is an indirect input and/or an input involving a virtual trackpad or input indication according to method 1800) (2226a), the movement of the second input corresponds to movement within the respective region (e.g., 2102) of the user interface when the second input satisfies one or more first criteria, such as in FIG. 21C, and the movement of the second input corresponds to movement outside of the respective region (e.g., 2102) of the user interface when the second input does not satisfy the one or more first criteria (2226b), such as in FIG. 21D. In some embodiments, the one or more first criteria are based on the speed, duration, and/or distance of the movement of the second input. In some embodiments, the electronic device translates the movement to a corresponding movement magnitude based on the speed, duration, and/or distance of the movement of the second input. For example, relatively high movement speed, duration, and/or distance corresponds to a relatively large movement magnitude whereas relatively low movement speed, duration, and/or distance corresponds to a relatively small movement magnitude. In some embodiments, the electronic device compares the movement magnitude to a predetermined threshold distance (e.g., a predetermined distance independent of the size of the respective region of the user interface, a distance equal to a dimension (e.g., width, height) of the respective region of the user interface). In some embodiments, the one or more first criteria are satisfied when the movement magnitude exceeds the predetermined threshold distance.

In some embodiments, such as in FIGS. 21C-21D, in accordance with a determination that the second input is provided by a predefined portion (e.g., one or more fingers, a hand, an arm, a head) of a user (e.g., 2103a) of the electronic device (e.g., 101a) while the predefined portion of the user (e.g., 2103a) is further than a threshold distance (e.g., 1, 2, 3, 5, 10, 15, 30, or 50 centimeters) from a location corresponding to the respective region (e.g., 2102) (e.g., the second input is an indirect input and/or an input involving a virtual trackpad or input indication according to method 1800) (2226a), in accordance with a determination that the second input is provided by the predefined portion of the user (e.g., 2103a) of the electronic device (e.g., 101a) while the predefined portion of the user (e.g., 2103a) is closer than the threshold distance from the location corresponding to the respective region (e.g., 2102) (e.g., the second input is a direct input), the movement of the second input corresponds to movement within the respective region (e.g., 2102) of the user interface when the second input satisfies one or more second criteria, different from the first criteria, such as in FIG. 21C, and the movement of the second input corresponds to movement outside of the respective region (e.g., 2102) of the user interface when the second input does not satisfy the one or more second criteria (2226c), such as in FIG. 21D. In some embodiments, the one or more second criteria are satisfied when the predefined portion of the user moves from a location within (e.g., a three-dimensional volume extruded from) the respective region of the user interface to a location outside of (e.g., a three-dimensional volume extruded from) the respective region of the user interface. In some embodiments, the one or more second criteria are based on the distance of the movement of the second input without being based on the speed or duration of the movement of the second input. In some embodiments, the electronic device determines whether the movement of the second input corresponds to movement within the respective region based on the speed, duration, and/or distance if the second input is an indirect input or based on the location of the predefined portion of the user in the three-dimensional environment during the second input if the second input is a direct input.

The above-described manner of applying different criteria to determine whether the movement of the second input corresponds to movement outside of the respective region of the user interface depending on the distance between the predefined portion of the user and the location corresponding to the respective region of the user interface provides an intuitive way of canceling or not canceling the input directed to the first user interface element for a variety of input types, which simplifies the interaction between the user and the electronic device and enhances the operability of the electronic device and makes the user-device interface more efficient, which provides additional control options to the user without cluttering the user interface with additional displayed controls.

In some embodiments, such as in FIG. 21B, modifying the appearance of the first user interface element (e.g., 2104) to indicate that further input directed to the first user interface element (e.g., 2104) will cause selection of the first user interface element (e.g., 2104) includes moving the first user interface element away from the viewpoint of the user in the three-dimensional environment (2228a). In some embodiments, the electronic device displays the first user interface element without being separated from the respective region of the user interface unless and until detecting the gaze of the user directed to the respective region of the user interface and/or a respective hand shape of the hand of the user (e.g., a pre-pinch hand shape in which a thumb of the user is within a threshold distance (e.g., 0.1, 0.2, 0.3, 0.5, 1, 2, 3, 4, or 5 centimeters) of another finger of the hand of the user, or a pointing hand shape in which one or more fingers are extended and one or more fingers are curled towards the palm of the hand). In some embodiments, in response to detecting the gaze of the user directed to the respective region of the user interface and/or the respective hand shape of the hand of the user, the electronic device displays the first user interface element (e.g., and second user interface element) separated from the respective region of the user interface by one or more of moving the first user interface element (e.g., and the second user interface element) towards the viewpoint of the user and/or moving the respective region of the user interface away from the user. In some embodiments, in response to detecting a selection input (e.g., the first input) directed to the first user interface element, the electronic device moves the first user interface element away from the viewpoint of the user (e.g., and towards the respective region of the user interface).

In some embodiments, such as in FIG. 21C, modifying the appearance of the second user interface element (e.g., 2106) to indicate that further input directed to the second user interface element (e.g., 2106) will cause selection of the second user interface element (e.g., 2106) includes moving the second user interface element (e.g., 2106) away from the viewpoint of the user in the three-dimensional environment (2228b). In some embodiments, the electronic device displays the second user interface element without being separated from the respective region of the user interface unless and until detecting the gaze of the user directed to the respective region of the user interface and/or a respective hand shape of the hand of the user (e.g., a pre-pinch hand shape in which a thumb of the user is within a threshold distance (e.g., 0.1, 0.2, 0.3, 0.5, 1, 2, 3, 4, or 5 centimeters) of another finger of the hand of the user, or a pointing hand shape in which one or more fingers are extended and one or more fingers are curled towards the palm of the hand). In some embodiments, in response to detecting the gaze of the user directed to the respective region of the user interface and/or the respective hand shape of the hand of the user, the electronic device displays the second user interface element (e.g., and first user interface element) separated from the respective region of the user interface by one or more of moving the second user interface element (e.g., and the first user interface element) towards the viewpoint of the user and/or moving the respective region of the user interface away from the user. In some embodiments, in response to detecting a selection input directed to the second user interface element (e.g., the second input), the electronic device moves the second user interface element away from the viewpoint of the user (e.g., and towards the respective region of the user interface).

The above-described manner of moving the first or second user interface element away from the viewpoint of the user to indicate that further input directed to the first or second user interface element will cause selection of the first or second user interface element provides an efficient way of indicating the progress towards selecting the first or second user interface element which simplifies the interaction between the user and the electronic device and enhances the operability of the electronic device and makes the user-device interface more efficient, and provides enhanced visual feedback to the user.

In some embodiments, while displaying the second user interface element (e.g., 2106) with the modified appearance to indicate that further input directed to the second user interface element (e.g., 2106) will cause selection of the second user interface element (e.g., 2106) (e.g., in response to the second input), such as in FIG. 21C, the electronic device (e.g., 101a) detects (2230a), via the one or more input devices, a third input, such as in FIG. 21E. In some embodiments, the third input is a selection input, such as a direct selection input, an indirect selection input, or an input involving interaction with a virtual trackpad or input indication according to method 1800.

In some embodiments, such as in FIG. 21E, in response to detecting the third input, in accordance with a determination that the third input corresponds to further (e.g., selection) input directed to the second user interface element (e.g., 2106), the electronic device (e.g., 101a) selects (2230b) the second user interface element (e.g., 2106) in accordance with the third input. In some embodiments, the third input is a continuation of the first input. For example, if the first input is a portion of a direct selection input including detecting the hand of the user “push” the first option towards the respective region of the user interface, the third input is further movement of the hand of the user towards the respective region of the user interface directed towards the second user interface element (e.g., “pushing” the second user interface element towards the respective user interface element). As another example, if the first input is a portion of an indirect selection input including detecting the hand of the user make a pinch gesture and maintain the pinch hand shape, the third input is a continuation of maintaining the pinch hand shape. As another example, if the first input is a portion of an indirect selection input including detecting the hand of the user move towards the first user interface element while in a pinch hand shape, the third input is a continuation of the movement (e.g., towards the second user interface element) while the hand maintains the pinch hand shape. In some embodiments, selecting the second user interface element includes performing an action associated with the second user interface element, such as launching an application, opening a file, initiating and/or ceasing playback of content with the electronic device, navigating to a respective user interface, changing a setting of the electronic device, or initiating communication with a second electronic device.

The above-described manner of selecting the second user interface element in response to the third input detected after the second input provides an efficient way of selecting the second user interface element after moving the input focus from the first user interface element to the second user interface element which simplifies the interaction between the user and the electronic device and enhances the operability of the electronic device and makes the user-device interface more efficient, which provides additional control options to the user without cluttering the user interface with additional displayed controls.

In some embodiments, such as in FIG. 21A, before detecting the first input, selection of the first user interface element (e.g., 2104) requires an input associated with a first magnitude (2232a) (e.g., of time, distance, intensity, etc.). In some embodiments, selection of the first user interface element in response to a direct selection input requires detecting movement of the finger and/or hand of the user (e.g., while the hand of the user is in the pointing hand shape) by a predetermined distance (e.g., 0.5, 1, 2, 3, 4, 5, or 10 centimeters) magnitude, such as a distance between the first user interface element and the respective region of the user interface. In some embodiments, selection of the first user interface element in response to an indirect selection input requires detecting the user maintain a pinch hand shape after performing the pinch gesture for a predetermined time (e.g., 0.1, 0.2, 0.3, 0.5, 1, 2, 3, 4, 5, or 10 seconds) magnitude. In some embodiments, selection of the first user interface element in response to an indirect selection input requires detecting the user move their hand a predetermined distance (e.g., 0.5, 1, 2, 3, 5, or 10 centimeters) towards the first user interface element while in a pinch hand shape.

In some embodiments, such as in FIG. 2104, the first input includes input of a second magnitude, less than the first magnitude (2232b). In some embodiments, if the first input is a direct input, the movement of the hand is less than the predetermined distance magnitude. In some embodiments, if the first input is an indirect input, the hand maintains the pinch hand shape for less than the predetermined time magnitude. In some embodiments, if the first input is an indirect input, the hand moves less than the predetermined distance magnitude towards the first user interface element while in the pinch hand shape.

In some embodiments, such as in FIG. 21A, before detecting the second input, selection of the second user interface element (e.g., 2106) requires an input associated with a third magnitude (e.g., of time, distance, intensity, etc.) (2232c). In some embodiments, the third magnitude is the magnitude of movement that would be required to select the second user interface element with a respective selection input. In some embodiments, the third magnitude is the same as the first magnitude. In some embodiments, the first and third magnitudes are different.

In some embodiments, such as in FIG. 21C, in response to detecting the second input, selection of the second user interface element (e.g., 2106) requires further input associated with the third magnitude less the second magnitude of the first input (2232d). For example, if selection of the second user interface element by an indirect input requires maintaining the pinch hand shape for 1 second and the first input includes maintaining the pinch hand shape for 0.3 seconds, the electronic device selects the second user interface element in response to detecting the pinch hand shape being maintained for an additional 0.7 seconds (e.g., after detecting the first and/or second inputs). In some embodiments, the second input is associated with a respective magnitude and selection of the second user interface element requires further input associated with the third magnitude less the sum of the second magnitude of the first input and the respective magnitude of the second input. For example, if selection of the second user interface element by direct input requires movement of the hand of the user by 2 centimeters away from the viewpoint of the user (e.g., towards the second user interface element) and the first input includes movement by 0.5 centimeters away from the viewpoint of the user (e.g., towards the first user interface element) and the second input includes movement by 0.3 centimeters away from the viewpoint of the user (e.g., towards the second user interface element), the further input requires 1.2 centimeters of movement away from the viewpoint of the user (e.g., towards the second user interface element).

The above-described manner of requiring the further input to have the magnitude of the third magnitude less the second magnitude provides an efficient way of quickly selecting the second user interface element after detecting the second input, which provides additional control options to the user without cluttering the user interface with additional displayed controls.

In some embodiments, such as in FIG. 21B, the first input includes a selection initiation portion followed by a second portion, and the appearance of the first user interface element (e.g., 2104) is modified to indicate that further input directed to the first user interface element (e.g., 2104) will cause selection of the first user interface element (e.g., 2104) in accordance with the first input including the selection initiation portion (2234a). In some embodiments, if the first input is an indirect selection input, detecting the initiation portion of the first input includes detecting a pinch gesture performed by a hand of the user and detecting the second portion of the first input includes detecting the user maintain a pinch hand shape and/or moving the hand while maintaining the pinch hand shape. In some embodiments, if the first input is a direct selection input, detecting the initiation portion of the first input includes detecting the user move their hand from a location between the first user interface element and the viewpoint of the user (e.g., while making the pointing hand shape) to the location corresponding to the first user interface element in the three-dimensional environment (e.g., while making the pointing hand shape). In some embodiments, if the first input is an input involving a virtual trackpad or input indication according to method 1800, the detecting the initiation portion includes detecting the user move a finger to the location of the virtual trackpad and/or input indication and detecting the second portion includes detecting the user continue to move their finger through the virtual trackpad or input indication (e.g., towards the first user interface element and/or away from the viewpoint of the user).

In some embodiments, such as in FIG. 21C, the appearance of the second user interface element (e.g., 2106) is modified to indicate that further input directed to the second user interface element (e.g., 2106) will cause selection of the second user interface element (e.g., 2106) without the electronic device (e.g., 101a) detecting another selection initiation portion after the selection initiation portion included in the first input (2234b). In some embodiments, the appearance of the second user interface element is modified in response to detecting the second input (e.g., after detecting the first input, including the initiation portion of the first input) without detecting a subsequent initiation portion of a selection input.

In some embodiments, such as in FIG. 21B, while displaying the second user interface element (e.g., 2106) without the modified appearance (e.g., prior to detecting the first and second inputs, or after ceasing to display the second user interface element with the modified appearance after detecting the first and second inputs), the electronic device (e.g., 101a) detects (2234c), via the one or more input devices, a third input directed to the second user interface element (e.g., 2106).

In some embodiments, such as in FIG. 21C, in response to detecting the third input (2234d), in accordance with a determination that the third input includes the selection initiation portion (e.g., the third input is a selection input), the electronic device (e.g., 101a) modifies (2234e) the appearance of the second user interface element (e.g., 2106) to indicate that further input directed to the second user interface element (e.g., 2106) will cause selection of the second user interface element. In some embodiments, the electronic device modifies the appearance of the second user interface element to indicate that further input will cause selection of the second user interface element in response to detecting the initiation portion of a selection input.

In some embodiments, such as in FIG. 21A, in response to detecting the third input (2234d), in accordance with a determination that the third input does not include the selection initiation portion (e.g., the third input is not a selection input or includes the second portion of a selection input but not the initiation portion of the selection input), the electronic device (e.g., 101a) forgoes (2234f) modifying the appearance of the second user interface element (e.g., 2106). In some embodiments, unless the electronic device detects the initiation portion of a selection input (e.g., before receiving the second portion of the selection input or before receiving the second portion of the input (e.g., the first input) followed by movement within the respective region of the user interface (e.g., of the second input)), the electronic device does not modify the appearance of the second user interface element to indicate that further input will cause selection of the second user interface element.

The above-described manner of modifying the appearance of the second user interface element to indicate that further input will cause selection of the second user interface element without detecting an additional initiation portion after detecting the initiation portion of the first input provides an efficient way of redirecting a selection input (e.g., from the first user interface element to the second user interface element) without starting the selection input over from the start, which simplifies the interaction between the user and the electronic device and enhances the operability of the electronic device and makes the user-device interface more efficient, which provides additional control options to the user without cluttering the user interface with additional displayed controls.

In some embodiments, aspects/operations of methods 800, 1000, 1200, 1400, 1600, 1800, 2000 and/or 2200 may be interchanged, substituted, and/or added between these methods. For example, the three-dimensional environments of methods 800, 1000, 1200, 1400, 1600, 1800, 2000, and/or 2200, the direct inputs in methods 800, 1000, 1400, 1600, 2000 and/or 2200, the indirect inputs in methods 800, 1000, 1200, 1400, 1600, 2000 and/or 2200, and/or the air gesture inputs in methods 1800, 2000 and/or 2200 are optionally interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method comprising:
at an electronic device in communication with a display generation component and one or more input devices:
displaying, via the display generation component, a user interface that includes a user interface element;
while displaying the user interface element, detecting, via the one or more input devices, an input from a predefined portion of a user of the electronic device; and
in response to detecting the input from the predefined portion of the user of the electronic device:
in accordance with a determination that a pose of the predefined portion of the user prior to detecting the input satisfies one or more criteria, performing a respective operation in accordance with the input from the predefined portion of the user of the electronic device; and
in accordance with a determination that the pose of the predefined portion of the user prior to detecting the input does not satisfy the one or more criteria, forgoing performing the respective operation in accordance with the input from the predefined portion of the user of the electronic device.

2. The method of claim 1, further comprising:
while the pose of the predefined portion of the user does not satisfy the one or more criteria, displaying the user interface element with a visual characteristic having a first value and displaying a second user interface element included in the user interface with the visual characteristic having a second value; and
while the pose of the predefined portion of the user satisfies the one or more criteria, updating the visual characteristic of a user interface element toward which an input focus is directed, including:
in accordance with a determination that that an input focus is directed to the user interface element, updating the user interface element to be displayed with the visual characteristic having a third value; and
in accordance with a determination that the input focus is directed to the second user interface element, updating the second user interface element to be displayed with the visual characteristic having a fourth value.

3. The method of claim 2, wherein:
the input focus is directed to the user interface element in accordance with a determination that the predefined portion of the user is within a threshold distance of a location corresponding to the user interface element, and
the input focus is directed to the second user interface element in accordance with a determination that the predefined portion of the user is within the threshold distance of the second user interface element.

4. The method of claim 2, wherein:
the input focus is directed to the user interface element in accordance with a determination that a gaze of the user is directed to the user interface element, and
the input focus is directed to the second user interface element in accordance with a determination that the gaze of the user is directed to the second user interface element.

5. The method of claim 2, wherein updating the visual characteristic of a user interface element toward which an input focus is directed includes:
in accordance with a determination that the predefined portion of the user is less than a threshold distance from a location corresponding to the user interface element, the visual characteristic of the user interface element toward which the input focus is directed is updated in accordance with a determination that the pose of the predefined portion of the user satisfies a first set of one or more criteria; and
in accordance with a determination that the predefined portion of the user is more than the threshold distance from the location corresponding to the user interface element, the visual characteristic of the user interface element toward which the input focus is directed is updated in accordance with a determination that the pose of the predefined portion of the user satisfies a second set of one or more criteria, different from the first set of one or more criteria.

6. The method of claim 1, wherein the pose of the predefined portion of the user satisfying the one or more criteria includes:
in accordance with a determination that the predefined portion of the user is less than a threshold distance from a location corresponding to the user interface element, the pose of the predefined portion of the user satisfying a first set of one or more criteria; and
in accordance with a determination that the predefined portion of the user is more than the threshold distance from the location corresponding to the user interface element, the pose of the predefined portion of the user satisfying a second set of one or more criteria, different from the first set of one or more criteria.

7. The method of claim 1, wherein the pose of the predefined portion of the user satisfying the one or more criteria includes:
in accordance with a determination that the predefined portion of the user is holding an input device of the one or more input devices, the pose of the predefined portion of the user satisfying a first set of one or more criteria, and
in accordance with a determination that the predefined portion of the user is not holding the input device, the pose of the predefined portion of the user satisfying a second set of one or more criteria.

8. The method of claim 1, wherein the pose of the predefined portion of the user satisfying the one or more criteria includes:
in accordance with a determination that the predefined portion of the user is less than a threshold distance from a location corresponding to the user interface element, the pose of the predefined portion of the user satisfying a first set of one or more criteria; and
in accordance with a determination that the predefined portion of the user is more than the threshold distance from the location corresponding to the user interface element, the pose of the predefined portion of the user satisfying the first set of one or more criteria.

9. The method of claim 1, wherein:
in accordance with a determination that the predefined portion of the user, during the input, is more than a threshold distance away from a location corresponding to the user interface element, the one or more criteria include a criterion that is satisfied when an attention of the user is directed towards the user interface element, and
in accordance with a determination that the predefined portion of the user, during the respective input, is less than the threshold distance away from the location corresponding to the user interface element, the one or more criteria do not include a requirement that the attention of the user is directed towards the user interface element in order for the one or more criteria to be met.

10. The method of claim 1, further comprising:
in response to detecting that a gaze of the user is directed to a first region of the user interface, visually de-emphasizing, via the display generation component, a second region of the user interface relative to the first region of the user interface; and
in response to detecting that the gaze of the user is directed to the second region of the user interface, visually de-emphasizing, via the display generation component, the first region of the user interface relative to the second region of the user interface.

11. The method of claim 10, wherein the user interface is accessible by the electronic device and a second electronic device, the method further comprising:
in accordance with an indication that a gaze of a second user of the second electronic device is directed to the first region of the user interface, forgoing visually de-emphasizing, via the display generation component, the second region of the user interface relative to the first region of the user interface; and
in accordance with an indication that the gaze of the second user of the second electronic device is directed to the second region of the user interface, forgoing visually de-emphasizing, via the display generation component, the first region of the user interface relative to the second region of the user interface.

12. The method of claim 1, wherein detecting the input from the predefined portion of the user of the electronic device includes detecting, via a hand tracking device, a pinch gesture performed by the predefined portion of the user.

13. The method of claim 1, wherein detecting the input from the predefined portion of the user of the electronic device includes detecting, via a hand tracking device, a press gesture performed by the predefined portion of the user.

14. The method of claim 1, wherein detecting the input from the predefined portion of the user of the electronic device includes detecting lateral movement of the predefined portion of the user relative to a location corresponding to the user interface element.

15. The method of claim 1, further comprising:
prior to determining that the pose of the predefined portion of the user prior to detecting the input satisfies the one or more criteria:
detecting, via an eye tracking device, that a gaze of the user is directed to the user interface element; and
in response to detecting, that the gaze of the user is directed to the user interface element, displaying, via the display generation component, a first indication that the gaze of the user is directed to the user interface element.

16. The method of claim 15, further comprising:
prior to detecting the input from the predefined portion of the user of the electronic device, while the pose of the predefined portion of the user prior to detecting the input satisfies the one or more criteria:
displaying, via the display generation component, a second indication that the pose of the predefined portion of the user prior to detecting the input satisfies the one or more criteria, wherein the first indication is different from the second indication.

17. The method of claim 1, further comprising:
while displaying the user interface element, detecting, via the one or more input devices, a second input from a second predefined portion of the user of the electronic device; and
in response to detecting the second input from the second predefined portion of the user of the electronic device:
in accordance with a determination that a pose of the second predefined portion of the user prior to detecting the second input satisfies one or more second criteria, performing a second respective operation in accordance with the second input from the second predefined portion of the user of the electronic device; and
in accordance with a determination that the pose of the second predefined portion of the user prior to detecting the second input does not satisfy the one or more second criteria, forgoing performing the second respective operation in accordance with the second input from the second predefined portion of the user of the electronic device.

18. The method of claim 1, wherein the user interface is accessible by the electronic device and a second electronic device, the method further comprising:
prior to detecting that the pose of the predefined portion of the user prior to detecting the input satisfies the one or more criteria, displaying the user interface element with a visual characteristic having a first value;
while the pose of the predefined portion of the user prior to detecting the input satisfies the one or more criteria, displaying the user interface element with the visual characteristic having a second value, different from the first value; and
while a pose of a predefined portion of a second user of the second electronic device satisfies the one or more criteria while displaying the user interface element with the visual characteristic having the first value, maintaining display of the user interface element with the visual characteristic having the first value.

19. The method of claim 18, further comprising:
in response to detecting the input from the predefined portion of the user of the electronic device, displaying the user interface element with the visual characteristic having a third value; and
in response to an indication of an input from the predefined portion of the second user of the second electronic device, displaying the user interface element with the visual characteristic having the third value.

20. An electronic device, comprising:
one or more processors;
memory; and
one or more programs, wherein the one or more programs are stored in the memory and configured to be executed by the one or more processors, the one or more programs including instructions for:
displaying, via a display generation component, a user interface that includes a user interface element;
while displaying the user interface element, detecting, via one or more input devices, an input from a predefined portion of a user of the electronic device; and
in response to detecting the input from the predefined portion of the user of the electronic device:
in accordance with a determination that a pose of the predefined portion of the user prior to detecting the input satisfies one or more criteria, performing a respective operation in accordance with the input from the predefined portion of the user of the electronic device; and
in accordance with a determination that the pose of the predefined portion of the user prior to detecting the input does not satisfy the one or more criteria, forgoing performing the respective operation in accordance with the input from the predefined portion of the user of the electronic device.

21. A non-transitory computer readable storage medium storing one or more programs, the one or more programs comprising instructions, which when executed by one or more processors of an electronic device, cause the electronic device to perform a method comprising:
displaying, via a display generation component, a user interface that includes a user interface element;
while displaying the user interface element, detecting, via one or more input devices, an input from a predefined portion of a user of the electronic device; and
in response to detecting the input from the predefined portion of the user of the electronic device:
in accordance with a determination that a pose of the predefined portion of the user prior to detecting the input satisfies one or more criteria, performing a respective operation in accordance with the input from the predefined portion of the user of the electronic device; and
in accordance with a determination that the pose of the predefined portion of the user prior to detecting the input does not satisfy the one or more criteria, forgoing performing the respective operation in accordance with the input from the predefined portion of the user of the electronic device.

22-200. (canceled)
